(19) United States
(12) Patent Application Publication
(10) Pub. No.: US 2026/0359924 A1
(43) Pub. Date: Nov. 12, 2026

(54) DISTRIBUTED PAIR WEIGHTED AVERAGING

(71) Applicant: NVIDIA Corporation, Santa Clara, CA (US)

(72) Inventors: Dejun Lin, Lynnwood, WA (US); Kit Sang Chu, Milpitas, CA (US); Kevin Boyd, Washington, DC (US); Christopher Brian Roland, New York, NY (US); John St. John, Brisbane, CA (US); Xiaowei Ren, Shanghai (CN); Emine Kucukbenli, Cambridge, MA (US); Yonatan Israeli, Los Altos, CA (US)

(21) Appl. No.: 19/672,628

(22) Filed: May 9, 2026

Related U.S. Application Data
(60) Provisional application No. 63/803,202, filed on May 9, 2025.

(51) Int. Cl. G06T 1/20

(52) U.S. Cl. CPC G06T 1/20

(57) ABSTRACT

Apparatuses, systems, and techniques to perform distributed weighted-averaging computations for machine-learning models. In at least one embodiment, aligned distributed blocks including value blocks derived from a sequence-alignment representation and weight blocks derived from a pair-representation tensor are used to compute a local weighted-averaging contribution and local normalization information, and a local normalization state and a local output block are updated based on the local weighted-averaging contribution and the local normalization information.

### CLAIM OF PRIORITY

This application claims the benefit of U.S. Provisional Application No. 63/803,202 (Attorney Docket No. 25-SE-0728), titled “Distributed Computation Strategy for the Training and Inference of Protein and Molecular Structure Prediction Models,” filed May 9, 2025, the entire contents of which is incorporated herein by reference.

### TECHNICAL FIELD

At least one embodiment pertains to distributed computing for machine learning. For example, at least one embodiment pertains to distributing computations for training and inference of a structure prediction model across multiple processors.

### BACKGROUND

Molecular structure prediction can be computationally challenging because the number of possible interactions among input elements may increase rapidly with sequence length and with the size of a molecular complex. For a molecular system having many input elements, a prediction system may evaluate large numbers of element-to-element relationships, including proximity, distance, orientation, connectivity, or other features associated with possible interactions among those input elements.

Some prediction models process multiple forms of representation while analyzing a molecular system. For example, a model may process information associated with individual sequence positions or atoms, information associated with pairs of sequence positions or atoms, and information associated with aligned biological sequences. As the number of input elements increases, such representations may grow into large multidimensional data structures, and computations performed on those representations may involve increasingly large sets of pairwise or alignment-based relationships.

The computational burden may become especially significant for long sequences and large complexes. In some cases, memory usage and processing time may increase substantially as input size increases. These effects may be present during model training, during model inference, or during both training and inference for molecular structure prediction.

### BRIEF DESCRIPTION OF DRAWINGS

FIG. 1 illustrates a distributed computing system to perform training and inference of a structure prediction model using distributed tensors across a device mesh, according to at least one embodiment;

FIG. 2 illustrates a process to prepare distributed input data for distributed model computation on a device mesh, according to at least one embodiment;

FIG. 3 illustrates data feature sharding to partition feature tensors into local tensor portions and corresponding distributed tensors for downstream distributed computation, according to at least one embodiment;

FIG. 4 illustrates a two-dimensional device mesh and example sharding of a single representation, a pair representation, a sequence-alignment representation, atom-level features, and mapping matrices across the device mesh, according to at least one embodiment;

FIG. 5 illustrates a process to perform inference data loading by generating a full feature set at a source device of a device mesh and distributing corresponding local portions to other devices of the device mesh for downstream distributed computation, according to at least one embodiment;

FIG. 6 illustrates a process to generate a predicted structure using feature preparation, distributed tensor generation, distributed model computation, and confidence computation, according to at least one embodiment;

FIG. 7A illustrates triangle attention using ring communication of key, value, triangle-bias, and, in some embodiments, mask blocks while a local query block remains local on a device mesh, according to at least one embodiment;

FIG. 7B illustrates an example of a process to perform distributed triangle attention, according to at least one embodiment;

FIG. 7C illustrates an example of a process to perform a backward pass for distributed triangle attention, according to at least one embodiment.

FIG. 8A illustrates triangle multiplication using redistribution of an input tensor and row-wise and column-wise ring communication on a device mesh, according to at least one embodiment;

FIG. 8B illustrates a process to perform distributed triangle multiplication, according to at least one embodiment;

FIG. 8C illustrates a process to perform a backward pass for distributed triangle multiplication, according to at least one embodiment;

FIG. 9A illustrates pair weighted averaging using value data derived from a sequence-alignment representation and weight data derived from a pair representation on a device mesh, according to at least one embodiment;

FIG. 9B illustrates an example of a process to perform distributed pair weighted averaging, according to at least one embodiment;

FIG. 9C illustrates an example of a process to perform a backward pass for distributed pair weighted averaging, according to at least one embodiment;

FIG. 10A illustrates outer product mean using projected sequence-alignment data communicated across a device mesh to update a local pair block, according to at least one embodiment;

FIG. 10B illustrates an example of a process to perform distributed outer product mean, according to at least one embodiment;

FIG. 10C illustrates an example of a process to perform a backward pass for distributed outer product mean, according to at least one embodiment;

FIG. 11A illustrates distributed attention with additive pair bias on a device mesh, according to at least one embodiment;

FIG. 11B illustrates an example of a process to perform distributed attention pair bias, according to at least one embodiment;

FIG. 11C illustrates an example of a process to perform a backward pass for distributed attention pair bias, according to at least one embodiment;

FIG. 12 illustrates a confidence model using distributed coordinate data to compute confidence scores, according to at least one embodiment;

FIG. 13 illustrates an example data center system, in accordance with at least one embodiment;

FIG. 14 illustrates a system-on-a-chip (SOC), in accordance with at least one embodiment;

FIG. 15 illustrates a parallel processor, in accordance with at least one embodiment;

FIG. 16 illustrates a core of central processing, in accordance with at least one embodiment;

FIGS. 17A and 17B illustrate a language processing unit, in accordance with at least one embodiment;

FIG. 18 illustrates a software stack of a programming platform, in accordance with at least one embodiment;

FIG. 19 illustrates compiling code to execute on programming platforms of FIG. 18, in accordance with at least one embodiment;

FIG. 20A illustrates inference and/or training logic, in accordance with at least one embodiment;

FIG. 20B illustrates inference and/or training logic, in accordance with at least one embodiment; and

FIG. 20C illustrates training and deployment of a neural network, in accordance with at least one embodiment.

### DETAILED DESCRIPTION

In the following description, numerous specific details are set forth to provide a more thorough understanding of at least one embodiment. However, it will be apparent to one skilled in the art that the inventive concepts may be practiced without one or more of these specific details.

In at least one embodiment, the present disclosure relates to distributed computation techniques for training and inference of protein and molecular structure prediction models. Such models often rely on tensor operations whose memory and compute costs grow rapidly with sequence length, atom count, alignment size, or combinations thereof. Pair-based representations, attention operations, pairwise update operations, and sequence-alignment-based reductions can therefore become difficult to execute efficiently on a single device because they involve large quadratic or higher-order tensor structures. As used herein, a sequence alignment refers to an arrangement of multiple biological sequences such that corresponding sequence positions appear in common alignment columns. As used herein, a sequence-alignment representation is a tensor representation of multiple aligned biological sequences that stores feature information for respective aligned sequences at respective aligned positions. The sequence-alignment representation includes an aligned-sequence axis that identifies different aligned sequences of the alignment and an aligned-position axis that identifies alignment columns shared across those aligned sequences. For example, the sequence-alignment representation may have shape (B, S, N, cin), where B identifies batch items, S identifies aligned sequences, N identifies aligned positions, and cin identifies feature channels. The disclosed techniques address these scaling challenges by partitioning data and computation across multiple devices while preserving correspondence with corresponding single-device computations. As used herein, a distributed computation is said to correspond to a corresponding single-device computation when the distributed computation produces output values numerically equivalent to those produced by the corresponding single-device computation up to floating-point round-off, with the floating-point round-off characterized by an order-of-summation difference and a relative error bound proportional to machine epsilon multiplied by the number of summands.

In at least one embodiment, the disclosed approach uses a distributed execution arrangement in which model inputs are transformed into distributed tensors and processed across a device mesh, such as a two-dimensional device mesh. Different categories of tensors may be distributed according to different sharding patterns based on their semantics, such as single-position features, pairwise features, sequence-alignment features, atom-level features, or mapping structures. As used herein, sharding refers to partitioning a global tensor into smaller portions that are distributed across different devices of a device mesh. Each device stores and computes on a local block of the global tensor, and different tensor dimensions may be sharded along different mesh dimensions or replicated depending on the distributed placement scheme. In at least one embodiment, feature tensors may be padded to mesh-compatible sizes, partitioned according to placement rules, and associated with distributed-tensor metadata that identifies global shape, local block ownership, and sharding placement on the device mesh. In at least one embodiment, a distributed resource manager and associated communication primitives maintain a consistent view of mesh topology, process-group structure, and coordinate-to-rank mappings, thereby enabling coordinated communication operations such as transpose communication, row-wise ring communication, column-wise ring communication, and point-to-point communication. In at least one embodiment, these techniques reduce per-device memory burden, avoid reconstructing full quadratic tensors on any one device, and enable larger structure-prediction workloads to be executed than would be practical on a single device.

In at least one embodiment, the disclosed techniques are useful in distributed attention computations, including distributed triangle attention and distributed attention with additive pair bias, in which one category of attention data remains local while other categories of attention data are communicated among devices. As used herein, a pair representation refers to a tensor representation that stores information associated with pairs of input elements. For example, entries of the pair representation may store feature vectors for respective pairs of input elements. As used herein, a shape of a tensor refers to an ordered set of dimension sizes of the tensor. In at least one embodiment, the pair representation has a shape that includes two dimensions corresponding to respective positions of the pairs. For example, a pair representation having shape B×N×N×D includes a batch dimension B, a first pair-position dimension N, a second pair-position dimension N, and a feature dimension D. As used herein, triangle attention refers to an attention operation performed over rows or columns of the pair representation, where entries of the pair representation store feature vectors for respective pairs of input elements, and where query data, key data, value data, triangle-bias data, and, in some cases, mask data are used to generate an updated representation. In at least one embodiment, distributed triangle attention is performed by retaining a local query block on a device while communicating aligned key blocks, value blocks, triangle-bias blocks, and, where used, mask blocks among devices so that each device computes local attention contributions for a local output block. As used herein, additive pair bias refers to a bias term derived from a pair representation and added to attention scores for corresponding query-key comparisons before normalization of the attention scores. In at least one embodiment, distributed attention with additive pair bias is performed by retaining a local query block on a device while communicating aligned key blocks, value blocks, pair-bias blocks, and, where used, mask blocks among devices so that the distributed attention result corresponds to a corresponding single-device computation. In at least one embodiment, such communicated blocks may be redistributed before the main attention computation and then shifted across one or more mesh dimensions during repeated communication steps. Each device may compute local attention contributions and local normalization information from its current locally available data and may generate an updated local normalization state and an updated local output block across communication steps so that the final distributed result corresponds to the corresponding single-device attention result.

In at least one embodiment, the disclosed techniques also support distributed contraction and reduction operations that build, update, or consume pair representations. As used herein, triangle multiplication refers to a tensor contraction over a shared index of two pair-derived tensors to generate an update to a pair representation. In at least one embodiment, distributed triangle multiplication is performed by partitioning two input tensors into local blocks, redistributing one input tensor for alignment, and then communicating blocks along different mesh dimensions so that each device successively computes local multiply-and-accumulate contributions for a local output block corresponding to the contraction over the shared index. As used herein, pair weighted averaging refers to an operation in which weight data derived from a pair representation is used to aggregate value data derived from a sequence-alignment representation into a weighted output. In at least one embodiment, distributed pair weighted averaging is performed by aligning value blocks derived from a sequence-alignment representation with weight blocks derived from a pair representation, redistributing the weight blocks for communication alignment, and generating updated local output blocks using local weighted-averaging contributions together with local normalization information. In this context, the sequence-alignment representation may encode information for many related biological sequences arranged in aligned columns, while the pair representation may encode information for relationships between pairs of positions.

In at least one embodiment, the disclosed techniques further support distributed operations that convert sequence-alignment information into pairwise information. As used herein, an outer product mean operation refers to an operation in which first and second projected representations derived from a sequence-alignment representation are combined through outer products and averaged over aligned sequences to generate or update a pair representation. In at least one embodiment, distributed outer product mean is performed by forming first and second projected tensors from a sequence-alignment representation, communicating aligned projected blocks across a device mesh, and accumulating local outer-product contributions into local pair blocks while also tracking contribution-count information, mask-count information, or other normalization information so that the resulting distributed computation produces the same mean as a corresponding single-device computation. In at least one embodiment, backward computation for distributed outer product mean may be performed using separate distributed passes for different projected tensors where gradients for different projected inputs contract with different pair axes.

In at least one embodiment, the disclosed framework encompasses a collection of distributed model operations that arise in protein and molecular structure prediction models, including triangle attention, triangle multiplication, pair weighted averaging, outer product mean, and attention with additive pair bias. Although these operations may use different communication patterns depending on the underlying tensor semantics, they share a common distributed strategy in which local tensor blocks are combined with communicated tensor blocks in a coordinated manner over repeated communication steps. Each device may compute local partial results, local normalization information, or local accumulation information, and may combine those local results across communication steps so that the distributed computation remains mathematically consistent with a corresponding single-device computation. In at least one embodiment, the disclosed framework may further support distributed data preparation, distributed gather operations, distributed scatter-reduce operations, and window-based computations that reduce or localize attention scope while preserving coordinated distributed execution across the device mesh. As a result, the disclosed techniques can provide scalable execution for structure-prediction model components that otherwise present substantial computational bottlenecks.

In at least one embodiment, the disclosed techniques support both inference and training. During inference, distributed model computation may produce a predicted structure together with confidence-related outputs derived from that predicted structure. During training, the same distributed framework may be used together with training data and model parameters to update the model while maintaining distributed execution across the device mesh. Although examples described herein are presented in the context of protein and molecular structure prediction, the disclosed distributed computation strategies may also be applied more generally to other machine-learning models that use large pairwise, attention-based, sequence-alignment-based, or windowed tensor operations.

In at least one embodiment, the disclosed framework further supports a window-batched distributed execution mode for atom-level or otherwise long-sequence operations in which standard attention scales as O(N²). In some embodiments, atoms are grouped into overlapping windows of length W with H half-windows per query window, and attention for each query window is restricted to the H neighboring half-windows, reducing complexity from O(N²) to O(N×H). In at least one embodiment, the window-batched mode is supported by a distributed sliding-window operation in which each device holds a balanced contiguous segment of input atoms after a distributed pack-and-pad operation, exchanges small halo regions of half-windows with immediate neighbor devices along a context-parallel mesh axis, and computes its local query windows using coordinate-adjusted offsets. In at least one embodiment, the distributed sliding-window operation exploits a block Toeplitz structure of the window-to-half-window mapping such that a constant-memory virtual view (e.g., implemented by an unfold operation) replaces an explicitly materialized sparse indexing matrix. In some embodiments, the window-batched mode is further supported by a distributed gather operation that uses interval-based point-to-point communication to fetch contiguous token ranges from peer devices, by a distributed outer-gather operation that uses two-dimensional interval-based communication for token-pair-to-atom-pair mapping over a two-dimensional sharded pair representation, and by a distributed scatter-reduce operation that aggregates atom-level results back to the token-owning device using interval-based point-to-point routing. In at least one embodiment, the distributed pack-and-pad operation rebalances variable-length inputs across devices via a prefix-sum and point-to-point redistribution, producing balanced segments divisible by the window size for downstream windowed attention. In some embodiments, backward computation for the window-batched operations performs purely local autograd over each device's windows for the attention itself, with cross-device gradient routing handled by the backward passes of the distributed gather, distributed outer-gather, and distributed scatter-reduce operations. In at least one embodiment, local autograd refers to calculating the gradients of a function within a small, self-contained tile of data without needing to reference global memory or generate a device-wide computation graph.

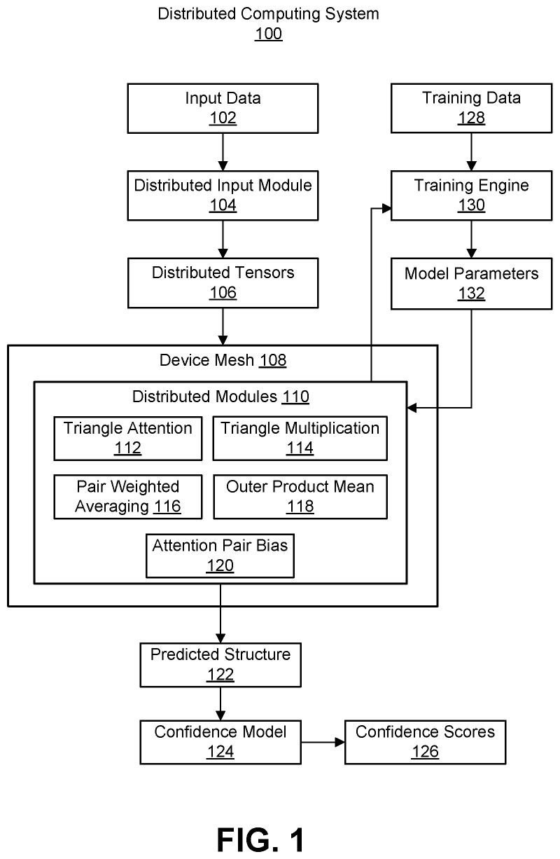

FIG. 1 illustrates an example of a distributed computing system 100 configured to perform distributed training and distributed inference for a structure prediction model, according to at least one embodiment. As shown, the distributed computing system 100 includes input data 102, a distributed input module 104, distributed tensors 106, a device mesh 108, distributed model modules 110, a predicted structure 122, a confidence model 124, and confidence scores 126. In some embodiments, the distributed computing system 100 further includes training data 128, a training engine 130, and model parameters 132. The input data 102 includes data from which a predicted structure is to be generated. In some embodiments, the input data 102 includes one or more of sequence data, token-level data, atom-level data, pairwise feature data, mask data, mapping data, sequence-alignment data, coordinate-related data, or other feature data used for structure prediction.

The distributed input module 104 receives the input data 102 and prepares the input data 102 for distributed computation. In some embodiments, the distributed input module 104 generates feature tensors, pads feature tensors to lengths compatible with distributed computation, partitions feature tensors into local portions corresponding to different devices, and associates the local portions with distributed-tensor metadata.

The distributed tensors 106 represent tensors distributed across multiple devices for downstream distributed model computation. In some embodiments, the distributed tensors 106 include distributed forms of one or more single representations, pair representations, sequence-alignment representations, atom-level features, mapping matrices, masks, projected tensors, or combinations thereof.

The device mesh 108 includes a plurality of devices arranged for distributed execution. In some embodiments, the device mesh 108 is a two-dimensional device mesh. The device mesh 108 executes distributed model operations on the distributed tensors 106 using the distributed model modules 110.

The distributed model modules 110 perform distributed model computations using the distributed tensors 106. In the illustrated embodiment, the distributed model modules 110 include triangle attention 112, triangle multiplication 114, pair weighted averaging 116, outer product mean 118, and attention pair bias 120.

The triangle attention 112 performs distributed triangle attention on a pair representation. The triangle multiplication 114 performs distributed triangle multiplication on distributed input tensors associated with a pair representation. The pair weighted averaging 116 performs distributed weighted averaging using value data derived from a sequence-alignment representation and weight data derived from a pair representation. The outer product mean 118 performs distributed reduction from a sequence-alignment representation to a pair representation. The attention pair bias 120 performs distributed attention using data derived from a single representation and a pair representation. In some embodiments, the attention pair bias 120 implements attention with additive pair bias.

In some embodiments, the distributed model modules 110 operate on local blocks of distributed tensors stored on respective devices of the device mesh 108 and exchange selected communicated blocks among the devices according to operator-specific communication patterns. For example, some distributed model modules retain one category of local block on a device while communicating other categories of blocks across one or more mesh dimensions, and some distributed model modules redistribute tensor blocks before repeated communication steps to align blocks for contraction, weighted averaging, or attention computation. Each device may compute local partial results and may update local accumulation information or local normalization information across multiple communication steps so that the distributed model computation corresponds to a corresponding single-device computation while avoiding reconstruction of full tensors on any one device.

Although FIG. 1 shows the particular distributed model modules 110 of triangle attention 112, triangle multiplication 114, pair weighted averaging 116, outer product mean 118, and attention pair bias 120, other embodiments may include fewer modules, additional modules, alternative modules, or different module ordering.

The predicted structure 122 is generated from computation performed by the distributed model modules 110. In some embodiments, the predicted structure 122 includes predicted coordinates, a predicted molecular structure, a predicted protein structure, atom-level structure output, token-level structure output, or another structure output produced from the distributed model computation.

The confidence model 124 receives the predicted structure 122 and/or structure-related intermediate data and generates confidence information associated with the predicted structure 122. In some embodiments, the confidence model 124 operates on distributed coordinate data or other distributed structure-related data to generate the confidence scores 126.

The confidence scores 126 represent output confidence information generated by the confidence model 124. In some embodiments, the confidence scores 126 indicate confidence for the overall predicted structure, for individual positions, for atom-level outputs, for pairwise relationships, or for other portions of the predicted structure 122.

FIG. 1 also shows a training path. The training data 128 includes data used to train the structure prediction model. The training engine 130 controls distributed training of the distributed model modules 110 and, in some embodiments, updates the model parameters 132 used by the distributed model modules 110. The model parameters 132 include parameters used by the distributed model modules 110 during inference and training.

In some embodiments, the distributed computing system 100 supports inference by processing the input data 102 through the distributed input module 104, generating the distributed tensors 106, executing the distributed model modules 110 across the device mesh 108, producing the predicted structure 122, and generating the confidence scores 126 using the confidence model 124. In some embodiments, the distributed computing system 100 supports training by additionally processing the training data 128 under control of the training engine 130 and updating the model parameters 132.

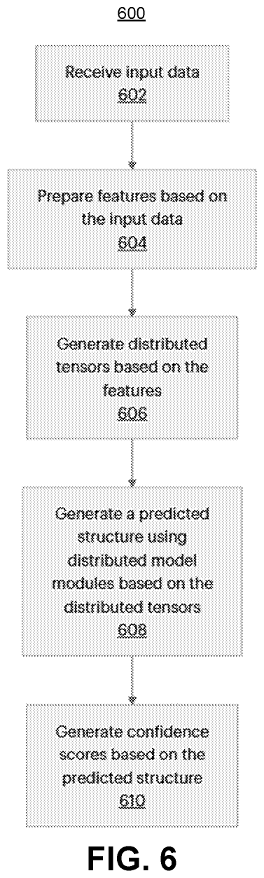

In some embodiments, the distributed computation performed in the distributed computing system 100 corresponds to a corresponding single-device computation while reducing per-device memory burden by distributing tensor storage and computation across the device mesh 108. Additional details of example communication patterns for the distributed model modules 110 are described below with respect to FIGS. 6-12.

Accordingly, FIG. 1 provides an overall system-level view of a distributed architecture for structure prediction in which input preparation, distributed tensor formation, distributed model execution, structure generation, confidence computation, and optional training are coordinated within the distributed computing system 100.

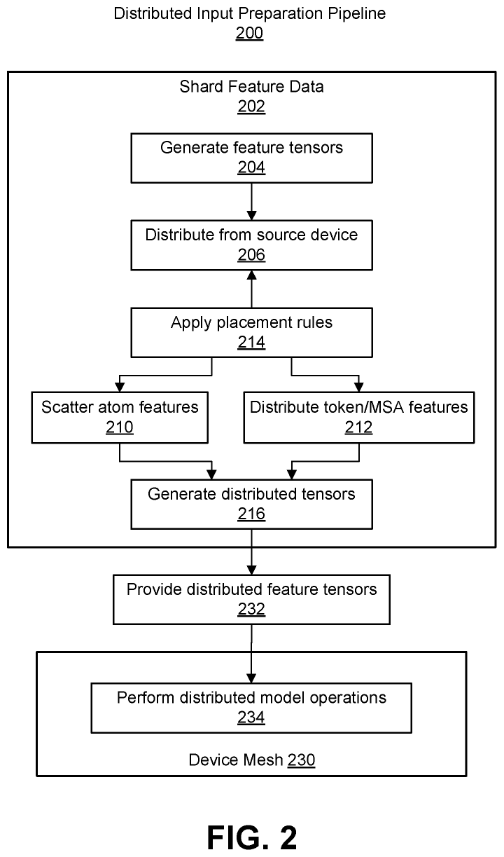

FIG. 2 illustrates an example of a process 200 to prepare distributed input data for distributed model computation on a device mesh, according to at least one embodiment. In at least one embodiment, some or all of process 200, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium. At least some computer-readable instructions usable to perform process 200 are not stored solely using transitory signals, such as a propagating transient electric or electromagnetic transmission. A non-transitory computer-readable medium does not necessarily include non-transitory data storage circuitry, such as buffers, caches, and queues, within transceivers of transitory signals.

In at least one embodiment, process 200 is performed by one or more systems such as those described in this present disclosure. In at least one embodiment, process 200 is performed by the system described in connection with FIG. 1. In at least one embodiment, process 200 is performed by a system of one or more programming models, such as CUDA, HIP, oneAPI, or variations thereof. One or more portions of process 200 are performed in any suitable order, including sequential, parallel, or variations thereof, and by any suitable system, such as those described herein, and using any suitable processing unit, such as a CPU, GPU, PPU, GPGPU, or variations thereof. Although process 200 is depicted as a series of steps or operations, process 200 may include altered or reordered steps or operations, or omit certain steps or operations, except where explicitly noted or logically required, such as when an output of one step or operation is used as input for another. One or more portions of process 200 may be performed as part of performing one or more server operations such as those described herein.

In at least one embodiment, shard feature data 202 is a stage of process 200 that prepares feature data for distributed execution. In at least one embodiment, shard feature data 202 includes generate 204 feature tensors, distribute 206 from source device, apply 214 placement rules, scatter 210 atom features, distribute 212 token/MSA features, and generate 216 distributed tensors. In at least one embodiment, shard feature data 202 distinguishes among different categories of feature tensors because different categories of features are distributed according to different sharding semantics. For example, the feature categories may include one-dimensional token features, one-dimensional atom features, two-dimensional pair features, multiple-sequence-alignment (MSA) features, mapping matrices, masks, coordinates, residue properties, or related feature tensors.

The system performing at least a part of process 200 includes code to at least generate 204 feature tensors. In at least one embodiment, generating 204 includes generating feature tensors for an example to be processed by the structure prediction model before distributed partitioning is applied. In at least one embodiment, generating 204 may include generating token features, atom features, pair masks, pair features, MSA features, residue properties, coordinates, masks, mapping matrices, or related tensors. In at least one embodiment, generating 204 corresponds to source-side feature preparation of the type performed by distributed input module 104 of FIG. 1.

The system performing at least a part of process 200 includes code to at least distribute 206 from source device. In at least one embodiment, distributing 206 includes distributing feature information from a source device for downstream distributed preparation. In at least one embodiment, only a source rank or source device initially holds a full feature set generated by a serial featurizer pipeline, and other ranks do not initially hold that full feature set. In at least one embodiment, distributing 206 includes broadcasting feature metadata, such as feature names, data types, or shapes, so that peer devices know tensor layouts before receiving corresponding local data. In at least one embodiment, distributing 206 may further include transmitting feature data or local feature portions from the source device after the metadata has been communicated.

The system performing at least a part of process 200 includes code to at least apply 214 placement rules. In at least one embodiment, applying 214 includes determining how different feature tensors are to be distributed. In at least one embodiment, the placement rules are predefined placement definitions that associate different feature categories with different sharding or replication patterns on device mesh 230. For example, one-dimensional atom features or one-dimensional token features may use row-sharded, column-replicated placement, two-dimensional pair features or MSA features may use both-axes sharded placement, and certain ensemble-aware features may use column-sharded, row-replicated placement. In at least one embodiment, mapping matrices such as atom-to-token mappings or token-to-representative-atom mappings are assigned placements that preserve intended structural relationships after distribution. In at least one embodiment, applying 214 determines whether downstream processing proceeds through scatter 210 atom features or distribute 212 token/MSA features.

The system performing at least a part of process 200 includes code to at least scatter 210 atom features. In at least one embodiment, scattering 210 includes distributing atom-related features according to atom-related partition boundaries. In at least one embodiment, atom features follow token partition boundaries based on atom-count information per token, such that token ranges map to corresponding atom ranges. In at least one embodiment, scattering 210 includes source-rank scatter in which the source device prepares per-rank shards and peer ranks receive corresponding shards. For example, one-dimensional atom features may be padded to mesh-compatible sizes and duplicated across a replicated mesh dimension, pair-mask or atom-pair features may be distributed as two-dimensionally sharded blocks, and diagonal mapping structures may be distributed according to diagonal block ownership. In at least one embodiment, scattering 210 is used because atom features may involve variable-length atom-to-token relationships that do not align with a regular tensor partition path.

The system performing at least a part of process 200 includes code to at least distribute 212 token/MSA features. In at least one embodiment, distributing 212 includes distributing token-level and MSA-related features according to the placement rules. In at least one embodiment, token and MSA features have regular tensor shapes that align more directly with mesh dimensions, and therefore can be distributed by a lighter-weight distribution path than the atom scatter path. For example, full tensors may be provided at the source rank and then sharded or replicated according to the corresponding placement entry for each feature. In at least one embodiment, distributing 212 is used for token features, pair features, MSA features, and other regularly shaped tensors whose distribution aligns directly with the mesh dimensions.

The system performing at least a part of process 200 includes code to at least generate 216 distributed tensors. In at least one embodiment, generating 216 includes generating distributed tensors from the local shards produced by scatter 210 atom features and distribute 212 token/MSA features. In at least one embodiment, generating 216 includes wrapping each local shard with explicit distributed metadata identifying a corresponding global shape, stride information, and placement information. For example, generating 216 may associate a local shard with metadata indicating whether the corresponding distributed tensor is row-sharded, column-sharded, both-axes sharded, replicated, or otherwise distributed across device mesh 230. In at least one embodiment, generating 216 uses explicit distributed metadata so that downstream distributed computation can operate on the resulting distributed tensors without requiring implicit metadata gathering.

The system performing at least a part of process 200 includes code to at least provide 232 distributed feature tensors. In at least one embodiment, providing 232 includes providing the distributed tensors for downstream distributed execution. In at least one embodiment, providing 232 corresponds to output distributed feature tensors that serve as a common distributed input representation for downstream distributed model modules. In at least one embodiment, providing 232 is downstream of shard feature data 202 and upstream of device mesh 230.

In at least one embodiment, device mesh 230 is an arrangement of multiple devices configured to execute distributed model computation using the distributed feature tensors. In at least one embodiment, device mesh 230 stores local shards of distributed tensors and executes distributed operations using those local shards together with inter-device communication. In at least one embodiment, device mesh 230 may be a two-dimensional device mesh, such as a two-dimensional GPU mesh, although other device arrangements may be used in various embodiments.

The system performing at least a part of process 200 includes code to at least perform 234 distributed model operations. In at least one embodiment, performing 234 includes performing downstream distributed model computations within device mesh 230. In at least one embodiment, performing 234 includes receiving the distributed feature tensors provided at provide 232 and using those distributed feature tensors as inputs to distributed model modules. For example, performing 234 may include distributed execution of triangle attention 112, triangle multiplication 114, pair weighted averaging 116, outer product mean 118, attention pair bias 120, or related distributed model computations of FIG. 1. In at least one embodiment, the distributed model operations are performed using local shards, communicated blocks, or both, while preserving correspondence with a non-distributed computation.

Accordingly, FIG. 2 illustrates a process 200 in which shard feature data 202 includes generating 204 feature tensors, distributing 206 from source device, applying 214 placement rules, scattering 210 atom features, distributing 212 token/MSA features, and generating 216 distributed tensors, after which distributed feature tensors are provided at 232 and distributed model operations are performed at 234 within device mesh 230. In at least one embodiment, process 200 bridges source-side feature preparation and downstream distributed model execution by converting source-side feature data into distributed tensors suitable for distributed computation.

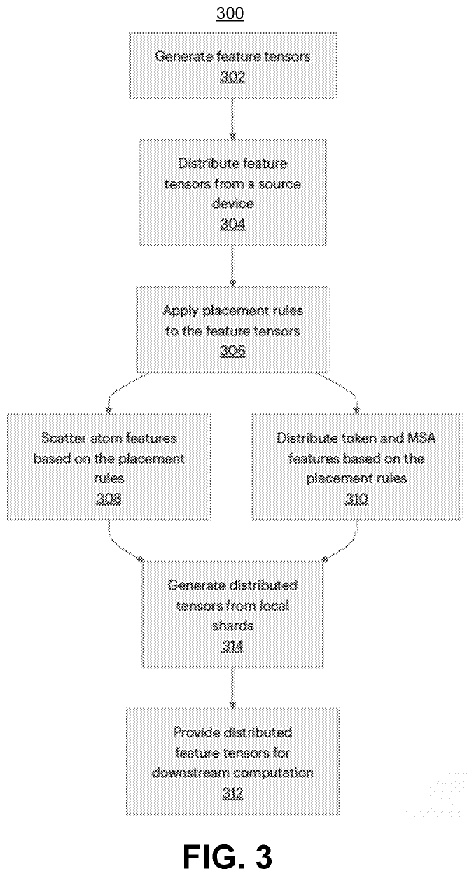

FIG. 3 illustrates an example of a process 300 to shard feature tensors into local tensor portions and corresponding distributed tensors for downstream distributed computation, according to at least one embodiment. In at least one embodiment, some or all of process 300, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium. At least some computer-readable instructions usable to perform process 300 are not stored solely using transitory signals, such as a propagating transient electric or electromagnetic transmission. A non-transitory computer-readable medium does not necessarily include non-transitory data storage circuitry, such as buffers, caches, and queues, within transceivers of transitory signals.

In at least one embodiment, process 300 is performed by one or more systems such as those described in this present disclosure. In at least one embodiment, process 300 is performed by the system described in connection with FIGS. 1, 2, 4, and 5. In at least one embodiment, process 300 is performed by a system of one or more programming models, such as CUDA, HIP, oneAPI, or variations thereof. One or more portions of process 300 are performed in any suitable order, including sequential, parallel, or variations thereof, and by any suitable system, such as those described herein, and using any suitable processing unit, such as a CPU, GPU, PPU, GPGPU, or variations thereof. Although process 300 is depicted as a series of steps or operations, process 300 may include altered or reordered steps or operations, or omit certain steps or operations, except where explicitly noted or logically required, such as when an output of one step or operation is used as input for another. In at least one embodiment, process 300 is performed by one or more systems such as those described in connection with FIG. 6. One or more portions of process 300 may be performed as part of performing one or more server operations such as those described herein.

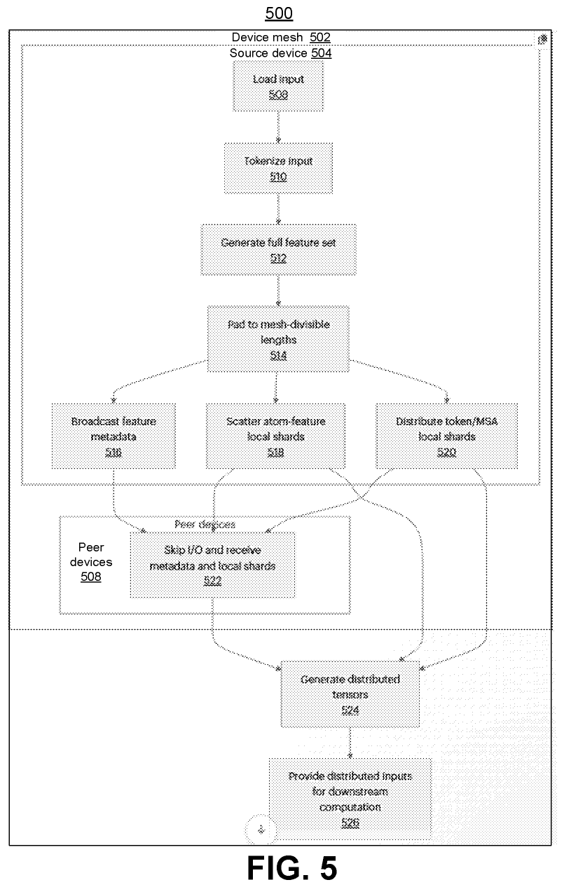

The system performing at least a part of process 300 includes code to at least generate 302 feature tensors. In at least one embodiment, generating 302 includes generating full feature tensors for a structure-prediction example before distributed partitioning is applied. In at least one embodiment, generating 302 may include generating token features, atom features, pair masks, pair features, multiple-sequence-alignment (MSA) features, residue properties, coordinates, masks, mapping matrices, or related tensors. In at least one embodiment, generating 302 corresponds to source-side feature preparation of the type described in connection with distributed input module 104 of FIG. 1 and source device 504 of FIG. 5.

The system performing at least a part of process 300 includes code to at least distribute 304 feature tensors from a source device. In at least one embodiment, distributing 304 includes distributing feature information from a source device for downstream distributed preparation. In at least one embodiment, only a source rank or source device initially holds a full feature set generated by a serial featurizer pipeline, and peer ranks do not initially hold that full feature set. In at least one embodiment, distributing 304 includes broadcasting feature metadata, such as feature names, data types, or shapes, so that peer devices can determine tensor layouts before receiving corresponding local data. In at least one embodiment, distributing 304 may further include transmitting feature data or local feature portions after the metadata has been communicated. In at least one embodiment, distributing 304 corresponds to source-device distribution of the type described in connection with source device 504 and peer devices of FIG. 5.

The system performing at least a part of process 300 includes code to at least apply 306 placement rules to the feature tensors. In at least one embodiment, applying 306 includes applying predefined placement definitions that determine how different feature tensors are distributed across a device mesh. In at least one embodiment, the placement rules associate different tensor semantics with different sharding or replication patterns on a two-dimensional device mesh. For example, one-dimensional token features or one-dimensional atom features may use row-sharded, column-replicated placement, two-dimensional pair features or MSA features may use both-axes sharded placement, and certain ensemble-aware features may use column-sharded, row-replicated placement. In at least one embodiment, mapping matrices such as atom-to-token mappings and token-to-representative-atom mappings are assigned placements that preserve intended structural relationships after distribution. In at least one embodiment, applying 306 controls distributing 304 and determines whether downstream processing proceeds through scatter atom features 308 or distribute token and MSA features 310.

The system performing at least a part of process 300 includes code to at least scatter 308 atom features based on the placement rules. In at least one embodiment, scattering 308 includes distributing atom-related features according to atom-related partition boundaries. In at least one embodiment, atom features follow token partition boundaries based on atom-count information per token, such that token ranges map to corresponding atom ranges. In at least one embodiment, scattering 308 includes source-rank scatter in which the source device prepares per-rank shards and peer ranks receive corresponding shards. For example, one-dimensional atom features may be padded to mesh-compatible sizes and duplicated across a replicated mesh dimension, pair-mask or atom-pair features may be distributed as two-dimensionally sharded blocks, and mapping structures may be distributed according to diagonal block ownership. In at least one embodiment, scattering 308 is used because atom features may involve variable-length atom-to-token relationships that do not align with a regular tensor partition path.

The system performing at least a part of process 300 includes code to at least distribute 310 token and MSA features based on the placement rules. In at least one embodiment, distributing 310 includes distributing token-level and MSA-related features according to the placement rules. In at least one embodiment, token and MSA features have regular tensor shapes that align more directly with mesh dimensions than atom features, and therefore can be distributed using a lighter-weight distribution path. For example, full tensors may be provided at the source rank and then sharded or replicated according to the corresponding placement entry for each feature. In at least one embodiment, distributing 310 is used for token features, pair features, MSA features, and other regularly shaped tensors whose distribution aligns directly with the mesh dimensions.

The system performing at least a part of process 300 includes code to at least generate 314 distributed tensors from local shards. In at least one embodiment, generating 314 includes generating distributed tensors from the local shards produced by scatter atom features 308 and distribute token and MSA features 310. In at least one embodiment, generating 314 includes wrapping each local shard with explicit distributed metadata identifying a corresponding global shape, stride information, and placement information. For example, generating 314 may associate a local shard with metadata indicating whether a corresponding distributed tensor is row-sharded, column-sharded, both-axes sharded, replicated, or otherwise distributed across a device mesh. In at least one embodiment, generating 314 uses explicit distributed metadata so that downstream distributed computation can operate on the resulting distributed tensors without requiring implicit metadata gathering.

The system performing at least a part of process 300 includes code to at least provide 312 distributed feature tensors for downstream computation. In at least one embodiment, providing 312 includes providing the distributed tensors generated at generate 314 for downstream distributed execution. In at least one embodiment, providing 312 corresponds to output distributed feature tensors that serve as a common distributed input representation for downstream distributed model modules. In at least one embodiment, providing 312 is downstream of generate 314 and upstream of one or more distributed model computations performed using the distributed feature tensors.

In at least one embodiment, the distributed feature tensors provided at provide 312 are consumed by distributed model computation on a device mesh, such as device mesh 108 of FIG. 1. In at least one embodiment, the device mesh stores local shards of distributed tensors and executes distributed operations using those local shards together with inter-device communication. In at least one embodiment, the device mesh may be a two-dimensional device mesh, such as a two-dimensional GPU mesh, although other device arrangements may be used in various embodiments.

In at least one embodiment, the distributed feature tensors provided at provide 312 may be used as inputs to distributed model modules such as triangle attention 112, triangle multiplication 114, pair weighted averaging 116, outer product mean 118, attention pair bias 120, or combinations thereof of FIG. 1. In at least one embodiment, those distributed model computations are performed using local shards, communicated blocks, or both, while preserving correspondence with a non-distributed computation. In at least one embodiment, process 300 therefore operates as a preparatory sharding and tensor-formation process for downstream distributed execution rather than as the distributed model computation itself.

Accordingly, FIG. 3 illustrates a process 300 in which feature tensors are generated at 302, feature tensors are distributed from a source device at 304, placement rules are applied to the feature tensors at 306, atom features are scattered based on the placement rules at 308, token and MSA features are distributed based on the placement rules at 310, distributed tensors are generated from local shards at 314, and distributed feature tensors are provided for downstream computation at 312. In at least one embodiment, process 300 bridges source-side feature preparation and downstream distributed model execution by converting feature tensors into distributed tensors having placements suitable for distributed computation while preserving feature-category-specific distribution behavior for atom-related features and for token-level and MSA-related features.

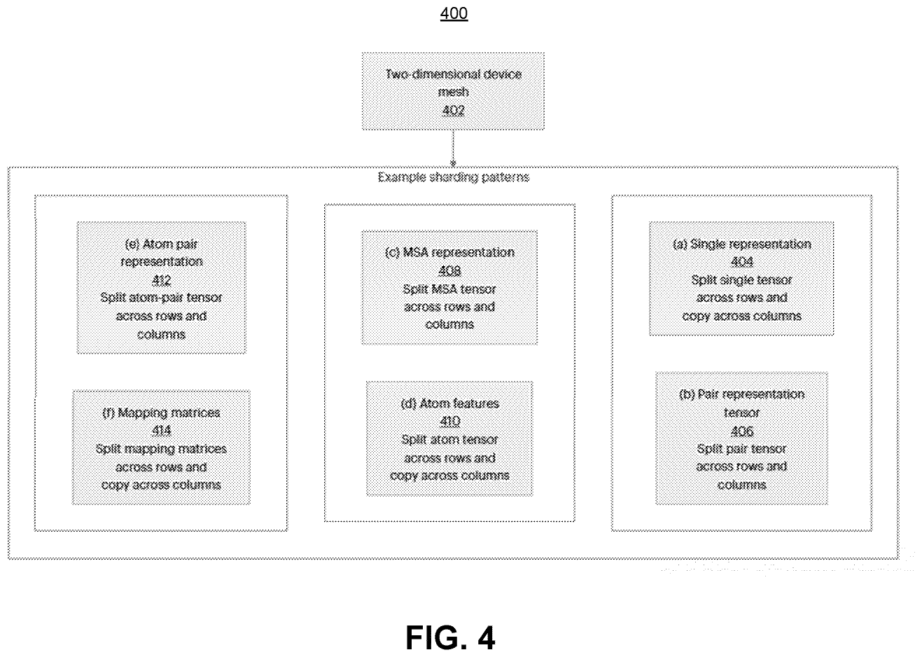

FIG. 4 illustrates a two-dimensional device mesh 402 and example sharding patterns for different tensor categories, according to at least one embodiment. In at least one embodiment, FIG. 4 shows how different tensor categories are distributed across the same two-dimensional device mesh 402 according to tensor semantics. In at least one embodiment, the illustrated sharding patterns correspond to placement definitions used by the data feature sharding techniques described herein.

In at least one embodiment, the two-dimensional device mesh 402 includes devices arranged along a first mesh axis and a second mesh axis. For explanatory purposes, an example 2×2 device mesh may include devices D[0,0], D[0,1], D[1,0], and D[1,1], where the first index identifies a coordinate of a GPU on a row mesh axis of the device mesh and the second index identifies a coordinate of the GPU on a column mesh axis of the device mesh. As used herein, a coordinate on a mesh axis may refer to an index value that identifies a position of a GPU on that mesh axis. In at least one embodiment, when a shard is described as being owned by D[0,:] or D[1,:], that indicates that the same shard is copied across the devices in the corresponding row.

A GPU may therefore be identified by a mesh coordinate that includes a respective coordinate on each mesh axis of the device mesh. For example, a GPU identified as D[i,j] may have coordinate i on the row mesh axis and coordinate j on the column mesh axis. In one example, in a 3×3 device mesh, a GPU at mesh coordinate (1, 2) has coordinate 1 on a first mesh axis and coordinate 2 on a second mesh axis.

The single representation 404 illustrates a single-representation tensor that is split across rows and copied across columns ((Shard(0), Replicate( ))). In at least one embodiment, an upper shard of the single representation 404 is owned by devices D[0,:], and a lower shard of the single representation 404 is owned by devices D[1,:]. In at least one embodiment, the single representation 404 may correspond to a token single representation or another one-dimensional tensor distributed by splitting the tensor along a first tensor dimension across rows of the device mesh and copying the resulting shard across columns of the device mesh.

The pair representation tensor 406 illustrates a pair tensor that is split across rows and columns ((Shard(0), Shard(1))). In at least one embodiment, a top-left block of the pair representation tensor 406 is owned by device D[0,0], a top-right block is owned by device D[0,1], a bottom-left block is owned by device D[1,0], and a bottom-right block is owned by device D[1,1]. In at least one embodiment, the pair representation tensor 406 may correspond to a token-pair representation or another two-dimensional pairwise tensor distributed by sharding a first tensor dimension across mesh rows and a second tensor dimension across mesh columns.

The MSA representation 408 illustrates an MSA tensor that is split across rows and columns ((Shard(0), Shard(1))). In at least one embodiment, a top-left block of the MSA representation 408 is owned by device D[0,0], a top-right block is owned by device D[0,1], a bottom-left block is owned by device D[1,0], and a bottom-right block is owned by device D[1,1]. In at least one embodiment, the MSA representation 408 may be indexed by an aligned-sequence axis and an aligned-position axis and may be distributed as two-dimensionally sharded blocks across the device mesh 402, where the aligned-sequence axis identifies different aligned sequences of the alignment and the aligned-position axis identifies alignment columns shared across those aligned sequences.

The atom features 410 illustrate atom-level features that are split across rows and copied across columns ((Shard(0), Replicate( ))). In at least one embodiment, an upper shard of the atom features 410 is owned by devices D[0,:], and a lower shard of the atom features 410 is owned by devices D[1,:]. In at least one embodiment, the atom features 410 may include one-dimensional atom features distributed by splitting an atom dimension across rows of the device mesh and copying the resulting shard across columns of the device mesh.

The atom pair representation 412 illustrates an atom-pair tensor that is split across rows and columns ((Shard(0), Shard(1))). In at least one embodiment, a top-left block of the atom pair representation 412 is owned by device D[0,0], a top-right block is owned by device D[0,1], a bottom-left block is owned by device D[1,0], and a bottom-right block is owned by device D[1,1]. In at least one embodiment, the atom pair representation 412 may include atom-pair masks or other two-dimensional atom-level pair tensors distributed across both mesh axes.

The mapping matrices 414 illustrate mapping structures that are split across rows and copied across columns ((Shard(0), Replicate( ))). In at least one embodiment, a top-left block of the mapping matrices 414 is owned by devices D[0,:], a bottom-right block is owned by devices D[1,:], and off-diagonal blocks are zeros. In at least one embodiment, the mapping matrices 414 have a diagonal block structure such that only the diagonal blocks carry mapping content and the off-diagonal blocks contain zeros. In at least one embodiment, the mapping matrices 414 may include atom_to_token, token_to_rep_atom, or related mapping structures.

In at least one embodiment, FIG. 4 therefore illustrates that different tensor categories may use different distributed layouts on the same two-dimensional device mesh 402. For example, single representations and atom features may be split across rows and copied across columns, pair representations, MSA representations, and atom-pair representations may be split across rows and columns, and mapping matrices may be split across rows and copied across columns while preserving a diagonal block structure. In at least one embodiment, these sharding patterns define device ownership of local shards for downstream distributed computation.

FIG. 5 illustrates a process to perform inference data loading by generating a full feature set at a source device 504 of a device mesh 502 and distributing corresponding local shards to peer devices 506 of the device mesh 502 for downstream distributed computation, according to at least one embodiment.

In at least one embodiment, the device mesh 502 includes multiple devices configured to participate in distributed inference. In at least one embodiment, one device of the device mesh 502 operates as the source device 504, while one or more other devices operate as peer devices 506. In at least one embodiment, the source device 504 corresponds to a source rank that performs serial input loading and feature generation for an input example, while the peer devices 506 do not independently perform the same serial pipeline for that input example.

The source device 504 performs a load input operation 508. In at least one embodiment, the load input operation 508 includes loading an input example for structure prediction, such as sequence data, atom-related data, alignment-related data, or other structure-prediction input data. In one illustrative example, the load input operation 508 includes loading an input sample representing a molecular target having an amino-acid sequence, atom information for residues of the sequence, and alignment-related information associated with homologous sequences. In at least one embodiment, the source device 504 reads that input sample while the peer devices 506 do not separately read the same sample from storage.

The source device 504 performs a tokenize input operation 510. In at least one embodiment, the tokenize input operation 510 includes converting the loaded input into token-level form for downstream feature generation. In one illustrative example, the tokenize input operation 510 includes converting a residue sequence into an ordered token sequence in which each token corresponds to a residue position of the input sequence. In at least one embodiment, if the input example contains four residues, the tokenize input operation 510 may generate four corresponding tokens that are then used to organize downstream token features, pair features, and atom-to-token mappings.

The source device 504 performs a generate full feature set operation 512. In at least one embodiment, the generate full feature set operation 512 includes generating a full feature dictionary or other full feature set for the input example before distribution across the device mesh 502. In at least one embodiment, the generated features include one or more of atom features, token features, pair features, multiple-sequence-alignment (MSA) features, mask features, mapping structures, or related feature tensors.

In one illustrative example, the generate full feature set operation 512 includes generating token-level features for each token, pairwise features for token pairs, MSA features for aligned sequences, atom-level features for atoms associated with the tokens, and mapping structures that associate atoms with tokens or representative atoms. In at least one embodiment, the source device 504 temporarily holds these features as full tensors before distribution of local shards to the peer devices 506.

The source device 504 performs a pad to mesh-divisible lengths operation 514. In at least one embodiment, the pad to mesh-divisible lengths operation 514 includes padding one or more feature tensors so that tensor lengths are compatible with sharding across the device mesh 502. In at least one embodiment, token lengths and sequence-alignment lengths are padded to values divisible by a shard count of a mesh axis, and atom-related lengths are padded to values compatible with both sharding and window-batching constraints.

In one illustrative example, for a 2×2 device mesh 502, an input having four tokens may already satisfy token divisibility, while an MSA having three aligned sequences may be padded to four aligned sequences so that the MSA dimension is divisible by a row-shard count of two. In another illustrative example, if atom features for the input correspond to ten atoms and a local atom-shard length of six is used for row-wise atom distribution, the source device 504 may pad one local atom shard so that per-row atom-feature buffers have compatible lengths before distribution.

The source device 504 performs a broadcast feature metadata operation 516. In at least one embodiment, the broadcast feature metadata operation 516 includes broadcasting metadata describing one or more feature tensors to the peer devices 506. In at least one embodiment, the metadata includes one or more of feature names, data types, shapes, tensor ordering information, or other information that allows the peer devices 506 to prepare to receive corresponding local shards.

In one illustrative example, the source device 504 broadcasts metadata indicating that a token feature tensor has a particular data type and shape, that an MSA tensor has another data type and shape, and that an atom-feature tensor has a further data type and shape. In at least one embodiment, the peer devices 506 use the broadcast metadata to allocate buffers or otherwise prepare to receive their local portions of those tensors without first generating the full tensors locally.

The source device 504 further performs a scatter atom-feature local shards operation 518 and a distribute token/MSA local shards operation 520. In at least one embodiment, these operations implement different distribution paths for different feature categories.

In at least one embodiment, the scatter atom-feature local shards operation 518 includes scattering local atom-feature shards from the source device 504 to devices of the device mesh 502. In at least one embodiment, atom features are distributed using a scatter-based path because atom-related feature structures may have irregular sizes or variable-length mappings associated with token partitions.

In at least one embodiment, the scatter atom-feature local shards operation 518 includes determining atom ranges from token partitions and transmitting corresponding local atom-feature shards from the source device 504 to devices of the device mesh 502. For example, for an input having four tokens with atom counts of 3, 1, 2, and 4 on a 2×2 device mesh, a first token partition containing the first two tokens corresponds to a first atom shard containing the first four atoms, and a second token partition containing the second two tokens corresponds to a second atom shard containing the remaining six atoms. The source device 504 may therefore transmit the first atom shard to devices in a first row of the device mesh 502 and the second atom shard to devices in a second row of the device mesh 502, with one or more of the shards padded before transmission.

In at least one embodiment, the distribute token/MSA local shards operation 520 includes distributing token-feature shards, pair-feature shards, and MSA-feature shards according to predefined distributed placements on the device mesh 502. In at least one embodiment, such tensors have regular shapes that align with the mesh dimensions and may therefore be distributed according to corresponding sharding placements without the same irregular scatter behavior used for certain atom features.

In one illustrative example, for a 2×2 device mesh 502 and an input having four tokens, a one-dimensional token feature tensor may be split into a first token shard for tokens 0-1 and a second token shard for tokens 2-3, with each row of the device mesh 502 receiving one of those token shards and copying that token shard across devices in the row. In another illustrative example, a token-pair tensor or MSA tensor may be split across both rows and columns so that different devices receive different two-dimensional blocks corresponding to different token-token or sequence-token regions of the global tensor.

The peer devices 506 perform a receive metadata and local shards operation 522. In at least one embodiment, the peer devices 506 do not perform the serial load, tokenize, and full-feature-generation operations for the input example. Instead, the peer devices 506 receive the broadcast metadata and the corresponding local shards generated and distributed by the source device 504.

In one illustrative example, a peer device 506 may receive metadata identifying the local tensor shapes it should expect, receive a local atom-feature shard associated with a token partition assigned to its mesh row, and receive local token, pair, or MSA shards associated with its distributed placement on the device mesh 502. In at least one embodiment, that peer device 506 may then proceed with downstream distributed processing without separately loading the original input sample or constructing the full feature set.

The devices of the device mesh 502, including the source device 504 and the peer devices 506, perform a generate distributed tensors operation 524. In at least one embodiment, the generate distributed tensors operation 524 includes wrapping local shards with distributed-tensor metadata that identifies global tensor shape, local shard ownership, and placement on the device mesh 502. In at least one embodiment, the distributed tensors are generated from the local shards after atom-feature scatter and token/MSA distribution have been completed.

In one illustrative example, after a device receives a local token shard, a local pair-tensor block, or a local atom-feature shard, the device generates a distributed tensor object that identifies the global tensor shape, the device-local shard, and whether the tensor is split across rows and copied across columns, split across rows and columns, or otherwise placed on the device mesh 502. In at least one embodiment, these distributed tensors form a common distributed-input representation for downstream model modules.

The devices of the device mesh 502 then perform a provide distributed inputs for downstream computation operation 526. In at least one embodiment, the distributed tensors generated at operation 524 are supplied as distributed inputs to downstream distributed model computation, such as triangle attention, triangle multiplication, pair weighted averaging, outer product mean, attention pair bias, or other distributed structure-prediction computation.

In one illustrative example, distributed token, pair, MSA, atom, and mapping tensors generated at operation 524 are provided to distributed model modules that compute local partial results on each device while communicating aligned blocks across the device mesh 502. In at least one embodiment, a distributed pair tensor generated through operation 524 may be consumed by triangle attention or triangle multiplication, while distributed MSA and pair tensors may be consumed by pair weighted averaging or outer product mean.

In at least one embodiment, FIG. 5 therefore illustrates an inference-loading arrangement in which the source device 504 performs serial input preparation for an input example, distributes local feature shards to peer devices 506 across the device mesh 502, and enables the devices of the device mesh 502 to generate distributed tensors for downstream distributed inference computation. In at least one embodiment, this arrangement reduces redundant file input/output and redundant serial preprocessing across devices while still providing each device with the local tensor data needed for distributed execution.

FIG. 6 illustrates an example of a process 600 to generate a predicted structure and confidence scores, according to at least one embodiment. In at least one embodiment, some or all of process 600, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium.

In at least one embodiment, process 600 is performed by one or more systems such as those described in the present disclosure. In at least one embodiment, process 600 is performed by the distributed computing system 100 described in connection with FIG. 1, including the distributed input module 104, the distributed tensors 106, the device mesh 108, the distributed model modules 110, the predicted structure 122, the confidence model 124, and the confidence scores 126. In at least one embodiment, one or more portions of process 600 are performed using distributed input preparation, feature sharding, and distributed tensor generation techniques such as those described herein. One or more portions of process 600 may be performed in any suitable order, including sequential, parallel, or variations thereof, and by any suitable system, such as those described herein, and using any suitable processing unit, such as a CPU, GPU, PPU, GPGPU, or variations thereof. Although process 600 is depicted as a series of steps or operations, process 600 may include altered or reordered steps or operations, or may omit certain steps or operations, except where explicitly noted or logically required.

The system performing at least a part of process 600 includes code to at least receive 602 input data. The input data is, for example, data from which a predicted structure is to be generated. For example, the input data may include sequence data, token-level data, atom-level data, pairwise feature data, mask data, mapping data, multiple-sequence-alignment data, coordinate-related data, or other structure-prediction input data. In at least one embodiment, a source device or source rank receives a full input example for downstream preparation, while another device of a device mesh receives local data, metadata, or both after distribution.

The system performing at least a part of process 600 includes code to at least prepare 604 features based on the input data. Feature preparation is, for example, processing that transforms the received input data into feature tensors or other prepared data structures suitable for downstream distributed computation. For example, feature preparation may include generating feature values, normalizing feature values, applying padding, generating or applying masks, generating mapping structures, or selecting placements for different categories of feature tensors. In at least one embodiment, the feature preparation aligns tensor lengths with mesh-compatible sizes and organizes feature data according to semantics associated with single-position data, pairwise data, sequence-alignment data, atom data, or mapping data.

The system performing at least a part of process 600 includes code to at least generate 606 distributed tensors based on the features. A distributed tensor is, for example, a tensor representation in which a global tensor is partitioned into local shards stored on different devices and associated with metadata that identifies global shape, local ownership, and placement on a device mesh. For example, the system may shard a single representation along a mesh axis and replicate that representation along another mesh axis, shard a pair representation along two mesh axes, or distribute atom features, multiple-sequence-alignment features, and mapping structures according to corresponding placement rules. In at least one embodiment, generating the distributed tensors includes scattering local portions of irregular feature data, distributing regular feature tensors according to predefined placements, and wrapping resulting local shards with distributed-tensor metadata for downstream execution.

The system performing at least a part of process 600 includes code to at least generate 608 a predicted structure using distributed model modules based on the distributed tensors. Distributed model computation is, for example, execution of model operations on local tensor blocks together with communicated tensor blocks across a device mesh so that the distributed result corresponds to a corresponding non-distributed model computation. For example, the distributed model modules may include triangle attention 112, triangle multiplication 114, pair weighted averaging 116, outer product mean 118, attention pair bias 120, or combinations thereof. In at least one embodiment, different devices compute local partial results for corresponding local blocks, exchange aligned blocks using row-wise communication, column-wise communication, transpose communication, point-to-point communication, or combinations thereof, and update local accumulation information, local normalization information, or both across repeated communication steps. In at least one embodiment, the predicted structure includes predicted coordinates, a predicted protein structure, a predicted molecular structure, atom-level structure output, token-level structure output, or other structure output generated from the distributed model modules.

The system performing at least a part of process 600 includes code to at least generate 610 confidence scores based on the predicted structure. Confidence scoring is, for example, computation of confidence information associated with the predicted structure using structure-related data, coordinate data, pairwise data, or other model outputs. For example, the confidence scores may include predicted local distance difference test values, predicted distance error values, predicted aligned error values, experimentally resolved predictions, or other confidence-related outputs associated with the predicted structure. In at least one embodiment, the confidence model 124 receives the predicted structure 122, distributed coordinate data, intermediate structure-related representations, or combinations thereof and generates confidence information for an overall structure, individual positions, pairwise relationships, or atom-level outputs.

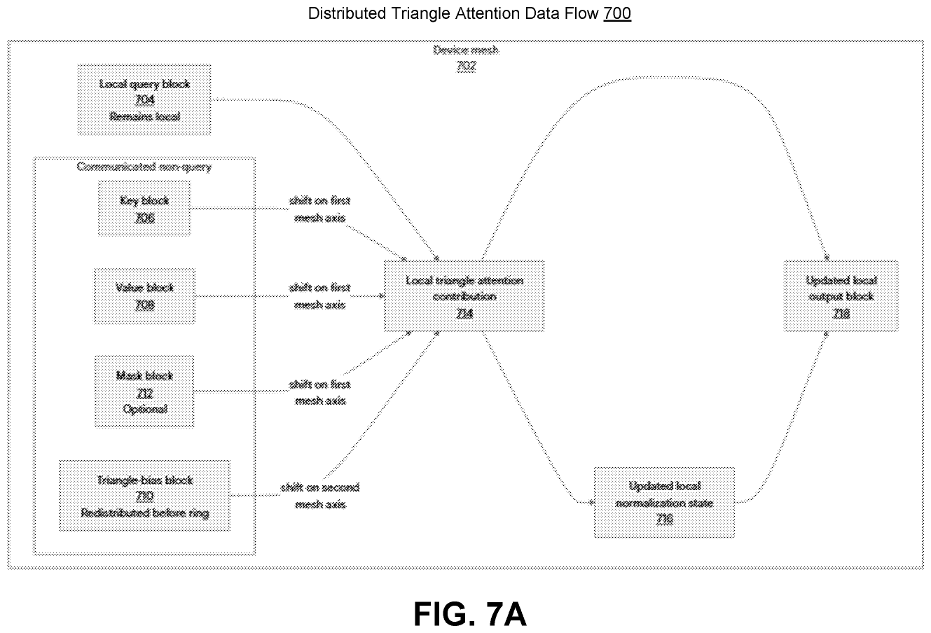

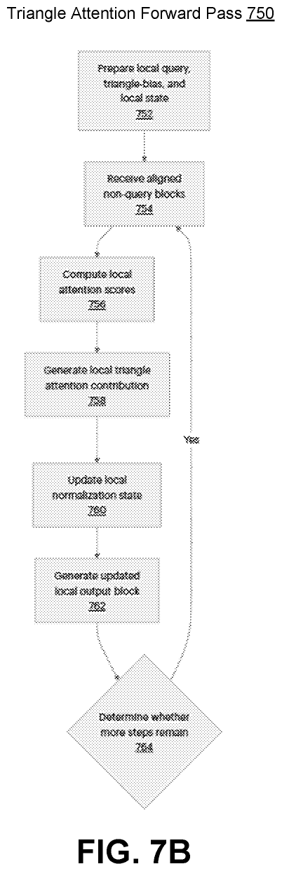

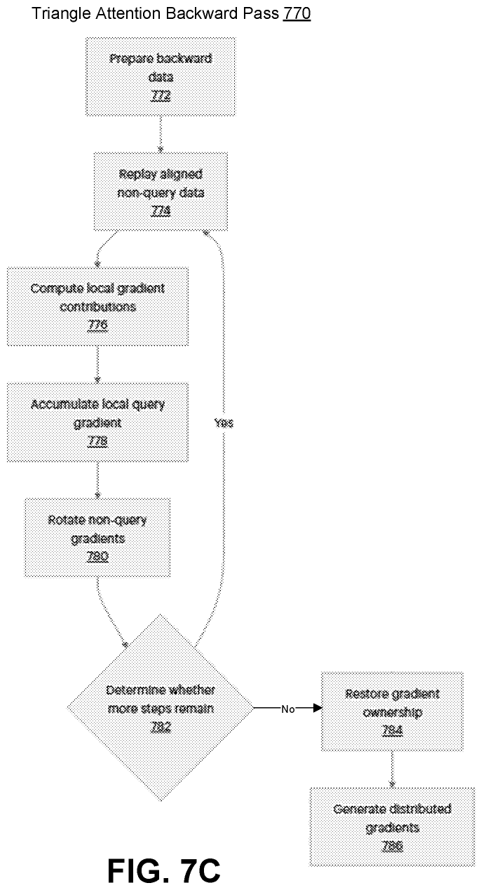

FIG. 7A illustrates triangle attention 700 using ring communication of key, value, triangle-bias, and, in some embodiments, mask blocks while a local query block remains local on a device mesh 702, according to at least one embodiment. In at least one embodiment, the triangle attention 700 distributes a triangle-attention computation over a pair-representation tensor across the device mesh 702 while preserving correspondence with a corresponding single-device triangle-attention computation.

In at least one embodiment, triangle attention is a multi-head attention operation performed over rows or columns of a pair-representation tensor, where entries of the pair-representation tensor store feature vectors for respective pairs of input elements. Query data, key data, and value data may be generated from the pair-representation tensor, and triangle-bias data may also be generated from the pair-representation tensor and added to attention scores for corresponding query-key comparisons prior to softmax normalization. For example, where z denotes the pair-representation tensor having shape B×N×N×D, the shape B×N×N×D indicates that z includes a batch dimension B, a first pair-position dimension N, a second pair-position dimension N, and a feature dimension D, such that each entry corresponding to an ordered pair of input elements in a batch item stores a D-dimensional feature vector, equation (1) may express the triangle-attention computation as a weighted value aggregation based on a scaled query-key similarity term QK^{T}/\sqrt{d} (together with triangle bias tri_bias(z) and, where used, mask bias, such that the resulting output is an updated pair-representation output.

$$Q , K , V = proj ( z ) , output = softmax ( \frac{{QK}^{T}}{\sqrt{d}} + tri\_bias ( z ) + mask\_bias ) V \qquad ( 1 )$$

In at least one embodiment, Q, K, and V are query, key, and value tensors derived from z by corresponding projection operations, and the triangle bias tri_bias(z) is derived from z by a bias projection operation that generates additive bias data for corresponding attention heads and corresponding query-key comparisons. In at least one embodiment, for distributed triangle attention, the pair-representation tensor may be tiled into local blocks of size (N/sqrt(P), N/sqrt(P)) across a two-dimensional device mesh of P devices, queries may remain local on each device, and keys, values, triangle-bias data, and, where used, mask data may be redistributed for successive communication steps, the triangle-bias data being associated with a different pair axis than the mask data and being maintained in alignment with corresponding query-key comparisons across the successive communication steps.

In at least one embodiment, distributed triangle attention may use an initial two-stage redistribution followed by a ring of sqrt(P) communication steps in which each device computes partial attention scores and a partial weighted value aggregation for a currently resident non-query block and merges the resulting partial output with previously accumulated output using a numerically stable tiled softmax based on a running maximum-score value and a running log-sum-exp value. In at least one embodiment, this distributed schedule allows the distributed result to correspond to the serial softmax result of equation (1) without materializing a full N×N attention matrix on any one device, and communication of a next non-query block may be overlapped with computation for a current non-query block using double-buffered communication.

In at least one embodiment, distributing the triangle-attention computation includes partitioning the pair-representation tensor across the device mesh 702 so that each GPU retains a local query block 704 generated from a local block of the pair-representation tensor while key blocks 706, value blocks 708, triangle-bias blocks 710, and, where used, mask blocks 712 are aligned and communicated for successive communication steps. For a communication step, a GPU may compute a local triangle attention contribution 714 and local normalization information from currently aligned blocks, may combine the local normalization information with normalization information maintained from prior communication steps to generate the updated local normalization state 716, and may generate the updated local output block 718 from the local triangle attention contribution 714 and a previously generated local output block so that the distributed result corresponds to the triangle-attention computation of equation (1) without reconstructing a full attention-score tensor on any one GPU.

In at least one embodiment, the pair-representation tensor used as an input to the triangle attention 700, and a corresponding output tensor generated by the triangle attention 700, are distributed across the device mesh 702 according to a sharding placement that includes a batch axis and two context-parallel axes. In at least one embodiment, an input pair-representation tensor and a corresponding output tensor have a distributed placement (Shard(0), Shard(1), Shard(2)) on a three-dimensional device mesh [batch, cp0, cp1], meaning that the batch dimension of the tensor is sharded across a batch mesh axis, a first pair dimension of the tensor is sharded across a first context-parallel mesh axis, and a second pair dimension of the tensor is sharded across a second context-parallel mesh axis, such that each device stores a local tensor block corresponding to a subset of batch entries, a subset of the first pair dimension, and a subset of the second pair dimension. For a pair-representation tensor having shape (B, I, J, C), the placement indicates that B is sharded on the batch mesh axis, I is sharded on cp0, J is sharded on cp1, and the channel dimension C remains local to each device for the corresponding local tensor block.

In at least one embodiment, the device mesh 702 used for the triangle attention 700 is a two-dimensional GPU mesh over which the two pair dimensions of the pair-representation tensor are partitioned for distributed triangle-attention communication. For example, when a larger device arrangement also includes a batch mesh axis, the triangle attention 700 may use a two-dimensional context-parallel submesh corresponding to the first pair axis and the second pair axis, such that a GPU at a mesh coordinate on that two-dimensional GPU mesh stores a local block of a pair-representation tensor of shape (B, I, J, C) for local batch entries and local ranges of I and J, generates the local query block 704 from that local block, and participates in communication of non-query attention data across the two-dimensional GPU mesh while the batch-axis partitioning remains outside the triangle-attention communication schedule.

A device at a mesh coordinate of the device mesh 702 may store a local block of the pair-representation tensor and generate the local query block 704 from that local block. The device may further generate or store local non-query data corresponding to the local block, including a local key/value source block, a local triangle-bias source block, and, where used, a local mask source block, and the local non-query data may be redistributed or communicated to provide a currently resident key block 706, a currently resident value block 708, a currently resident triangle-bias block 710, and, where used, a currently resident mask block 712 for a current communication step. The key block 706 and the triangle-bias block 710 may correspond to the same query-key comparisons as the local query block 704 for the current communication step, and the value block 708 and, where used, the mask block 712 may correspond to the key block 706 for that communication step, such that the device may compute a local triangle-attention contribution for a local output block owned by that device without reconstructing the full pair-representation tensor on any one device.

In at least one embodiment, the triangle-bias block 710 is additive attention-bias data derived from channel information of the pair-representation tensor for corresponding query-key comparisons. For example, triangle-bias data may be generated by applying a linear projection to channel data of a local block of the pair-representation tensor to convert pair-representation channels into additive bias values for respective attention heads and respective query-key comparisons, and the resulting projected bias values may be arranged into triangle-bias blocks 710 that remain aligned with the currently resident key block 706 and the local query block 704 during the repeated communication steps.

The local query block 704 may remain resident on the device that owns the corresponding local block of the pair-representation tensor during repeated communication steps of the triangle-attention computation. The repeated communication steps may also be referred to herein as successive communication steps. The local query block 704 may remain untransmitted to peer devices during the repeated communication steps. Instead, non-query attention data may be communicated so that different key blocks 706, value blocks 708, triangle-bias blocks 710, and, where used, mask blocks 712 are successively aligned with the local query block 704. As used herein, blocks described as being aligned for a communication step are coordinated such that a key block 706 and a triangle-bias block 710 correspond to the same query-key comparisons as the local query block 704, and a value block 708 and, where used, a mask block 712 correspond to the key block 706 for that communication step.

Before the repeated communication steps begin, the triangle-bias block 710 may be redistributed in two stages so that a triangle-bias block held by a given device corresponds to the same query-key comparisons as the local query block 704 and the key block 706 used by that device at that communication step. A first redistribution stage may shift triangle-bias data along one mesh axis by an offset based on the GPU's coordinate on the other mesh axis of the device mesh 702 so that diagonal groups of triangle-bias data are flattened onto rows or columns of the device mesh 702. A second redistribution stage may shift the resulting triangle-bias data along the other mesh axis by an offset based on the GPU's coordinate on said one mesh axis of the device mesh 702 so that, immediately before the repeated communication steps begin, the triangle-bias block 710 held by each device is ring-aligned with the key block 706 and the value block 708 used with the local query block 704 at an initial communication step. The two-stage redistribution may be performed without reconstructing a full triangle-bias tensor on any one device.

Such coordinate-based shifting may use a coordinate of a GPU on one mesh axis to determine a shift along another mesh axis. For example, for a GPU at mesh coordinate (i, j), the first redistribution stage may shift triangle-bias data along the first mesh axis by an offset derived from j, and the second redistribution stage may shift resulting triangle-bias data along the second mesh axis by an offset derived from i. In one example, for a GPU at mesh coordinate (1, 2) of a 3×3 device mesh, the GPU has coordinate 1 on the first mesh axis and coordinate 2 on the second mesh axis. Accordingly, a first redistribution stage that shifts triangle-bias data along the first mesh axis by an offset based on the GPU's coordinate on the second mesh axis may use an offset of 2, and a second redistribution stage that shifts resulting triangle-bias data along the second mesh axis by an offset based on the GPU's coordinate on the first mesh axis may use an offset of 1.

In at least one embodiment, before a first repeated communication step, the key block 706, the value block 708, and, where used, the mask block 712 are shifted along the first mesh axis so that, at the first repeated communication step, the currently resident key block 706, the currently resident value block 708, the currently resident triangle-bias block 710, and, where used, the currently resident mask block 712 are aligned with the local query block 704 for a same initial set of query-key comparisons. In at least one embodiment, subsequent shifts of the key block 706, the value block 708, and, where used, the mask block 712 along the first mesh axis and of the triangle-bias block 710 along the second mesh axis preserve the per-step alignment across later communication steps.

The key block 706, the value block 708, and, where used, the mask block 712 may be shifted along a first mesh axis of the device mesh 702 during repeated communication steps, while the triangle-bias block 710 may be shifted along a second mesh axis of the device mesh 702. The first mesh axis and the second mesh axis may be orthogonal mesh axes of the two-dimensional context-parallel mesh. In some embodiments, the first mesh axis corresponds to device-mesh rows and the second mesh axis corresponds to device-mesh columns, although other mesh organizations may be used. The repeated communication steps may preserve a per-step alignment in which, for a given communication step, the currently resident key block 706 and the currently resident triangle-bias block 710 correspond to the same query-key comparisons as the local query block 704. The currently resident value block 708, and, where used, the currently resident mask block 712, may correspond to the currently resident key block 706 for that communication step.

In at least one embodiment, communication of the key block 706, the value block 708, the triangle-bias block 710, and, where used, the mask block 712 may be overlapped with computation of the local triangle attention contribution 714 by using double-buffered receive storage for successive communication steps. For example, a device may maintain a current receive buffer holding currently resident non-query attention data for a current communication step and a next receive buffer for non-query attention data of a subsequent communication step, may enqueue communication of the subsequent communication step while computing the local triangle attention contribution 714 for the current communication step using the current receive buffer, may wait for completion of the enqueued communication prior to consuming data stored in the next receive buffer, and may then swap roles of the current receive buffer and the next receive buffer for a following communication step.

Using the local query block 704 generated from the local block of the pair-representation tensor together with the currently resident key block 706, value block 708, triangle-bias block 710, and, where used, mask block 712 for the communication step, a device may compute a local triangle attention contribution 714 for the local output block corresponding to that local block of the pair-representation tensor. The device may also compute local normalization information corresponding to the communication step. The local triangle attention contribution 714 may represent a partial attention output associated with the local query block 704 for the currently resident non-query attention data.

In at least one embodiment, the local normalization information generated for a communication step is local normalization information for softmax normalization corresponding to modified local attention scores generated from the local query block 704 and the currently resident non-query attention data. For example, the device may generate local attention scores from the local query block 704 and the currently resident key block 706, may modify the local attention scores by adding the triangle-bias block 710 and, where used, the mask block 712 prior to normalization, may generate normalized attention weights from the modified local attention scores, and may generate the local triangle attention contribution 714 by applying the normalized attention weights to the currently resident value block 708. The local normalization information may include a current-step maximum-score value, a current-step exponential-sum quantity, a current-step logarithm of a sum of exponentials of values obtained by subtracting the current-step maximum-score value from respective modified local attention scores, or combinations thereof. In at least one embodiment, the device updates the local normalization state for a communication step by combining local normalization information for the communication step with a previously maintained local normalization state.

An updated local output block 718 may be generated based on the local triangle attention contribution 714, a previously generated local output block, and the updated local normalization state 716. Generating the updated local output block 718 may include rescaling the previously generated local output block and the local triangle attention contribution 714 based on the updated local normalization state 716 and then combining the rescaled previously generated local output block and the rescaled local triangle attention contribution 714. The rescaling may be based on the maximum-score value and the logarithm of a sum of exponentials maintained in the updated local normalization state 716 so that the updated local output block 718 reflects a numerically stable merge of contributions produced at different communication steps. The updated local output block 718 may correspond to the local query block 704. Repeated updating of the local output block 718 across communication steps may accumulate contributions associated with different communicated key blocks 706, value blocks 708, triangle-bias blocks 710, and mask blocks 712 until the triangle-attention computation for that local query block is complete without reconstructing a full attention-score tensor on any one device.

In at least one embodiment, attention-score differences are values obtained by subtracting a maximum-score value from respective modified local attention scores. The updated local normalization state 716 may include a maximum-score value and a logarithm of a sum of exponentials of attention-score differences, each maintained across the repeated communication steps for the local query block 704. For example, at a current communication step, the device may combine a previously generated maximum-score value with a current-step maximum-score value to generate an updated maximum-score value, may combine a previously generated exponential-sum quantity with a current-step exponential-sum quantity relative to the updated maximum-score value to generate an updated logarithm of a sum of exponentials of attention-score differences, may rescale a previously generated local output block according to the updated local normalization state 716, may rescale the local triangle attention contribution 714 according to the updated local normalization state 716, and may combine the rescaled quantities to generate the updated local output block 718. In at least one embodiment, this merge across the repeated communication steps enables the updated local output block 718 to correspond to a softmax-normalized weighted combination over non-query attention data received across multiple communication steps.

In at least one embodiment, the triangle attention 700 corresponds to a starting-node triangle-attention variant or an ending-node triangle-attention variant. In at least one embodiment, in the starting-node triangle-attention variant, the local query block 704 corresponds to a row-oriented query dimension of the pair-representation tensor, the key block 706, the value block 708, and, where used, the mask block 712 are shifted along the first mesh axis, and the triangle-bias block 710 is shifted along the second mesh axis after the two-stage redistribution. In at least one embodiment, in the ending-node triangle-attention variant, the pair-representation tensor is transposed with respect to the pair dimensions before the repeated communication steps and a corresponding output is transposed after the repeated communication steps, such that roles of the pair dimensions and corresponding mesh-axis communication directions are exchanged while the same maximum-score and logarithm-of-a-sum-of-exponentials update mechanism maintained across communication steps is used to merge partial triangle-attention results across communication steps. In at least one embodiment, the two-stage redistribution of the triangle-bias block 710 is correspondingly oriented with respect to the transposed pair dimensions in the ending-node triangle-attention variant.

In at least one embodiment, the triangle attention 700 further supports a backward pass that reuses a communication schedule corresponding to the repeated communication steps of the forward pass while preserving ownership of local query data. In at least one embodiment, the backward pass receives or replays saved forward-pass key-block data, value-block data, triangle-bias-block data, and, where used, mask-block data through device-local buffers. The saved forward-pass key-block data, value-block data, triangle-bias-block data, and mask-block data correspond to non-query attention data aligned with the local query block 704 for respective communication steps of the forward pass. The backward pass receives an upstream gradient corresponding to the updated local output block 718. The backward pass further generates local gradient contributions corresponding to the local query block 704, the key block 706, the value block 708, and the triangle-bias block 710. In at least one embodiment, backward computation uses saved forward-pass normalization information corresponding to the distributed softmax merge. For example, the saved forward-pass normalization information may include saved maximum-score information, saved exponential-sum information, saved logarithm of a sum of exponentials of attention-score differences information, or combinations thereof. In at least one embodiment, the upstream gradient is cast to a data type corresponding to saved forward-pass tensor data before communication of gradient data is initiated.

In at least one embodiment, during repeated backward communication steps, a device accumulates a query gradient locally for the local query block 704 while key-gradient data, value-gradient data, and triangle-bias-gradient data are rotated among devices according to the communication schedule. In at least one embodiment, during the repeated backward communication steps, the device receives and transmits key-gradient blocks, value-gradient blocks, and triangle-bias-gradient blocks corresponding to successive backward communication steps. In at least one embodiment, the device combines gradient contributions generated for a current backward communication step using the saved forward-pass key-block data, value-block data, triangle-bias-block data, and, where used, mask-block data. The device further combines the gradient contributions with gradient data received from a peer device. The device then transmits resulting gradient data for a subsequent backward communication step. In at least one embodiment, gradient contributions associated with multiple forward-pass alignments are accumulated without reconstructing full gradient tensors on any one device.

In at least one embodiment, after the repeated backward communication steps, the device performs a gradient-ownership restoration sequence. In at least one embodiment, the gradient-ownership restoration sequence includes an additional rotation that restores a ring-ready gradient layout. The gradient-ownership restoration sequence further includes a first triangle-bias-gradient restoration that reverses shifting of triangle-bias data along the second mesh axis performed during forward redistribution. The gradient-ownership restoration sequence further includes a second triangle-bias-gradient restoration that reverses shifting of triangle-bias data along the first mesh axis performed during forward redistribution. The gradient-ownership restoration sequence further includes a key/value-gradient restoration that returns key-gradient data and value-gradient data to devices corresponding to forward-pass ownership of the saved forward-pass key-block data and value-block data. In at least one embodiment, for an ending-node triangle-attention variant, gradient tensors are transposed with respect to the pair dimensions after the backward communication steps so that gradient layout corresponds to an input layout of the ending-node triangle-attention variant.

In at least one embodiment, the backward pass further generates projection-weight gradients corresponding to query projection data, key projection data, and value projection data based on locally accumulated gradient tensors and corresponding saved forward-pass tensor data. In at least one embodiment, the saved forward-pass tensor data includes local query-source data. The saved forward-pass tensor data further includes saved forward-pass key-block data and value-block data corresponding to received or replayed non-query attention data. Such projection-weight gradients may be maintained as distributed partial sums for later reduction.

Accordingly, FIG. 7A illustrates triangle attention 700 in which the local query block 704 remains local on the device mesh 702 while the key block 706, the value block 708, the triangle-bias block 710, and, where used, the mask block 712 are communicated in a coordinated manner, including two-stage redistribution of the triangle-bias block 710 before repeated communication steps, enabling generation of the local triangle attention contribution 714, the updated local normalization state 716, the updated local output block 718, and backward-pass gradient recovery for distributed triangle attention, while preserving alignment of communicated non-query attention data with the local query block 704 across successive communication steps.

In at least one embodiment, processes 750 and 770 of FIGS. 7B and 7C, respectively, are performed by one or more systems such as those described in this present disclosure. In at least one embodiment, processes 750 and 770 are performed by the system described in connection with FIGS. 1, 4, and 7A. In at least one embodiment, processes 750 and 770 are performed by a system using one or more programming models, such as CUDA, HIP, oneAPI, or variations thereof. One or more portions of processes 750 and 770 are performed in any suitable order, including sequential, parallel, overlapped, or variations thereof, and by any suitable system, such as those described herein, and using any suitable processing unit, such as a CPU, GPU, PPU, GPGPU, or variations thereof. Although processes 750 and 770 are depicted as series of steps or operations, processes 750 and 770 may include altered or reordered steps or operations, or may omit certain steps or operations, except where explicitly noted or logically required, such as when an output of one step or operation is used as input for another. In at least one embodiment, process 750 may be performed using the device mesh 702, the local query block 704, the key block 706, the value block 708, the triangle-bias block 710, the mask block 712, the local triangle attention contribution 714, the updated local normalization state 716, and the updated local output block 718 of FIG. 7A, and process 770 may be performed using forward-pass data and distributed gradient data corresponding thereto. One or more portions of processes 750 and 770 may be performed as part of performing one or more server operations such as those described herein.

FIG. 7B illustrates an example of a process 750 to perform distributed triangle attention, according to at least one embodiment. In at least one embodiment, some or all of process 750, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium. At least some computer-readable instructions usable to perform process 750 are not stored solely using transitory signals, such as a propagating transient electric or electromagnetic transmission. A non-transitory computer-readable medium does not necessarily include non-transitory data storage circuitry, such as buffers, caches, and queues, within transceivers of transitory signals.

In at least one embodiment, process 750 is performed by one or more systems such as those described in this present disclosure. In at least one embodiment, process 750 is performed by the system described in connection with FIGS. 1, 4, and 7. In at least one embodiment, process 750 is performed by a system of one or more programming models, such as CUDA, HIP, oneAPI, or variations thereof. One or more portions of process 750 are performed in any suitable order, including sequential, parallel, or variations thereof, and by any suitable system, such as those described herein, and using any suitable processing unit, such as a CPU, GPU, PPU, GPGPU, or variations thereof. Although process 750 is depicted as a series of steps or operations, process 750 may include altered or reordered steps or operations, or omit certain steps or operations, except where explicitly noted or logically required, such as when an output of one step or operation is used as input for another. For example, process 750 may be performed using the device mesh 702, the local query block 704, the key block 706, the value block 708, the triangle-bias block 710, the mask block 712, the local triangle attention contribution 714, the updated local normalization state 716, and the updated local output block 718 of FIG. 7A. One or more portions of process 750 may be performed as part of performing one or more server operations such as those described herein.

The system performing at least a part of process 750 includes code to at least prepare 752 local query, triangle-bias, and local state. In at least one embodiment, preparing 752 includes obtaining a local block of a pair-representation tensor distributed across a two-dimensional GPU mesh and generating the local query block 704 from that local block while retaining the local query block 704 on the GPU on which the local query block 704 is generated during subsequent communication steps. The triangle-bias data is, e.g., additive attention-bias data corresponding to query-key comparisons represented by the pair-representation tensor. For example, preparing 752 may include generating triangle-bias data by applying a linear projection to channel data of the local block of the pair-representation tensor, performing a first triangle-bias redistribution stage along a first mesh axis by an offset based on a GPU coordinate on a second mesh axis, performing a second triangle-bias redistribution stage along the second mesh axis by an offset based on a GPU coordinate on the first mesh axis, and storing a resulting triangle-bias block 710 for use at a first communication step. Preparing 752 may further include initializing the updated local normalization state 716 and the updated local output block 718 so that a first local triangle attention contribution 714 can be merged into the local output without requiring a previously accumulated attention result. In one example, for an ending-node variant of the triangle attention, preparing 752 may include transposing pair dimensions of the pair-representation tensor prior to generating the local query block 704, and a corresponding transpose-back operation may be performed after process 750 completes.

The system performing at least a part of process 750 includes code to at least receive 754 aligned non-query blocks. In at least one embodiment, receiving 754 includes, during a communication step of a sequence of communication steps, obtaining a currently resident key block 706 and a currently resident value block 708 along a first mesh axis of the device mesh 702 and obtaining a currently resident triangle-bias block 710 along a second mesh axis of the device mesh 702 such that the currently resident key block 706 and the currently resident triangle-bias block 710 correspond to the same query-key comparisons as the local query block 704. Where used, receiving 754 may further include obtaining a currently resident mask block 712 along the first mesh axis together with the key block 706 and the value block 708. In at least one embodiment, the alignment established prior to the first communication step is preserved across later communication steps by shifting the key block 706, the value block 708, and the mask block 712 on one mesh axis while shifting the triangle-bias block 710 on the other mesh axis. For example, the device may maintain a current receive buffer and a next receive buffer for non-query attention data, may enqueue communication for a subsequent communication step while processing a current communication step, and may swap the receive buffers after completion of the enqueued communication.

The system performing at least a part of process 750 includes code to at least compute 756 local attention scores. In at least one embodiment, computing 756 includes generating attention-score information from the local query block 704 and the currently resident key block 706 for the query-key comparisons represented at the current communication step. The attention-score information is, e.g., score information from which local weighting information for the current communication step is derived. For example, the device may generate raw attention scores from the local query block 704 and the key block 706, may modify those attention scores by adding the triangle-bias block 710, and may further modify the attention scores by applying the mask block 712 where the mask block 712 is used. In at least one embodiment, computing 756 produces current-step normalization information associated with the modified attention scores, such as a current-step maximum-score value, a current-step exponential-sum quantity, a current-step logarithm of a sum of exponentials of attention-score differences quantity, or combinations thereof.

The system performing at least a part of process 750 includes code to at least generate 758 local triangle attention contribution. In at least one embodiment, generating 758 includes forming a current-step weighted contribution for the local output block corresponding to the local query block 704 based on the local attention scores and the currently resident value block 708. The local triangle attention contribution 714 is, e.g., a partial weighted output corresponding to a subset of key-value information processed at a current communication step. For example, the device may apply a normalization operation to the modified attention scores to generate local weighting information for the current communication step and may apply that local weighting information to the value block 708 to generate the local triangle attention contribution 714. In at least one embodiment, the local triangle attention contribution 714 therefore represents only a current-step portion of the full triangle-attention output for the local query block 704, and additional portions are generated during later communication steps using later key blocks 706, value blocks 708, triangle-bias blocks 710, and optional mask blocks 712.

The system performing at least a part of process 750 includes code to at least update 760 local normalization state. In at least one embodiment, updating 760 includes combining current-step normalization information with previously maintained normalization information for the local query block 704 to generate the updated local normalization state 716. The updated local normalization state 716 is, e.g., state information that tracks normalization across multiple communication steps so that a distributed softmax result corresponds to a corresponding single-device softmax result. For example, the updated local normalization state 716 may include a maximum-score value and a logarithm of a sum of exponentials of attention-score differences maintained across the sequence of communication steps, and updating 760 may include combining a previously generated maximum-score value with a current-step maximum-score value, combining a previously generated exponential-sum quantity with a current-step exponential-sum quantity relative to an updated maximum-score value, and storing resulting normalization information for use in updating the local output block. In at least one embodiment, maintaining the updated local normalization state 716 across communication steps permits the device to merge partial triangle-attention results from different communication steps without materializing full attention-score tensors for all query-key comparisons on one GPU.

The system performing at least a part of process 750 includes code to at least generate 762 updated local output block. In at least one embodiment, generating 762 includes combining the local triangle attention contribution 714 with a previously accumulated local output quantity according to the updated local normalization state 716 to produce the updated local output block 718 corresponding to the local query block 704. The updated local output block 718 is, e.g., an accumulated distributed triangle-attention result for the local query block 704 after merging current-step and prior-step contributions. For example, the device may rescale a previously generated local output quantity according to differences between prior normalization information and the updated local normalization state 716, may rescale the local triangle attention contribution 714 according to the updated local normalization state 716, and may combine the rescaled quantities to generate the updated local output block 718. In at least one embodiment, the updated local output block 718 is therefore refined at successive communication steps until the updated local output block 718 reflects contributions associated with key-value information received from all relevant devices for the local query block 704.

The system performing at least a part of process 750 includes code to at least determine 764 whether more steps remain. In at least one embodiment, determining 764 includes determining whether additional communication steps remain in the distributed triangle-attention schedule for the local query block 704. For example, the device may determine whether additional key blocks 706, value blocks 708, triangle-bias blocks 710, and optional mask blocks 712 remain to be processed based on a number of GPUs participating along a selected mesh axis, a current communication-step index, a communication schedule established for the device mesh 702, or combinations thereof. If additional communication steps remain, process 750 may return to receiving 754 aligned non-query blocks for a subsequent communication step. If additional communication steps do not remain, the updated local output block 718 may be provided as the distributed triangle-attention output corresponding to the local query block 704, and that output may be used in a subsequent distributed model operation.

FIG. 7C illustrates an example of a process 770 to perform a backward pass for distributed triangle attention, according to at least one embodiment. In at least one embodiment, some or all of process 770, or any other processes described herein, or variations and combinations thereof, are performed under control of one or more computer systems configured with computer-executable instructions and are implemented as code executing collectively on one or more processors, by hardware, software, or combinations thereof. In at least one embodiment, process 770 is performed using the device mesh 702 and distributed triangle-attention data of FIG. 7A and the forward-pass process 750 of FIG. 7B. One or more portions of process 770 may be performed in any suitable order, including sequential, parallel, overlapped, or variations thereof, and although process 770 is depicted as a series of operations, process 770 may include altered or reordered operations, or may omit certain operations, except where explicitly noted or logically required.

In at least one embodiment, process 770 performs backward computation for distributed triangle attention while preserving distributed ownership of local tensor blocks across the device mesh 702. In at least one embodiment, process 770 uses saved forward-pass data corresponding to the local query block 704, the key block 706, the value block 708, the triangle-bias block 710, the mask block 712, the local triangle attention contribution 714, the updated local normalization state 716, the updated local output block 718, or combinations thereof. In at least one embodiment, process 770 generates distributed gradient information corresponding to a pair-representation tensor, one or more projected non-query tensors, one or more projection weights, or combinations thereof, without reconstructing full forward-pass tensors or full gradient tensors on any one device.

The system performing at least a part of process 770 includes code to at least prepare 772 backward data. In at least one embodiment, preparing 772 includes receiving an upstream gradient corresponding to the updated local output block 718 generated by the forward pass and preparing local buffers and saved forward-pass data for backward computation. In at least one embodiment, preparing 772 further includes restoring or accessing saved forward-pass tensor data corresponding to the local query block 704, currently resident non-query attention data, and numerical-stability information used during the forward pass. For example, preparing 772 may include restoring saved projected query data, saved key data, saved value data, saved triangle-bias data, saved mask data, saved local output data, saved maximum-score information, saved exponential-sum information, saved logarithm of a sum of exponentials of attention-score differences information, or combinations thereof. In at least one embodiment, preparing 772 includes casting the upstream gradient to a data type corresponding to a saved forward-pass tensor data type prior to communication of gradient data or invocation of a backward kernel, thereby reducing risk of mismatched communication-buffer formats. In at least one embodiment, preparing 772 further includes allocating local gradient buffers for a query gradient, a key gradient, a value gradient, a triangle-bias gradient, or combinations thereof.

The system performing at least a part of process 770 includes code to at least receive 774 aligned non-query data. In at least one embodiment, receiving 774 includes making available, for a current backward communication step, non-query attention data aligned with the local query block 704 in a manner corresponding to alignment used during a corresponding forward communication step. In at least one embodiment, receiving 774 includes restoring or receiving a currently resident key block 706, a currently resident value block 708, a currently resident triangle-bias block 710, and, where used, a currently resident mask block 712 corresponding to the same query-key comparisons as the local query block 704 for the current backward communication step. In at least one embodiment, receiving 774 uses saved forward-pass buffers, communicated buffers, or combinations thereof. In at least one embodiment, receiving 774 may be performed using double-buffered storage so that non-query data for a subsequent backward communication step is received while local backward computation is performed for a current backward communication step.

The system performing at least a part of process 770 includes code to at least compute 776 local gradient contributions. In at least one embodiment, computing 776 includes generating current-step gradient contributions corresponding to the local query block 704 and the currently received non-query attention data. In at least one embodiment, computing 776 includes executing a backward triangle-attention kernel or other backward computation using the upstream gradient, the local query block 704, the currently resident key block 706, the currently resident value block 708, the currently resident triangle-bias block 710, and, where used, the currently resident mask block 712, together with numerical-stability information saved from the forward pass. For example, computing 776 may include generating a current-step query-gradient contribution, a current-step key-gradient contribution, a current-step value-gradient contribution, and a current-step triangle-bias-gradient contribution associated with a current backward communication step. In at least one embodiment, where a mask block 712 is used as a non-differentiable masking structure, process 770 need not generate a gradient for the mask block 712.

The system performing at least a part of process 770 includes code to at least accumulate 778 local query gradient. In at least one embodiment, accumulating 778 includes adding a current-step query-gradient contribution to a previously accumulated local query gradient corresponding to the local query block 704. In at least one embodiment, because the local query block 704 remained local during the forward-pass communication steps, the query gradient corresponding to that local query block 704 may likewise be accumulated locally during the backward pass without inter-device communication of the query gradient during the repeated backward communication steps. In at least one embodiment, accumulating 778 therefore includes updating a local query-gradient buffer using current-step query-gradient information while non-query gradient data is communicated among devices of the device mesh 702.

The system performing at least a part of process 770 includes code to at least rotate 780 non-query gradients. In at least one embodiment, rotating 780 includes communicating gradient data corresponding to non-query attention data among devices of the device mesh 702 according to a backward communication schedule. In at least one embodiment, rotating 780 includes receiving gradient data for a current backward communication step from a peer device, combining the received gradient data with current-step gradient contributions generated at computing 776, and transmitting resulting gradient data to another peer device for a subsequent backward communication step. For example, rotating 780 may include rotating key-gradient data, value-gradient data, and triangle-bias-gradient data through communication buffers while query-gradient data accumulates locally. In at least one embodiment, rotating 780 uses a communication pattern corresponding to the repeated communication steps of the forward pass, such that non-query gradient contributions associated with multiple forward-pass alignments are accumulated across the device mesh 702 without reconstructing full non-query gradient tensors on any one device. In at least one embodiment, rotating 780 may further include enqueueing communication for a subsequent backward communication step while current-step gradient computation is performed.

The system performing at least a part of process 770 includes code to at least determine 782 whether more steps remain. In at least one embodiment, determining 782 includes determining whether additional backward communication steps remain for the distributed triangle-attention schedule. In at least one embodiment, the determination is based on a number of devices participating along a selected mesh axis, a current backward communication-step index, a communication schedule corresponding to the forward pass, or combinations thereof. If additional backward communication steps remain, process 770 may return to receiving 774 aligned non-query data for a subsequent backward communication step. If additional backward communication steps do not remain, process 770 may proceed to restoring 784 gradient ownership.

The system performing at least a part of process 770 includes code to at least restore 784 gradient ownership. In at least one embodiment, restoring 784 includes performing one or more post-loop communication operations that return accumulated non-query gradient data to devices corresponding to forward-pass ownership of the corresponding source data. In at least one embodiment, restoring 784 includes an additional rotation that restores a ring-ready gradient layout after the repeated backward communication steps. In at least one embodiment, restoring 784 further includes one or more triangle-bias-gradient restoration stages that reverse the forward two-stage redistribution of the triangle-bias block 710. For example, a first triangle-bias-gradient restoration stage may reverse shifting of triangle-bias data along the second mesh axis performed during forward redistribution, and a second triangle-bias-gradient restoration stage may reverse shifting of triangle-bias data along the first mesh axis performed during forward redistribution, such that resulting triangle-bias-gradient ownership corresponds to ownership of triangle-bias source data prior to forward redistribution. In at least one embodiment, restoring 784 further includes a key/value-gradient restoration operation that returns key-gradient data and value-gradient data to devices corresponding to forward-pass ownership of the corresponding saved forward-pass key data and value data. In at least one embodiment, for an ending-node triangle-attention variant, restoring 784 further includes transposing one or more gradient tensors with respect to the pair dimensions so that gradient layout corresponds to an input layout of the ending-node variant.

The system performing at least a part of process 770 includes code to at least generate 786 distributed gradients. In at least one embodiment, generating 786 includes producing distributed gradient outputs corresponding to the distributed triangle-attention operation. In at least one embodiment, generating 786 includes generating an input gradient corresponding to a local block of the pair-representation tensor based on the accumulated local query gradient and the restored key-gradient data and value-gradient data. In at least one embodiment, generating 786 further includes generating projection-weight gradients corresponding to a query projection, a key projection, a value projection, a triangle-bias projection, or combinations thereof, based on locally accumulated gradient tensors and saved forward-pass tensor data. In at least one embodiment, one or more such projection-weight gradients are maintained as distributed partial sums for later reduction. In at least one embodiment, generating 786 further includes wrapping locally owned gradient tensors with distributed-tensor metadata so that resulting distributed gradients can be consumed by downstream training computation.

Accordingly, FIG. 7C illustrates a backward-pass process 770 for distributed triangle attention in which backward data is prepared at 772, aligned non-query forward-pass data is received at 774, local gradient contributions are computed at 776, local query-gradient information is accumulated at 778, non-query gradient data is rotated at 780 through repeated backward communication steps, a determination is made at 782 whether more steps remain, gradient ownership is restored at 784, and distributed gradients are generated at 786. In at least one embodiment, process 770 enables training of a distributed triangle-attention implementation while preserving distributed ownership of local tensor blocks and while maintaining correspondence with a corresponding single-device backward computation.

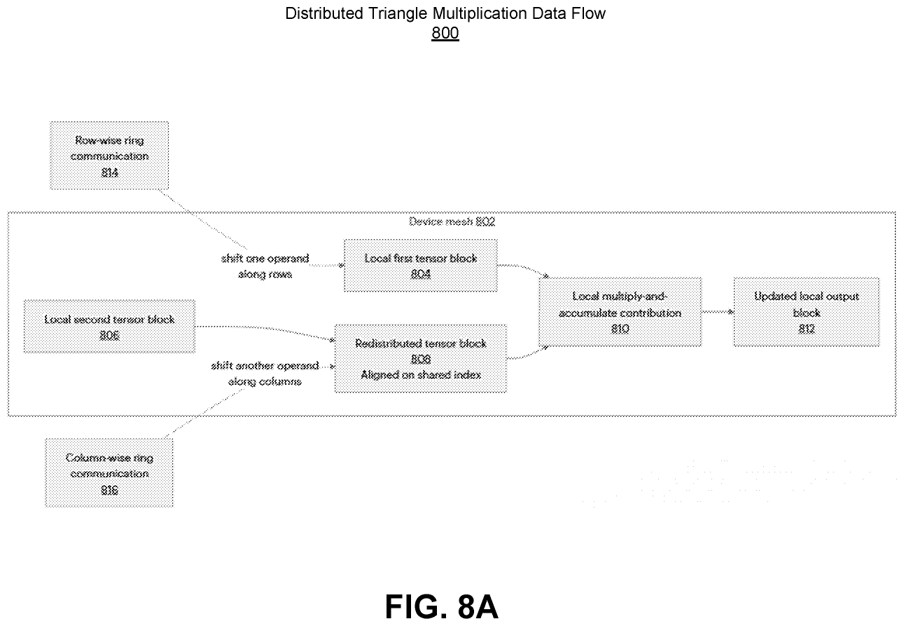

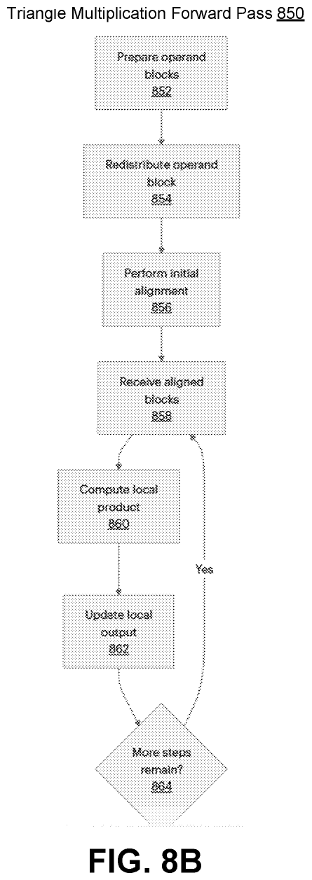

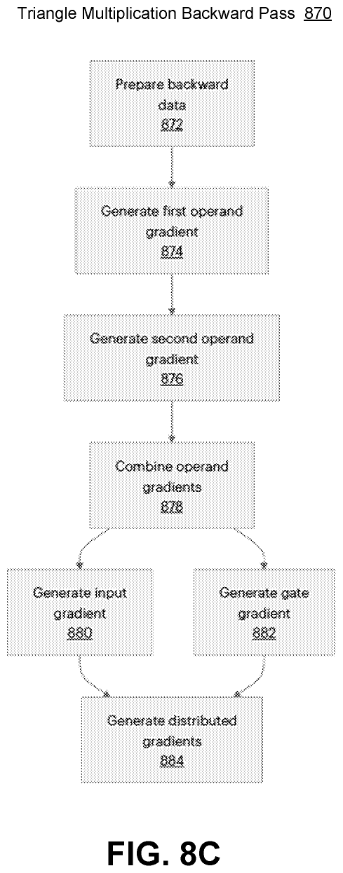

FIG. 8A illustrates triangle multiplication 800 using variant-dependent redistribution of an operand tensor, initial alignment of operand blocks, and row-wise and column-wise ring communication on a device mesh 802, according to at least one embodiment. In at least one embodiment, the triangle multiplication 800 distributes a contraction over a shared index of two pair-derived tensors across the device mesh 802 while preserving correspondence with a corresponding single-device triangle multiplication computation.

In at least one embodiment, triangle multiplication 800 is a pair-representation update operation that aggregates over a shared index of two pair-derived tensors to update entries corresponding to the other two pair indices. For example, where z denotes a pair representation having shape B×N×N×D, an outgoing triangle-multiplication variant may update z according to equation (2), and an incoming triangle-multiplication variant may update z according to equation (3), where equations (2) and (3) may be expressed as follows:

Outgoing: zₙₘ+=Σₖaₙₖ⊙bₘₖ (2)

Incoming: zₙₘ+=Σₖaₖₙ⊙bₖₘ (3)

In at least one embodiment, a and b are projections of the pair representation z, and triangle multiplication 800 is structurally a batched matrix multiplication over the shared index together with elementwise gating applied to operand data prior to the contraction.

In at least one embodiment, for distributed triangle multiplication 800, the pair representation may be tiled into local blocks of size (N/sqrt(P), N/sqrt(P)) across the two-dimensional device mesh 802 of P devices, and each device may store a local first tensor block 804, a local second tensor block 806, and an updated local output block 812 corresponding to a same local output region. In at least one embodiment, one operand may be redistributed by transposing ownership across the device mesh 802 so that the contracted index of that operand is aligned with a ring-shift direction, the redistributed operand corresponding to the second operand for an outgoing variant of equation (2) and to the first operand for an incoming variant of equation (3). In at least one embodiment, initial row-wise and column-wise shifts may then place currently resident operand blocks having a same partition of the shared index on a same device for a first local contraction step.

In an example P×P two-dimensional GPU mesh, each GPU stores local blocks of the first input tensor, the second input tensor, and the output tensor having shape (B, N/P, N/P, D), and each communication step exchanges tensor-block data having volume proportional to B×(N/P)\hat{ }2×D.

In at least one embodiment, distributed triangle multiplication 800 may proceed through a Cannon-style ring of sqrt(P) communication steps in which blocks of one operand circulate along rows of the device mesh 802 using row-wise ring communication 814 and blocks of the other operand circulate along columns of the device mesh 802 using column-wise ring communication 816 while each device performs a local batched matrix multiplication for currently resident aligned blocks and accumulates a resulting local multiply-and-accumulate contribution 810 into the updated local output block 812. In at least one embodiment, communication of a next operand block may be overlapped with computation for a current operand block using asynchronous point-to-point transfers and double-buffered receive storage, and the outgoing variant and the incoming variant may differ in which operand is redistributed prior to the ring while otherwise reusing a same row-wise and column-wise ring-communication pattern to generate the distributed triangle multiplication result corresponding to equation (2) or equation (3) without materializing full operand tensors on any one device.

In at least one embodiment, a device of the device mesh 802 stores a local first tensor block 804 generated from a local block of a first input tensor and a local second tensor block 806 generated from a local block of a second input tensor. In at least one embodiment, the first input tensor and the second input tensor are pair-derived tensors used in a triangle multiplication computation that contracts over a shared index to produce an updated pair-representation output, the triangle multiplication computation corresponding to an outgoing variant or an incoming variant of the contraction.

In at least one embodiment, before repeated contraction steps are performed, one of the input tensors is redistributed across the device mesh 802 to generate a redistributed tensor block 808. In at least one embodiment, the redistributed tensor block 808 is aligned on the shared index with a local tensor block corresponding to the other input tensor so that the aligned blocks can be used for a local contraction over the shared index. In at least one embodiment, the tensor selected for redistribution depends on the triangle-multiplication variant, such that, for an outgoing variant, the redistributed tensor block 808 corresponds to a right-hand-side operand and, for an incoming variant, the redistributed tensor block 808 corresponds to a left-hand-side operand. In some embodiments, redistributing the tensor comprises transposing ownership of tensor blocks across the two-dimensional device mesh 802 before repeated communication steps begin so that tensor blocks initially owned at mesh coordinates (i, j) are moved to mesh coordinates selected for subsequent shared-index alignment.

In at least one embodiment, the device mesh 802 further performs row-wise ring communication 814 and column-wise ring communication 816 during repeated communication steps of the triangle multiplication computation. In some embodiments, tensor blocks corresponding to one input tensor are shifted along rows of the device mesh 802 using the row-wise ring communication 814, while tensor blocks corresponding to the other input tensor are shifted along columns of the device mesh 802 using the column-wise ring communication 816. In at least one embodiment, before a first repeated communication step, the device mesh 802 performs initial row-wise and column-wise shifts that establish a ring-ready alignment of currently resident operand blocks on the shared index. In at least one embodiment, the repeated shifts thereafter successively align different pairings of tensor blocks corresponding to different partitions of the shared index without reconstructing either full input tensor on any one device.

Using the currently aligned tensor blocks, a device computes a local multiply-and-accumulate contribution 810 for the triangle multiplication computation. In at least one embodiment, the local multiply-and-accumulate contribution 810 is generated by multiplying the currently aligned tensor blocks and contracting over the shared index associated with those tensor blocks. In at least one embodiment, the local multiply-and-accumulate contribution 810 is generated by a local batched matrix multiplication or another local contraction operation and represents a partial product associated with the local output region owned by the device.

In at least one embodiment, the device updates an updated local output block 812 based on the local multiply-and-accumulate contribution 810 and a previously generated local output block. In at least one embodiment, the updated local output block 812 accumulates partial products from multiple communication steps until the contraction over the shared index is complete for that local output region. In this manner, different devices of the device mesh 802 may accumulate different local output blocks that together form the distributed triangle multiplication result.

In some embodiments, different triangle multiplication variants may differ in which input tensor is redistributed before the repeated communication steps. For example, in an outgoing variant, the second input tensor may be redistributed to form the redistributed tensor block 808, while in an incoming variant, the first input tensor may be redistributed. In at least one embodiment, the subsequent row-wise ring communication 814 and column-wise ring communication 816 then operate so that the appropriate tensor-block pairings are successively aligned for the corresponding contraction pattern, including after initial row-wise and column-wise shifts that establish alignment for a first local contraction step.

In at least one embodiment, the local first tensor block 804 and the local second tensor block 806 are tensor shards assigned to the device under a distributed sharding scheme over the device mesh 802. In at least one embodiment, the updated local output block 812 is likewise a local shard of a distributed output tensor. In some embodiments, the device mesh 802 is a two-dimensional GPU mesh, although other multi-device mesh organizations may be used.

Accordingly, FIG. 8A illustrates triangle multiplication 800 in which a local first tensor block 804, a local second tensor block 806, and a redistributed tensor block 808 are coordinated over the device mesh 802 using row-wise ring communication 814 and column-wise ring communication 816 so that devices compute local multiply-and-accumulate contributions 810 and generate updated local output blocks 812 for a distributed triangle multiplication computation, the distributed triangle multiplication computation including variant-dependent operand redistribution, initial shared-index alignment, and repeated row-wise and column-wise communication steps that preserve distributed ownership of tensor shards.

FIG. 8B illustrates an example of a process 850 to perform distributed triangle multiplication, according to at least one embodiment. In at least one embodiment, some or all of process 850, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium.

In at least one embodiment, process 850 is performed by one or more systems such as those described in this present disclosure. In at least one embodiment, process 850 is performed by the system described in connection with FIGS. 1, 4, and 8A. In at least one embodiment, one or more portions of process 850 are performed in any suitable order, including sequential, parallel, overlapped, or variations thereof, and by any suitable system, such as those described herein, and using any suitable processing unit, such as a CPU, GPU, PPU, GPGPU, or variations thereof. Although process 850 is depicted as a series of steps or operations, process 850 may include altered or reordered steps or operations, or may omit certain steps or operations, except where explicitly noted or logically required. In at least one embodiment, process 850 is performed using distributed data corresponding to the device mesh 802, the local first tensor block 804, the local second tensor block 806, the redistributed tensor block 808, the local multiply-and-accumulate contribution 810, the updated local output block 812, the row-wise ring communication 814, and the column-wise ring communication 816 of FIG. 8A. One or more portions of process 850 may be performed as part of performing one or more server operations such as those described herein.

In at least one embodiment, process 850 performs a distributed triangle multiplication computation that contracts two pair-derived tensors over a shared index to generate an update to a pair representation. In at least one embodiment, the triangle multiplication is an outgoing variant or an incoming variant. For example, where z denotes a pair representation having shape B×N×N×D, an outgoing triangle-multiplication variant may update z according to equation (2), and an incoming triangle-multiplication variant may update z according to equation (3). In at least one embodiment, the outgoing triangle-multiplication variant may correspond to a contraction of the form o=einsum(“bnkd,bmkd->bnmd”, a, b), in which the shared index k is the second pair-position axis of each operand, and the incoming triangle-multiplication variant may correspond to a contraction of the form o=einsum(“bknd,bkmd->bnmd”, a, b), in which the shared index k is the first pair-position axis of each operand. In at least one embodiment, a and b are projections of the pair representation z, and the operands and output correspond to pair-derived tensors having shape B×N×N×D or corresponding local distributed blocks thereof. In at least one embodiment, process 850 distributes the contraction across the device mesh 802 so that no device reconstructs the full input tensors or the full output tensor.

The system performing at least a part of process 850 includes code to at least prepare 852 operand blocks. In at least one embodiment, preparing 852 includes obtaining local tensor data from a local block of a distributed pair representation and generating therefrom the local first tensor block 804 and the local second tensor block 806. In at least one embodiment, preparing 852 includes applying one or more preprocessing operations to local pair-representation data, such as normalization, projection, masking, gating, chunking, permutation, or combinations thereof, to generate operand tensors a and b for the distributed triangle multiplication computation of equation (2) or equation (3). In at least one embodiment, the local first tensor block 804 and the local second tensor block 806 correspond to different chunks or projections of the same local pair-representation block. In at least one embodiment, preparing 852 further includes initializing the updated local output block 812 to an initial accumulation value, such as zero, before distributed multiply-and-accumulate operations begin.

The system performing at least a part of process 850 includes code to at least redistribute 854 operand block. In at least one embodiment, redistributing 854 includes redistributing one of the operand tensors across the two-dimensional device mesh 802 before repeated ring communication steps so that the redistributed operand can be aligned for contraction over the shared index. In at least one embodiment, redistributing 854 includes transposing ownership of blocks across the device mesh 802, such that a tensor block initially owned at one mesh coordinate is moved to another mesh coordinate selected for later alignment with blocks of the other operand. In at least one embodiment, the redistributed tensor block 808 corresponds to the operand selected for redistribution. In at least one embodiment, the redistributed operand depends on the triangle-multiplication variant. In at least one embodiment, for an outgoing variant, redistributed tensor block 808 corresponds to a block of the second operand of equation (2), and for an incoming variant, the redistributed tensor block 808 corresponds to a block of the first operand of equation (3). In at least one embodiment, redistributing 854 prepares the selected operand for subsequent initial alignment and repeated local batched matrix multiplications over the shared index.

The system performing at least a part of process 850 includes code to at least perform 856 initial alignment. In at least one embodiment, performing 856 includes applying initial row-wise and column-wise shifts so that, before a first ring step, a currently resident block of one operand and a currently resident block of the other operand are aligned on the shared index for local contraction. In at least one embodiment, blocks corresponding to a left-hand-side operand are shifted along rows of the device mesh 802 by offsets based on row coordinates of GPUs, and blocks corresponding to a right-hand-side operand are shifted along columns of the device mesh 802 by offsets based on column coordinates of the GPUs, such that the currently resident blocks correspond to a same shared-index partition before the first local contraction. In at least one embodiment, performing 856 therefore establishes a Cannon-style initial alignment that prepares the distributed blocks for repeated local multiply-and-accumulate operations over successive communication steps.

The system performing at least a part of process 850 includes code to at least receive 858 aligned blocks. In at least one embodiment, receiving 858 includes obtaining, for a current communication step, operand blocks that are presently aligned on the shared index for local contraction on a device of the device mesh 802. In at least one embodiment, the currently aligned blocks include the local first tensor block 804 or a communicated version thereof and the local second tensor block 806 or the redistributed tensor block 808 or a communicated version thereof, depending on the triangle-multiplication variant and the current communication step. In at least one embodiment, receiving 858 occurs after the initial alignment of 856 and also after each successive row-wise and column-wise ring shift that brings a next shared-index partition into alignment on the device mesh 802. In at least one embodiment, receiving 858 may be implemented using double-buffered communication so that operand blocks for a next communication step are transferred while a local contraction is performed using operand blocks already received for a current communication step.

The system performing at least a part of process 850 includes code to at least compute 860 local product. In at least one embodiment, computing 860 includes performing a local block-wise multiplication that contracts the currently aligned operand blocks over the shared index to generate the local multiply-and-accumulate contribution 810. In at least one embodiment, the local multiply-and-accumulate contribution 810 is a partial contribution to the pair update corresponding to the local output region owned by the device. In at least one embodiment, computing 860 includes performing a local batched matrix multiplication or another local contraction operation corresponding to the distributed triangle multiplication computation. In at least one embodiment, because different communication steps provide different operand-block pairings aligned on the shared index, computing 860 at successive communication steps generates different partial contributions that collectively correspond to the full contraction result for the local output region.

The system performing at least a part of process 850 includes code to at least update 862 local output. In at least one embodiment, updating 862 includes combining the local multiply-and-accumulate contribution 810 with a previously accumulated local output quantity to generate the updated local output block 812. In at least one embodiment, updating 862 includes adding the local multiply-and-accumulate contribution 810 to the updated local output block 812 without performing a collective all-gather of either full operand tensor and without performing a collective all-reduce of the output tensor. In at least one embodiment, the updated local output block 812 therefore stores an accumulated partial result corresponding to multiple pairings of operand blocks encountered across successive communication steps of the distributed batched matrix multiplication schedule.

The system performing at least a part of process 850 includes code to at least determine 864 whether more steps remain. In at least one embodiment, determining 864 includes determining whether additional row-wise and column-wise ring-communication steps remain in the distributed triangle multiplication schedule. In at least one embodiment, the determination is based on a number of devices participating along a row axis or a column axis of the device mesh 802, a current communication-step index, a communication schedule of the device mesh 802, or combinations thereof. If additional communication steps remain, process 850 returns to receiving 858 aligned blocks for a subsequent communication step. In at least one embodiment, during those subsequent communication steps, blocks of one operand continue to shift by one position along rows of the device mesh 802 according to the row-wise ring communication 814, and blocks of the other operand continue to shift by one position along columns of the device mesh 802 according to the column-wise ring communication 816, such that successive shared-index block pairings are brought into alignment on each device until all shared-index partitions assigned to the distributed triangle multiplication computation have been processed. If no additional communication steps remain, the updated local output block 812 is retained as the distributed local result of the triangle multiplication computation and may be used for further local processing, such as normalization, projection, gating, or downstream pair-representation updates.

Accordingly, FIG. 8B illustrates a forward-pass process 850 for distributed triangle multiplication in which operand blocks are prepared at 852, an operand block is redistributed at 854, an initial alignment is performed at 856, aligned blocks are received at 858, a local product is computed at 860, a local output is updated at 862, and a determination is made at 864 whether more steps remain. In at least one embodiment, process 850 enables an outgoing variant or an incoming variant of a shared-index triangle-multiplication contraction to be distributed across the device mesh 802 by variant-dependent redistribution of one operand, Cannon-style initial alignment, and repeated row-wise and column-wise ring communication, while preserving distributed ownership of local tensor blocks and correspondence with a corresponding single-device triangle multiplication computation.

FIG. 8C illustrates an example of a process 870 to perform a backward pass for distributed triangle multiplication, according to at least one embodiment. In at least one embodiment, some or all of process 870, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium.

In at least one embodiment, process 870 is performed by one or more systems such as those described in this present disclosure. In at least one embodiment, process 870 is performed by the system described in connection with FIGS. 1, 4, and 8A. In at least one embodiment, process 870 is performed by a system using one or more programming models, such as CUDA, HIP, oneAPI, or variations thereof. One or more portions of process 870 are performed in any suitable order, including sequential, parallel, overlapped, or variations thereof, and by any suitable system, such as those described herein, and using any suitable processing unit, such as a CPU, GPU, PPU, GPGPU, or variations thereof. Although process 870 is depicted as a series of steps or operations, process 870 may include altered or reordered steps or operations, or may omit certain steps or operations, except where explicitly noted or logically required. In at least one embodiment, process 870 is performed using distributed data corresponding to the device mesh 802, the local first tensor block 804, the local second tensor block 806, the redistributed tensor block 808, the local multiply-and-accumulate contribution 810, the updated local output block 812, the row-wise ring communication 814, and the column-wise ring communication 816 of FIG. 8A. One or more portions of process 870 may be performed as part of performing one or more server operations such as those described herein.

In at least one embodiment, process 870 performs backward computation for distributed triangle multiplication by propagating an upstream gradient through a distributed contraction that was performed over a shared index of pair-derived tensors. In at least one embodiment, the backward computation uses saved forward-pass operand data and performs two separate distributed batched matrix multiplications, one to generate a gradient for a first operand and another to generate a gradient for a second operand. In at least one embodiment, where z denotes a pair representation having shape B×N×N×D, the forward distributed triangle multiplication computation corresponds to an outgoing triangle-multiplication variant according to equation (2) or an incoming triangle-multiplication variant according to equation (3). In at least one embodiment, a and b are projections of the pair representation z, and the two distributed batched matrix multiplications reuse a row-wise and column-wise communication pattern corresponding to the forward distributed triangle multiplication computation to generate gradients for operands a and b of equation (2) or equation (3). In at least one embodiment, the resulting operand gradients are then combined and used to generate an input gradient and a gate gradient corresponding to preprocessing operations applied before the forward triangle-multiplication contraction. In at least one embodiment, the backward distributed computation corresponds to a single-device backward computation while preserving distributed ownership of local tensor blocks on the device mesh 802.

The system performing at least a part of process 870 includes code to at least prepare 872 backward data. In at least one embodiment, preparing 872 includes receiving an upstream gradient corresponding to the updated local output block 812 generated by the forward distributed triangle multiplication computation. In at least one embodiment, preparing 872 further includes restoring saved forward-pass tensors, such as local operand tensors corresponding to the local first tensor block 804 and the local second tensor block 806, mask data, saved gate data, and masked-and-gated input data. In at least one embodiment, the restored saved forward-pass tensors include operand data corresponding to projected tensors a and b used in equation (2) or equation (3). In at least one embodiment, preparing 872 includes casting the upstream gradient to a data type corresponding to a saved-tensor data type before distributed communication or contraction so that communicated buffers remain compatible in size and format. In at least one embodiment, preparing 872 also includes preparing local buffers for a first operand gradient, a second operand gradient, an input gradient, and a gate gradient, the local buffers being used in backward computation corresponding to an outgoing triangle-multiplication variant or an incoming triangle-multiplication variant of the forward distributed triangle multiplication computation.

The system performing at least a part of process 870 includes code to at least generate 874 first operand gradient. In at least one embodiment, generating 874 includes performing a first distributed batched matrix multiplication using the upstream gradient together with a saved operand tensor corresponding to one of the forward-pass operands. In at least one embodiment, the first distributed batched matrix multiplication uses the same row-wise and column-wise communication pattern used for the forward distributed triangle multiplication computation, including communication on the row-wise ring communication 814 and the column-wise ring communication 816. In at least one embodiment, generating 874 includes performing any variant-dependent redistribution or transpose operation needed to align blocks for the first distributed batched matrix multiplication. In at least one embodiment, the alignment used for generating 874 depends on whether the forward distributed triangle multiplication computation was an outgoing variant or an incoming variant. For example, for an outgoing variant of equation (2), generating 874 may use the upstream gradient in an untransposed arrangement together with a saved operand tensor corresponding to the other forward-pass operand to generate a gradient corresponding to operand a of equation (2), whereas for an incoming variant of equation (3) generating 874 may use a transposed arrangement of the upstream gradient or another complementary alignment so that the contracted index is aligned across the device mesh 802 to generate a gradient corresponding to operand a of equation (3). In at least one embodiment, generating 874 includes accumulating local contraction results across repeated communication steps to produce a local first operand gradient.

The system performing at least a part of process 870 includes code to at least generate 876 second operand gradient. In at least one embodiment, generating 876 includes performing a second distributed batched matrix multiplication, separate from the first distributed batched matrix multiplication, using the upstream gradient together with another saved operand tensor corresponding to the other forward-pass operand. In at least one embodiment, generating 876 uses the same general row-wise and column-wise communication structure as generating 874, but applies a complementary redistribution or transpose rule relative to the forward distributed triangle multiplication computation. In at least one embodiment, the transpose choice for generating 876 complements the transpose choice used for generating 874 and depends on whether the forward distributed triangle multiplication computation was an outgoing variant or an incoming variant. For example, for an outgoing variant of equation (2), generating 876 may use a transposed arrangement of the upstream gradient together with a saved operand tensor corresponding to the first forward-pass operand to generate a gradient corresponding to operand b of equation (2), whereas for an incoming variant of equation (3) generating 876 may use an untransposed arrangement of the upstream gradient and a complementary alignment of the saved operand tensor so that the contraction for the second operand gradient is aligned correctly on the device mesh 802 to generate a gradient corresponding to operand b of equation (3). In at least one embodiment, generating 876 includes accumulating local contraction results across repeated communication steps to produce a local second operand gradient.

In at least one embodiment, the operand redistributed across the two-dimensional device mesh during backward computation is complementary to the operand redistributed during the forward triangle-multiplication computation for the same variant. For an outgoing variant, forward computation redistributes the second operand, and backward computation redistributes an arrangement of the upstream output gradient when generating the gradient corresponding to the second operand. For an incoming variant, forward computation redistributes the first operand, and backward computation redistributes an arrangement of the upstream output gradient when generating the gradient corresponding to the first operand. In at least one embodiment, the same row-wise and column-wise ring-communication primitive used in the forward pass is reused for the backward distributed batched matrix multiplications.

The system performing at least a part of process 870 includes code to at least combine 878 operand gradients. In at least one embodiment, combining 878 includes combining the local first operand gradient generated at 874 and the local second operand gradient generated at 876 into a combined gradient representation corresponding to the input layout used before the forward contraction. For example, where the forward distributed triangle multiplication computation used an input tensor that was split into two operand tensors along a feature dimension, combining 878 may include concatenating the first operand gradient and the second operand gradient along the feature dimension to restore a gradient layout corresponding to the split input tensor representation used before the forward contraction. In at least one embodiment, the combined operand gradients therefore correspond to a gradient of a pre-contraction tensor representation from which the forward-pass operands were derived, including a pre-contraction representation from which projected tensors a and b of equation (2) or equation (3) were produced.

The system performing at least a part of process 870 includes code to at least generate 880 input gradient. In at least one embodiment, generating 880 includes applying chain-rule operations to the combined operand gradients using saved mask data and saved gate data from the forward distributed triangle multiplication computation. In at least one embodiment, generating 880 includes generating the input gradient by combining the combined operand gradients with the saved mask and the saved gate so that the gradient is propagated through masking and gating operations applied before the forward contraction. For example, generating 880 may include an elementwise chain-rule combination of the combined operand gradients with the saved mask and the saved gate so that the resulting input gradient corresponds to a gradient of an input pair representation from which the local first tensor block 804 and the local second tensor block 806 were derived. In at least one embodiment, the resulting input gradient corresponds to the gradient of an input pair representation from which the local first tensor block 804 and the local second tensor block 806 were derived, including an input pair representation from which projected tensors a and b of equation (2) or equation (3) were produced.

The system performing at least a part of process 870 includes code to at least generate 882 gate gradient. In at least one embodiment, generating 882 includes applying chain-rule operations to the combined operand gradients using saved masked-and-gated input data and saved gate data from the forward distributed triangle multiplication computation. In at least one embodiment, generating 882 includes computing a derivative contribution associated with a sigmoid gate or another gating function used to form the forward-pass operands. For example, generating 882 may include an elementwise chain-rule combination of the combined operand gradients with the saved masked-and-gated input data and a term corresponding to a derivative of the saved gate data so that the resulting gate gradient corresponds to gating circuitry used to generate the forward-pass operands corresponding to projected tensors a and b of equation (2) or equation (3). In at least one embodiment, the resulting gate gradient corresponds to a gradient for gate-generation circuitry used in the forward distributed triangle multiplication computation to form operand data from which projected tensors a and b of equation (2) or equation (3) were generated.

The system performing at least a part of process 870 includes code to at least generate 884 distributed gradients. In at least one embodiment, generating 884 includes producing distributed gradient outputs corresponding to the backward distributed triangle multiplication computation. In at least one embodiment, the distributed gradient outputs include the input gradient generated at 880 and the gate gradient generated at 882. In at least one embodiment, generating 884 further includes retaining local ownership of the gradients according to the distributed layout of the corresponding local tensor blocks on the device mesh 802 and, where appropriate, wrapping the locally generated gradients with distributed-tensor metadata so that the gradients can be consumed by downstream training computation. In at least one embodiment, generating 884 may also include generating or exposing parameter-gradient information associated with forward-pass projections used to generate the operand tensors, including projection-gradient information corresponding to projections used in the outgoing variant or the incoming variant of the forward distributed triangle multiplication computation of equation (2) or equation (3). Accordingly, FIG. 8C illustrates a backward-pass process 870 for distributed triangle multiplication in which backward data is prepared at 872, a first operand gradient is generated at 874, a second operand gradient is generated at 876, the operand gradients are combined at 878, an input gradient is generated at 880, a gate gradient is generated at 882, and distributed gradients are generated at 884. In at least one embodiment, process 870 uses two separate distributed batched matrix multiplications so that gradients corresponding to different forward-pass operands are computed using communication schedules aligned to the corresponding contraction structure of equation (2) or equation (3), with alignment and transpose choices that depend on whether the forward distributed triangle multiplication computation was an outgoing variant or an incoming variant, while preserving distributed ownership of local tensor blocks and correspondence with a corresponding single-device backward computation.

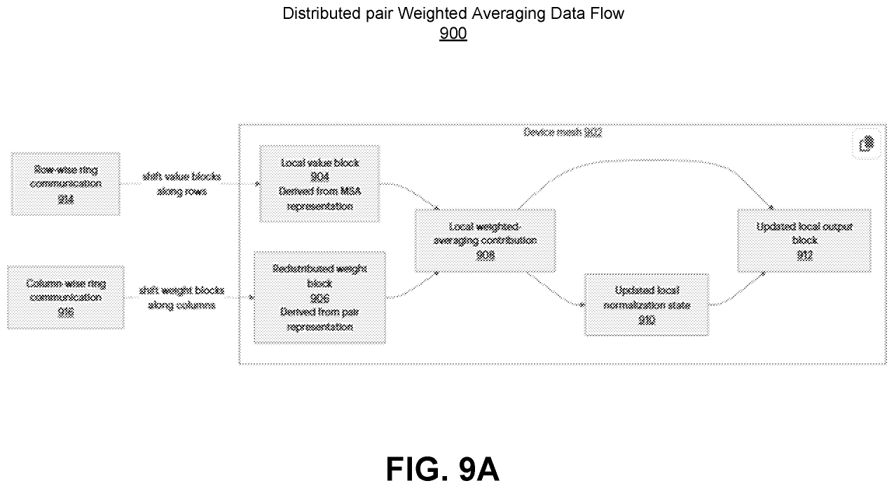

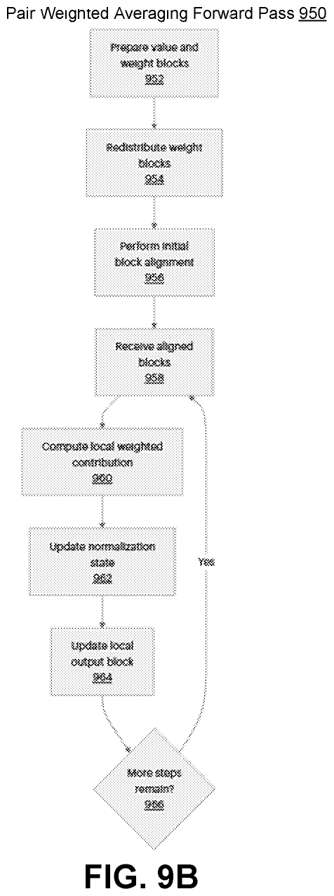

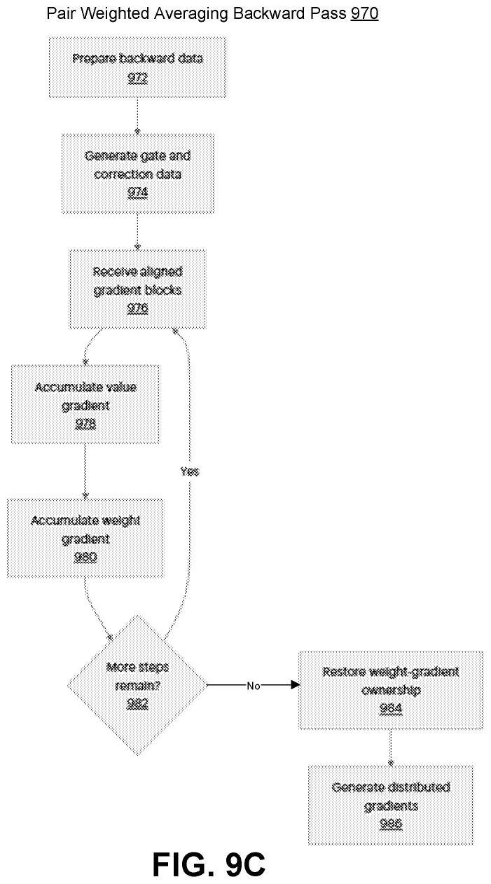

FIG. 9A illustrates pair weighted averaging 900 using value data derived from a sequence-alignment representation and weight data derived from a pair-representation tensor on a device mesh 902, according to at least one embodiment. In at least one embodiment, the pair weighted averaging 900 distributes a weighted-averaging computation in which pair-derived weights are applied to sequence-alignment-derived values while preserving correspondence with a corresponding single-device pair weighted averaging computation. In a representative embodiment, the sequence-alignment representation has shape (B, S, N, c_m) and the pair representation has shape (B, N, N, c_z). Value data derived from the sequence-alignment representation is distributed so that each GPU stores a local value block sharded over the aligned-sequence dimension S and the sequence-position dimension N. Weight data derived from the pair representation is distributed so that each GPU stores a local weight block sharded over a first sequence-position dimension N and a second sequence-position dimension N of the pair representation. The value-side blocks and the weight-side blocks are therefore distributed according to different sharding arrangements on the two-dimensional GPU mesh.

In at least one embodiment, pair weighted averaging 900 is a pair-conditioned aggregation operation in which weight data derived from a pair representation controls a weighted averaging of value data derived from a sequence-alignment representation. For example, where m denotes a sequence-alignment representation having shape B×S×N×D and z denotes a pair representation having shape B×N×N×D, equation (4) may express the pair weighted averaging 900 as a softmax-normalized weighted sum in which pair-derived weight data is applied over a sequence-position dimension to value data derived from the sequence-alignment representation to generate a weighted output. In at least one embodiment, v and g may be projected from the sequence-alignment representation m, w may be derived from the pair representation z, and the weighted output o may be generated by applying softmax-normalized pair-derived weights to value data across a shared sequence-position index prior to application of the gate g and an output projection. In at least one embodiment, prior to applying softmax normalization to the weight blocks along the shared sequence-position axis, mask-bias values are added to a projected pair-representation block, where the mask-bias values comprise large-negative values for masked pair positions and zero for unmasked pair positions, such that masked positions have effectively zero weight after the softmax normalization.

For distributed pair weighted averaging 900, the sequence-alignment representation and the pair representation may be distributed across the device mesh 902 according to different sharding arrangements that nevertheless permit aligned weighted-averaging computation. In at least one embodiment, value data derived from the sequence-alignment representation may be sharded along the sequence-depth dimension S and the sequence-position dimension N, while weight data derived from the pair representation may be sharded along two sequence-position dimensions, so that a device stores a local value block 904 associated with a local sequence-alignment region and a redistributed weight block 906 associated with a corresponding local pair region for the same weighted-averaging computation. In at least one embodiment, the redistributed weight block 906 may be generated by transposing ownership of pair-derived weight data across the device mesh 902 so that a weight block initially owned at a mesh coordinate (i, j) is transferred to a mesh coordinate (j, i), thereby aligning a contraction axis of the weight data with a corresponding sequence-position axis of the local value block 904 for subsequent communication steps.

After the redistributed weight block 906 is prepared, pair weighted averaging 900 may proceed through an initial alignment followed by a Cannon-style ring of communication steps in which value blocks are shifted using the row-wise ring communication 914 and weight blocks are shifted using the column-wise ring communication 916 while each device computes a local weighted-averaging contribution 908 for currently aligned blocks. In at least one embodiment, each communication step may include computing local weighting information from a currently resident redistributed weight block 906, applying softmax normalization on that local weight block, applying the resulting local weights to a currently resident local value block 904, and generating local normalization information that is merged into the updated local normalization state 910 using a running maximum-score value and a running log-sum-exp value. In at least one embodiment, the updated local output block 912 may be generated by merging the local weighted-averaging contribution 908 with a previously accumulated local output using the updated local normalization state 910 so that the distributed result corresponds to the serial softmax result of equation (4) without materializing a full N×N weight matrix on any one device. In at least one embodiment, communication of a next value block and a next weight block may be overlapped with computation for a current value block and a current weight block using double-buffered communication. As used herein, a value block and a weight block are aligned for a weighted-averaging computation when, after any redistribution and initial alignment operations, a contraction axis of the weight block indexes the same set of sequence positions as a corresponding sequence-position axis of the value block on the same GPU for a same local weighted-averaging computation.

In at least one embodiment, a device of the device mesh 902 stores a local value block 904 derived from a local block of a sequence-alignment representation, such as a multiple-sequence-alignment (MSA) representation. In at least one embodiment, the local value block 904 includes value data associated with aligned sequences and sequence positions to be combined in the weighted-averaging computation.

In at least one embodiment, the device further stores a redistributed weight block 906 derived from a pair-representation tensor. In at least one embodiment, the redistributed weight block 906 is generated by redistributing pair-derived weight data across the device mesh 902 before repeated communication steps begin. In some embodiments, redistributing the weight data comprises transposing ownership of weight blocks across the two-dimensional device mesh 902 so that the redistributed weight block 906 is aligned for subsequent distributed communication and weighted-averaging computation.

In at least one embodiment, the local value block 904 and the redistributed weight block 906 are aligned for the same weighted-averaging computation. In at least one embodiment, the redistributed weight block 906 corresponds to weighting information for the same sequence-position comparisons represented by the currently aligned local value block 904. In some embodiments, the redistributed weight block 906 comprises pair-derived attention-score data or normalized weight data generated from pair-representation data.

In at least one embodiment, the device mesh 902 performs row-wise ring communication 914 and column-wise ring communication 916 during repeated communication steps of the pair weighted averaging computation. In some embodiments, value blocks corresponding to the local value block 904 are shifted along rows of the device mesh 902 using the row-wise ring communication 914, while weight blocks corresponding to the redistributed weight block 906 are shifted along columns of the device mesh 902 using the column-wise ring communication 916. In at least one embodiment, these repeated communication steps successively align different value blocks and weight blocks for corresponding portions of the weighted-averaging computation without reconstructing the full value tensor or full pair-derived weight tensor on any one device.

Using the currently aligned local value block 904 and redistributed weight block 906, a device computes a local weighted-averaging contribution 908. In at least one embodiment, computing the local weighted-averaging contribution 908 includes generating local weighting information from the redistributed weight block 906 and applying the local weighting information to the aligned local value block 904. In at least one embodiment, the local weighted-averaging contribution 908 represents a partial weighted output associated with a local output region owned by the device.

In at least one embodiment, the device also computes local normalization information for the current communication step and combines that local normalization information with previously generated normalization information to produce an updated local normalization state 910. In at least one embodiment, the updated local normalization state 910 is a running normalization state maintained across repeated communication steps so that weighted contributions generated from different communicated blocks are merged using normalization corresponding to the full weighted-averaging computation.

In at least one embodiment, the device generates an updated local output block 912 based on the local weighted-averaging contribution 908, a previously generated local output block, and the updated local normalization state 910. In at least one embodiment, the updated local output block 912 corresponds to a local output portion of a sequence-alignment-derived output tensor. In at least one embodiment, repeated updates of the local output block 912 across communication steps accumulate weighted contributions associated with different communicated value blocks and weight blocks until the distributed pair weighted averaging computation for that local output portion is complete.

In some embodiments, the pair weighted averaging 900 uses pair-derived weights that are normalized across multiple communication steps so that the distributed result corresponds to a corresponding single-device softmax-based or otherwise normalized weighted-averaging computation. In at least one embodiment, the updated local normalization state 910 enables numerically consistent combination of partial weighted contributions generated at different communication steps.

In some embodiments, the local value block 904 is derived from an MSA representation and the redistributed weight block 906 is derived from a pair representation, such that the pair representation injects pairwise relational information into sequence-alignment-derived outputs through the distributed weighted-averaging computation. In at least one embodiment, the output represented by the updated local output block 912 preserves sequence-alignment semantics while incorporating information from pair-derived weighting.

Accordingly, FIG. 9A illustrates pair weighted averaging 900 in which the local value block 904 and the redistributed weight block 906 are coordinated over the device mesh 902 using row-wise ring communication 914 and column-wise ring communication 916 so that devices compute local weighted-averaging contributions 908, maintain updated local normalization states 910, and generate updated local output blocks 912 for a distributed pair weighted averaging computation.

FIG. 9B illustrates an example of a process 950 to perform distributed pair weighted averaging, according to at least one embodiment. In at least one embodiment, some or all of process 950, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium.

In at least one embodiment, process 950 is performed by one or more systems such as those described in this present disclosure. In at least one embodiment, process 950 is performed by the system described in connection with FIGS. 1, 4, and 9A. In at least one embodiment, process 950 is performed by a system using one or more programming models, such as CUDA, HIP, oneAPI, or variations thereof. One or more portions of process 950 are performed in any suitable order, including sequential, parallel, overlapped, or variations thereof, and by any suitable system, such as those described herein, and using any suitable processing unit, such as a CPU, GPU, PPU, GPGPU, or variations thereof. Although process 950 is depicted as a series of steps or operations, process 950 may include altered or reordered steps or operations, or may omit certain steps or operations, except where explicitly noted or logically required. In at least one embodiment, process 950 is performed using distributed data corresponding to the device mesh 902, the local value block 904, the redistributed weight block 906, the local weighted contribution 908, the updated normalization state 910, and the updated local output block 912 of FIG. 9A. One or more portions of process 950 may be performed as part of performing one or more server operations such as those described herein.

In at least one embodiment, process 950 performs a distributed pair weighted averaging computation in which value data derived from a sequence-alignment representation is combined with weight data derived from a pair representation. In at least one embodiment, process 950 may implement the weighted-averaging computation of equation (4) using aligned distributed value-side data and weight-side data and repeated communication steps across the device mesh 902.

In at least one embodiment, process 950 performs pair weighted averaging corresponding to equation (4), in which weight data derived from a pair representation controls a weighted averaging of value data derived from a sequence-alignment representation. For example, where m denotes a sequence-alignment representation having shape B×S×N×D and z denotes a pair representation having shape B×N×N×D, value data v and gate data g may be projected from m, weight data w may be derived from z, and a weighted output o may be generated by applying softmax-normalized pair-derived weights to the value data over a shared sequence-position index prior to application of the gate data and an output projection. In at least one embodiment, process 950 distributes that weighted-averaging computation across the device mesh 902 so that the distributed result corresponds to the serial softmax result of equation (4) without materializing a full N×N weight matrix on any one device.

For distributed pair weighted averaging, process 950 may operate on differently sharded value-side data and weight-side data that are aligned for a same weighted-averaging computation. In at least one embodiment, value data derived from the sequence-alignment representation may be sharded along the aligned-sequence dimension S and the sequence-position dimension N, while weight data derived from the pair representation may be sharded along two sequence-position dimensions, so that preparing 952 produces the local value block 904 for a local sequence-alignment region and redistributing 954 produces the redistributed weight block 906 for a corresponding local pair region. In at least one embodiment, redistributing 954 includes transposing ownership of pair-derived weight blocks across the device mesh 902 so that a weight block initially owned at a mesh coordinate (i, j) is transferred to a mesh coordinate (j, i), and performing 956 may then apply initial row-wise and column-wise shifts that align the redistributed weight block 906 with the local value block 904 for a first weighted-averaging step.

After the initial alignment, process 950 may proceed through a Cannon-style ring of communication steps in which receiving 958 obtains currently aligned value and weight blocks, computing 960 locally applies softmax normalization to the currently resident redistributed weight block and applies the resulting local weights to the currently resident value block to generate the local weighted contribution 908, updating 962 merges local normalization information into the updated normalization state 910 using a running maximum-score value and a running log-sum-exp value, and updating 964 merges the local weighted contribution 908 into the updated local output block 912 computing 960 generates the local weighted contribution 908 by locally softmax-normalizing a currently resident redistributed weight block and applying resulting local weights to a currently resident value block, updating 962 merges local normalization information into the updated normalization state 910 using a running maximum-score value and a running log-sum-exp value, and updating 964 merges the local weighted contribution 908 into the updated local output block 912.

In at least one embodiment, determining 966 causes process 950 to repeat those communication steps until each local output region has incorporated weighted contributions associated with all corresponding communicated value and weight blocks. In at least one embodiment, communication of a next value block and a next weight block may be overlapped with computation for a current value block and a current weight block using double-buffered communication. In one embodiment, redistributing the weight blocks includes transferring a weight block owned by a GPU having a first coordinate on a first mesh axis and a second coordinate on a second mesh axis to a GPU having the second coordinate on the first mesh axis and the first coordinate on the second mesh axis.

The system performing at least a part of process 950 includes code to at least prepare 952 value and weight blocks. In at least one embodiment, preparing 952 includes obtaining local tensor blocks derived from a sequence-alignment representation and a pair representation that have been distributed across the device mesh 902. In at least one embodiment, preparing 952 includes generating the local value block 904 from a local block of the sequence-alignment representation and generating a local weight block from a local block of the pair representation. In at least one embodiment, preparing 952 further includes generating a local gating tensor from the sequence-alignment representation for later application to a weighted-averaging output. In at least one embodiment, preparing 952 also includes initializing local accumulation state, such as the updated normalization state 910 and the updated local output block 912, prior to a first communication step. After redistribution of the weight blocks, value blocks may be circularly shifted along a row axis of the two-dimensional GPU mesh by an offset based on a coordinate of the GPU on a column axis, and redistributed weight blocks may be circularly shifted along the column axis by an offset based on a coordinate of the GPU on the row axis, thereby aligning the contraction axis of the weight blocks with the sequence-position axis of the value blocks for a first weighted-averaging step.

The system performing at least a part of process 950 includes code to at least redistribute 954 weight blocks. In at least one embodiment, redistributing 954 includes redistributing ownership of weight blocks across the device mesh 902 so that the weight blocks are arranged for subsequent weighted-averaging communication steps. In at least one embodiment, redistributing 954 includes transposing ownership of pair-derived weight blocks across the two-dimensional device mesh 902 so that a weight block initially associated with one mesh coordinate is moved to another mesh coordinate selected to align the weight block with value-side communication. In at least one embodiment, the redistributed weight block 906 is thereby prepared for local computation with the local value block 904 during a sequence of distributed communication steps.

The system performing at least a part of process 950 includes code to at least perform 956 initial block alignment. In at least one embodiment, performing 956 includes applying one or more initial row-wise and column-wise shifts to value blocks and redistributed weight blocks so that, at a first communication step, the currently resident value block and the currently resident weight block correspond to the same weighted-averaging computation. In at least one embodiment, value blocks are initially shifted along one mesh axis of the device mesh 902, and redistributed weight blocks are initially shifted along another mesh axis of the device mesh 902, thereby establishing a ring-ready alignment pattern for subsequent communication steps. In at least one embodiment, the initial block alignment allows each device to begin computing weighted-averaging contributions using locally available aligned blocks without reconstructing full global tensors.

The system performing at least a part of process 950 includes code to at least receive 958 aligned blocks. In at least one embodiment, receiving 958 includes obtaining, for a communication step of a sequence of communication steps, a currently resident value block and a currently resident redistributed weight block that are aligned for a local weighted-averaging computation on a device of the device mesh 902. In at least one embodiment, the currently resident value block corresponds to the local value block 904 or to a communicated value block received from a peer device, and the currently resident redistributed weight block corresponds to the redistributed weight block 906 or to a communicated redistributed weight block received from a peer device. In at least one embodiment, receiving 958 may be implemented using double-buffered communication so that blocks for a subsequent communication step are received while local computation is performed using blocks of a current communication step.

For a current communication step, local normalization information may include a local maximum-score value and a local logarithm of a sum of exponentials of values obtained by subtracting the local maximum-score value from respective weighting values of a current weight block. A local normalization state maintained across successive communication steps may include a running maximum-score value and a running logarithm of a sum of exponentials of values obtained by subtracting the running maximum-score value from respective weighting values of weight blocks processed so far. An updated local output block may be generated by rescaling a previously generated local output block and a current local weighted-averaging contribution according to the updated local normalization state and combining the rescaled quantities.

The system performing at least a part of process 950 includes code to at least compute 960 local weighted contribution. In at least one embodiment, computing 960 includes generating local weighting information from the currently resident redistributed weight block and applying that local weighting information to the currently resident value block to generate the local weighted contribution 908. In at least one embodiment, computing 960 includes computing pre-normalized weighting values from the redistributed weight block, applying softmax normalization or other weighting normalization along a contraction axis, and using the resulting local weights to form a partial weighted sum of the value data. In at least one embodiment, computing 960 further includes generating local normalization information corresponding to the current communication step, such as local maximum-score information, local exponential-sum information, local logarithm of a sum of exponentials of attention-score differences information, or combinations thereof, for later merging into the updated normalization state 910. In some embodiments, after completion of the distributed weighted averaging, a gating tensor derived from the sequence-alignment representation is applied elementwise to the local output block, and an output projection is applied to the gated result.

The system performing at least a part of process 950 includes code to at least update 962 normalization state. In at least one embodiment, updating 962 includes combining normalization information generated at the current communication step with previously maintained normalization information to produce the updated normalization state 910. In at least one embodiment, the updated normalization state 910 is maintained across the sequence of communication steps so that local weighted contributions generated from different currently resident redistributed weight blocks can be merged in a numerically stable manner. In at least one embodiment, updating 962 includes maintaining a running maximum and a running logarithm of a sum of exponentials of attention-score differences or another numerically stable normalization representation across communication steps.

The system performing at least a part of process 950 includes code to at least update 964 local output block. In at least one embodiment, updating 964 includes combining the local weighted contribution 908 with a previously accumulated local output quantity to generate the updated local output block 912. In at least one embodiment, updating 964 includes rescaling a previously accumulated local output quantity according to the updated normalization state 910, rescaling the current local weighted contribution 908 according to the updated normalization state 910, and combining the rescaled quantities to produce the updated local output block 912. In at least one embodiment, after completion of the communication steps, the updated local output block 912 corresponds to a local portion of a distributed pair weighted averaging output that is numerically consistent with a corresponding single-device weighted-averaging computation.

The system performing at least a part of process 950 includes code to at least determine 966 whether more steps remain. In at least one embodiment, determining 966 includes determining whether additional communication steps remain in the distributed pair weighted averaging schedule. In at least one embodiment, if more communication steps remain, process 950 returns to receiving 958 aligned blocks for a subsequent communication step. In at least one embodiment, during those subsequent communication steps, value blocks are shifted along one mesh axis, such as along rows of the device mesh 902, and redistributed weight blocks are shifted along another mesh axis, such as along columns of the device mesh 902, so that different value-and-weight block pairings are successively aligned on each device. If additional communication steps do not remain, the updated local output block 912 is retained as a local output corresponding to the distributed pair weighted averaging computation and may be further processed, such as by applying a locally derived gate and an output projection.

Accordingly, FIG. 9B illustrates a forward-pass process 950 for distributed pair weighted averaging in which value and weight blocks are prepared at 952, weight blocks are redistributed at 954, initial block alignment is performed at 956, aligned blocks are received at 958, a local weighted contribution is computed at 960, a normalization state is updated at 962, a local output block is updated at 964, and a determination is made at 966 whether more steps remain. In at least one embodiment, process 950 enables pair-derived weighting information and sequence-alignment-derived value information to be combined across a distributed device mesh while preserving distributed ownership of local tensor blocks and correspondence with a corresponding single-device weighted-averaging computation.

FIG. 9C illustrates an example of a process 970 to perform a backward pass for distributed pair weighted averaging, according to at least one embodiment. In at least one embodiment, some or all of process 970, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium.

In at least one embodiment, process 970 is performed by one or more systems such as those described in this present disclosure. In at least one embodiment, process 970 is performed by the system described in connection with FIGS. 1, 4, and 9A. In at least one embodiment, process 970 is performed by a system using one or more programming models, such as CUDA, HIP, oneAPI, or variations thereof. One or more portions of process 970 are performed in any suitable order, including sequential, parallel, overlapped, or variations thereof, and by any suitable system, such as those described herein, and using any suitable processing unit, such as a CPU, GPU, PPU, GPGPU, or variations thereof. Although process 970 is depicted as a series of steps or operations, process 970 may include altered or reordered steps or operations, or may omit certain steps or operations, except where explicitly noted or logically required. In at least one embodiment, process 970 is performed using distributed data corresponding to the device mesh 902, the local value block 904, the redistributed weight block 906, the local weighted contribution 908, the updated normalization state 910, and the updated local output block 912 of FIG. 9A. One or more portions of process 970 may be performed as part of performing one or more server operations such as those described herein.

In at least one embodiment, process 970 performs backward computation for distributed pair weighted averaging corresponding to equation (4) by propagating an upstream gradient through a softmax-normalized weighted-averaging computation in which weight data derived from a pair representation is applied to value data derived from a sequence-alignment representation. For example, where m denotes a sequence-alignment representation having shape B×S×N×D and z denotes a pair representation having shape B×N×N×D, value data v and gate data g may be projected from m, weight data w may be derived from z, and the backward computation may generate gradients corresponding to value data projected from m, weight data derived from z, and gate data projected from m while preserving distributed ownership of local tensor blocks on the device mesh 902. In at least one embodiment, process 970 may use saved forward-pass tensors corresponding to value data, post-softmax weight data, gating data, output data prior to a final projection, and normalization-related data associated with the softmax-normalized weighted averaging, and may perform repeated communication steps across the device mesh 902 in which value-gradient contributions accumulate locally while weight-gradient contributions accumulate according to a distributed communication pattern that restores weight-gradient ownership corresponding to the distributed pair-representation layout.

The system performing at least a part of process 970 includes code to at least prepare 972 backward data. In at least one embodiment, preparing 972 includes receiving an upstream gradient corresponding to the updated local output block 912 generated by the forward distributed pair weighted averaging computation. In at least one embodiment, preparing 972 further includes restoring saved forward-pass tensors, such as a local value tensor corresponding to the local value block 904, post-softmax weight data corresponding to the redistributed weight block 906, a local gate tensor derived from a sequence-alignment representation, and local output data produced before application of a gate or output projection. In at least one embodiment, preparing 972 also includes allocating local gradient buffers for a value gradient, a weight gradient, and a gate gradient. In at least one embodiment, the upstream gradient is cast to a data type corresponding to a saved forward-pass tensor data type before distributed communication or accumulation so that communicated buffers remain compatible in size and format.

The system performing at least a part of process 970 includes code to at least generate 974 gate and correction data. In at least one embodiment, generating 974 includes generating a local gate gradient based on the upstream gradient, saved local output data, and saved gate data. For example, where a gate is produced using a sigmoid activation, generating 974 may include applying a sigmoid-derivative factor to produce a gate-gradient contribution. In at least one embodiment, generating 974 further includes applying the saved gate data to the upstream gradient to produce gated output-gradient data for later distributed backward computation. In at least one embodiment, generating 974 also includes generating softmax-correction data used for the backward propagation of gradients through the softmax-normalized weighted averaging of equation (4). For example, the softmax-correction data may include a per-head or per-position quantity corresponding to a reduction of a product of output-gradient data and forward output data.

The system performing at least a part of process 970 includes code to at least receive 976 aligned gradient blocks. In at least one embodiment, receiving 976 includes obtaining, for a communication step of a sequence of communication steps, currently aligned distributed blocks used for backward computation. In at least one embodiment, the aligned gradient blocks include currently resident post-softmax weight data, currently resident output-gradient data, and currently resident correction data that correspond to the same local weighted-averaging relationships for the communication step. In at least one embodiment, receiving 976 follows an initial alignment in which post-softmax weight data is aligned along one mesh axis of the device mesh 902 and output-gradient data and correction data are aligned along another mesh axis. In at least one embodiment, receiving 976 may be implemented using double-buffered communication so that blocks for a subsequent communication step are received while local gradient computation is performed using blocks of a current communication step.

The system performing at least a part of process 970 includes code to at least accumulate 978 value gradient. In at least one embodiment, accumulating 978 includes generating a local value-gradient contribution from the currently resident output-gradient data and the currently resident post-softmax weight data and adding that contribution to a previously accumulated local value gradient. In at least one embodiment, because the value-side layout remains local with respect to accumulation of the value gradient, the value gradient is accumulated locally on the device without a distributed reduction of the value-gradient tensor during the repeated communication steps. In at least one embodiment, the accumulated value gradient corresponds to gradient information for value data derived from the sequence-alignment representation and associated with the local value block 904. In one embodiment, during the backward pass, post-softmax weight blocks shift along a column axis of the two-dimensional GPU mesh while output-gradient blocks and softmax-correction data shift along a row axis of the two-dimensional GPU mesh. Value-gradient contributions accumulate locally on each GPU without inter-GPU reduction of the value-gradient tensor. Weight-gradient contributions are accumulated using a virtual all-reduce in which each GPU adds a current partial weight-gradient contribution to a running weight-gradient buffer and forwards the running weight-gradient buffer along the column axis at each communication step. After the successive communication steps, an ownership-restoration communication returns each accumulated weight-gradient block to the GPU corresponding to ownership of the original pair-representation block from which the corresponding weight block was derived.

The system performing at least a part of process 970 includes code to at least accumulate 980 weight gradient. In at least one embodiment, accumulating 980 includes generating a weight-gradient contribution for the current communication step based on the currently resident post-softmax weight data, the currently resident output-gradient data, the saved local value data, and the currently resident correction data, the weight-gradient contribution reflecting backward propagation through the softmax-normalized weighting operation of equation (4). In at least one embodiment, accumulating 980 further includes combining the current-step weight-gradient contribution with a previously accumulated weight-gradient buffer and forwarding the accumulated weight-gradient buffer according to a distributed communication schedule, such that the weight-gradient accumulation behaves as a virtual all-reduce across devices participating in the weighted-averaging computation. In at least one embodiment, weight-gradient contributions are accumulated across communication steps while preserving compatibility with the distributed ownership pattern of the pair-derived weight data.

The system performing at least a part of process 970 includes code to at least determine 982 whether more steps remain. In at least one embodiment, determining 982 includes determining whether additional communication steps remain in the backward distributed pair weighted averaging schedule. In at least one embodiment, the determination is based on a number of devices participating along a selected mesh axis, a current communication-step index, a communication schedule of the device mesh 902, or combinations thereof. If additional communication steps remain, process 970 returns to receiving 976 aligned gradient blocks for a subsequent communication step. In at least one embodiment, during the repeated communication steps, post-softmax weight data continues to shift along one mesh axis, while output-gradient data and correction data continue to shift along another mesh axis, thereby successively exposing different aligned block combinations for backward accumulation.

The system performing at least a part of process 970 includes code to at least restore 984 weight-gradient ownership. In at least one embodiment, restoring 984 includes performing one or more communication operations after completion of the repeated communication steps so that accumulated weight-gradient buffers are returned to devices corresponding to the original distributed ownership of the pair-derived weight data. In at least one embodiment, restoring 984 reverses a communication offset or redistributed ownership arrangement used during the forward weighted-averaging computation or during backward virtual all-reduce accumulation. In at least one embodiment, restoring 984 produces a distributed weight gradient whose local ownership corresponds to the local ownership of the corresponding pair-representation blocks from which the weight data was derived.

The system performing at least a part of process 970 includes code to at least generate 986 distributed gradients. In at least one embodiment, generating 986 includes producing distributed gradient outputs corresponding to the backward distributed pair weighted averaging computation. In at least one embodiment, the distributed gradient outputs include a local value gradient corresponding to the local value block 904, a restored local weight gradient corresponding to the redistributed weight block 906 and its underlying pair-representation ownership, and a local gate gradient corresponding to gate data derived from the sequence-alignment representation. In at least one embodiment, generating 986 further includes wrapping one or more locally accumulated gradients with distributed-tensor metadata so that the resulting distributed gradients can be consumed by downstream training computation.

Accordingly, FIG. 9C illustrates a backward-pass process 970 for distributed pair weighted averaging in which backward data is prepared at 972, gate and correction data are generated at 974, aligned gradient blocks are received at 976, a value gradient is accumulated at 978, a weight gradient is accumulated at 980, a determination is made at 982 whether more steps remain, weight-gradient ownership is restored at 984, and distributed gradients are generated at 986. In at least one embodiment, process 970 enables distributed backward propagation for pair weighted averaging corresponding to equation (4) while preserving distributed ownership of local tensor blocks and correspondence with a corresponding single-device backward computation. In at least one embodiment, the backward computation accumulates value-gradient contributions locally, accumulates weight-gradient contributions using a virtual all-reduce communication pattern across repeated communication steps, and restores ownership of the weight gradient to match the distributed pair-representation layout after the repeated communication steps are complete.

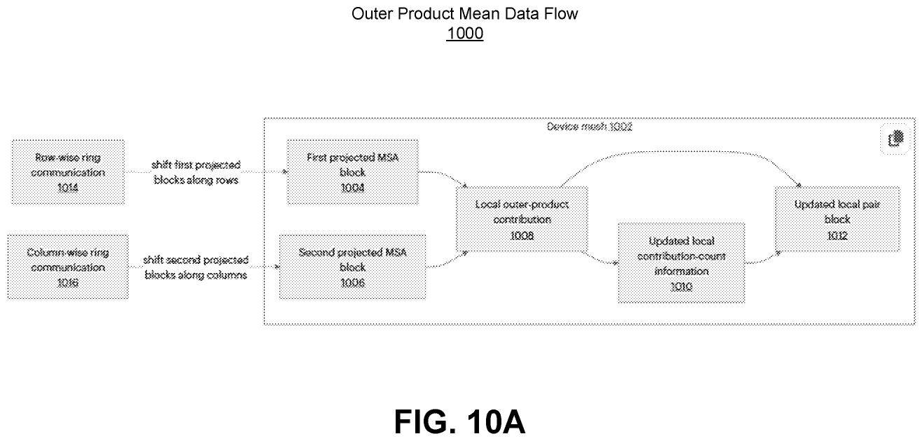

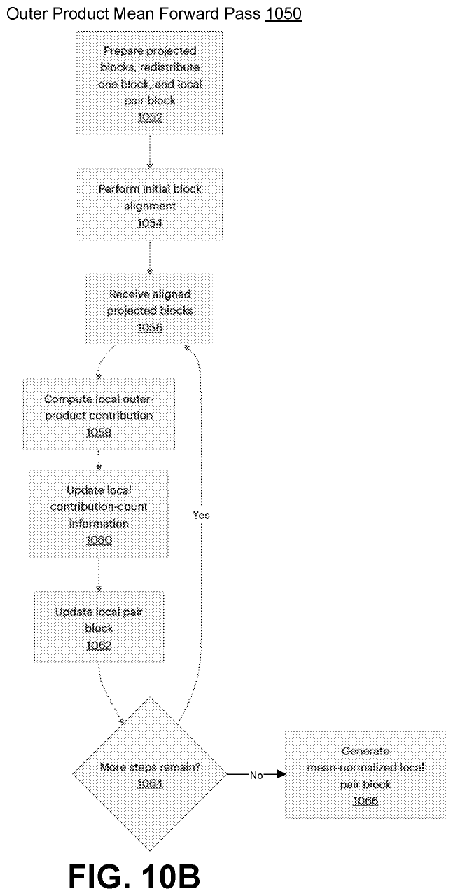

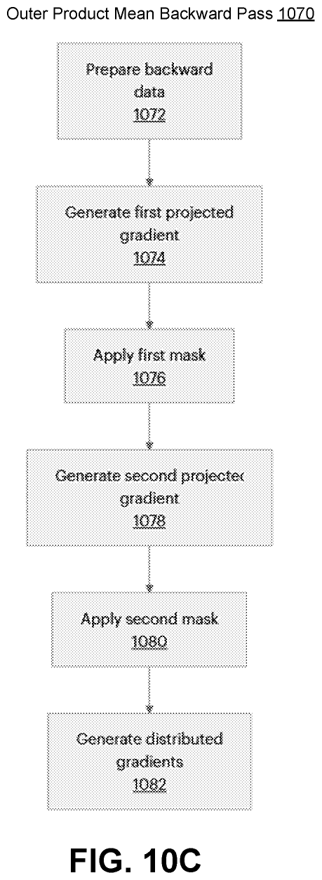

FIG. 10A illustrates outer product mean 1000 using projected sequence-alignment data communicated across a device mesh 1002 to update a pair representation tensor, according to at least one embodiment. In at least one embodiment, the outer product mean 1000 distributes an operation that forms or updates a pair representation from a sequence-alignment representation by combining projected sequence-alignment data through outer products and accumulating corresponding contributions across the device mesh 1002.

$${z}_{i j c d} = \frac{1}{\vert S \vert} {\sum }_{s} {a}_{s i c} {b}_{s j d} , a = {proj}_{a} ( m ) , b = p r o {j}_{b} ( m ) \qquad ( 5 )$$

In at least one embodiment, outer product mean 1000 is a sequence-alignment-to-pair reduction operation in which first and second projected representations derived from a sequence-alignment representation are combined through outer products and averaged over an aligned-sequence dimension to generate or update a pair representation. For example, where m denotes a sequence-alignment representation having shape B×S×N×D, equation (5) may express the outer product mean 1000 as z_{ijcd}. In at least one embodiment, a and b may each have shape B×S×N×D, indices cand d may each range over D, and the outer-product accumulation may therefore generate an intermediate tensor z having shape B×N×N×D×D that is flattened and linearly projected to generate an updated pair representation. In at least one embodiment, when masked aligned sequences are present, the divisor used for the mean may be based on contribution-count information or mask-count information corresponding to participating aligned sequences rather than only a raw cardinality of S.

For distributed outer product mean 1000, the first projected MSA tensor and the second projected MSA tensor may be distributed across the device mesh 1002 so that different devices hold different local projected blocks along the aligned-sequence dimension S and the aligned-position dimension N while still permitting aligned outer-product accumulation for a same local pair region. In at least one embodiment, a device may store the first projected MSA block 1004 and the second projected MSA block 1006 as local projected blocks derived from a local block of the sequence-alignment representation, and one of the projected tensors, such as the first projected tensor, may be redistributed by transposing ownership across the two-dimensional device mesh 1002 for ring alignment. In at least one embodiment, after that redistribution, an initial row-wise alignment and an initial column-wise alignment may place currently resident projected blocks corresponding to a same shard of the aligned-sequence dimension on a same device for a first outer-product step. In at least one embodiment, projected blocks corresponding to one projected tensor are initially circularly shifted along GPU rows by offsets based on row indices of the GPUs, and projected blocks corresponding to the other projected tensor are initially circularly shifted along GPU columns by offsets based on column indices of the GPUs, thereby aligning the projected blocks on a same shard of the aligned-sequence axis for a first communication step.

After the initial alignment, outer product mean 1000 may proceed through a Cannon-style ring of communication steps in which blocks corresponding to the first projected MSA tensor are shifted using the row-wise ring communication 1014 and blocks corresponding to the second projected MSA tensor are shifted using the column-wise ring communication 1016 while each device computes a local outer-product contribution 1008 for currently aligned projected blocks and accumulates that contribution into the updated local pair block 1012. In at least one embodiment, the updated local contribution-count information 1010 may track counts of aligned-sequence contributions, mask-count information, or both, and a reduction operation, such as an all-reduce of local count information, may be used to finalize a divisor for the mean so that the distributed result corresponds to the single-device mean of equation (5) rather than only an accumulated outer-product sum. In at least one embodiment, backward computation for the outer product mean 1000 may use separate distributed ring passes for gradients of the first projected tensor and gradients of the second projected tensor because those gradients contract with different pair axes, and communication of a next projected block may be overlapped with computation for a current projected block using double-buffered communication.

In at least one embodiment, a device of the device mesh 1002 stores a first projected MSA block 1004 and a second projected MSA block 1006. In at least one embodiment, the first projected MSA block 1004 and the second projected MSA block 1006 are local projected blocks derived from a local block of a multiple-sequence-alignment representation and correspond to projected sequence-alignment data used to generate a local portion of a pair-representation output for the outer product mean of equation (5).

In at least one embodiment, the device mesh 1002 performs row-wise ring communication 1014 and column-wise ring communication 1016 during repeated communication steps of the outer-product-mean computation. In at least one embodiment, after an initial alignment described above, blocks corresponding to the first projected MSA tensor are shifted along rows of the device mesh 1002 using the row-wise ring communication 1014, while blocks corresponding to the second projected MSA tensor are shifted along columns of the device mesh 1002 using the column-wise ring communication 1016. In at least one embodiment, the repeated communication steps successively align different pairings of first projected data and second projected data for corresponding shards of the aligned-sequence dimension without reconstructing the full projected tensors on any one device.

Using the currently aligned projected data, a device computes a local outer-product contribution 1008. In at least one embodiment, the local outer-product contribution 1008 is generated by combining currently aligned projected blocks from the first projected MSA block 1004 and the second projected MSA block 1006 to form a partial contribution for a local pair output. In at least one embodiment, the local outer-product contribution 1008 corresponds to one portion of an outer-product reduction over the aligned-sequence dimension of equation (5).

In at least one embodiment, the device generates an updated local pair block 1012 based on the local outer-product contribution 1008, a previously generated local pair block, and the updated local contribution-count information 1010. In at least one embodiment, the updated local pair block 1012 is a local shard of a distributed pair-representation tensor. In at least one embodiment, repeated updates of the local pair block 1012 across communication steps accumulate partial outer-product contributions associated with different communicated projected blocks until the outer-product-mean computation for that local pair block is complete.

In at least one embodiment, the outer product mean 1000 computes a mean over aligned sequences by combining accumulated outer-product contributions with the updated local contribution-count information 1010, such as after reduction of local count information used to finalize a divisor for the mean. In at least one embodiment, this normalization allows the distributed result to correspond to a corresponding single-device outer-product-mean computation of equation (5) rather than merely an unnormalized accumulated outer-product sum.

In at least one embodiment, one of the projected MSA tensors is initially redistributed across the device mesh 1002 before the repeated communication steps begin, including by transposing ownership of projected blocks across the device mesh 1002, so that projected blocks are aligned for the row-wise ring communication 1014 and the column-wise ring communication 1016.

In at least one embodiment, backward computation associated with the outer product mean 1000 may use separate distributed passes for different projected tensors. For example, a first distributed pass may generate gradient information for projected data corresponding to the first projected MSA block 1004 based on gradient data associated with the updated local pair block 1012 and communicated projected data corresponding to the second projected MSA block 1006, and a second distributed pass may generate gradient information for projected data corresponding to the second projected MSA block 1006 based on gradient data associated with the updated local pair block 1012 and communicated projected data corresponding to the first projected MSA block 1004, the separate distributed passes corresponding to contractions with different pair axes.

Accordingly, FIG. 10A illustrates outer product mean 1000 in which the first projected MSA block 1004 and the second projected MSA block 1006 are coordinated over the device mesh 1002 using row-wise ring communication 1014 and column-wise ring communication 1016 so that devices compute local outer-product contributions 1008, update local contribution-count information 1010, and generate updated local pair blocks 1012 for a distributed outer-product-mean computation, the distributed outer-product-mean computation including initial redistribution of one projected tensor, initial alignment of projected blocks for a first outer-product step, repeated row-wise and column-wise communication steps across the device mesh 1002, and count-based normalization for a mean corresponding to equation (5).

FIG. 10B illustrates an example of a process 1050 to perform distributed outer product mean, according to at least one embodiment. In at least one embodiment, some or all of process 1050, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium.

In at least one embodiment, process 1050 is performed by one or more systems such as those described in this present disclosure. In at least one embodiment, process 1050 is performed by the system described in connection with FIGS. 1, 4, and 10A. In at least one embodiment, process 1050 is performed by a system using one or more programming models, such as CUDA, HIP, oneAPI, or variations thereof. One or more portions of process 1050 may be performed in any suitable order, including sequential, parallel, overlapped, or variations thereof, and by any suitable system, such as those described herein, and using any suitable processing unit, such as a CPU, GPU, PPU, GPGPU, or variations thereof. Although process 1050 is depicted as a series of steps or operations, process 1050 may include altered or reordered steps or operations, or may omit certain steps or operations, except where explicitly noted or logically required. In at least one embodiment, process 1050 is performed using distributed data corresponding to the device mesh 1002, the first projected MSA block 1004, the second projected MSA block 1006, the local outer-product contribution 1008, the updated local contribution-count information 1010, and the updated local pair block 1012 of FIG. 10A. One or more portions of process 1050 may be performed as part of performing one or more server operations such as those described herein.

In at least one embodiment, process 1050 performs distributed outer product mean corresponding to equation (5), in which a first projected tensor and a second projected tensor derived from a sequence-alignment representation are combined through outer products and averaged over an aligned-sequence dimension to generate or update a pair representation. For example, where m denotes a sequence-alignment representation having shape B×S×N×D, equation (5) may express the outer product mean as

$${z}_{i j c d} = \frac{1}{\vert S \vert} {\sum }_{s} {a}_{s i c} {b}_{s j d} ,$$

with a=projₐ(m) and b=proj_{b}(m). In at least one embodiment, process 1050 may distribute that outer-product-mean computation across the device mesh 1002 so that the distributed result corresponds to the single-device mean of equation (5) without materializing a full pair tensor of shape B×N×N×D×D on any one device.

For distributed outer product mean, process 1050 may operate on differently positioned projected tensors that nevertheless remain alignable for a same local pair computation. In at least one embodiment, projected tensors derived from the sequence-alignment representation may be sharded along the aligned-sequence dimension S and the aligned-position dimension N so that preparing 1052 produces the first projected MSA block 1004 and the second projected MSA block 1006 and initializes the updated local pair block 1012 for a local sequence-alignment region. In at least one embodiment, preparing 1052 may further include redistributing one of the projected tensors by transposing ownership across the device mesh 1002 so that a projected block initially owned at a mesh coordinate i,j is transferred to a mesh coordinate j,i, and performing 1054 may then apply a Cannon-style initial alignment that aligns the first projected MSA block 1004 and the second projected MSA block 1006 for a first outer-product step over a same shard of the aligned-sequence dimension.

After the Cannon-style initial alignment, process 1050 may proceed through repeated ring communication steps in which receiving 1056 obtains currently aligned projected blocks, computing 1058 generates the local outer-product contribution 1008 by combining the currently resident projected blocks, updating 1060 updates the updated local contribution-count information 1010 for the same local pair region, and updating 1062 merges the local outer-product contribution 1008 into the updated local pair block 1012. In at least one embodiment, determining 1064 may cause process 1050 to repeat those communication steps until each local pair region has incorporated outer-product contributions associated with all corresponding communicated projected blocks. In at least one embodiment, when the communication steps are complete, local count information may be reduced across devices holding different aligned-sequence shards so that a divisor for the mean is finalized and the resulting local pair block corresponds to the single-device mean of equation (5). In at least one embodiment, generating 1066 includes generating a mean-normalized local pair block based on the finalized divisor. In at least one embodiment, communication of a next projected block may be overlapped with computation for a current projected block using double-buffered communication.

The system performing at least a part of process 1050 includes code to at least prepare 1052 projected blocks and local pair state. In at least one embodiment, preparing 1052 includes obtaining local tensor data from a local block of a sequence-alignment representation and generating therefrom the first projected MSA block 1004 and the second projected MSA block 1006. In at least one embodiment, preparing 1052 includes applying one or more preprocessing operations to local sequence-alignment data, such as normalization, projection, masking, padding, chunking, permutation, or combinations thereof, to generate projected tensors corresponding to a and b of equation (5). In at least one embodiment, preparing 1052 further includes initializing local accumulation state, such as the updated local pair block 1012 and the updated local contribution-count information 1010, prior to a first communication step. In at least one embodiment, preparing 1052 further includes redistributing ownership of one of the projected tensors across the device mesh 1002 so that projected blocks are arranged for subsequent outer-product communication steps, including by transposing ownership of projected blocks across the two-dimensional device mesh 1002 so that a projected block initially associated with one mesh coordinate is moved to another mesh coordinate selected to align the projected block with a corresponding projected block of the other tensor for contraction over the aligned-sequence dimension.

The system performing at least a part of process 1050 includes code to at least perform 1054 initial block alignment. In at least one embodiment, performing 1054 includes applying a Cannon-style initial alignment to projected blocks so that, at a first communication step, the currently resident projected blocks correspond to the same outer-product computation over a same shard of the aligned-sequence dimension. In at least one embodiment, blocks corresponding to one projected tensor are initially shifted along one mesh axis of the device mesh 1002, and blocks corresponding to the other projected tensor are initially shifted along another mesh axis of the device mesh 1002, thereby establishing a ring-ready alignment pattern for subsequent communication steps. In at least one embodiment, the initial block alignment allows each device to begin computing local outer-product contributions using locally available aligned projected blocks without reconstructing full global projected tensors.

The system performing at least a part of process 1050 includes code to at least receive 1056 aligned projected blocks. In at least one embodiment, receiving 1056 includes obtaining, for a communication step of a sequence of communication steps, a currently resident first projected block and a currently resident second projected block that are aligned for a local outer-product computation on a device of the device mesh 1002. In at least one embodiment, the currently resident first projected block corresponds to the first projected MSA block 1004 or to a communicated projected block received from a peer device, and the currently resident second projected block corresponds to the second projected MSA block 1006 or to a communicated projected block received from a peer device. In at least one embodiment, receiving 1056 may be implemented using double-buffered communication so that blocks for a subsequent communication step are received while local computation is performed using blocks of a current communication step.

The system performing at least a part of process 1050 includes code to at least compute 1058 local outer-product contribution. In at least one embodiment, computing 1058 includes generating the local outer-product contribution 1008 from the currently resident first projected block and the currently resident second projected block by forming a partial outer-product contribution for a local pair output. In at least one embodiment, computing 1058 includes accumulating one portion of the reduction over the aligned-sequence dimension of equation (5) for a local i,j pair region owned by the device. In at least one embodiment, the local outer-product contribution 1008 is generated without materializing a full global pair tensor on the device.

The system performing at least a part of process 1050 includes code to at least update 1060 contribution-count information. In at least one embodiment, updating 1060 includes generating or updating the updated local contribution-count information 1010 corresponding to aligned-sequence contributions for the same local pair region as the local outer-product contribution 1008. In at least one embodiment, the updated local contribution-count information 1010 includes contribution counts, mask-count information, or other normalization-related information used to compute a mean rather than only an accumulated outer-product sum. In at least one embodiment, the updated local contribution-count information 1010 is maintained across the sequence of communication steps so that contributions associated with different communicated projected blocks can be count-normalized according to the full outer-product-mean computation.

The system performing at least a part of process 1050 includes code to at least update 1062 local pair block. In at least one embodiment, updating 1062 includes combining the local outer-product contribution 1008 with a previously accumulated local pair quantity to generate the updated local pair block 1012. In at least one embodiment, the updated local pair block 1012 is a local shard of a distributed pair-representation tensor. In at least one embodiment, repeated updates of the local pair block 1012 across communication steps accumulate partial outer-product contributions associated with different communicated projected blocks until the outer-product accumulation for that local pair block is complete.

The system performing at least a part of process 1050 includes code to at least determine 1064 whether more steps remain. In at least one embodiment, determining 1064 includes determining whether additional communication steps remain in the distributed outer-product-mean schedule. In at least one embodiment, if more communication steps remain, process 1050 returns to receiving 1056 aligned projected blocks for a subsequent communication step. In at least one embodiment, during those subsequent communication steps, projected blocks corresponding to one projected tensor are shifted along one mesh axis, such as along rows of the device mesh 1002, and projected blocks corresponding to the other projected tensor are shifted along another mesh axis, such as along columns of the device mesh 1002, so that different projected-block pairings are successively aligned on each device. In at least one embodiment, the local projected blocks of the first projected tensor and the second projected tensor are multiplied elementwise by a sequence-alignment mask block prior to outer-product accumulation, such that masked aligned sequences contribute zero to the outer-product sum, and the count information used for normalization counts only unmasked aligned sequences.

The system performing at least a part of process 1050 includes code to at least generate 1066 mean-normalized local pair block. In at least one embodiment, generating 1066 includes, after a determination that additional communication steps do not remain, reducing local contribution-count information across devices corresponding to different aligned-sequence shards to finalize a divisor for the mean. In at least one embodiment, generating 1066 further includes normalizing the updated local pair block 1012 according to that divisor to produce a mean-normalized local pair block. In at least one embodiment, generating 1066 may further include flattening outer-product channels and applying a projection so that the resulting local pair output corresponds to a distributed pair-representation output of the outer-product-mean computation.

Accordingly, FIG. 10B illustrates a forward-pass process 1050 for distributed outer product mean in which projected blocks are prepared at 1052, including redistribution of one projected block, initial block alignment is performed at 1054, aligned projected blocks are received at 1056, a local outer-product contribution is computed at 1058, contribution-count information is updated at 1060, a local pair block is updated at 1062, and a determination is made at 1064 whether more steps remain, after which a mean-normalized local pair block is generated at 1066. In at least one embodiment, process 1050 enables first and second projected tensors derived from a sequence-alignment representation to be combined across a distributed device mesh to generate a pair-representation output corresponding to the mean of equation (5) while preserving distributed ownership of local tensor blocks and correspondence with a corresponding single-device outer-product-mean computation.

FIG. 10C illustrates an example of a process 1070 to perform a backward pass for distributed outer product mean, according to at least one embodiment. In at least one embodiment, some or all of process 1070, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium.

In at least one embodiment, process 1070 is performed by one or more systems such as those described in this present disclosure. In at least one embodiment, process 1070 is performed by the system described in connection with FIGS. 1, 4, and 10A. In at least one embodiment, process 1070 is performed by a system using one or more programming models, such as CUDA, HIP, oneAPI, or variations thereof. One or more portions of process 1070 may be performed in any suitable order, including sequential, parallel, overlapped, or variations thereof, and by any suitable system, such as those described herein, and using any suitable processing unit, such as a CPU, GPU, PPU, GPGPU, or variations thereof. Although process 1070 is depicted as a series of steps or operations, process 1070 may include altered or reordered steps or operations, or may omit certain steps or operations, except where explicitly noted or logically required. In at least one embodiment, process 1070 is performed using distributed data corresponding to the device mesh 1002, the first projected MSA block 1004, the second projected MSA block 1006, the local outer-product contribution 1008, the updated local contribution-count information 1010, and the updated local pair block 1012 of FIG. 10A. One or more portions of process 1070 may be performed as part of performing one or more server operations such as those described herein.

In at least one embodiment, process 1070 performs backward computation for distributed outer product mean corresponding to equation (5) by propagating an upstream pair gradient through an operation in which a first projected tensor and a second projected tensor derived from a sequence-alignment representation are combined through outer products and averaged over an aligned-sequence dimension to generate or update a pair representation. For example, where m denotes a sequence-alignment representation having shape B×S×N×D, equation (5) may express the forward outer product mean as

$${z}_{i j c d} = \frac{1}{\vert S \vert} {\sum }_{s} {a}_{s i c} {b}_{s j d} ,$$

with a=projₐ(m) and b=proj_{b}(m). In at least one embodiment, process 1070 may use saved forward-pass tensors corresponding to projected tensors a and b, local mask data, and contribution-count information associated with the mean, and may perform a first backward ring pass for the first projected tensor and a second backward ring pass for the second projected tensor because those gradients contract with different pair axes.

The system performing at least a part of process 1070 includes code to at least prepare 1072 backward data. In at least one embodiment, preparing 1072 includes receiving an upstream pair gradient corresponding to the updated local pair block 1012 generated by the forward distributed outer-product-mean computation. In at least one embodiment, preparing 1072 further includes restoring saved forward-pass tensors, such as local projected tensors corresponding to the first projected MSA block 1004 and the second projected MSA block 1006, local mask data, and local contribution-count information associated with the count-normalization for the mean. In at least one embodiment, where the forward computation included flattening or projection of outer-product channels, preparing 1072 may include converting the upstream pair gradient to a gradient representation corresponding to pre-projection outer-product channels and dividing that gradient representation by a divisor derived from the updated local contribution-count information 1010 so that the backward computation corresponds to the mean of equation (5). In at least one embodiment, preparing 1072 also includes allocating local gradient buffers for a first projected-tensor gradient and a second projected-tensor gradient.

The system performing at least a part of process 1070 includes code to at least generate 1074 first projected-tensor gradient. In at least one embodiment, generating 1074 includes performing the first backward ring pass in which a currently resident upstream pair-gradient block is aligned with a currently resident projected block corresponding to the second projected MSA block 1006 so that the contraction for a gradient of the first projected tensor is locally computable on a device of the device mesh 1002. In at least one embodiment, generating 1074 includes applying a transpose-based and Cannon-style initial alignment in which the upstream pair-gradient block is transposed across the device mesh 1002 and column-initialized, while projected blocks corresponding to the second projected MSA block 1006 are row-initialized for a first backward communication step. In at least one embodiment, generating 1074 further includes accumulating, at each communication step, a local first projected-tensor gradient contribution produced by contracting the currently resident upstream pair-gradient block with the currently resident projected block corresponding to the second projected MSA block 1006 over a pair axis associated with the second projected tensor.

The system performing at least a part of process 1070 includes code to at least determine 1076 whether more first-pass steps remain. In at least one embodiment, determining 1076 includes determining whether additional communication steps remain in the first backward ring pass for the first projected-tensor gradient. In at least one embodiment, if additional communication steps remain, process 1070 returns to generating 1074 first projected-tensor gradient for a subsequent communication step. In at least one embodiment, during those subsequent communication steps, projected blocks corresponding to the second projected MSA block 1006 continue to shift along one mesh axis, such as along rows of the device mesh 1002, while upstream pair-gradient blocks continue to shift along another mesh axis, such as along columns of the device mesh 1002, so that different aligned block combinations are successively exposed for accumulation of the first projected-tensor gradient.

The system performing at least a part of process 1070 includes code to at least generate 1078 second projected-tensor gradient. In at least one embodiment, generating 1078 includes performing the second backward ring pass, separate from the first backward ring pass, in which a currently resident upstream pair-gradient block is aligned with a currently resident projected block corresponding to the first projected MSA block 1004 so that the contraction for a gradient of the second projected tensor is locally computable on a device of the device mesh 1002. In at least one embodiment, generating 1078 includes applying a Cannon-style initial alignment in which the upstream pair-gradient block is column-initialized without transposing ownership across the device mesh 1002, while projected blocks corresponding to the first projected MSA block 1004 are row-initialized for a first communication step of the second backward ring pass. In at least one embodiment, generating 1078 further includes accumulating, at each communication step, a local second projected-tensor gradient contribution produced by contracting the currently resident upstream pair-gradient block with the currently resident projected block corresponding to the first projected MSA block 1004 over a pair axis associated with the first projected tensor.

The system performing at least a part of process 1070 includes code to at least determine 1080 whether more second-pass steps remain. In at least one embodiment, determining 1080 includes determining whether additional communication steps remain in the second backward ring pass for the second projected-tensor gradient. In at least one embodiment, if additional communication steps remain, process 1070 returns to generating 1078 second projected-tensor gradient for a subsequent communication step. In at least one embodiment, during those subsequent communication steps, projected blocks corresponding to the first projected MSA block 1004 continue to shift along one mesh axis, such as along rows of the device mesh 1002, while upstream pair-gradient blocks continue to shift along another mesh axis, such as along columns of the device mesh 1002, so that different aligned block combinations are successively exposed for accumulation of the second projected-tensor gradient.

The system performing at least a part of process 1070 includes code to at least finalize 1082 projected gradients. In at least one embodiment, finalizing 1082 includes applying local mask data to the accumulated first projected-tensor gradient and the accumulated second projected-tensor gradient so that gradient contributions corresponding to masked aligned-sequence positions are suppressed consistently with the forward distributed outer-product-mean computation. In at least one embodiment, finalizing 1082 may further include preserving scaling associated with the divisor derived from the updated local contribution-count information 1010 that was applied during preparing 1072 so that the finalized projected gradients correspond to backward propagation through the count-normalized mean of equation (5). In at least one embodiment, finalizing 1082 does not require a separate all-reduce of contribution-count information during the backward pass because the contribution-count information used for the mean may already have been reduced during the forward distributed outer-product-mean computation.

The system performing at least a part of process 1070 includes code to at least generate 1084 distributed gradients. In at least one embodiment, generating 1084 includes producing distributed gradient outputs corresponding to the backward distributed outer-product-mean computation. In at least one embodiment, the distributed gradient outputs include a local first projected-tensor gradient corresponding to the first projected MSA block 1004 and a local second projected-tensor gradient corresponding to the second projected MSA block 1006. In at least one embodiment, generating 1084 further includes wrapping one or more locally accumulated gradients with distributed-tensor metadata so that the resulting distributed gradients can be consumed by downstream training computation. Accordingly, FIG. 10C illustrates a backward-pass process 1070 for distributed outer product mean in which backward data is prepared at 1072, a first projected-tensor gradient is generated at 1074, a determination is made at 1076 whether more first-pass steps remain, a second projected-tensor gradient is generated at 1078, a determination is made at 1080 whether more second-pass steps remain, projected gradients are finalized at 1082, and distributed gradients are generated at 1084. In at least one embodiment, process 1070 enables distributed backward propagation for outer product mean corresponding to equation (5) while preserving distributed ownership of local tensor blocks and correspondence with a corresponding single-device backward computation.

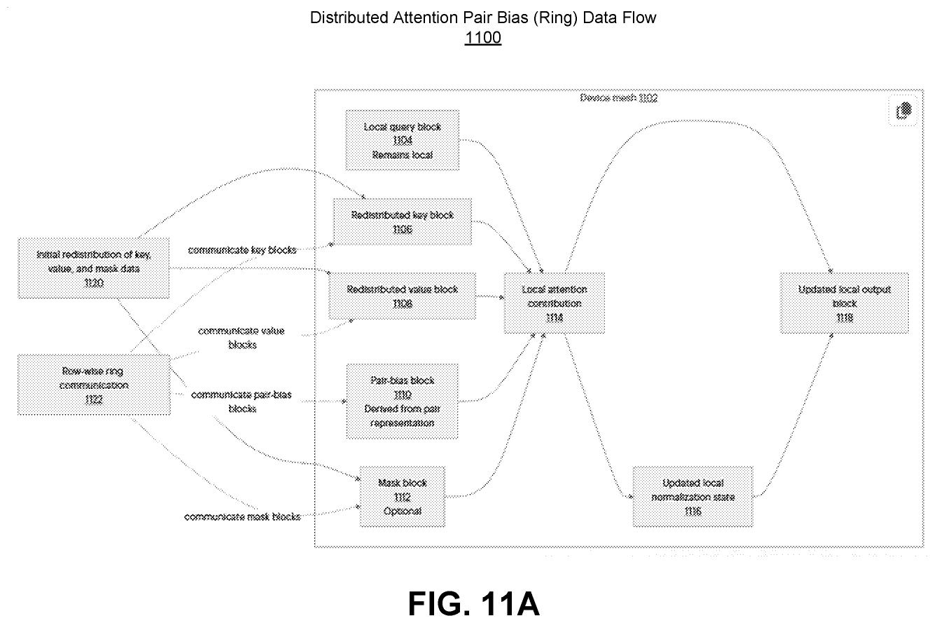

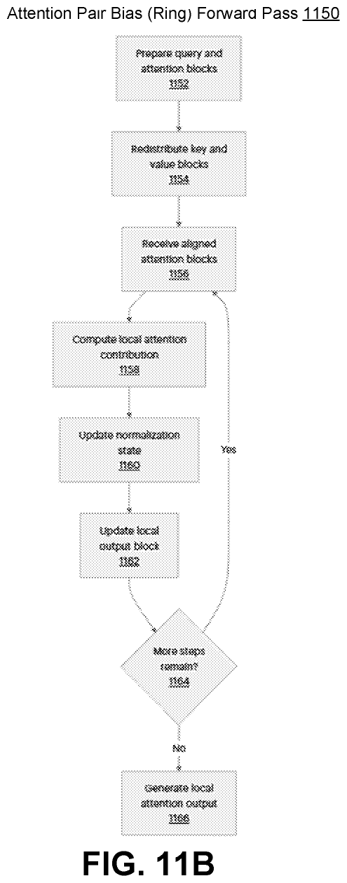

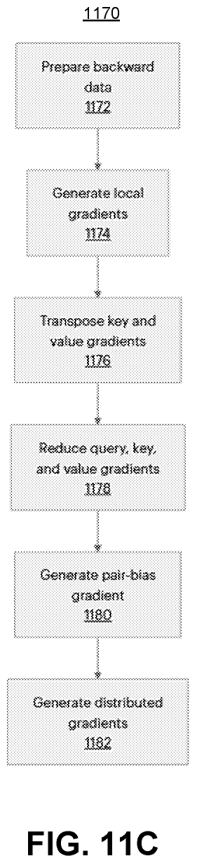

FIG. 11A illustrates distributed attention with additive pair bias on a device mesh 1102, according to at least one embodiment. In at least one embodiment, the attention pair bias 1100 distributes an attention computation in which attention scores are modified by bias data derived from a pair representation while preserving correspondence with a corresponding single-device attention-with-pair-bias computation.

In at least one embodiment, attention pair bias is a distributed attention operation in which attention scores formed from a single representation are modified by an additive bias derived from a pair representation prior to softmax normalization and weighted value aggregation. For example, where s denotes a single representation having shape B×N×Dₛ and z denotes a pair representation having shape B×N×N×D_{z}, the operation may be expressed by equation (6), where Q, K, V, and g are projected from the single representation s. In at least one embodiment, the pair-derived bias may be projected from the pair representation to produce a per-head additive bias for corresponding query-key comparisons, and the distributed computation may preserve numerical equivalence to a single-device softmax attention computation by merging partial attention contributions using tiled softmax normalization.

$$attn = softmax ( \frac{{QK}^{T}}{\sqrt{d}} + z + mask\_bias ) , output = {proj}_{o} ( g \cdot ( attn \cdot V ) ) \qquad ( 6 )$$

For distributed attention pair bias, the single representation and the pair representation may be distributed across a two-dimensional device mesh so that each device retains a local query block while non-query attention blocks are prepared for transpose-based redistribution and ring communication. In at least one embodiment, a local query block may remain resident on a device throughout the distributed attention computation, while key blocks, value blocks, and, where used, mask blocks may be redistributed by transposing ownership across one mesh axis so that different sequence-position shards are aligned for subsequent ring steps. In at least one embodiment, pair-bias blocks derived from the pair representation may remain associated with the same query-key comparisons as the redistributed key blocks and value blocks, such that each device holds, for a current communication step, a local query block together with currently resident key, value, pair-bias, and optional mask blocks corresponding to the same local attention sub-computation.

After the transpose-based redistribution, attention pair bias may proceed through repeated ring communication steps in which key blocks, value blocks, and pair-bias blocks are shifted among devices while each device computes a local attention contribution for its resident query block. In at least one embodiment, each communication step may include computing local attention scores from the local query block and a currently resident key block, modifying those scores with the currently resident pair-bias block and, where used, a currently resident mask block, applying softmax normalization to obtain local attention weights, and applying the local attention weights to a currently resident value block to generate a local weighted value contribution. In at least one embodiment, partial attention outputs generated at different communication steps may be merged using a running normalization state that includes a running maximum value and a running log-sum-exp value so that the distributed result corresponds to the serial softmax result of equation (6) without materializing a full N×N attention-score matrix on any one device. In at least one embodiment, communication of a next key block, value block, and pair-bias block may be overlapped with computation for a current key block, value block, and pair-bias block using double-buffered communication.

In at least one embodiment, a device of the device mesh 1102 stores a local query block 1104 generated from a local block of a single-representation tensor. In at least one embodiment, the local query block 1104 remains resident on the device during repeated communication steps of the distributed attention computation and is not transmitted during the repeated communication steps.

In at least one embodiment, an initial redistribution 1120 is performed for non-query attention data before repeated ring communication begins. In at least one embodiment, the initial redistribution 1120 includes redistributing key data to generate a redistributed key block 1106, redistributing value data to generate a redistributed value block 1108, and, where used, redistributing mask data to generate a mask block 1112 aligned for subsequent distributed communication. In some embodiments, the initial redistribution 1120 comprises transposing ownership of key, value, and, where used, mask blocks across a mesh axis of the device mesh 1102 of the device mesh 1102 so that different sequence-position shards are distributed across devices for subsequent ring communication.

In at least one embodiment, the device further stores a pair-bias block 1110 derived from a pair representation tensor. In at least one embodiment, the pair-bias block 1110 corresponds to the same query-key comparisons as the redistributed key block 1106 and the redistributed value block 1108 used with the local query block 1104. In some embodiments, the pair-bias block 1110 is generated by applying a pair-bias projection to a local block of the pair representation tensor.

In at least one embodiment, the device mesh 1102 performs row-wise ring communication 1122 during repeated communication steps of the distributed attention computation. In at least one embodiment, the row-wise ring communication 1122 communicates redistributed key blocks 1106, redistributed value blocks 1108, pair-bias blocks 1110, and, where used, mask blocks 1112 among devices so that different non-query attention blocks are successively aligned with the local query block 1104. In at least one embodiment, the local query block 1104 remains local while the redistributed key block 1106, the redistributed value block 1108, the pair-bias block 1110, and, where used, the mask block 1112 are communicated for successive partial attention computations.

Using the local query block 1104 together with the currently aligned redistributed key block 1106, redistributed value block 1108, pair-bias block 1110, and, where used, mask block 1112, a device computes a local attention contribution 1114. In at least one embodiment, computing the local attention contribution 1114 includes generating local attention scores from the local query block 1104 and the redistributed key block 1106, modifying the local attention scores with the pair-bias block 1110 and, where used, the mask block 1112, and forming a partial weighted sum using the redistributed value block 1108.

In at least one embodiment, the device also computes local normalization information for the current communication step and uses that local normalization information to generate an updated local normalization state 1116. In at least one embodiment, the updated local normalization state 1116 is a running normalization state maintained across repeated communication steps so that partial attention results generated from different communicated blocks are combined using normalization corresponding to the full attention computation.

In at least one embodiment, the device generates an updated local output block 1118 based on the local attention contribution 1114, a previously generated local output block, and the updated local normalization state 1116. In at least one embodiment, the updated local output block 1118 corresponds to the local query block 1104. In at least one embodiment, repeated updates of the local output block 1118 across communication steps accumulate attention contributions associated with different redistributed key blocks 1106, redistributed value blocks 1108, pair-bias blocks 1110, and mask blocks 1112 until the distributed attention computation for that local query block is complete.

In some embodiments, the attention pair bias 1100 is performed on a two-dimensional GPU mesh, although other device-mesh organizations may be used. In at least one embodiment, the pair-bias block 1110 is coordinated with the redistributed key block 1106 and the redistributed value block 1108 during the row-wise ring communication 1122 so that the communicated pair-bias data remains aligned with the same query-key comparisons as the communicated key and value data.

Accordingly, FIG. 11A illustrates attention pair bias 1100 in which the local query block 1104 remains local on the device mesh 1102, the redistributed key block 1106, the redistributed value block 1108, the pair-bias block 1110, and, where used, the mask block 1112 are coordinated through the initial redistribution 1120 and the row-wise ring communication 1122, and devices generate the local attention contribution 1114, the updated local normalization state 1116, and the updated local output block 1118 for distributed attention with additive pair bias.

FIG. 11B illustrates an example of a process 1150 to perform distributed attention pair bias, according to at least one embodiment. In at least one embodiment, some or all of process 1150, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium. At least some computer-readable instructions usable to perform process 1150 are not stored solely using transitory signals, such as a propagating transient electric or electromagnetic transmission. A non-transitory computer-readable medium does not necessarily include non-transitory data storage circuitry, such as buffers, caches, and queues, within transceivers of transitory signals.

In at least one embodiment, process 1150 is performed by one or more systems such as those described in this present disclosure. In at least one embodiment, process 1150 is performed by the system described in connection with FIGS. 1, 4, and 11A. In at least one embodiment, process 1150 is performed by a system using one or more programming models, such as CUDA, HIP, oneAPI, or variations thereof. One or more portions of process 1150 may be performed in any suitable order, including sequential, parallel, overlapped, or variations thereof, and by any suitable system, such as those described herein, and using any suitable processing unit, such as a CPU, GPU, PPU, GPGPU, or variations thereof. Although process 1150 is depicted as a series of steps or operations, process 1150 may include altered or reordered steps or operations, or may omit certain steps or operations, except where explicitly noted or logically required, such as when an output of one step or operation is used as input for another. In at least one embodiment, process 1150 is performed using distributed data corresponding to the device mesh 1102, the local query block 1104, the redistributed key block 1106, the redistributed value block 1108, the pair-bias block 1110, the mask block 1112, the local attention contribution 1114, the updated local normalization state 1116, the updated local output block 1118, the initial redistribution 1120, and the row-wise ring communication 1122 of FIG. 11A. One or more portions of process 1150 may be performed as part of performing one or more server operations such as those described herein.

In at least one embodiment, process 1150 performs distributed attention with additive pair bias corresponding to equation (6), in which attention scores formed from a single representation are modified by an additive bias derived from a pair representation prior to softmax normalization and weighted value aggregation. For example, where s denotes a single representation having shape B×N×Ds and z denotes a pair representation having shape B×N×N×Dz, equation (6) may operate on query-side data that remains local to a device and non-query attention data that is prepared for transpose-based redistribution and repeated ring communication. In at least one embodiment, preparing 1152 may produce a local query block, a local key block, a local value block, a local gate block, and a local pair-bias block derived from local blocks of the single representation and the pair representation. In at least one embodiment, transposing 1154 may transpose ownership of key blocks, value blocks, and, where used, mask blocks across one mesh axis of the device mesh 1102 so that different sequence-position shards are redistributed for ring alignment while the local query block remains resident on the device on which the local query block was formed. In at least one embodiment, repeated ring communication after transposing 1154 is performed along another mesh axis of the device mesh 1102. In at least one embodiment, the local pair-bias block may correspond to the same query-key comparisons as the redistributed key blocks and redistributed value blocks used in a current local attention sub-computation. After the transpose-based redistribution, process 1150 may proceed through repeated ring communication steps in which receiving 1156 obtains currently resident key blocks, value blocks, pair-bias blocks, and, where used, mask blocks, computing 1158 generates a local attention contribution and local normalization information for the resident local query block, updating 1160 merges the local normalization information into a running normalization state, and updating 1162 merges the local attention contribution into a local output block. In at least one embodiment, determining 1164 may cause process 1150 to repeat those ring communication steps until the local query block has been combined with all corresponding key, value, pair-bias, and, where used, mask blocks required for the full attention computation. In at least one embodiment, the running normalization state may include a running maximum value and a running log-sum-exp value so that partial attention outputs generated at different ring communication steps may be merged in a numerically stable manner corresponding to the full softmax of equation (6). In at least one embodiment, communication of a next key block, value block, and pair-bias block may be overlapped with computation for a current key block, value block, and pair-bias block using double-buffered communication.

The system performing at least a part of process 1150 includes code to at least prepare 1152 query and non-query blocks. In at least one embodiment, preparing 1152 includes obtaining local tensor data from a local block of a single representation and a local block of a pair representation and generating therefrom a local query block, a local key block, a local value block, a local gate block, and a local pair-bias block. In at least one embodiment, preparing 1152 includes applying one or more preprocessing operations to the local single-representation data or the local pair-representation data, such as normalization, projection, reshaping into attention heads, masking preparation, or combinations thereof, to produce local tensors corresponding to Q, K, V, g, and pair-bias data for equation (6). In at least one embodiment, preparing 1152 further includes obtaining or generating the mask block 1112, where used, and initializing the updated local normalization state 1116 and the updated local output block 1118 prior to a first ring communication step.

The system performing at least a part of process 1150 includes code to at least transpose 1154 non-query blocks. In at least one embodiment, transposing 1154 includes performing the initial redistribution 1120 for key blocks and value blocks across the device mesh 1102 so that different sequence-position shards are redistributed for subsequent ring communication. In at least one embodiment, where a mask is used, transposing 1154 may further include transposing ownership of mask blocks so that the mask blocks remain aligned with corresponding key blocks and value blocks. In at least one embodiment, the local query block 1104 is not transposed and remains resident on the device throughout the repeated ring communication steps. In at least one embodiment, the pair-bias block 1110 is not subjected to transposing 1154 and is later communicated in coordination with the redistributed key block 1106 and the redistributed value block 1108 during the row-wise ring communication 1122.

The system performing at least a part of process 1150 includes code to at least receive 1156 aligned non-query blocks. In at least one embodiment, receiving 1156 includes obtaining, for a ring communication step of a sequence of ring communication steps, a currently resident key block, a currently resident value block, a currently resident pair-bias block, and, where used, a currently resident mask block corresponding to a same local attention sub-computation for the resident local query block. In at least one embodiment, the currently resident key block and the currently resident value block correspond to transposed key blocks and transposed value blocks initially received after transposing 1154 or to communicated key blocks and communicated value blocks received from peer devices during later ring communication steps. In at least one embodiment, the currently resident pair-bias block is passed among neighboring devices along the row-wise ring communication 1122 in coordination with the currently resident key block and the currently resident value block so that the currently resident pair-bias block remains aligned with the same query-key comparisons. In at least one embodiment, receiving 1156 may be implemented using double-buffered communication so that blocks for a subsequent ring communication step are received while local computation is performed using blocks of a current ring communication step.

The system performing at least a part of process 1150 includes code to at least compute 1158 local attention contribution. In at least one embodiment, computing 1158 includes generating local attention scores from the resident local query block and the currently resident key block. In at least one embodiment, the local attention scores are computed using a scaled query-key product, such as a query-key dot product divided by a scale factor based on a head dimension. In at least one embodiment, computing 1158 further includes modifying the local attention scores with the currently resident pair-bias block and, where used, the currently resident mask block, applying softmax normalization to obtain local attention weights, and applying the local attention weights to the currently resident value block to generate the local attention contribution 1114. In at least one embodiment, the local attention contribution 1114 corresponds to a partial weighted value output for the local query block for one ring communication step of the distributed attention pair bias computation. In at least one embodiment, computing 1158 further includes generating local normalization information corresponding to the current ring communication step, such as a local maximum value, a local exponential-sum value, a local log-sum-exp value, or combinations thereof, for later merging into the running normalization state.

The system performing at least a part of process 1150 includes code to at least update 1160 normalization state. In at least one embodiment, updating 1160 includes combining the local normalization information generated at the current ring communication step with previously maintained normalization information to produce the updated local normalization state 1116. In at least one embodiment, the updated local normalization state 1116 includes a running maximum value and a running log-sum-exp value maintained across the sequence of ring communication steps so that partial attention outputs generated from different communicated key blocks, value blocks, pair-bias blocks, and, where used, mask blocks may be merged in a numerically stable manner. In at least one embodiment, updating 1160 corresponds to tiled softmax merging for equation (6).

The system performing at least a part of process 1150 includes code to at least update 1162 local output block. In at least one embodiment, updating 1162 includes combining the local attention contribution 1114 with a previously accumulated local output quantity to generate the updated local output block 1118. In at least one embodiment, updating 1162 includes rescaling the previously accumulated local output quantity according to the updated local normalization state 1116, rescaling the local attention contribution 1114 according to the updated local normalization state 1116, and combining the rescaled quantities to produce the updated local output block 1118. In at least one embodiment, after completion of the ring communication steps, the updated local output block 1118 corresponds to a local portion of a distributed attention-pair-bias output that is numerically consistent with a corresponding single-device attention computation for equation (6).

The system performing at least a part of process 1150 includes code to at least determine 1164 whether more steps remain. In at least one embodiment, determining 1164 includes determining whether additional ring communication steps remain in the distributed attention pair bias schedule. In at least one embodiment, the determination is based on a number of devices participating along a selected mesh axis of the device mesh 1102, a current communication-step index, or a communication schedule associated with the row-wise ring communication 1122. If additional ring communication steps remain, process 1150 returns to receiving 1156 aligned non-query blocks for a subsequent ring communication step. In at least one embodiment, during those subsequent ring communication steps, key blocks, value blocks, and pair-bias blocks are shifted among neighboring devices along the row-wise ring communication 1122 while the local query block remains resident on the device on which the local query block was formed, so that different local query-key pairings are successively aligned on each device. In at least one embodiment, where used, mask blocks are also shifted among neighboring devices with the key blocks and the value blocks during those subsequent ring communication steps. If additional ring communication steps do not remain, process 1150 proceeds to generating 1166 a local attention output.

The system performing at least a part of process 1150 includes code to at least generate 1166 local attention output. In at least one embodiment, generating 1166 includes transforming the updated local output block 1118 into a local attention output corresponding to the distributed attention computation. In at least one embodiment, generating 1166 includes reshaping or combining head-specific output channels, applying the local gate block generated from the local single-representation block to gate the updated local output block 1118, and applying an output projection to generate a local output having a channel structure corresponding to the single representation tensor. In at least one embodiment, the resulting local attention output remains distributed according to ownership of the corresponding local sequence-position shard on the device mesh 1102 and may be consumed by downstream distributed model computation.

FIG. 11C illustrates an example of a process 1170 to perform a backward pass for distributed attention pair bias, according to at least one embodiment. In at least one embodiment, some or all of process 1170, or any other processes described herein, or variations and combinations thereof, are performed under control of one or more computer systems configured with computer-executable instructions and are implemented as code executing collectively on one or more processors, by hardware, software, or combinations thereof. In at least one embodiment, the code is stored on a computer-readable storage medium in the form of a computer program comprising a plurality of computer-readable instructions executable by one or more processors. In at least one embodiment, the computer-readable storage medium is a non-transitory computer-readable medium. At least some computer-readable instructions usable to perform process 1170 are not stored solely using transitory signals, such as a propagating transient electric or electromagnetic transmission. A non-transitory computer-readable medium does not necessarily include non-transitory data storage circuitry, such as buffers, caches, and queues, within transceivers of transitory signals.

In at least one embodiment, process 1170 is performed by one or more systems such as those described in this present disclosure. In at least one embodiment, process 1170 is performed by the system described in connection with FIGS. 1, 4, 11A, and 11B. For example, process 1170 may be performed using the device mesh 1102, the local query block 1104, the redistributed key block 1106, the redistributed value block 1108, the pair-bias block 1110, the mask block 1112, the updated local normalization state 1116, the updated local output block 1118, the initial redistribution 1120, and the row-wise ring communication 1122 of FIG. 11A, together with the local attention output generated by process 1150 of FIG. 11B. In at least one embodiment, process 1170 is performed by a system using one or more programming models, such as CUDA, HIP, oneAPI, or variations thereof. One or more portions of process 1170 are performed in any suitable order, including sequential, parallel, overlapped, or variations thereof, and by any suitable system, such as those described herein, and using any suitable processing unit, such as a CPU, GPU, PPU, GPGPU, or variations thereof. Although process 1170 is depicted as a series of steps or operations, process 1170 may include altered or reordered steps or operations, or omit certain steps or operations, except where explicitly noted or logically required, such as when an output of one step or operation is used as input for another. One or more portions of process 1170 may be performed as part of performing one or more server operations such as those described herein.

The system performing at least a part of process 1170 includes code to at least prepare 1172 backward data. Backward data is, e.g., data used to propagate an upstream gradient through a distributed attention computation in which attention scores are modified by additive pair bias. In at least one embodiment, preparing 1172 includes receiving an upstream gradient corresponding to the updated local output block 1118 and restoring saved forward-pass tensors used to generate that updated local output block 1118. For example, preparing 1172 may include restoring saved local query data corresponding to the local query block 1104, saved redistributed key data corresponding to the redistributed key block 1106, saved redistributed value data corresponding to the redistributed value block 1108, saved pair-bias data corresponding to the pair-bias block 1110, and, where used, saved mask data corresponding to the mask block 1112. In at least one embodiment, preparing 1172 further includes restoring saved output data, saved gate data, and saved normalization data associated with tiled softmax merging, such as log-sum-exp information, maximum-score information, or combinations thereof. In at least one embodiment, preparing 1172 also includes casting the upstream gradient to a data type corresponding to a saved forward-pass tensor data type and allocating local gradient buffers for query-gradient data, key-gradient data, value-gradient data, gate-gradient data, pair-bias-gradient data, or combinations thereof.

The system performing at least a part of process 1170 includes code to at least generate 1174 local gradients. Local gradients are, e.g., gradient contributions generated on a device from locally available forward-pass tensors without reconstructing a full global attention computation on any one device. In at least one embodiment, generating 1174 includes generating a gated output-gradient representation and generating gate-gradient data based on the upstream gradient, saved local output data, and saved gate data. For example, where a gate is generated using a sigmoid function, generating 1174 may include applying a derivative factor corresponding to the saved gate data to produce a local gate-gradient contribution and applying the saved gate data to the upstream gradient to produce a gated output-gradient representation. In at least one embodiment, generating 1174 further includes generating attention-score-gradient data using the gated output-gradient representation together with the saved local query data, the saved redistributed key data, the saved redistributed value data, the saved pair-bias data, the saved normalization data, and, where used, the saved mask data. In at least one embodiment, generating 1174 also includes generating local query-gradient contributions, local key-gradient contributions, and local value-gradient contributions in the redistributed forward-pass layout, and process 1170 need not generate a gradient for the mask block 1112 where the mask block 1112 is used as a non-differentiable masking structure.

The system performing at least a part of process 1170 includes code to at least transpose 1176 key and value gradients. Transposing the key and value gradients is, e.g., communication that restores key-gradient data and value-gradient data toward distributed ownership corresponding to the key projection and the value projection prior to the forward-pass redistribution. In at least one embodiment, transposing 1176 includes communicating local key-gradient contributions and local value-gradient contributions across the device mesh 1102 using transpose communication corresponding to the initial redistribution 1120 used in the forward pass. For example, a device holding key-gradient data or value-gradient data in a redistributed layout may exchange that gradient data with a peer device so that the resulting key-gradient data and value-gradient data correspond to the original distributed layout of the key and value projections rather than only to the redistributed forward-pass layout. In at least one embodiment, query-gradient data is not transposed during transposing 1176 because the local query block 1104 remained resident on the device during the forward computation. In at least one embodiment, pair-bias-gradient data also remains associated with local query-key comparisons and therefore is not subjected to the key-value transpose communication of transposing 1176.

The system performing at least a part of process 1170 includes code to at least reduce 1178 query, key, and value gradients. Reducing the query, key, and value gradients is, e.g., combining partial gradient contributions generated on different devices so that the resulting gradients correspond to a full attention computation rather than only to a single local shard interaction. In at least one embodiment, reducing 1178 includes combining local query-gradient contributions, transposed key-gradient contributions, and transposed value-gradient contributions across devices participating in a selected context-parallel subgroup of the device mesh 1102. For example, reducing 1178 may include one or more all-reduce operations performed along a context-parallel mesh axis so that different partial contributions generated from different query-key alignments are summed to produce reduced query-gradient data, reduced key-gradient data, and reduced value-gradient data. In at least one embodiment, reducing 1178 is performed after transposing 1176 so that key-gradient data and value-gradient data are reduced under ownership corresponding to the original distributed layout of the key and value projections. In at least one embodiment, communication used for reducing 1178 may be overlapped with local computation or local buffer preparation using asynchronous communication and buffer reuse.

The system performing at least a part of process 1170 includes code to at least generate 1180 pair-bias gradient. A pair-bias gradient is, e.g., gradient data corresponding to additive bias values derived from a pair representation and added to attention scores for corresponding query-key comparisons. In at least one embodiment, generating 1180 includes generating pair-bias-gradient data from the attention-score-gradient data for the same local query-key comparisons represented by the saved pair-bias data corresponding to the pair-bias block 1110. For example, generating 1180 may include summing or otherwise reducing attention-score-gradient data across one or more non-bias dimensions so that the resulting pair-bias-gradient data corresponds to the dimensionality of a pair-bias projection applied to a local block of the pair representation. In at least one embodiment, generating 1180 preserves local ownership of the pair-bias-gradient data with respect to the distributed pair-representation layout because each device generates pair-bias-gradient data for pair-bias values associated with its local query-key comparisons. In at least one embodiment, generating 1180 may also include generating or accumulating parameter-gradient data corresponding to a pair-bias projection based on the pair-bias-gradient data and saved pair-representation-side inputs.

The system performing at least a part of process 1170 includes code to at least generate 1182 distributed gradients. Distributed gradients are, e.g., gradient outputs maintained in a distributed layout for downstream training computation. In at least one embodiment, generating 1182 includes producing distributed gradient outputs corresponding to data projected from a single representation and data derived from a pair representation. For example, generating 1182 may include producing reduced query-gradient data, reduced key-gradient data, reduced value-gradient data, gate-gradient data, pair-bias-gradient data, output-projection-gradient data, query-projection-gradient data, key-projection-gradient data, value-projection-gradient data, pair-bias-projection-gradient data, or combinations thereof. In at least one embodiment, generating 1182 further includes combining one or more of the reduced query-gradient data, the reduced key-gradient data, the reduced value-gradient data, and the gate-gradient data to generate a distributed gradient corresponding to the single representation, while retaining the pair-bias-gradient data as a distributed gradient corresponding to the pair representation. In at least one embodiment, generating 1182 also includes associating locally owned gradient tensors with distributed-tensor metadata so that the resulting distributed gradients may be consumed by downstream training computation.

Accordingly, FIG. 11C illustrates a backward-pass process 1170 for distributed attention pair bias in which backward data is prepared at 1172, local gradients are generated at 1174, key-gradient data and value-gradient data are transposed at 1176, query-gradient data, key-gradient data, and value-gradient data are reduced at 1178, a pair-bias gradient is generated at 1180, and distributed gradients are generated at 1182. In at least one embodiment, process 1170 enables distributed backward propagation for attention with additive pair bias while preserving local ownership of query-side data, restoring ownership of key-gradient data and value-gradient data to the distributed layout corresponding to the key and value projections, maintaining pair-bias-gradient ownership corresponding to the distributed pair representation, and producing distributed gradients corresponding to a backward computation consistent with the forward distributed attention computation.

In at least one embodiment, in addition to the ring variant of distributed attention with additive pair bias described above, the disclosed framework supports a shardwise variant of distributed attention with additive pair bias in which a device holds a shard of query windows and the corresponding key, value, and pair-bias data for those query windows. In at least one embodiment, in the shardwise variant, no cross-device communication is performed during the attention computation itself; each device computes multi-head attention locally over its own query, key, value, and pair-bias windows. In some embodiments, the shardwise variant operates on tensors having window-batched shapes, where a query single representation has a window dimension and a half-window dimension, and a pair-bias tensor has shape including the window dimension, the half-window dimension, and a head dimension. In at least one embodiment, the shardwise variant is preceded by one or more of a distributed sliding-window operation, a distributed gather operation, or a distributed outer-gather operation to provide each device with the key, value, and pair-bias data corresponding to its query windows, such that the shardwise attention computation is communication-free. In some embodiments, backward computation for the shardwise variant is performed entirely locally by autograd through the local computation graph, with cross-device gradient routing handled by the backward passes of the upstream distributed gather, distributed outer-gather, or distributed sliding-window operations.

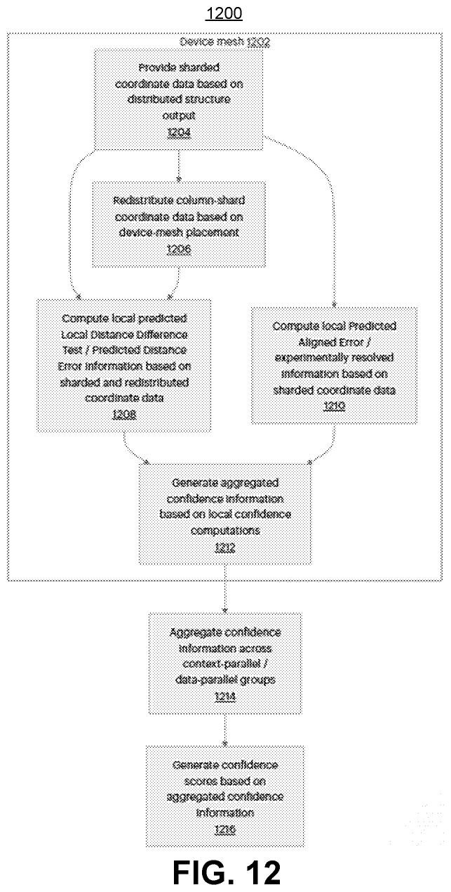

FIG. 12 illustrates a confidence model 1200 using distributed coordinate data and distributed confidence computations on a device mesh 1202 to generate confidence scores for a predicted structure, according to at least one embodiment. In at least one embodiment, the confidence model 1200 computes one or more confidence-related outputs associated with a predicted structure, such as predicted Local Distance Difference Test values, Predicted Distance Error values, Predicted Aligned Error values, experimentally resolved predictions, or combinations thereof.

In at least one embodiment, devices of the device mesh 1202 provide sharded coordinate data 1204 based on distributed structure output. In at least one embodiment, the sharded coordinate data 1204 comprises local coordinate shards corresponding to predicted coordinates, reference coordinates, token-level coordinates, atom-level coordinates, frame-related coordinates, or combinations thereof. In some embodiments, the sharded coordinate data 1204 is derived from a distributed predicted structure generated by distributed model modules such as those described elsewhere herein.

In at least one embodiment, devices of the device mesh 1202 further redistribute column-shard coordinate data 1206 based on device-mesh placement. In at least one embodiment, the redistributed column-shard coordinate data 1206 is generated by changing ownership of one or more coordinate shards across the device mesh 1202 so that a given device can compute local pairwise or cross-shard confidence quantities using local row-oriented coordinate data together with redistributed column-oriented coordinate data. In some embodiments, the redistribution comprises transpose-style redistribution of coordinate-related tensors from one distributed placement to another distributed placement without reconstructing a full global coordinate tensor on any one device.

In at least one embodiment, devices of the device mesh 1202 compute local predicted Local Distance Difference Test/Predicted Distance Error information 1208 based on the sharded coordinate data 1204 and the redistributed column-shard coordinate data 1206. In at least one embodiment, the local predicted Local Distance Difference Test/Predicted Distance Error information 1208 includes local confidence quantities computed from pairwise distance relationships between local row-coordinate data and redistributed column-coordinate data. In some embodiments, these computations include local pairwise distance computations, local masking operations, local binning operations, local cross-entropy operations, local score accumulations, or combinations thereof. In at least one embodiment, distributed computation of the predicted Local Distance Difference Test information and the Predicted Distance Error information avoids materializing full global pairwise distance matrices on a single device.

In at least one embodiment, devices of the device mesh 1202 also compute local Predicted Aligned Error/experimentally resolved information 1210 based on the sharded coordinate data 1204. In at least one embodiment, the local Predicted Aligned Error/experimentally resolved information 1210 includes local confidence quantities associated with predicted alignment error, local frame-dependent structure quality, experimentally resolved predictions, or combinations thereof. In some embodiments, such computations use local coordinate shards, local frame information, local masks, local logits, or local pair-related data to generate local contributions for one or more confidence outputs.

In at least one embodiment, devices of the device mesh 1202 generate aggregated confidence information 1212 based on the local confidence computations. In at least one embodiment, the aggregated confidence information 1212 includes local partial sums, local numerators, local denominators, local masked accumulations, local confidence logits, local per-position confidence values, local per-pair confidence values, or combinations thereof. In some embodiments, the aggregated confidence information 1212 combines outputs from the local predicted Local Distance Difference Test/Predicted Distance Error information 1208 and the local Predicted Aligned Error/experimentally resolved information 1210.

In at least one embodiment, the system aggregates confidence information across context-parallel/data-parallel groups 1214. In at least one embodiment, the aggregation across context-parallel/data-parallel groups 1214 includes one or more collective communication operations that combine corresponding local confidence information from multiple devices so that the resulting confidence computation corresponds to a confidence computation over the full structure or full distributed batch. In some embodiments, the aggregation includes one or more sum-reduction operations, maximum-reduction operations, normalization operations, batch-wise aggregation operations, or combinations thereof performed across one or more process groups associated with context parallelism, data parallelism, or both.

In at least one embodiment, the system generates confidence scores 1216 based on the aggregated confidence information. In at least one embodiment, the confidence scores 1216 include one or more predicted Local Distance Difference Test scores, Predicted Distance Error scores, Predicted Aligned Error scores, experimentally resolved predictions, or combinations thereof for an overall structure, for individual positions, for pairwise relationships, for atoms, for tokens, or for other structural elements. In some embodiments, the generated confidence scores 1216 are supplied as outputs associated with a predicted structure for downstream analysis, ranking, filtering, display, or other use.

In some embodiments, computations associated with the confidence model 1200 are implemented using one or more custom distributed operations operating on distributed tensors. In some embodiments, one or more confidence computations use fused kernels for local pairwise distance computation, masking, thresholding, binning, reduction, or combinations thereof. In at least one embodiment, local confidence computations are performed on local shards while inter-device communication is used only for redistribution and aggregation needed to preserve correspondence with a corresponding single-device confidence computation.

In some embodiments, predicted Local Distance Difference Test computation and Predicted Distance Error computation use redistributed column-shard coordinate data 1206 because those computations depend on pairwise relationships between row-sharded and column-sharded coordinate data. In some embodiments, Predicted Aligned Error computation and experimentally resolved computation use local coordinate data, local frame-related information, or local prediction data in a manner that differs from the pairwise distance computations used for predicted Local Distance Difference Test and Predicted Distance Error. In at least one embodiment, the confidence model 1200 therefore supports multiple confidence heads having different distributed data-access patterns while still operating within the common distributed framework of the device mesh 1202.

Accordingly, FIG. 12 illustrates a confidence model 1200 in which sharded coordinate data 1204 is provided on a device mesh 1202, column-shard coordinate data 1206 is redistributed for cross-shard confidence computation, local predicted Local Distance Difference Test/Predicted Distance Error information 1208 and local Predicted Aligned Error/experimentally resolved information 1210 are computed, aggregated confidence information 1212 is generated and aggregated across context-parallel/data-parallel groups 1214, and confidence scores 1216 are generated for a distributed structure-prediction workflow.

### Data Center

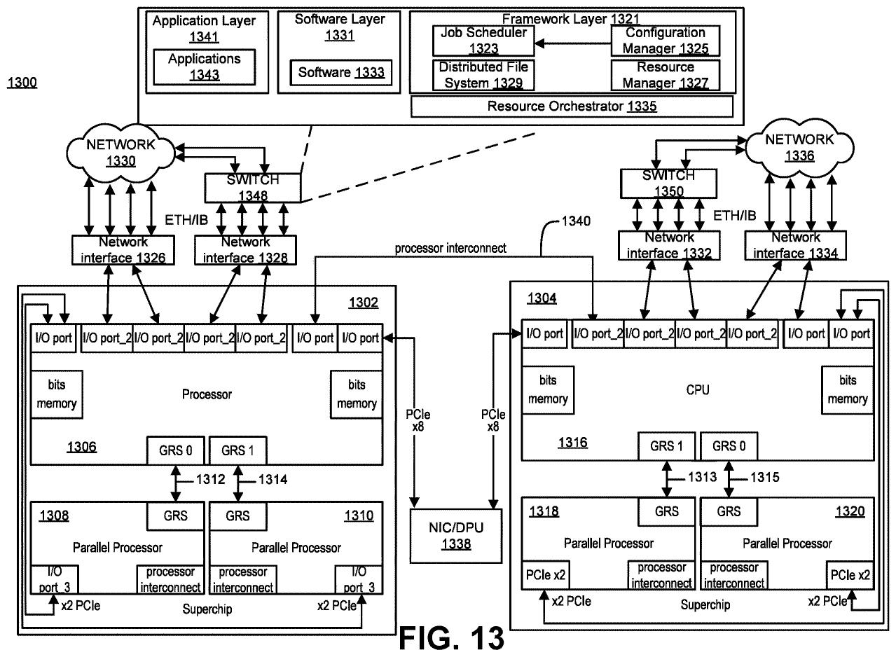

FIG. 13 demonstrates an example architecture of a multi-GPU architecture. As illustrated in the figure, computing system 1300 includes a processing device 1302 with a multi-GPU architecture. In particular, processing device 1302 may be a system-on-chip and includes multiple subsystems such as a CPU 1306, a GPU 1308, and a GPU 1310. CPU 1306 can be coupled to GPU 1308 via a die-to-die (D2D) or chip-to-chip (C2C) interconnect 1312, such as a Ground-Referenced Signaling interconnect (GRS interconnect). CPU 1306 can be coupled to GPU 1310 via a D2D or C2C interconnect 1314. CPU 1306 can also couple to GPU 1308 and GPU 1310 via PCIe interconnects.

CPU 1306 can be coupled to one or more NICs or DPUs, which are coupled to one or more networks. For example, as illustrated in FIG. 13, CPU 1306 is coupled to a first NIC/DPU 1326, which is coupled to a network 1330. CPU 1306 is also coupled to a second NIC/DPU 1328, which is coupled to network 1330 via switch 1348. NIC/DPU 1326 and NIC/DPU 1328 can be coupled to network 1330 over Ethernet (ETH), NVLINK or InfiniBand (IB) connections, for example.

Computing system 1300 also includes a processing device 1304 with a multi-GPU architecture. In particular, processing device 1304 includes multiple subsystems including a CPU 1316, a GPU 1318, and a GPU 1320. CPU 1316 can be coupled to GPU 1318 via an D2D or C2C interconnect 1313. CPU 1316 can be coupled to GPU 1320 via a D2D or C2C interconnect 1315. CPU 1316 can also couple to GPU 1318 and GPU 1320 via PCIe interconnects. CPU 1316 can be coupled to one or more NICs or DPUs, which are coupled to one or more networks. For example, as illustrated in FIG. 13, CPU 1316 is coupled to a first NIC/DPU 1332, which is coupled to a network 1336 via switch 1350. CPU 1316 is also coupled to a second NIC/DPU 1334, which is coupled to network 1336. NIC/DPU 1332 and NIC/DPU 1334 can be coupled to network 1336 over Ethernet (ETH), NVLINK or InfiniBand (IB) connections.

In at least one embodiment, processing device 1302 and processing device 1304 can communication with each other via a NIC/DPU 1338, such as over PCIe interconnects. Processing device 1302 and processing device 1304 can also communicate with each other over a high-bandwidth communication interconnects 1340, such as an NVLink interconnect or other high-speed interconnects. The packet switches in FIG. 13 may comprise, for example, Nvidia Quantum-2 switches. The NICs/DPUs in the figure may comprise, for example, Nvidia Bluefield DPUs.

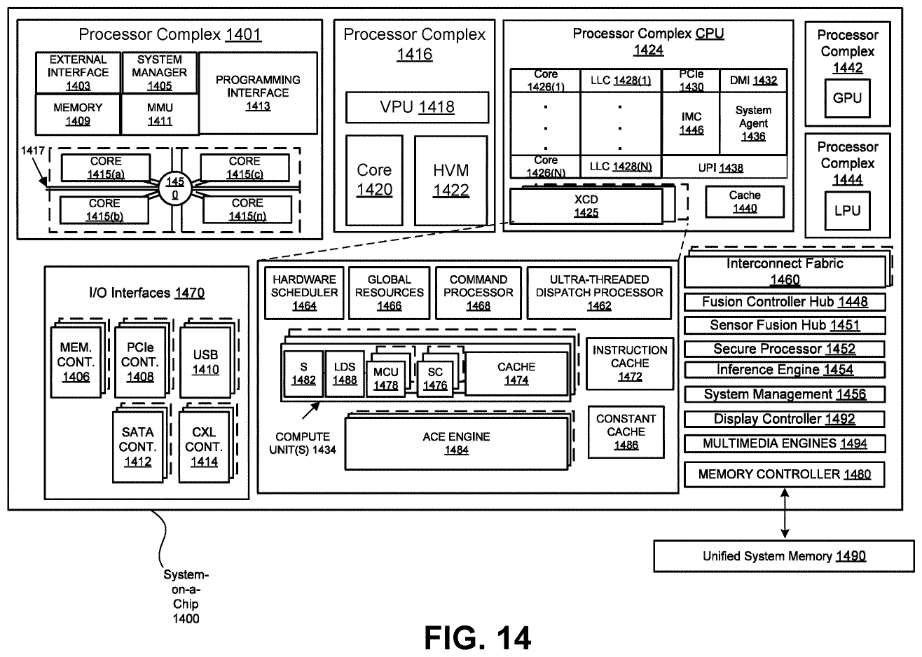

In at least one embodiment, processing device 1302 and processing device 1304 can include sub-systems, modules, add-in cards, and other semiconductor components. Processing devices may include any number of processors, such as, but not limited to, central processing units (“CPUs”), graphics processing units (“GPUs”), or other processors (including accelerators, field programmable gate arrays (FPGAs), graphics processors, etc.), including any processors described herein, such as, but not limited to, processors in FIGS. 14-17B. Processing devices can include one or more memory storage devices (e.g., dynamic read-only memory, solid state storage or disk drives), as well as network input/output (“NW I/O”) devices, network switches, virtual machines (“VMs”), power modules, and cooling modules, etc.

Processing devices can include separate groupings of computing units housed within one or more racks (not shown), or many racks housed in data centers at various geographical locations (also not shown). Separate groupings of computing units may include grouped compute, network, memory or storage resources that may be configured or allocated to support one or more workloads. Several computing units (e.g., including CPUs and/or other processors) may be grouped within one or more racks to provide compute resources to support one or more workloads. A resource orchestrator 1335 may configure or otherwise control one or more processing devices or groups of computing units. Resource orchestrator 1335 may include a software design infrastructure (“SDI”) management entity for computing system 1300. Resource orchestrator 1335 may include hardware, software or some combination thereof.

Computing system 1300 can include any one of or any combination of a framework layer 1321, a software layer 1331 and an application layer 1341. As shown in FIG. 13, framework layer 1321 includes a job scheduler 1323, a configuration manager 1325, a resource manager 1327 and a distributed file system 1329. Framework layer 1321 may include a framework to support software 1333 of software layer 1331 and/or one or more application(s) 1343 of application layer 1341. Software 1333 or application(s) 1343 may respectively include web-based service software or applications, such as, but not limited to, those provided by Amazon Web Services, Google Cloud and Microsoft Azure. Framework layer 1321 may be a type of free and open-source software web application framework such as, but not limited to, Apache Spark™ (hereinafter “Spark”) that may utilize distributed file system 1329 for large-scale data processing (e.g., “big data”). Job scheduler 1323 may include a Spark driver to facilitate scheduling of workloads supported by various layers of computing system 1300.

Configuration manager 1325 may be capable of configuring different layers such as, but not limited to, software layer 1331 and framework layer 1321 including Spark and distributed file system 1329 for supporting large-scale data processing. Resource manager 1327 may be capable of managing clustered or grouped processing devices mapped to or allocated for support of distributed file system 1329 and job scheduler 1323. Resource manager 1327 may coordinate with resource orchestrator 1335 to manage these mapped or allocated computing resources.

Software 1333 can be included in software layer 1331 and may include software used by at least portions of processing devices, and/or distributed file system 1329 of framework layer 1321. One or more types of software may include, but are not limited to, Internet web page search software, e-mail virus scan software, database software, and streaming video content software.

Application(s) 1343 can be included in application layer 1341 and may include one or more types of applications used by at least portions of processing devices, and/or distributed file system 1329 of framework layer 1321. One or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

Any of configuration manager 1325, resource manager 1327, and resource orchestrator 1335 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

Any of configuration manager 1325, resource manager 1327, and resource orchestrator 1335 may implement any number and type of self-modifying actions based on any amount and type of data acquired in any technically feasible fashion. Self-modifying actions may relieve a data center operator of computing system 1300 from making possibly bad configuration decisions and possibly avoiding underutilized and/or poor performing portions of a data center.

Computing system 1300 may include tools, services, software or other resources to train one or more machine learning models or predict or infer information using one or more machine learning models in accordance with one or more embodiments described herein. For example, a machine learning model may be trained by calculating weight parameters in accordance with a neural network architecture using software and computing resources described above with respect to computing system 1300. Trained machine learning models corresponding to one or more neural networks may be used to infer or predict information using resources described above with respect to computing system 1300 by using weight parameters calculated through one or more training techniques described herein.

Computing system 1300 may use CPUs, application-specific integrated circuits (ASICs), GPUs, FPGAs, language processing units (LPUs), or other hardware (e.g., embodiments in FIGS. 14-17B) to perform some or all of processes and techniques described elsewhere herein, such as, but not limited to, training and/or inferencing using above-described resources. Moreover, one or more software and/or hardware resources described above may be configured as a service to allow users to train or perform inferencing of information, such as, but not limited to, image recognition, speech recognition, content generation (e.g., image generation, video generation, code generation), or other artificial intelligence services.

As another example, computing system 1300 may represent a server farm. As another example, computing system 1300 may represent a data cloud or a processing cloud. The data cloud or processing cloud may comprise an interface to which web service or other application programming interface (API) calls can be submitted to cause the system or components thereof to perform operations described herein. As another example, computing system 1300 can represent a supercomputer. Computing system 1300 may include tens, hundreds, or thousands of nodes. With respect to any of processors in system 1300 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of a processor or node (e.g., in cache and/or memory). A result of API(s) can then be stored in storage within or outside of a processor or node, including registers, DRAM, flash, SRAM, cache, or other memory equivalents. System 1300 may include over nine thousand nodes, with each node including two Intel Xeon Max processors, six Intel Max series GPUs and a unified memory architecture, such as, but not limited to, that used in Intel Aurora Supercomputer from Intel Corporation in Santa Clara, CA or another supercomputer that shares at least some of the components described herein.

System 1300 can include one or more racks, which represent structural and interconnect resources to house and interconnect multiple computation nodes. A rack can include multiple nodes. A rack may host multiple blade components. Blades can refer to computing resources on printed circuit boards (PCBs), where a PCB houses hardware components for one or more nodes. Blades may or may not include a chassis or housing or other “box” other than that provided by rack. Blades may include housing with exposed connector to connect into a rack. System may or may not include a rack, and each blade can include a chassis or housing that can stack or otherwise reside in close proximity to other blades and allow interconnection of nodes. System may include 10,624 compute blades, which include 63,744 Intel Max Series GPUs and 21,248 Intel Xeon Max CPUs across 166 racks.

System 1300 can include a fabric, which represents one or more interconnectors for nodes. The fabric can include multiple switches or routers or other hardware to route signals among nodes. Additionally, the fabric can couple system 1300 to network 1330 for access by clients 1302. Likewise, the fabric can couple system 1300 to network 1336 for access by clients 1304. The fabric can have one or more associated protocols to manage routing of signals through system 1300. A protocol or protocols can be at least partly dependent on hardware equipment used in system 1300.

A rack can include N blades. In addition to a first rack, system 1300 can include a second rack. As illustrated, the second rack may include M blades. Blades of the second rack can be the same or similar to blades of the first rack. Nodes can be any type of node as described herein, and may not be necessarily all the same type of node. System 1300 is not limited to being homogenous, nor is it limited to not being homogenous.

In at least one embodiment, a node in a blade may be computation nodes, with processor and memory. A computation node refers to a node with processing resources (e.g., one or more processors) that executes an operating system and can receive and process one or more tasks. At least some nodes can include storage server nodes with a server as processing resources and memory. A storage server refers to a node with more storage resources than a computation node, and rather than having processors for execution of tasks, a storage server includes processing resources to manage access to storage nodes within a storage server.

A node can include interface controller, which can represent logic to control access by node to fabric. Logic can include hardware resources to interconnect to physical interconnection hardware. Logic can include software or firmware logic to manage interconnection. Interface controller can include a host fabric interface, which can include a fabric interface in accordance with any embodiment described herein.

A node may include a memory subsystem. Memory can include memory computation resources (comp), which represent one or more capabilities by memory to perform memory computations. System 1300 enables remote memory operations, such as, but not limited to, the operations described elsewhere herein. Thus, nodes can request memory computations by remote nodes, where data for computation remains local to an executing node instead of being sent over fabric or instead of being sent from memory to a fabric interface. In response to execution of memory computation, an executing node can provide a result to a requesting node.

Reference to memory devices can apply to different memory types. Memory devices generally refer to volatile memory technologies. Volatile memory can be memory whose state (and therefore data stored on it) is indeterminate if power is interrupted. Nonvolatile memory refers to memory whose state is determinate even if power is interrupted. Dynamic volatile memory can refresh data stored in a device to maintain state. One example of dynamic volatile memory includes DRAM (dynamic random access memory), or some variant such as, but not limited to, synchronous DRAM (SDRAM). A memory subsystem as described herein may be compatible with a number of memory technologies, such as, but not limited to, DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), DDR4E (DDR version 4, extended, currently in discussion by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideI02), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), HBM3 (HBM version 3), HBM3E (HBM version 3, extended), HBM4 (HBM version 4), HBM5 (HBM version 5, currently in discussion by JEDEC), or others or combinations of memory technologies, and technologies based on derivatives or extensions of such specifications.

In addition to, or alternatively to, volatile memory, in one embodiment, reference to memory devices can refer to a nonvolatile memory device whose state is determinate even if power is interrupted. In one embodiment, nonvolatile memory device is a block addressable memory device, such as, but not limited to, NAND or NOR technologies. Thus, a memory device can also include a future generation nonvolatile devices, such as, but not limited to, a three-dimensional crosspoint (3DXP) memory device, other byte addressable nonvolatile memory devices, or memory devices that use chalcogenide phase change material (e.g., chalcogenide glass). In one embodiment, a memory device can be or include multi-threshold level NAND flash memory, NOR flash memory, single or multi-level phase change memory (PCM) or phase change memory with a switch (PCMS), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

In at least one embodiment, processor 1300 can include circuitry (e.g., one or more circuits described above and elsewhere herein) to perform distributed computations for training and inference of a structure prediction model across multiple processors or otherwise perform any of the operations described above or elsewhere herein. In at least one embodiment, processing device 1302 is configured by software 1333 to perform distributed computations for training and inference of a structure prediction model across multiple processors or otherwise perform any of the operations described above or elsewhere herein. Data center 1300 may use logic, CPUs, application-specific integrated circuits (ASICs), GPUs, FPGAs, or other hardware (e.g., embodiments in FIGS. 14-17B) to perform any of the operations described above or elsewhere herein.

### Processors

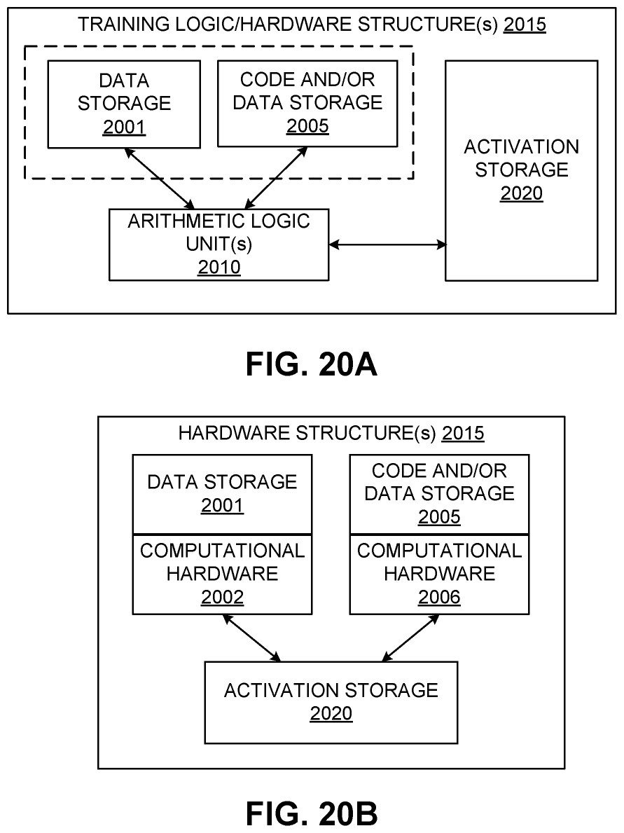

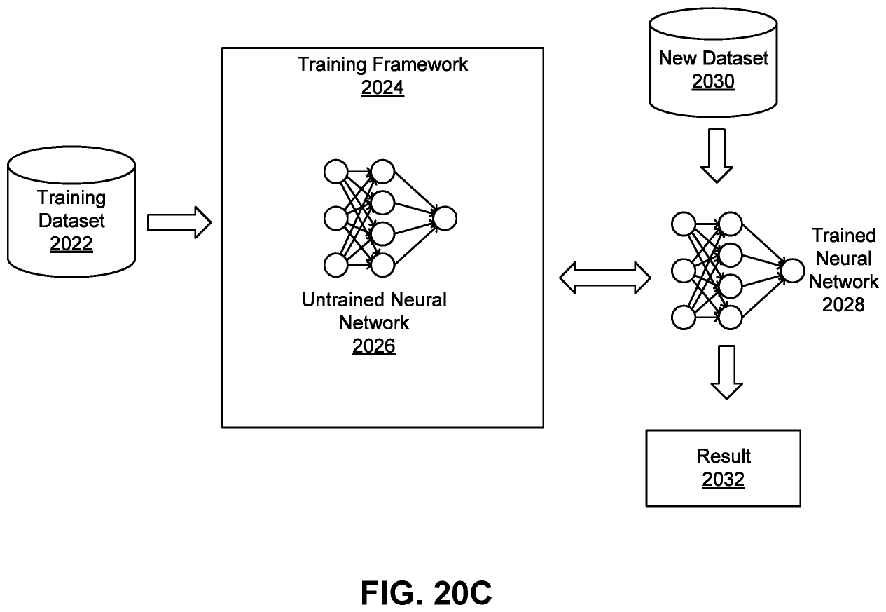

The following figures set forth, without limitation, example processors and processing systems that can be used to perform distributed computations for training and inference of a structure prediction model across multiple processors or otherwise perform some or all of processes, operations and/or and techniques described elsewhere herein. Example processors and processing systems can be configured by software to perform distributed computations for training and inference of a structure prediction model across multiple processors or otherwise perform any of the operations described above or elsewhere herein. Processors and processing systems can include logic, central processing units (CPUs), application-specific integrated circuits (ASICs), graphics processing units (GPUs), field programmable arrays (FPGAs), XPUs (i.e., any compute architecture that best fits the need of an application), network interface cards (NICs), switches, network adapters, data processing units (DPUs), or other hardware (e.g., embodiments in FIGS. 14-17B) to perform any of the operations described above, below, or elsewhere herein. Processors and/or processing systems described herein can include circuitry (e.g., one or more circuits) that can be used to perform distributed computations for training and inference of a structure prediction model across multiple processors or otherwise perform any of the operations described above or elsewhere herein. As used herein, one or more circuits can be configured by software to perform distributed computations for training and inference of a structure prediction model across multiple processors or otherwise perform any of the operations described above or elsewhere herein. FIGS. 20A and 20B illustrate logic 2015 which, as described elsewhere herein, can be used in one or more devices to perform operations such as, but not limited to, those discussed herein in accordance with at least one embodiment. Logic can refer, for example, to any combination of software logic, hardware logic, and/or firmware logic to provide functionality and/or operations described herein, wherein logic may be, collectively or individually, embodied as circuitry that forms part of a larger system, for example, an integrated circuit (IC), an application-specific integrated circuit (ASIC), a field programmable array (FPGA), system-on-chip (SoC), or one or processors (e.g., CPU, GPU).

FIG. 14 illustrates a processor which is a system-on-a-chip (SOC) 1400 (which may be referred to as system-on-chip, a superchip, or another name), in accordance with at least one embodiment. SOC 1400 can include one or more processor complexes. SOC 1400 can include any number of processor complexes that may include any number of processors that are described herein, such as, but not limited to, those in FIGS. 14-17B, in any combination. For example, processor complex 1424 may include a central processing unit (CPU), processor complex 1442 may include a graphics processor (GPU) or tensor processor (TPU), processor complex 1416 may include a vision processing unit (VPU), processor complex 1401 may include a neural processing unit (NPU), and processor complex 1444 may include a language processing unit (LPU), any of which may be implemented as separate or combined processor complexes. For example, processor 1424 may include a graphics processor, and processor 1442 may include a graphics processor. SOC 1400 may include any number of display controllers 1492, any number of multimedia engines 1494, any number of I/O Interfaces 1470, any number of memory controllers 1480, and any number of fabrics 1460 in any combination. For explanatory purposes, multiple instances of like objects are denoted herein with reference numbers identifying the object and parenthetical numbers identifying the instance where needed. SOC 1400 can include a processor from Broadcom in Palo Alto, CA. I/O Interfaces 1470 can include one or more memory controllers 1406 that can manage memory usage (e.g., DDR5 memory) for SOC 1400. I/O Interfaces 1470 may include one or more SATA disk controllers 1412 for managing storage and one or more Compute Express Link (CXL™) 1.1+ memory controllers 1414 that can provide CPU-to-device and CPU-to-memory connections and can be flexibly assigned to specific functions at server design time. I/O Interfaces 1470 may include PCIe controller 1408 for connecting peripherals and other components connected to SOC 1400. I/O Interfaces 1470 may include USB ports 1410 for connecting to other components separate from SOC 1400. Memory controller 1406, PCIe controller 1408, USB ports 1410, SATA controller 1412, and/or CXL controller 1414 can be integrated anywhere within SOC 1400 either separately or in any groups or combinations thereof.

Processor complex 1424 can include a CPU, processor complex 1442 can include a GPU, and SOC 1400 can include a processing unit that integrates 1424 and 1442 onto a single chip. Some tasks may be assigned to processor complex 1424 and other tasks may be assigned to processor complex 1442. Processor complex 1424 can be configured to execute main control software associated with SOC 1400, such as, but not limited to, an operating system. Processor complex 1424 can be the master processor of SOC 1400, controlling and coordinating operations of other processors. Processor complex 1424 can issue commands that control the operation of processor complex 1442 to perform some or all of the operations described herein. Processor complex 1424 can be configured to execute host executable code derived from CUDA or other source code (e.g., HIP source code), and processor complex 1442 can be configured to execute device executable code derived from CUDA or other source code in order to perform any of the operations described herein.

Processor complex 1424 can include cores 1426-1426(N) and a cache (e.g., L3 cache) 1440 to store information to perform operations described herein. Processor complex 1424 may include any number of cores 1426 and any number and type of caches in any combination. Each core can be associated with one lower level cache (LLC) slice 1428(1)-1428(N), or cores 1426(1)-1426(N) can share cache, e.g., lower level cache. LLCs 1428(1)-1428(N) can be inclusive by incorporating blocks in higher level cache (e.g., L2 cache) or non-inclusive (having blocks that may be not present in higher level cache). Each core and LLC slice can include a Caching and Home Agent (CHA) (not shown) that can maintain cache coherency by providing scalability of resources across mesh interconnects for Intel® Ultra Path Interconnect (Intel® UPI 1438) cache coherency functionality. UPI 1438 can provide a coherent interconnect for scalable systems and can allow for multiple processors to share a single shared address space through links, such as, but not limited to, two or three UPI links per processor. Cores 1426 can be configured to execute instructions of a particular instruction set architecture (“ISA”) to perform some or all of the operations described herein. Each core 1426 can include a CPU core. Core 1426-1426(N) can be referred to as a computing units or compute units. SOC 1400 can include any number of processor complexes 1424, fabric 1460, I/O interfaces 1470, and memory controllers 1480.

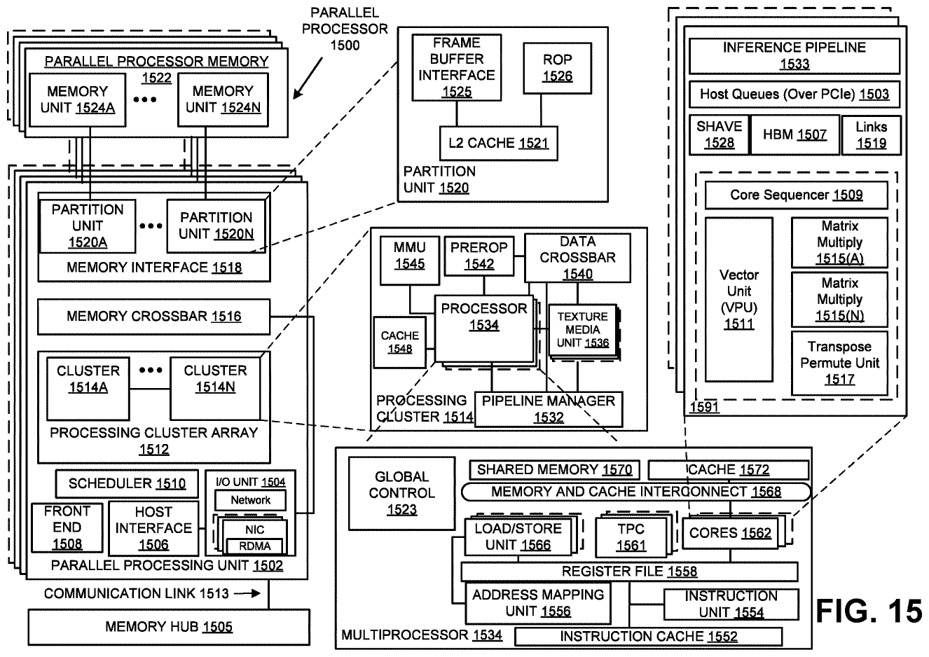

Processor complex 1442 can be a graphics complex that can be configured to perform compute operations (e.g., compute operations involved in operations described herein) in a highly-parallel fashion. Processor complex 1442 can be configured to execute graphics pipeline operations such as, but not limited to, draw commands, pixel operations, geometric computations, and other operations associated with rendering an image to a display. Processor complex 1442 can be configured to execute operations unrelated to graphics, such as, but not limited to, neural network training and/or simulations. Processor complex 1442 can be configured to execute both operations related to graphics and operations unrelated to graphics. Processor complex 1442 can include any number of compute units that are described herein, such as, but not limited to, those in FIG. 15.

Fabric 1460 can be a system interconnect that facilitates data and control transmissions across processor complex 1424, processor complex 1442, I/O interfaces 1470, memory controllers 1480, display controller 1492, and multimedia engine 1494, e.g., to perform some or all of the operations described herein. SOC 1400 may include any amount and type of system interconnect in addition to or instead of fabric 1460 that facilitates data and control transmissions across any number and type of directly or indirectly linked components that may be internal or external to SOC 1400. I/O interfaces 1470 can be representative of any number and type of I/O interfaces (e.g., PCI, PCI-Extended (“PCI-X”), PCIe, gigabit Ethernet (“GBE”), USB, etc.). Various types of peripheral devices can be coupled to I/O interfaces 1470. Peripheral devices that can be coupled to I/O interfaces 1470 may include keyboards, mice, printers, scanners, joysticks or other types of game controllers, media recording devices, external storage devices, network interface cards, and so forth.

Display controller 1492 may display images on one or more display device(s), such as, but not limited to, a liquid crystal display (“LCD”) device. Multimedia engine 1494 can include any amount and type of circuitry that is related to multimedia, such as, but not limited to, a video decoder, a video encoder, an image signal processor, etc. Memory controllers 1480 may facilitate data transfers between SOC 1400 and a unified system memory 1490. Processor complex 1424 and processor complex 1442 may share unified system memory 1490. Unified system memory 1490 can include various types of memory devices, including dynamic random access memory (DRAM) or graphics random access memory, such as, but not limited to, synchronous graphics random access memory (SGRAM), including graphics double data rate (GDDR) memory. Unified system memory 1490 may include 3D stacked memory, including but not limited to one or more high bandwidth memory generations (e.g., HBM, HBM2e, HBM3, HBM3e, HBM4, HBM5, etc.).

SOC 1400 may implement a memory subsystem that includes any amount and type of memory controllers 1480 and memory devices (e.g., shared memory) that may be dedicated to one component or shared among multiple components in order to perform any of the operations described herein. SOC 1400 can implement a cache subsystem that includes one or more cache memories (e.g., L1, L2, L3, and/or last-level cache) that may each be private to or shared between any number of components (e.g., cores 1420, core complex 1424, SIMD units, compute units, and processor complex 1442).

Processor complex 1401 may include a processor, in accordance with at least one embodiment. Processor complex 1401 can include a processor with hybrid architecture (e.g., Lunar Lake or Meteor Lake) from Intel Corporation in Santa Clara, CA or another processor that shares at least some of the components described herein. Processor complex 1401 can include one or more CPU(s), one or more GPU(s), and/or one or more Neural Processing Unit(s) (NPU) that can be, e.g., a dedicated AI accelerator that offloads artificial intelligence (AI) workloads from CPU and GPU. Processor complex 1401 can use instructions that, if executed cause processor complex 1401 and/or any of its components to perform some or all of processes and techniques described elsewhere herein. Processor complex 1401 may include any number of memory and cache units 1409 to facilitate processing amongst different components of processor complex 1401. Memory and cache 1409 on processor complex 1401 may include one or more levels of cache (e.g., L1, L2, L3, and/or last-level cache) and high-bandwidth memory (e.g., HBM2e or HBM3) in any combination. With respect to processor complex 1401 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor complex 1401 (e.g., in cache and/or memory). A result of API(s) can then be stored in storage within or outside of processor complex 1401, including registers, DRAM, flash, SRAM, cache, or other memory. One or more of APIs described herein can include a call.

A Intel® Thread Director, which includes firmware that can be built into processor complex 1401, can prioritize and manage distribution of workloads, sending tasks to optimized cores. This instruction set may be optimized with OpenVINO™ Toolkit and oneAPI to accelerate INT8 inferencing. A software stack, e.g., as described elsewhere herein, can be used to enable AI inference using Open VINO™ toolkit. Processor complex 1401 can be configured to execute an application program, such as, but not limited to, a CUDA program.

Processor complex 1401 can alternatively include a processor based on AI Engine Direct architecture from Qualcomm Corporation in Santa Clara, CA or another processor that shares at least some of the components described herein. That may include any number of NPUs, GPUs, CPUs and other related components, such as, but not limited to, NPU as a Hexagon NPU, GPU as an Adreno GPU, CPU as a Kryo or Qualcomm Oryon CPU, as well as a Qualcomm Sensing Hub and a memory subsystem, in any combination. Hexagon NPU can include a power rail a micro-tile inferencing unit, a hardware acceleration unit, a tensor unit, a scalar unit, and a vector unit (all not shown), which can have dedicated memory or share memory (e.g., cache or memory, such HBM3) for, e.g., storing instructions to perform any of the operations described above or elsewhere herein. Adreno GPU can provide graphics and parallel processing for AI in formats, such as, but not limited to, 32-bit floating point (FP32), 16-bit floating point (FP16), and 8-bit integer (INT8). Kryo or Qualcomm Oryon CPUs can perform AI workloads, and can handle contextualization for pervasive generative AI applications. CPU can also include an instruction fetch unit, a rename and retire unit, a memory management unit, a vector execution unit, an integer execution unit, and a load and store unit for processing and instruction management. With respect to processor and any of its components described above or elsewhere herein, one or more of APIs described herein can, for example, get compiled into instructions, which may be fetched by instruction fetch unit, decoded by a processor decoder or equivalents, scheduled (e.g., in order or out of order) for execution by a scheduler or equivalents, executed by execution logic or equivalents, reordered, and then retired by rename and retire unit. API(s) (and/or compiled instructions including API(s)) can be stored in any storage outside or inside of processor complex 1401 (e.g., in cache and/or memory). Any number of CPU cores may be included in any number of CPU cluster(s) that can be coupled to memory and/or cache, such as, but not limited to a shared L2 cache. Memory can be separate or shared, e.g., CPU clusters of CPU cores can couple to memory subsystem that can include fabric, system level cache and any number of memory management units that can, for example, read and write memory (e.g., DRAM). Qualcomm Sensing Hub (not shown) includes micro NPUs, a power rail, and traditional sensors (a gyrometer, accelerometer, even a barometer) with voice and data streams. Memory subsystem can include memory and cache on processor complex 1401, which may include one or more levels of cache (e.g., L1, L2, L3, and/or last-level cache) and high-bandwidth memory (e.g., HBM2e or HBM3) in any combination, e.g., for storing information and/or instructions to perform any of the operations described above or elsewhere herein. All or some of memory and/or cache in memory subsystem can be shared or used individually by any one or combinations of components (e.g., GPU, NPU, and CPU) on processor complex 1401.

Qualcomm AI Engine on a processor complex 1401 may be programmed and controlled with a software stack to perform some or all of the operations described herein, and include, e.g., a Qualcomm® Neural Processing SDK for inferencing with versions for Android, Linux, and Windows. Developer libraries and services support programming languages, virtual platforms, and compilers. At a lower level of software stack, system software includes basic real-time operating system (RTOS), system interfaces, and drivers. Software stack supports different operating systems, including Android, Windows, Linux, and QNX, and deployment and monitoring infrastructure like Prometheus, Kubernetes, and Docker. For direct cross-platform access to GPU, OpenCL and DirectML may be supported. For CPU, a LLVM compiler infrastructure optimizations enable accelerated and efficient AI inference. With respect to Qualcomm AI Engine and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of Qualcomm AI Engine (e.g., in cache and/or memory). A result of API(s) can then be stored in storage within or outside of Qualcomm AI Engine, including registers, DRAM, flash, SRAM, cache, or other memory.

Processor complex 1424 can include a processor with scalable family from Intel Corporation in Santa Clara, CA or another processor that shares at least some of the components described herein. Processor complex 1424 can include one or more cores 1426(1)-1426(N), where Nis any integer greater than 1 that can perform the operations described elsewhere herein. Cores 1426(1)-1426(N) can be interlinked together using ring and/or mesh interconnects. With a mesh interconnects architecture, an array of vertical and horizontal communication paths may allow traversal from one core to another 1426(1)-1426(N) through a shortest path (hop on vertical path to correct row, and hop across horizontal path to correct column).

Processor complex 1424 can also include System Agent 1436 that can house and/or perform various functionalities, such as, but not limited to, memory management, display functions, and/or input/output (I/O) functions. For example, processor complex 1424 can include one or more integrated memory controller(s) (IMC) 1446. IMC 1446 can control and manage memory, such as, but not limited to, different memory types e.g., DDR ram, like DDR4 or others described elsewhere herein. System Agent 1436 can include a display controller (not shown) to support display(s). System Agent 1436 can also incorporate PCIe 1430 (e.g., up to 20 lanes of PCIe), e.g., that can connect with an external dedicated graphics hookup over DMI bus (e.g., Intel's DMI 3.0 bus) 1432. System Agent 1436 can include an Image Processing Unit (IPU) (not shown) which incorporates an image signal processor (ISP) on-die.

A neuromorphic computing system is described that adopts a multicore architecture where each core houses computing elements including neurons, synapses with on-chip learning capability, and local memory to store synaptic weights and routing tables. Processor complex 1401 include a simplified block diagram illustrating an example of at least a portion of such a neuromorphic computing device, in accordance with at least one embodiment. Neuromorphic computing device 1401 can include a neuromorphic processor from Intel Corporation in Santa Clara, CA or another processor that shares at least some of the components described herein. As shown in this example, a device 1401 may be provided with a network 1417 of multiple neural network cores interconnected by an on-device network such that multiple different connections may be potentially defined between cores. For instance, a network 1417 of spiking neural network cores may be provided in device 1401 and may each communicate via short packetized spike messages sent from core to core over network channels. Each core (e.g., 1415) may possess processing and memory resources and logic to implement some number of primitive nonlinear temporal computing elements, such as, but not limited to, multiple (e.g., 1000+) distinct artificial neurons (referred to herein as “neurons”). For instance, each core may be capable of concurrently implementing multiple neurons such that neuromorphic cores may implement many multiples of neurons using device 1401. With respect to neuromorphic computing device 1401 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents.

In at least one embodiment, neuromorphic computing device 1401 may additionally include a processor and system memory 1409 to implement one or more components, such as via a system manager 1405, a memory management unit (MMU) 1411, or other components, to manage and provide functionality of neuromorphic computing device 1401. For instance, system manager 1405 may be provided to manage global attributes and operations of neuromorphic computing device 1401 (e.g., attributes affecting network of cores 1415, multiple cores in network 1417, interconnections of neuromorphic computing device 1401 with other devices, manage access to global system memory 1490, as assisted by MMU 1411 which may provide address translation and check permissions, among other potential examples). In one example, system manager 1405 may manage the definition and provisioning of a specific routing tables to various routers in network, orchestration of a network definition and attributes (e.g., weights, decay rates, etc.) to be applied in network, core synchronization and time multiplexing management, routing of inputs to appropriate cores, among other potential functions.

As another example, neuromorphic computing device 1401 may additionally include programming interface 1413 through which a user or system may specify a neural network definition to be applied (e.g., through a routing table and individual neuron properties) and implemented by mesh 1417 of neuromorphic cores. Programming interface 1413 may take an input of a programmer to then generate corresponding routing tables and populate local memory of individual neuromorphic cores (e.g., 1415) with specified parameters to implement a corresponding, customized network of artificial neurons implemented by neuromorphic cores 1415.

In some cases, neuromorphic computing device 1401 may advantageously interface with and interoperate with other devices, including general purpose computing devices, to realize certain applications and use cases. Accordingly, external interface logic 1403 may be provided in some cases to communicate (e.g., over one or more defined communication protocols) with one or more other devices. An external interface 1403 may be utilized to accept input data from another device or external memory controller acting as a source of input data. External interface 1403 may be additionally or alternatively utilized to allow results or output of computations of a neural network implemented using neuromorphic computing device 1401 to be provided to another device (e.g., another general purpose processor implementing a machine learning algorithm) to realize additional applications and enhancements, among other examples.

In at least one embodiment, a network 1417 of multiple neural network cores interconnected by an on-device network is shown illustrating a portion of a network fabric interconnecting multiple neuromorphic cores (e.g., 1415). For instance, a number of neuromorphic cores (e.g., 1415) may be provided in a mesh, with each core being interconnected by a network including a number of routers (e.g., 1450). In one implementation, each neuromorphic core (e.g., 1415) may be connected to a single one of routers (e.g., 1450) and routers may be connected to at least one other router. As an example, in one particular implementation, four neuromorphic cores (e.g., 1415) may be connected to a single router (e.g., 1450) and each of routers 1450 may be connected to two or more other routers to form a manycore mesh, allowing each neuromorphic core to interconnect with each other neuromorphic core in neuromorphic computing device 1401. Moreover, as each neuromorphic core may be configured to implement multiple distinct neurons, router network of neuromorphic computing device 1401 may similarly enable connections, or artificial synapses (or, simply, “synapses”), to be defined between any two of potentially many (e.g., 30,000+) neurons defined using network of neuromorphic cores 1417 provided in neuromorphic computing device 1401.

Processor complex 1424 can include an accelerated processing unit. Accelerated processing unit 1424 can include a processor for a processor complex based on CDNA architecture from AMD Corporation in Santa Clara, CA or another processor that shares at least some of the components described herein. Accelerated processing unit 1424 can include one or more accelerator complex dies (XCDs) 1425 for performing operations described elsewhere herein, such as, but not limited to, graphics processing and/or parallel processing as well as computations with instruction-level parallelism, including support for a broad range of precisions (INT8, FP8, BF16, FP16, TF32, FP32, and FP64) and sparse matrix data (i.e. sparsity). XCDs may, in some instances, be referred to as Graphics Compute Dies (GCDs). Accelerated processing unit 1424 can include one or more complex compute dies (CCDs) 1426 for performing operations described elsewhere herein, such as, but not limited to, those operations performed by host processors.

Accelerated processing unit 1424 can include one or more memory units for storing instructions and other information used to perform operations described elsewhere herein. Memory units can include any volatile memory, such as, but not limited to, memory types described elsewhere herein and can include, e.g., high-bandwidth memory (e.g., HMB3) or high-bandwidth DRAM. Memory associated with accelerated processing unit 1424 (e.g., memory units) can include system memory that can be used, for example, for commands, instructions and constants, and inputs and outputs. Memory units can also include device memory that can be used as storage and, for example, for commands, instructions and constants, and inputs and outputs, as return buffer(s) and for private data. Memory units can be linked to one or more IODs. L1 cache starts a memory hierarchy that includes shared L2 cache, e.g., within XCDs. AMD Infinity Cache™, which can be a last level cache (LLC) located on an active I/O die (IOD). CCDs 1426 and XCDs 1425 may have separate or shared memory. AMD Infinity Architecture and AMD Infinity Fabric™ technology can enable coherent, high-throughput unification of GPU and CPU chiplet technologies (e.g., XCDs, CCDs, and/or CCXs) with memory (e.g., stacked HBM3 memory) in single devices and across multi-device platforms.

As shown in FIG. 14, an XCD 1425 can include a shared set of global resources 1466, which can include hardware scheduler 1464 and Asynchronous Compute Engines (ACE) 1484 that send tasks (e.g., compute shader workgroups) to Compute Units (CUs or cores) 1434. ACEs 1484 (e.g., four) can be each associated with CUs 1434 (e.g., 40 CUs), and some of CUs 1434 can be disabled for yield management. CUs 1434 can have dedicated cache or share cache (e.g., L2 cache) 1474 that may be used to coalesce all memory traffic for a die. CUs 1434 can include threaded and parallel processor cores including instruction fetching and scheduling with Scheduler(S) 1482, matrix core unit (MCU) 1478 and shader core (SC) 1476 (e.g., execution units for scalar, vector and matrix data types), as well as load/store pipelines with an L1 cache 1474 and Local Data Share (LDS) 1488. Local data share can include, for example, a scratch RAM with built-in arithmetic capabilities that allow data to be shared between threads in a workgroup. An instruction cache 1472 (e.g., for storing and providing instructions for performing operations described elsewhere herein) and a constant cache 1486 can be connected to one or more CUs and can be shared between two CUs. Matrix cores 1478 can process a variety of data types, such as, but not limited to, INT8, FP8, FP16, BF16 and TF32 data types. Processor complex 1424 can include compute units 1434 that may be arranged in an array format, e.g., as a data-parallel-processor (DPP) array. Ultra-threaded dispatch processor 1462 can communicate with compute units 1434, and command processor 1468 can read commands that a host has written to memory-mapped registers in a system-memory address space (not shown). Command processor 1468 can send hardware-generated interrupts to a host processor (e.g., a CCD) when a command is completed. Memory controller 1480 can also have direct access to all device memory and host-specified areas of system memory. To satisfy read and write requests, memory controller can perform functions of a direct-memory access (DMA) controller, including computing memory-address offsets based on a format of requested data in memory. For example, one or more of APIs described herein can, for example, get compiled into instructions that can be stored in instruction cache 1472 and then fetched by instruction fetch logic in processor complex 1424, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor complex 1424 (e.g., in cache and/or memory). A result of API(s) can then be stored in storage within or outside of processor complex 1424, including registers, DRAM, flash, SRAM, cache, or other memory equivalents.

An application can include a program running on a host processor (e.g., a CCD) and programs, called kernels, running on one or more XCDs. Programs can be controlled by host commands that set internal base-address and other configuration registers, specify a data domain on which accelerated processor complex 1424 can operate, invalidate and flush caches on accelerated processor complex 1424, and cause accelerated processor complex 1424 to begin execution of a program. Kernels can be referred to as programs executed by accelerated processor complex 1424. A kernel can be executed independently on every work item, or as groups of work-items that can be referred to as a wavefront, which can execute a kernel on all work-items in a group (e.g., 64) in one pass. Compute units 1434 can include a scalar arithmetic logic unit (ALU), which can operates on one value per wavefront (common to all work items), a vector ALU, which can operate on unique values per work-item, a local data share 1488, which can allow work-items within a workgroup to communicate and share data, a scalar memory (not shown), which can transfer data between scalar general-purpose registers (SGPRs) and memory through a cache, and vector memory, which can transfer data between vector general-purpose registers (VGPRs) and memory, including sampling texture maps. Kernel control flow can be handled using scalar ALU instructions, which can include if/else, branches and looping. Scalar ALU (SALU) and memory instructions can work on an entire wavefront and operate on one or more SGPRs. Vector memory and ALU instructions can operate on all work-items in a wavefront at one time.

SOC 1400 can include Infinity Fabric 1460 interconnects (which can be similar to or based on PCIe architectures) that can provide connections among CPUs (e.g., CPU dies 1426(1)-1426(N)), graphics processor(s), inference engine(s), and other components in a multi-chip architecture, such as secure processor(s) and I/O unit 1470. One or more AMD Infinity Fabric™ interconnects can connect to CPU dies 1426(1)-1426(N) and serve as a connection that is used between CPUs. One or more Infinity Fabric connections can connect each CPU die to I/O unit 1470.

Inference engine 1454 can provide neural processing capabilities for any processors disclosed herein for computational processes that are used for neural networks, deep learning, and other artificial intelligence-related operations described further herein. Processors disclosed herein can include secure processor(s) 1452 for managing security of processors, display controller 1492 for controlling displays, a system management unit 1456 for managing and operating some or all of the components on processors disclosed herein, multimedia engines 1494 for audio and video operations, fusion controller hub 1448 for managing USB, SATA and PCIe connections to processors, and sensor fusion hub 1451 for managing sensors, such as accelerometers. Processors can also include that include different memory types, such as LPDDR5 and/or DDR5, or others described elsewhere herein.

For performing operations described further herein, processors can include an execution pipeline including a front-end that can include a cache (e.g., L1 cache) that stores instructions (not shown). Flow of instructions can be modified by a branch predictor. Instructions can be decoded by a decoder, dispatched to a back-end for execution, and renamed. Instruction fetch and decode pipes, for example, can be dispatched to integer or floating point execution operations that can be scheduled by a scheduler and transferred to vector and/or general-purpose registers. Floating point multiplier and/or add operations can be processed, and arithmetic logic units (ALUs) can also be used to perform computations, such as arithmetic and logic operations. Outputs from computation units can be coupled to a load/store queue, which can be connected to cache, such as L1 cache and/or L2 cache.

Processor complex 1416 may include one or more processors, in accordance with at least one embodiment. Vector processor 1418 may support a RISC-V standard. Vector processing unit (VPU) 1418 can include one or more vector functional units (FUs) that can be chained together for parallel processing, independent memory paths for RISC-V vector (RVV) load/store via ACE-RVV and Andes Streaming port (ASP) load/store, and a vector load/store unit (VLSU).

Vector processor 1418 can include bus interfaces, such as, but not limited to, L2 cache memory port for cacheable access, a MMIO port for non-cacheable access, an input-output coherence Port (IOCP) for cacheless bus master, local memory access ports for ILM/DLM, which can be coupled to SRAM, and high-bandwidth vector memory (HVM) 1422 access, a shared peripheral port (SPP) for external peripherals. Other memory ports include LM slave port AXI, HVM subordinate port AXI, MEM (AXI), and AXI. Trace I/F can capture, encode, and transmit off-chip via Inst. Trace I/F, e.g., a record of executed processor instructions, which software tools can use to reconstruct the exact execution sequence of a program.

FIG. 15 illustrates a parallel processor 1500, in accordance with at least one embodiment. Parallel processor 1500 may be implemented using one or more circuits and may be referred to as a programmable processor (e.g., a CPU and/or GPU), logic, an application specific integrated circuit (ASIC), a field programmable gate array (FPGA) or other hardware (e.g., embodiments in FIGS. 14-17B) to perform any of the operations described above or elsewhere herein.

Parallel processor 1500 can include a parallel processing unit 1502 to perform any of the operations described above or elsewhere herein. Parallel processing unit 1502 can include an I/O unit 1504 that enables communication with other devices, including other instances of parallel processing unit 1502. I/O unit 1504 may be directly connected to other devices. I/O unit 1504 may connect with other devices via use of a hub or switch interface, such as, but not limited to, a memory hub 1505. Connections between memory hub 1505 and I/O unit 1504 can form a communication link 1513. I/O unit 1504 may connect with a host interface 1506 and a memory crossbar 1516, where host interface 1506 receives commands directed to performing processing operations and memory crossbar 1516 receives commands directed to performing memory operations.

When host interface 1506 receives a command buffer via I/O unit 1504, host interface 1506 can direct work operations to perform those commands to a front end 1508. Front end 1508 can couple with a scheduler 1510 (which may be referred to as a sequencer), which can be configured to distribute commands or other work items to a processing cluster array 1512. Scheduler 1510 can ensure that processing cluster array 1512 is properly configured and in a valid state before tasks may be distributed to a cluster of processing cluster array 1512. Scheduler 1510 may be implemented via firmware logic executing on a microcontroller. Microcontroller-implemented scheduler 1510 can be configurable to perform complex scheduling and work distribution operations at coarse and fine granularity, enabling rapid preemption and context switching of threads executing on processing array 1512. Host software can prove workloads for scheduling on processing cluster array 1512 via one of multiple graphics processing paths. Workloads can then be automatically distributed across processing array cluster 1512 by scheduler 1510 logic within a microcontroller including scheduler 1510.

Processing cluster array 1512 can perform any of the operations described above or elsewhere herein and can include up to “N” processing clusters (e.g., cluster 1514A, cluster 1514B, through cluster 1514N), where “N” represents a positive integer (which may be a different integer “N” than used in other figures). Each cluster 1514A-1514N of processing cluster array 1512 can execute a large number of concurrent threads. Scheduler 1510 can allocate work to clusters 1514A-1514N of processing cluster array 1512 using various scheduling and/or work distribution algorithms, which may vary depending on workload arising for each type of program or computation. Scheduling can be handled dynamically by scheduler 1510, or can be assisted in part by compiler logic during compilation of program logic configured for execution by processing cluster array 1512. Different clusters 1514A-1514N of processing cluster array 1512 can be allocated for processing different types of programs or for performing different types of computations.

Processing cluster array 1512 can be configured to perform various types of parallel processing operations, such as, but not limited to, any of the operations described above or elsewhere herein. Processing cluster array 1512 can be configured to perform general-purpose parallel compute operations. For example, processing cluster array 1512 can include logic to execute processing tasks including filtering of video and/or audio data, performing modeling operations, including physics operations, and performing data transformations.

Processing cluster array 1512 can be configured to perform parallel graphics processing operations. Processing cluster array 1512 can include additional logic to support execution of such graphics processing operations, including but not limited to, texture sampling logic to perform texture operations, as well as tessellation logic and other vertex processing logic. Processing cluster array 1512 can be configured to execute graphics processing related shader programs such as, but not limited to, vertex shaders, tessellation shaders, geometry shaders, and pixel shaders. Parallel processing unit 1502 can transfer data from system memory via I/O unit 1504 for processing. During processing, transferred data can be stored to on-chip memory (e.g., parallel processor memory 1522) during processing, then written back to system memory.

When parallel processing unit 1502 is used to perform graphics processing, scheduler 1510 can be configured to divide a processing workload into approximately equal sized tasks, to better enable distribution of graphics processing operations to multiple clusters 1514A-1514N of processing cluster array 1512. Portions of processing cluster array 1512 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of clusters 1514A-1514N may be stored in buffers to allow intermediate data to be transmitted between clusters 1514A-1514N for further processing.

Processing cluster array 1512 can receive processing tasks to be executed via scheduler 1510, which receives commands defining processing tasks from front end 1508. Processing tasks can include indices of data to be processed, e.g., surface (patch) data, primitive data, vertex data, and/or pixel data, as well as state parameters and commands defining how data is to be processed (e.g., what program is to be executed). Scheduler 1510 may be configured to fetch indices corresponding to tasks or may receive indices from front end 1508. Front end 1508 can be configured to ensure processing cluster array 1512 is configured to a valid state before a workload specified by incoming command buffers (e.g., batch-buffers, push buffers, etc.) is initiated.

Each of one or more instances of parallel processing unit 1502 can couple with a parallel processor memory 1522 to perform any of the operations described above or elsewhere herein. Parallel processor memory 1522 can be accessed via memory crossbar 1516, which can receive memory requests from processing cluster array 1512 as well as I/O unit 1504. Memory crossbar 1516 can access parallel processor memory 1522 via a memory interface 1518. Memory interface 1518 can include multiple partition units (e.g., partition unit 1520A, partition unit 1520B, through partition unit 1520N) that can each couple to a portion (e.g., memory unit) of parallel processor memory 1522. A number of partition units 1520A-1520N can be configured to be equal to a number of memory units, such that a first partition unit 1520A has a corresponding first memory unit 1524A, a second partition unit 1520B has a corresponding memory unit 1524B, and an N-th partition unit 1520N has a corresponding N-th memory unit 1524N. A number of partition units 1520A-1520N may not be equal to a number of memory units.

Memory units 1524A-1524N can include various types of memory devices, including dynamic random access memory (DRAM) or graphics random access memory, such as, but not limited to, synchronous graphics random access memory (SGRAM), including graphics double data rate (GDDR) memory. Memory units 1524A-1524N may also include 3D stacked memory, including but not limited to high bandwidth memory (HBM), HBM2e, or HBM3. Render targets, such as, but not limited to, frame buffers or texture maps may be stored across memory units 1524A-1524N, allowing partition units 1520A-1520N to write portions of each render target in parallel to efficiently use available bandwidth of parallel processor memory 1522. A local instance of parallel processor memory 1522 may be excluded in favor of a unified memory design that utilizes system memory in conjunction with local cache memory.

Any one of clusters 1514A-1514N of processing cluster array 1512 can process data that will be written to any of memory units 1524A-1524N within parallel processor memory 1522. Memory crossbar 1516 can be configured to transfer an output of each cluster 1514A-1514N to any partition unit 1520A-1520N or to another cluster 1514A-1514N, which can perform additional processing operations on an output. Each cluster 1514A-1514N can communicate with memory interface 1518 through memory crossbar 1516 to read from or write to various external memory devices. Memory crossbar 1516 can have a connection to memory interface 1518 to communicate with I/O unit 1504, as well as a connection to a local instance of parallel processor memory 1522, enabling processing units within different processing clusters 1514A-1514N to communicate with system memory or other memory that is not local to parallel processing unit 1502. Memory crossbar 1516 can use virtual channels to separate traffic streams between clusters 1514A-1514N and partition units 1520A-1520N.

Multiple instances of parallel processing unit 1502 can be provided on a single add-in card, or multiple add-in cards can be interconnected. Different instances of parallel processing unit 1502 can be configured to interoperate even if different instances have different numbers of processing cores, different amounts of local parallel processor memory, and/or other configuration differences. For example, some instances of parallel processing unit 1502 can include higher precision floating point units relative to other instances. Systems incorporating one or more instances of parallel processing unit 1502 or parallel processor 1500 can be implemented in a variety of configurations and form factors, including but not limited to desktop, laptop, or handheld personal computers, servers, workstations, game consoles, and/or embedded systems.

FIG. 15 further includes a block diagram of a partition unit 1520, in accordance with at least one embodiment. Partition unit 1520 can be an instance of one of partition units 1520A-1520N of FIG. 15. Partition unit 1520 can include an L2 cache 1521, a frame buffer interface 1525, and a ROP 1526 (raster operations unit). L2 cache 1521 can be a read/write cache that is configured to perform load and store operations received from memory crossbar 1516 and ROP 1526. Read misses and urgent write-back requests can be output by L2 cache 1521 to frame buffer interface 1525 for processing. Updates can also be sent to a frame buffer via frame buffer interface 1525 for processing. Frame buffer interface 1525 may interface with one of memory units in parallel processor memory, such as, but not limited to, memory units 1524A-1524N (shown as 1524) of FIG. 15 (e.g., within parallel processor memory 1522).

ROP 1526 can be a processing unit that performs raster operations such as, but not limited to, stencil, z test, blending, etc. ROP 1526 can then output processed graphics data that can be stored in graphics memory. ROP 1526 can include compression logic to compress depth or color data that is written to memory and decompress depth or color data that is read from memory. Compression logic can be lossless compression logic that makes use of one or more of multiple compression algorithms. A type of compression that is performed by ROP 1526 can vary based on statistical characteristics of data to be compressed. For example, delta color compression is performed on depth and color data on a per-tile basis.

ROP 1526 can be included within each processing cluster (e.g., cluster 1514A-1514N of FIG. 15) instead of within partition unit 1520. Read and write requests for pixel data may be transmitted over memory crossbar 1516 instead of pixel fragment data. Processed graphics data may be displayed on a display routed for further processing by processor(s), or routed for further processing by one of processing entities within parallel processor 1500 of FIG. 15.

In at least one embodiment, parallel processor 1500 can include circuitry (e.g., one or more circuits) to perform distributed computations for training and inference of a structure prediction model across multiple processors or otherwise perform any of the operations described above or elsewhere herein. One or more circuits can be configured by software to perform distributed computations for training and inference of a structure prediction model across multiple processors or otherwise perform any of the operations described above or elsewhere herein.

FIG. 15 includes a block diagram of a processing cluster 1514 within a parallel processing unit, in accordance with at least one embodiment. A processing cluster can be an instance of one of processing clusters 1514A-1514N of FIG. 15 that can be used to perform any of the operations described above or elsewhere herein. Processing cluster 1514 can be configured to execute many threads in parallel, where “thread” refers to an instance of a particular program executing on a particular set of input data. Single-instruction, multiple-data (SIMD) instruction issue techniques can be used to support parallel execution of a large number of threads without providing multiple independent instruction units. Single-instruction, multiple-thread (SIMT) techniques may be used to support parallel execution of a large number of generally synchronized threads, using a common instruction unit configured to issue instructions to a set of processing engines within each one of processing clusters.

Operation of processing cluster 1514 can be controlled via a pipeline manager 1532 that distributes processing tasks to SIMT parallel processors. Pipeline manager 1532 can receive instructions from scheduler 1510 of FIG. 15 and manages execution of those instructions via a graphics multiprocessor 1534 and/or a texture unit 1536. Graphics multiprocessor 1534 may be an example instance of a SIMT parallel processor. However, various types of SIMT parallel processors of differing architectures may be included within processing cluster 1514. One or more instances of graphics multiprocessor 1534 can be included within a processing cluster 1514. Graphics multiprocessor 1534 can process data and a data crossbar 1540 can be used to distribute processed data to one of multiple possible destinations, including other shader units. Pipeline manager 1532 can facilitate distribution of processed data by specifying destinations for processed data to be distributed via data crossbar 1540.

Each graphics multiprocessor 1534 within processing cluster 1514 can include an identical set of functional execution logic (e.g., arithmetic logic units, load-store units, etc.) to perform computations for any of the operations described above or elsewhere herein. Functional execution logic can be configured in a pipelined manner in which new instructions can be issued before previous instructions may be complete. Functional execution logic can support a variety of operations including integer and floating point arithmetic, comparison operations, Boolean operations, bit-shifting, and computation of various algebraic functions. Same functional-unit hardware can be leveraged to perform different operations and any combination of functional units may be present.

Instructions transmitted to processing cluster 1514 may constitute a thread, which can also be referred to as a warp, subgroup, wave, or a wavefront. A set of threads executing across a set of parallel processing engines can be referred to as a thread group. A thread group can execute a common program on different input data. Each thread within a thread group can be assigned to a different processing engine within a graphics multiprocessor 1534. A thread group may include fewer threads than a number of processing engines within graphics multiprocessor 1534. When a thread group includes fewer threads than a number of processing engines, one or more of processing engines may be idle during cycles in which that thread group is being processed. A thread group may also include more threads than a number of processing engines within graphics multiprocessor 1534. When a thread group includes more threads than number of processing engines within graphics multiprocessor 1534, processing can be performed over consecutive clock cycles. Multiple thread groups can be executed concurrently on a graphics multiprocessor 1534.

Graphics multiprocessor 1534 includes an internal cache memory to perform load and store operations, such as, but not limited to, any of the operations described above or elsewhere herein. Graphics multiprocessor 1534 can forego an internal cache and use a cache memory (e.g., L1 cache 1548) within processing cluster 1514. Each graphics multiprocessor 1534 may also have access to L2 caches within partition units (e.g., partition units 1520A-1520N of FIG. 15) that can be shared among all processing clusters 1514 and may be used to transfer data between threads. Graphics multiprocessor 1534 may also access off-chip global memory, which can include one or more of local parallel processor memory and/or system memory. Any memory external to parallel processing unit 1502 may be used as global memory. Processing cluster 1514 can include multiple instances of graphics multiprocessor 1534 and can share common instructions and data, which may be stored in L1 cache 1548.

Each processing cluster 1514 may include an MMU 1545 (memory management unit) that can be configured to map virtual addresses into physical addresses. One or more instances of MMU 1545 may reside within memory interface 1518 of FIG. 15. MMU 1545 can include a set of page table entries (PTEs) used to map a virtual address to a physical address of a tile and optionally a cache line index. MMU 1545 may include address translation lookaside buffers (TLB) or caches that may reside within graphics multiprocessor 1534 or L1 cache 1548 cache or processing cluster 1514. A physical address can be processed to distribute surface data access locally to allow for efficient request interleaving among partition units. A cache line index may be used to determine whether a request for a cache line is a hit or miss.

A processing cluster 1514 may be configured such that each graphics multiprocessor 1534 is coupled to a texture unit 1536 for performing texture mapping operations, e.g., determining texture sample positions, reading texture data, and filtering texture data. Texture data can be read from an internal texture L1 cache (not shown) or from an L1 cache within graphics multiprocessor 1534 and can be fetched from an L2 cache, local parallel processor memory, or system memory, as needed. Each graphics multiprocessor 1534 can output processed tasks to data crossbar 1540 to provide processed task to another processing cluster 1514 for further processing or to store processed task in an L2 cache, local parallel processor memory, or system memory via memory crossbar 1516. A preROP 1542 (pre-raster operations unit) can be configured to receive data from graphics multiprocessor 1534, and direct data to ROP units, which may be located with partition units as described herein (e.g., partition units 1520A-1520N of FIG. 15). PreROP 1542 unit can perform optimizations for color blending, organizing pixel color data, and performing address translations.

In at least one embodiment, graphics multiprocessor 1534 can couple with pipeline manager 1532 of processing cluster 1514. Graphics multiprocessor 1534 can include an execution pipeline including but not limited to an instruction cache 1552 (that, e.g., can store instructions, such as, not limited to compiled API instructions), an instruction unit 1554, an address mapping unit 1556, a register file 1558, one or more general purpose graphics processing unit (GPGPU) cores 1562, and one or more load/store units 1566, where one or more load/store units 1566 can perform load/store operations to load/store instructions corresponding to performing an operation. GPGPU cores 1562 and load/store units 1566 can be coupled with cache memory 1572 and shared memory 1570 via a memory and cache interconnect 1568. GPGPU cores 1562 can be part of an SoC such as, but not limited to, part of integrated circuit 1400 in FIG. 14.

Instruction cache 1552 can receive a stream of instructions (e.g., to perform any of the operations described above or elsewhere herein) to execute from pipeline manager 1532. Instructions can be cached in instruction cache 1552 and dispatched for execution by an instruction unit 1554. Instruction unit 1554 can dispatch instructions as thread groups (e.g., warps, subgroups, wavefronts, or waves), with each thread of thread group assigned to a different execution unit within GPGPU cores 1562. An instruction can access any of a local, shared, or global address space by specifying an address within a unified address space. Address mapping unit 1556 can be used to translate addresses in a unified address space into a distinct memory address that can be accessed by load/store units 1566.

Register file 1558 can provide a set of registers for functional units of graphics multiprocessor 1534. Register file 1558 may provide temporary storage for operands connected to data paths of functional units (e.g., GPGPU cores 1562, load/store units 1566) of graphics multiprocessor 1534. Register file 1558 may be divided between each of functional units such that each functional unit is allocated a dedicated portion of register file 1558. Register file 1558 can be divided between different warps (which may be referred to as wavefronts, subgroups, and/or waves or threads) being executed by graphics multiprocessor 1534.

GPGPU cores 1562 can each include floating point units (FPUs) and/or integer arithmetic logic units (ALUs) that can be used to execute instructions of graphics multiprocessor 1534. GPGPU cores 1562 can be similar in architecture or can differ in architecture. A first portion of GPGPU cores 1562 can include a single precision FPU and an integer ALU while a second portion of GPGPU cores include a double precision FPU. FPUs can implement IEEE 754-2008 standard floating point arithmetic or enable variable precision floating point arithmetic. Graphics multiprocessor 1534 can additionally include one or more fixed function or special function units to perform specific functions such as, but not limited to, copy rectangle or pixel blending operations. One or more of GPGPU cores 1562 can also include fixed or special function logic.

GPGPU cores 1562 can include SIMD logic capable of performing a single instruction on multiple sets of data. GPGPU cores 1562 can physically execute SIMD4, SIMD8, and SIMD16 instructions and logically execute SIMD1, SIMD2, and SIMD32 instructions. SIMD instructions for GPGPU cores can be generated at compile time by a shader compiler or automatically generated when executing programs written and compiled for single program multiple data (SPMD) or SIMT architectures. Multiple threads of a program can be configured for an SIMT execution model that can be executed via a single SIMD instruction. For example, eight SIMT threads that perform same or similar operations can be executed in parallel via a single SIMD8 logic unit.

Memory and cache interconnect 1568 can include an interconnect network that connects each functional unit of graphics multiprocessor 1534 to register file 1558 and to shared memory 1570. Memory and cache interconnect 1568 may be a crossbar interconnect that allows load/store unit 1566 to implement load and store operations between shared memory 1570 and register file 1558. Register file 1558 can operate at a same frequency as GPGPU cores 1562, thus data transfer between GPGPU cores 1562 and register file 1558 can have very low latency. Shared memory 1570 can be used to enable communication between threads that execute on functional units within graphics multiprocessor 1534. Cache memory 1572 can be used as a data cache for example, to cache texture data communicated between functional units and texture unit 1536. Shared memory 1570 can also be used as a program managed cache. Threads executing on GPGPU cores 1562 can programmatically store data within shared memory in addition to automatically cached data that is stored within cache memory 1572.

A parallel processor or GPGPU as described herein may be communicatively coupled to host/processor cores to accelerate graphics operations, machine-learning operations, pattern analysis operations, and various general purpose GPU (GPGPU) functions. A GPU may be communicatively coupled to host processor/cores over a bus or other interconnect (e.g., a high-speed interconnect such as, but not limited to, PCIe or NVLink). An SoC may include a parallel processor or GPGPU as described herein, where said parallel processor or said GPGPU is performed on said SoC. A GPU may be integrated on a package or chip as cores and communicatively coupled to cores over an internal processor bus/interconnect internal to a package or chip. Regardless of a manner in which a GPU is connected, processor cores may allocate work to such GPU in a form of sequences of commands/instructions contained in a work descriptor. GPU then may use dedicated circuitry/logic for efficiently processing these commands/instructions to perform any of the operations described above or elsewhere herein.

In at least one embodiment, graphics multiprocessor 1534 can include circuitry (e.g., one or more circuits) to perform distributed computations for training and inference of a structure prediction model across multiple processors or otherwise perform any of the operations described above or elsewhere herein. One or more circuits can be configured by software to perform distributed computations for training and inference of a structure prediction model across multiple processors or otherwise perform any of the operations described above or elsewhere herein.

In at least one embodiment, processor 1500 can include a processor with AI accelerator architecture from Intel Corporation in Santa Clara, CA or another processor that shares at least some of the components described herein. AI accelerator 1500 may use instructions that, if executed by AI accelerator 1500, cause AI accelerator 1500 to perform some or all of processes and techniques described elsewhere herein. For example, with respect to AI accelerator 1500 and any of its components described above or elsewhere herein, one or more of APIs described herein can, for example, get compiled into instructions, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of AI accelerator 1500 (e.g., in cache and/or memory). A result of API(s) can then be stored in storage within or outside of AI accelerator 1500, including registers, DRAM, flash, SRAM, cache, or other memory. AI accelerator 1500 may include one or more compute dies that can include homogeneous or heterogeneous processors. Compute dies may include one or more central processing units (CPU), one or more graphics processing units (GPU), or combinations of both.

In at least one embodiment, compute dies may include compute engines to perform AI computations. In at least one embodiment, AI accelerator 1500 compute dies may be split into any number of (e.g., four) clusters that may be referred to as a DCORE (Deep Learning Core) 1534 and contain any number of Matrix Multiplication Engines (MMEs), Tensor Processor Cores (TPCs) 1561, a global control 1523, a memory management unit, and an L2 Cache, in any combination. MME(s) can perform operations that use Matrix Multiplication, like fully connected layers, convolutions and batched-General Matrix Multiplications (GEMMs). MME(s) may be programmed with array dimensions, locations, data types, and various execution operands. MME(s) can retrieve tensors A and B from memory, pulling them into its streaming buffers for matrix multiplication to be performed in parallel by MACs. MME(s) may push tensor C back to memory upon completion. TPCs can support different types of parallel processing, e.g., Very Long Instruction Word (VLIW) Single-Instruction Multiple-Data (SIMD) that supports data types, such as, but not limited to, FP32, BF16, FP16 & FP8 (both E4M3 and E5M2), UINT32, INT32, UINT16, INT16, UINT8 and INT8 datatypes. Any number of compute dies may be connected through an interconnect. An interconnect that can connect compute dies can be over an interposer bridge that, e.g., is transparent to software.

Memory on AI Accelerator 1500 may include one or more levels of cache (e.g., L1, L2, L3, and/or last-level cache) and high-bandwidth memory (e.g., HBM2e or HBM3) in any combination. Memory and/or cache systems can be unified or separate. Compute dies of AI accelerator 1500 may include on-die memory that includes one or more levels (e.g., two-levels) of cache. On-die SRAM or other memory described elsewhere herein can be used as a uniformly accessible last-level cache (L3) or split to slices of L2 cache that may be accessible to groups of MMEs and TPCs 1561. Using on-die memory as L2 or L3 cache can be fully configurable by software, which dynamically may decide per I/O tensor its optimal cache allocation. AI Accelerator 1500 may include one or more Memory Management Units (MMUs) for managing memory, such as allowing AI accelerator 1500 memory subsystem to operate in a virtual space when accessing VRAM.

AI accelerator 1500 may include a communications port (e.g., a PCIe Gen5 X16 port) for communicating with a host and Scheduling and Synchronization Unit. AI accelerator 1500 may include Media Unit that may include any number or combinations of Media Decoder Engines (DECs) and Rotator Engines (ROT). AI accelerator 1500 may include a network unit that may include any number or combinations of network ports and accompanied RDMA Engine(s), L2 Cache, and memory (e.g., HBM2e or HBM3) stacks.

AI accelerator 1500 may include media decoding units that support Video Formats, such as, but not limited to, HEVC, Progressive H.264, SVC base layer, MVC, VP9, JPEG, Progressive JPEG. AI accelerator 1500 may support post processing of decoded media streams, such as, but not limited to, image down-scaling (resizing an image), vertical and horizontal scaling at different scaling ratios, Image up-scaling, Image cropping, bilinear scaling, and Lancos scaling. AI accelerator 1500 may implement two post processing channels per decoder unit, one with scalar (up and down) and one just to output the original image. AI accelerator 1500 may include a hardware rotator engine that performs the following transformations of an input image: 2D rotation, 3D rotation, Projection, distorting and undistorting images, resampling input data at user-defined coordinates, and rescaling.

RDMA over Converged Ethernet on AI accelerator 1500 may enable scaling from a single node (i.e., a single AI Accelerator 1500 to hundreds or thousands of nodes or AI Accelerators 1500). NW Subsystem can include an Intel® Gaudi® Communication Library (IGCL), a master conductor that orchestrates data movement, and a programable scheduling mechanism that can enable smooth activation of engines while maintaining task dependencies. A accelerator networking sub-system can include Gigabit Ethernet NIC ports.

AI Accelerator 1500 can be operated and controlled using software layer that may include low-level components, such as, but not limited to, a graph compiler, an automatic kernel fuser and a library of precompiled kernels, as well as integration to AI ecosystems, such as, but not limited to, PyTorch, JAX, TensorFlow, DeepSpeed, Hugging Face, vLLM, Ray and more, or as described elsewhere herein with respect to software and programming platforms. Software layer may include implementations of algorithms, such as, but not limited to, Paged Attention, Flash Attention and more. Software layer may generate optimized binary code that implements a given model topology, such as, but not limited to, performing operator fusion, data layout management, parallelization, pipelining and memory management, and graph-level optimizations.

In at least one embodiment, cores 1562 may be configured similar to a NPU and can include one or more Intel® AI Boost built-in neural processing unit(s) (NPUs). NPU can be enumerated to a host processor as an integrated PCIe device. NPU can include one or more (e.g., two) Neural Compute Engine (NCE) tiles. For general compute needs, NCE tiles can include inference pipeline 1533 and Streaming Hybrid Architecture Vector Engines (SHAVE) 1528 for high performance parallel computing, which can include DMA (Direct Memory Access) engines to shuttle data between system memory DRAM (Dynamic Random Access Memory) and a software managed cache.

In one example, a single neuromorphic core may implement some number of neurons (e.g., 1024) that share architectural resources of neuromorphic core 1562 in a time-multiplexed manner. In one example, each neuromorphic core 1562 may include processor block capable of performing arithmetic functions and routing in connection with the realization of a digitally implemented artificial neuron, such as, but not limited to, explained herein. Each neuromorphic core 1562 may additionally provide local memory in which a routing table may be stored and accessed for a neural network, accumulated potential of each soma of each neuron implemented using core 1562 may be tracked, parameters of each neuron implemented by core 1562 may be recorded, among other data and usage. Components, or architectural resources, of neuromorphic core 1562 may further include input interface to accept input spike messages generated by other neurons on other neuromorphic cores and output interface to send spike messages to other neuromorphic cores over mesh network. In some instances, routing logic for neuromorphic core 1562 may be at least partially implemented using output interface. Further, in some cases, core 1562 may implement multiple neurons within an example SNN and some of these neurons may be interconnected. In such instances, spike messages sent between neurons hosted on core 1562 may forego communication over routing fabric of neuromorphic computing device and may instead by managed locally at particular neuromorphic core 1562.

Each neuromorphic core 1562 may additionally include logic to implement, for each neuron, artificial dendrite and artificial soma (referred to herein, simply, as “dendrite” and “soma” respectively). Dendrite may be a hardware-implemented process that receives spikes from network. Soma may be a hardware-implemented process that receives each dendrite's accumulated neurotransmitter amounts for the current time and evolves each dendrite and soma's potential state to generate outgoing spike messages at the appropriate times. Dendrite may be defined for each connection receiving inputs from another source (e.g., another neuron). In one implementation, dendrite process may receive and handle spike messages as they serially arrive in time-multiplexed fashion from network. As spikes are received, neuron's activation (tracked using soma (and local memory)) may increase. When neuron's activation exceeds a threshold set for neuron, neuron may generate a spike message that is propagated to a fixed set of fanout neurons via output interface. Network distributes spike messages to all destination neurons, and in response those neurons, in turn, may update their activations in a transient, time-dependent manner, and so on, potentially causing the activation of some of these destination neurons to also surpass corresponding thresholds and trigger further spike messages, as in real biological neural networks.

In an improved implementation of a system capable of supporting SNNs, such as, but not limited to, a very large scale integration (VLSI) hardware device illustrated in the example of FIG. 15, high speed and reliable circuits may be provided to implement SNNs to model information processing algorithms as employed by a brain, but in a more programmable manner. For instance, while a biological brain can only implement a specific set of defined behaviors, as conditioned by years of development, a neuromorphic processor device may provide a capability to rapidly reprogram all neural parameters. Accordingly, a single neuromorphic processor may be utilized to realize a broader range of behaviors than those provided by a single slice of biological brain tissue. This distinction may be realized by adopting a neuromorphic processor with neuromorphic design realizations that differ markedly from those of neural circuits found in nature.

As an example, a neuromorphic processor 1534 may utilize time-multiplexed computation in both a spike communication network and neuron machinery of neuromorphic computing device to implement SNNs. Accordingly, physical circuitry of neuromorphic computing device may be shared among many neurons to realize higher neuron density. With time multiplexing, a network can connect N cores with O(N) total wiring length, whereas discrete point-to-point wiring would scale as O(N²), realizing a significant reduction in wiring resources to accommodate planar and non-plastic VLSI wiring technologies, among other examples. In neuromorphic cores, time multiplexing may be implemented through dense memory allocation, for instance, using Static Random Access Memory (SRAM), with shared buses, address decoding logic, and other multiplexed logic elements. State of each neuron may be stored in processor's memory, with data describing each neuron state including state of each neuron's collective synapses, all currents and voltages over its membrane, among other example information (such as, but not limited to, configuration and other information).

In operation, neuromorphic computing device 1500 may begin in an idle state with all neuromorphic cores inactive. As each core asynchronously cycles through its neurons, it generates spike messages that a mesh interconnect routes to appropriate destination cores containing all destination neurons. Implementation of multiple neurons on a single neuromorphic core may be time-multiplexed, and a time step may be defined in which all spikes involving multiple neurons may be processed and considered using shared resources of a corresponding core. As each core finishes servicing its neurons for a respective time step, cores may, in some implementations, communicate (e.g., using a handshake) with neighboring cores using synchronization messages to flush a mesh of all spike messages in flight, allowing cores to safely determine that all spikes have been serviced for a time step. At that point all cores may be considered synchronized, allowing them to advance their time step and return to an initial state and begin a next time step.

Given this context, and as introduced above, a device (e.g., 1500) implementing a mesh of interconnected neuromorphic cores may be provided, with core 1562 implementing potentially multiple artificial neurons capable of being interconnected to implement an SNN. Each neuromorphic core (e.g., 1562) may provide two loosely coupled asynchronous processes: an input dendrite process that receives spikes from network and applies them to an appropriate destination dendrite compartments at the appropriate future times, and output soma process that receives each dendrite compartment's accumulated neurotransmitter amounts for the current time and evolves each dendrite and soma's membrane potential state, generating outgoing spike messages at appropriate times (e.g., when a threshold potential of a soma has been reached). Note that, from a biological perspective, dendrite and soma names used here only approximate a role of these functions and should not be interpreted too literally.

In at least one embodiment, parallel processor 1500 may include one or more tensor processing units (TPUs), in accordance with at least one embodiment. TPUs can include application specific integrated circuits (ASICs), e.g., to perform some or all of the operations described above or elsewhere herein, such as, but not limited to, accelerate machine learning workloads performing matrix operations. TPUs may be ASICs from Alphabet Corporation in Mountain View, CA. Cloud TPU includes a cloud service that makes TPUs available as a scalable resource for processing tasks, such as, but not limited to, machine learning workloads that can run on frameworks such as, but not limited to, TensorFlow, Pytorch, and JAX.

Parallel processor 1500 can include any number of TPUs that can include tensor cores 1562. Tensor core 1562 can include one or more of core sequencer 1509, vector processing unit (VPU) 1511, matrix multiply unit (MXU) 1515(A)-1515(N), where N is any integer greater than 1, and transpose permute unit 1517. Core Sequencer 1509 can fetch (e.g., VLIW (Very Long Instruction Word)) instructions from core's Instruction Memory (Imem), execute scalar operations using a scalar data memory (Smem) and scalar registers (Sregs) (not shown), and forward vector instructions to Vector Processing Unit (VPU) 1511. Instructions can, for example, launch eight operations: two scalar, two vector ALU, vector load and store, and a pair of slots that queue data to and from matrix multiply and transpose units. VPU 1511 can perform vector operations using a large on-chip vector memory (Vmem), and vector registers (Vregs). VPU 1511 can stream data to and from MXU through decoupling FIFOs. VPU 1511 can collect and distribute data to Vmem via data-level parallelism (2D matrix and vector functional units) and instruction-level parallelism (8 operations per instruction). A large two-dimensional matrix multiply unit (MXU) 1515(A)-1515(N) can, e.g., use a systolic array to reduce area and energy plus large, software-controlled on-chip memories instead of caches. Transpose Reduction Permute Unit 1517 can do (e.g., 128×128) matrix transposes, reductions, and permutations of VPU 1511 lanes. High Bandwidth Memory 1507 can be used for applications on chip, and it can be coupled to host queue(s) 1503, e.g., over PCIe. One or more chips 1591 can be connected together for computing. For example, one or more chips 1591 can be connected as a torus, e.g., a 2D torus. Chip 1591 can also include any number (e.g., four) Inter-Core Interconnect (ICI) links 1519 that can enable direct connections between chips to form a supercomputer.

With respect to any processors in chip 1591 and any of its components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of any processors in chip 1591 (e.g., in cache and/or memory). A result of API(s) can then be stored in storage within or outside of any processors in chip 1500, including registers, DRAM, flash, SRAM, cache, or other memory equivalents.

In at least one embodiment, parallel processor 1500 may include one or more vector processors, in accordance with at least one embodiment. Vector processor may support a RISC-V standard. Vector processor can include one more cores (e.g., scalar units) with one or more Vector Processing Units (VPUs) (e.g., vector units) that can, e.g., perform some or all of the operations described above or elsewhere herein. The one or more cores may include Andes Custom Extension (ACE) that can be used for communication of customized instructions for processor, for example, via ACP. The one or more cores may include 1-cycle multiplier and 1-cycle instruction/data local memory (ILM/DLM) for increased parallelism by allowing simultaneous instruction fetches and data accesses. A memory management unit (e.g., MMU 1545) may manage system memory and cache, and provide for branch execution, issuance of instruction pairs, L1 instruction/data caches and local memory storage. The one or more cores can include Physical memory protection and programmable physical memory attribute unit (PMP/PPMA). Core can include a digital signal processor (DSP), and a floating-point unit (FPU) as well as load-store unit (LSU) to interface with memory hierarchy (D$ and I$). The one or more cores can include branch prediction unit and multiplier unit.

In at least one embodiment, chip 1591 can include circuitry (e.g., one or more circuits described above and elsewhere herein) to perform distributed computations for training and inference of a structure prediction model across multiple processors or otherwise perform any of the operations described above or elsewhere herein. One or more circuits can be configured by software to perform distributed computations for training and inference of a structure prediction model across multiple processors or otherwise perform any of the operations described above or elsewhere herein.

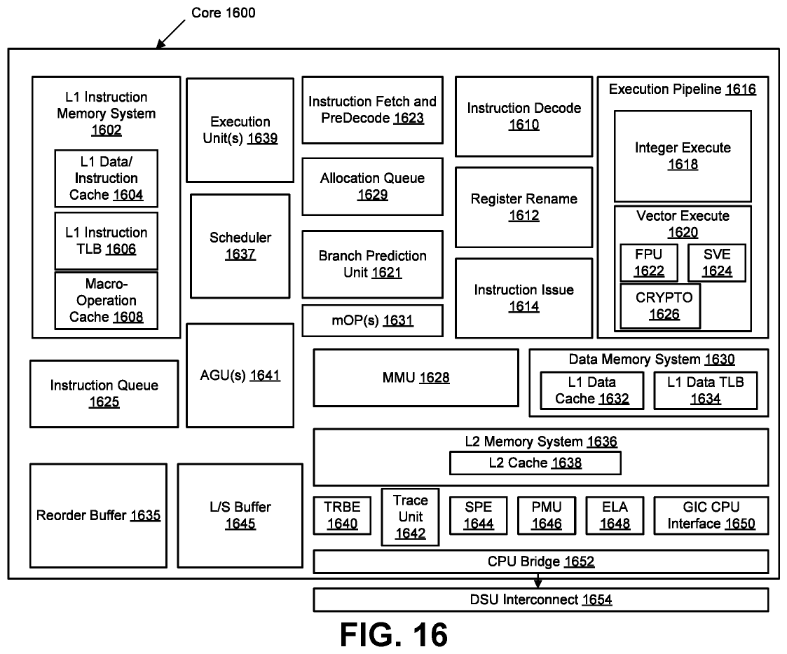

FIG. 16 illustrates an example of a processing core 1600 that may implement Arm architecture (e.g., v9.0-A) or another processor that shares at least some of the components described herein. Neoverse™ V2 core 1600 can be implemented inside a DynamIQ Shared Unit (DSU) cluster via DSU-110 interconnect 1654 for connected one or more cores, e.g., for parallel processing. Neoverse™ V2 core may be implemented as a single core in a DSU cluster that is configured for Direct connect, with or without L3 cache, snoop filter, or Snoop Control Unit (SCU) logic (not shown). Neoverse™ V2 core can include a CPU bridge 1652 that connects core 1600 to DSU-110 interconnect 1654, which can also connect core 1600 to an external memory system and the rest of a system-on-a-chip. L1 instruction memory system 1602 can fetch instructions from an instruction cache 1604 and deliver instructions (e.g., one or more APIs described herein that may be compiled into instructions) to an instruction decode unit 1610, e.g., to perform some or all of operations described above or elsewhere herein. L1 instruction memory system 1602 may include L1 instruction cache 1604, e.g., with 64-byte cache lines, L1 instruction Translation Lookaside Buffer (TLB) 1606, e.g., with native support for 4 KB, 16 KB, 64 KB, and 2 MB page sizes, Macro-Operation Cache (MOP) 1608 (e.g., 1536-entry, 4-way skewed associative L0 MOP cache), which can contain decoded and optimized instructions for higher performance. Instruction decode unit 1610 can decode AArch64 instructions into internal format. Register rename unit 1612 can perform register renaming to facilitate out-of-order execution and dispatches decoded instructions to various issue queues. Instruction issue unit 1614 can control when decoded instructions may be dispatched to execution pipelines, and it can include issue queues for storing instructions pending dispatch to execution pipelines. Integer execution pipeline 1616 can be included in an execution pipeline and include integer execute unit 1618 that can perform arithmetic and logical data processing operations. Vector execute unit 1620 can be included in an execution pipeline and can perform Advanced SIMD and floating-point operations (FPU) 1622, execute Scalable Vector Extension (SVE) and Scalable Vector Extension 2 (SVE2) instructions 1624, and can optionally execute cryptographic instructions (Crypto) 1626. Advanced SIMD can include media and signal processing architecture that adds instructions primarily for audio, video, 3D graphics, image, and speech processing. A floating-point architecture provides support for single-precision and double-precision floating-point operations. L1 data memory system 1630 can execute load and store instructions, as well as service memory coherency requests. L1 data memory system 1630 can include an L1 data cache 1632 and a fully associative L1 data TLB 1634 with native support for 4 KB, 16 KB and 64 KB page sizes and 2 MB and 512 MB block sizes. Memory Management Unit (MMU) 1628 can provide fine-grained memory system control through a set of virtual-to-physical address mappings and memory attributes that can be held in translation tables, which can be saved into TLB 1634 when an address is translated. L2 memory system 1636 can include L2 cache 1638, and it can be connected to DSU-110 1654 through an asynchronous CPU bridge 1652. Neoverse™ V2 core 1600 can support a range of debug, test, and trace options including a trace unit 1642 and a trace buffer 1640, and an Embedded Logic Analyzer (ELA) 1648. Neoverse™ V2 core 1600 can implement Statistical Profiling Extension (SPE) 1644 to provide a statistical view of the performance characteristics of executed instructions that software writers can use to optimize their code for better performance. Performance Monitoring Unit (PMU) 1646 can provide performance monitors that can be configured to gather statistics on operation of each core and memory system. Information can be used for debug and code profiling. Generic Interrupt Controller (GIC) CPU interface 1650, when integrated with an external distributor component, can be a resource for supporting and managing interrupts in a cluster system. In a cluster, there can be one CPU bridge 1652 between each Neoverse™ V2 core 1600 and DSU-110 1654. CPU bridge 1652 can control buffering and synchronization between core 1600 and DSU-110 1654. CPU bridge 1652 can be asynchronous to allow different frequency, power, and area implementation points for each core 1600. CPU bridge 1652 can run synchronously without affecting other interfaces such as, but not limited to, debug and trace which can be asynchronous.

Each core 1600 can include a fetch/decode unit (e.g., 1623), an integer execution engine (e.g., 1618), a floating point execution engine (e.g., 1620), and an L2 cache (e.g., 1638). The fetch/decode unit can fetch instructions to perform some or all of the operations described herein (such as, but not limited to, an API that is compiled into instructions) and decode such instructions, generate micro-operations, and dispatch separate micro-instructions to the integer execution engine and/or the floating point execution engine. The fetch/decode unit can concurrently dispatch one micro-instruction to the integer execution engine and another micro-instruction to the floating point execution engine. The integer execution engine can execute integer and memory operations. The floating point engine can execute floating point and vector operations. The fetch/decode unit can dispatch micro-instructions to one or more execution engines that replace both the integer execution engine and the floating point execution engine.

Each core 1600 may access an i-th L2 cache included in i-th core 1600. Each core 1600 included in a j-th core complex, where j is an integer representing a particular instance of the core complex, can be connected to other cores 1600 included in the j-th core complex via an L3 cache included in the j-th core complex. Cores 1600 included in the j-th core complex, where j is an integer representing a particular instance of the core complex, can access all of the L3 cache included in the j-th core complex. The L3 cache may include any number of slices.

In at least one embodiment, core 1600 can include a front-end, a back-end or execution engine, and a memory subsystem. The front-end can provide the execution engine with operations (e.g., operations described elsewhere herein) by decoding instructions stored in memory. For example, the front-end can include a micro-operations (μOps) cache path and/or a legacy path 1631, along with branch prediction unit 1621 that can determine paths instructions. A legacy path for instructions may include fetching variable-length (e.g., x86) instructions from L1 instruction cache 1604 with instruction fetch and predecode 1623, queuing the instructions in instruction queue 1625, and decoding instructions using a decoder (e.g., 1610) into μOps that can be provided to allocation queue 1629. Alternatively, a μOPs cache path may include a cache containing already decoded μOps (μOps 1631) that can be sent to allocation queue 1629. Allocation queue 1629 can perform as an interface between the front-end and the execution engine, and can provide instructions to the execution engine. One or more of API(s) described herein can, for example, get compiled into instructions that can be stored, processed, and executed by the front-end, the execution engine, and stored in the memory subsystem.

The execution engine can receive micro-operations into reorder buffer 1635, which can register allocation, rename, and retire μOPs. From reorder buffer 1635, μOPs can be sent to scheduler 1637 that can be connected one or more different execution units 1639, which can be connected to address generation unit (AGU) 1641. Execution units 1639 can perform, e.g., basic arithmetic logic unit (ALU) operations, multiplication, division, and/or more complex operations, such as, but not limited to, various vector operations. Scheduler 1637 may manage queuing μOPs for one or more of execution units 1639 depending, e.g., on operations needed to be performed.

The memory subsystem can process load and store requests as well as ordering operations. For example, μOPs may relate to memory access (e.g. load and store), and those can be sent on dedicated scheduler ports that can perform those memory operations. Store and load operations, for example, can be sent to load and store buffer(s) 1645. The memory subsystem can also include shared or separate L1 data and instruction cache 1604, as well as L2 cache 1638 that can be used and shared by L1 data and instruction cache 1604. As described above for FIG. 16, each core 1600 can be connected to a slice of a third level of cache that can be shared by all cores 1600.

In at least one embodiment, processor 1600 can include circuitry (e.g., one or more circuits described above and elsewhere herein) to perform distributed computations for training and inference of a structure prediction model across multiple processors or otherwise perform any of the operations described above or elsewhere herein. One or more circuits can be configured by software to perform distributed computations for training and inference of a structure prediction model across multiple processors or otherwise perform any of the operations described above or elsewhere herein.

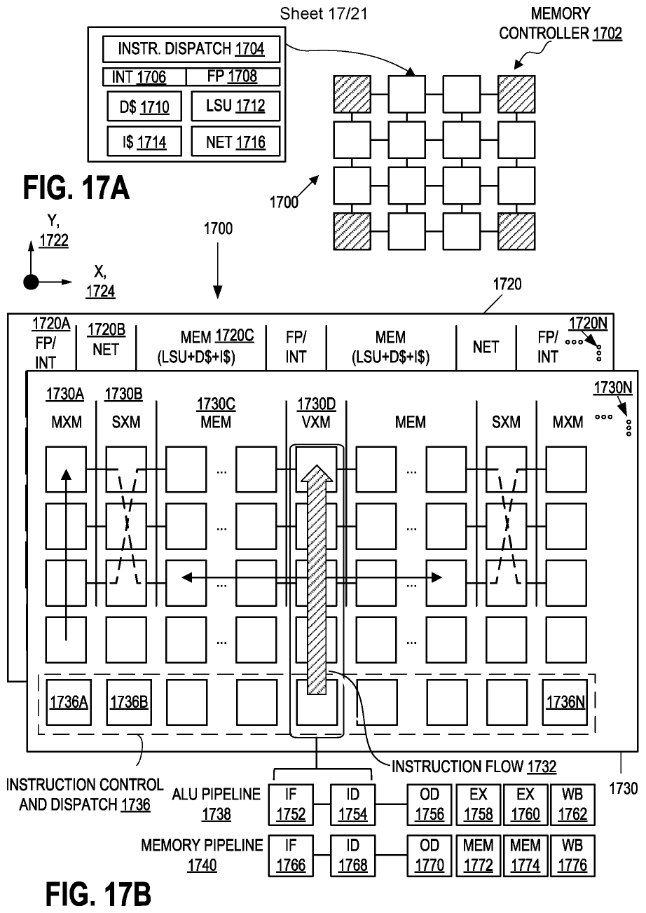

FIG. 17A illustrates a diagram of an example many-core tiled processor microarchitecture. Many-core tiled processor in FIG. 17A may be configured as a Language Processing Unit (LPU), Tensor Streaming Processor (TSP), or other such processor. As illustrated in FIG. 17A, each “tile” of a processor architecture can be a processing element tied together using a network-on-chip (NoC) that can be used, e.g., to perform some or all of the operations described above or elsewhere herein. For example, each tile may have an instruction dispatch 1704 and an integer (INT) 1706 and floating-point (FP) unit 1708 as well as load-store unit (LSU) 1712 to interface with memory hierarchy (data cache (D$) 1710 and instruction cache (I$) 1714) and network (NET) 1716 interface for communication with other tiles. Some tiles in processor 1700 may include memory controller 1702 for managing and controlling memory, as described further herein. Processor 1700 can have a functional slice architecture. Processor 1700 may be located on an application specific integrated circuit (ASIC), and FIG. 17A may represent a layout of an ASIC. Processor 1700 can include a co-processor that is designed to execute instructions for a predictive model. A predictive model is any model that is configured to make a prediction from input data. A predictive model can use a classifier to make a classification prediction. A predictive model may be a machine learning model such as, but not limited to, a tensor flow model, and processor 1700 is a tensor streaming processor.

Processor 1700 can employ different microarchitectures, which disaggregates functional units shown in each tile in FIG. 17B. The processor 1700 may be characterized by a functional slice architecture, in which the processor 1700 is physically and logically divided into a plurality of functional slices 1730 (e.g., 1730A, 1730B, 1730C, 1730D, . . . , 1730N), each dedicated to a specific computational or storage role. These slices may be arranged in a grid-like tile structure, wherein a first dimension (e.g., the vertical or y-axis 1722) is used for instruction dispatch (e.g., instruction flow 1732), and a second dimension (e.g., the horizontal or x-axis 1724) is used for the streaming of operand data (e.g., data flow). In another embodiment, functional tiles of processor 1700 may be aggregated into a plurality of functional process units 1720 (e.g., 1720A, 1720B, 1720C, . . . , 1720N), each corresponding to a particular function type (e.g., FP/INT 1720A, NET 1720B, MEM 1720C). For example, as illustrated in FIG. 17B, each slice may correspond to a column of functional tiles extending in a north-south direction. In addition, processor 1700 also may include communication lanes to carry data between tiles of different slices, each running horizontally in an east-west direction. Each communication lane may be connected to each of slices 1730 of processor 1700.

Slices 1730 of processor 1700 may each correspond to a different function, and may include arithmetic logic slices (e.g., FP/INT 1720A), lane switching slices (e.g., NET 1720B), and memory slices (e.g., MEM 1720C). Arithmetic logic units may execute one or more arithmetic and/or logic operations on data received via communication lanes to generate output data. Examples of arithmetic logic units may be matrix multiplication units and vector multiplication units. Memory slices include memory cells that store data. Memory slices can provide data to other slices through communication lanes. Memory slices can also receive data from other slices through communication lanes. Lane switching slices can configurably route data from one communication lane to any other communication lane. For example, data from a first lane can be provided to a second lane through a lane switching slice. In some embodiments, a lane switching slice can be implemented as a crossbar switch. Each slice 1730 also includes its own instruction queue (not shown) that stores instructions, and an instruction control unit (ICU) to control execution of instructions. Instructions in a given instruction queue may be executed only by tiles in its associated functional slice and may not be executed by other slice(s) of processor 1700.

By arranging tiles of processor 1700 into different functional slices 1730, on-chip instruction and control flow of processor 1700 can be decoupled from data flow. For example, one arrow in FIG. 17B illustrates flow of instructions within processor architecture, in accordance with some embodiments. Another arrow in FIG. 17B illustrates data flow within processor architecture, in accordance with at least one embodiment. As illustrated, instructions and control flow can flow in a first direction across tiles of processor 1700 (e.g., north-south, along a length of functional slices, as shown by the first arrow), while data flows flow in a second direction across tiles of processor 1700 (e.g., east-west, across functional slices, as shown by the second arrow) that is perpendicular to the first direction.

Different functional slices of processor 1700 may correspond to MEM 1730C (memory), VXM 1730D (vector execution module), MXM 1730A (matrix execution module), NIM (numerical interpretation module), and SXM 1730B (switching and permutation module). Each slice may include N tiles that may all be controlled by a same instruction control unit (ICU). VXM 1730D may be configured to execute pointwise operations, activation functions (e.g., GeLU, SiLU), and other element-wise computations required by machine learning models. MXM 1730A may be configured to perform high-density matrix multiplication operations, such as outer products and convolutions, using systolic arrays or similar dense compute structures. Data Switching Slices may be configured to route data between the functional slices and to external interfaces. Each slice may operate completely independently and can only be coordinated using barrier-like synchronization primitives or through a compiler by exploiting “tractable determinism.” Each tile of processor 1700 can correspond to an execution unit organized as an ×M SIMD tile. For example, each tile of on-chip memory of processor 1700 may be organized to store an L-element vector atomically. As such, a MEM slice having N tiles may work together to store or process a large vector (e.g., having a total of N×M elements).

MXM 1730A can include dedicated matrix-computation logic within a functionally sliced tensor-processing architecture and can be configured to support deterministic, high-throughput execution of machine-learning or other workloads in accordance with any embodiment described herein. MXM 1730A can be implemented as a functional slice within a functionally sliced processor architecture, wherein the MXM 1730A is spatially arranged to receive operand streams and to emit result streams without reliance on register-based load-store semantics. MXM 1730A can be spatially arranged to operate on streamed tensor data rather than register-resident operands. MXM 1730A can be architected to align with a wide-vector, lane-based programming model in which tensors are represented as vectors of more than 320 elements.

In some embodiments, MXM 1730A can be configured to perform matrix multiplication and convolution operations that form computational kernels for deep neural network inference, training or other workloads described above or elsewhere herein. MXM 1730A can consume streams of activation data and streams of weight data, can compute dot products between activations and weights across a plurality of lanes, and can produce accumulated output feature or other vectors. MXM 1730A can support low-precision input formats including but not limited to int8 and fp16, while accumulating results into higher-precision formats such as int32 or fp32, thereby enabling quantized execution and floating-point execution within the same architecture, as described herein. In at least one embodiment, once an MXM 1730A pipeline is filled, MXM 1730A generates a new output vector on each cycle, thereby sustaining high arithmetic utilization consistent with throughput requirements of various devices and/or processing units.

In some embodiments, MXM 1730A can communicate with other processor components through streams implementing a producer-consumer dataflow model. The result streams can be consumed by VXM 1730D for post-processing operations, forwarded for data rearrangement, written to memory slices, or transmitted to chip-to-chip interfaces. VXM 1730D can consume this without reliance on caches, interrupts, or dynamic arbitration thereby enabling predictable performance and chained execution pipelines characteristic of processing units (e.g., embodiments in FIGS. 14-17B).

SXM 1730B can include dedicated stream-switching, lane-shifting, and permutation logic within a functionally sliced tensor-processing architecture and can be configured to provide data movement for machine-learning or other tensor workloads in accordance with any embodiment described herein. SXM 1730B can be implemented as a functional slice within a functionally sliced processor architecture, wherein the SXM 1730B is spatially arranged to operate on architecturally-visible streams and to move vector elements without reliance on register based load store semantics. In some embodiments, SXM 1730B can be arranged to effect inter-lane movement of streamed tensor data across a wide-vector, lane-based programming model and can cooperate with memory slices to route stream data deterministically in two dimensions of an on-chip network.

In some embodiments, SXM 1730B can be configured to perform lane-shift operations and programmable permutations that implement tensor reshape, alignment, padding, and layout transforms. SXM 1730B can further include a permuter configured to apply a programmed bijection mapping for correspondingly indexed streams, thereby enabling arbitrary lane remapping across the full vector width while preserving predictable timing and avoiding dynamic arbitration.

In some embodiments, SXM 1730B can be coupled between memory slices 1730C as part of an on-chip network that routes streamed operands and results deterministically in two dimensions. As described herein, horizontally propagating streams can traverse the X-dimension via the MEM 1730C slice stream-register interfaces, while SXM 1730B can provide the Y-dimension movement by shifting and permuting elements across lanes, thereby enabling inter-lane communication without packet routing, arbitration, or caches. SXM 1730B can receive one or more incoming streams and can emit correspondingly indexed streams after permutation, transposition, distribution, and/or rotation, such that downstream slices can consume the transformed stream values in a producer-consumer chain. In at least one embodiment, SXM 1730B can be instantiated in each hemisphere of the processor adjacent to corresponding MEM 1730C resources, enabling concurrent transpose/permutation operations while instruction control units (ICUs) 1736 dispatch temporally-scheduled operations so that SXM-produced streams intersect deterministically with consumer operations in VXM 1730D and/or MXM 1730A.

VXM 1730D can include dedicated vector-execution logic within a functionally sliced, tensor-streaming processor architecture and can be configured to perform operations on streamed vector data in accordance with any embodiment described herein. VXM 1730D can be implemented as a functional slice spatially interposed between memory slices and other arithmetic slices, and can be arranged to consume operand streams and emit result streams without reliance on register-resident operands, condition codes, or load/store semantics. In some embodiments, VXM 1730D can operate on vectors represented as parallel lanes, each lane corresponding to an element of a tensor, and can align with a wide-vector programming model supporting scalable vector, as described herein.

In some embodiments, each lane of VXM 1730D can comprise a mesh of vector arithmetic logic units (ALUs) 1738 configured to execute operations on streamed operands, comprising unary operations, binary operations, type conversions, and activation functions. VXM 1730D can support fixed-point and floating-point numerics, comprising int8, int16, int32, fp16, and fp32 formats, and can provide saturating or modular arithmetic semantics to enable predictable handling of overflow and quantization behavior. Instruction execution can be carried out over several stages: (1) instruction fetch (IF), (2) instruction decode (ID), (3) execution on ALUs (EX), (4) memory access (MEM), and (5) writeback (WB) to update the results in the general-purpose registers (GPRs).

The processor 1700 may use a specialized, high-performance instruction pipeline (e.g., integer ALU instruction pipeline 1738) that is designed for deterministic execution, where the software/compiler pre-schedules every operation to avoid bottlenecks. The pipeline 1738 may include an instruction fetch (IF) stage 1752, an instruction decode (ID) stage 1754, an operand dispatch/decode (OD) stage 1756, one or more execution (EX) stages (e.g., a first execution stage 1758 and a second execution stage 1760), and a write back (WB) stage 1762. For example, the pipeline 1738 may include an instruction fetch (IF) stage 1752 where the processor 1700 may fetch the next instruction from the instruction queue/instructions memory, typically the on-chip SRAM, to be processed. The pipeline 1738 may include an instruction decode (ID) stage 1754 where the processor 1700 decodes opcode and operands, selects source/destination streaming registers, and prepares control signals. The pipeline 1738 may include an operand dispatch/decode (OD) stage 1756 where the processor 1700 may access and align the operand streams for this slice, and handle any local muxing/steering from the streaming register file into the VXM slice 1730D. The pipeline 1738 may include one or more execute (EX) stages—e.g., a first execute stage 1758 and a second execute stage 1760. The first execute stage 1758, for example, may include handling parts of the tensor arithmetic or data reshaping, while the second execute stage 1760, for example, may allow for the processor 1700 to handle more complex operations—such as matrix operations (e.g., using the MXMs), vector processing (e.g., using the VXMs), etc.—in a pipelined fashion. As an example, the first execution stage 1758 may perform lower-latency integer operations or a first half of a multi-cycle integer operation while the second execution stage 1760 may complete the integer operation and produce a final result value. The pipeline 1738 may include a write back (WB) stage 1762 where the compiled result (e.g., activation) is written back to the appropriate stream/register (e.g., to on-chip SRAM) so it can continue flowing across slices 1730. As such, the pipeline 1738 may effectively use a six-stage realization of the IF/ID/EX/MEM/WB pattern, with OD as an explicit operand stage, EX split into two back-to-back execution stages, and no separate MEM stage because the VXM slice 1730D (e.g., INT ALU path) doesn't perform memory access itself.

The processor 1700 may use a memory (load/store) instruction pipeline 1740 that includes an instruction fetch (IF) stage 1766, an instruction decode (ID) stage 1768, an operand decode/dispatch (OD) stage 1770, one or more memory stages (e.g., first memory stage 1772 and second memory stage 1774), and a write back (WB) stage 1776. The pipeline 1740 may include an instruction fetch (IF) stage 1766 where an instruction control unit (ICU) 1736 fetches the memory instruction (e.g., READ a,s, WRITE a,s, GATHER, SCATTER, etc., where “a” is the memory or base address and “s” is the destination stream ID) from the appropriate instruction queue. In the instruction decode (ID) stage 1768 the instruction may be decoded to determine an operation type (e.g., load, store, gather, scatter), base address/map stream, destination/source stream IDs, and control bits (e.g., stride, count, delays, etc.). The operand decode/dispatch (OD) stage 1770 may include the LSU/DS logic preparing operands—e.g., by selecting the correct address stream or immediate address, applying configured stride or iteration count, and aligning the target source/destination stream in the streaming register file. The first memory stage 1772 may generate physical RAM addresses from the logical address operands, including any loop/stride logic for multi-element tensors. The first memory stage 1772 may also resolve which memory slice 1720C, bank, and timing group will service each access, given the partitioned on-chip SRAM (e.g., 88 MEM slices across hemispheres). The second memory stage 1774 may perform the actual SRAM read or write in the targeted memory slice(s) 1730C. As an example, for loads, the processor 1700 may pull a 320-byte vector from SRAM and launch it as a physical stream on the appropriate logical stream ID, and for stores, the processor 1700 may consume a stream and writes its contents into SRAM addresses (including indirect/gather—scatter cases). The write back (WB) stage 1776 finalizes the operation at the streaming-register level—e.g., marking the destination stream as having new data (for loads/gathers) or completing the lifetime of a source stream once its data has been stored (for stores/scatters). From the programmer's view, this can be where the tensor “appears” on the target stream or is durably written back to on-chip global SRAM, ready for subsequent VXM/MXM/SXM instructions.

In some embodiments, VXM 1730D can consume operand streams sourced directly from MEM slices or produced by upstream MXM slices, with instructions dispatched from instruction control units (ICUs) 1736 such that vertically flowing instruction parcels intersect horizontally flowing data streams at precise, compiler-scheduled cycles. Results produced by VXM 1730D can be emitted onto eastward or westward streams and forwarded without intermediate storage to downstream functional slices, including SXM 1730B slices for lane permutation, transposition, or redistribution, or MEM 1730C slices for commitment to on-chip SRAM.

Instruction control units (ICUs) 1736 can be configured to provide deterministic instruction fetch, sequencing, and dispatch for a functionally sliced tensor-streaming processor architecture. The ICU 1736 can include a per-slice controller that fetches, decodes, and schedules instructions (VXM, MXM, MEM, SXM, etc.) and handles barriers and synchronization. In embodiments, each functional slice may have its own ICU, which fetches instructions from local SRAM into an instruction queue and issues them down the slice in a staggered fashion. The ICUs 1736 perform instruction fetch, decode, and parceling, while the tiles handle operand read, execute, and write back, which cleanly separates the instruction control from the data flow execution. The ICUs 1736 support control instructions such as IFETCH, NOP, SYNC, and NOTIFY, enabling barrier-style synchronization and waking/sleeping of the independent ICUs 1736 on chip so slices can coordinate without complex dynamic scheduling hardware.

In some embodiments, ICUs 1736 can be spatially separated from execution logic and can be architected such that instruction fetch, decode, and parceling are centralized while operand execution occurs in downstream functional slices. In some embodiments, ICUs 1736 can manage a plurality of independent instruction queues, each corresponding to a functional slice or slice row, thereby enabling single-instruction, multiple-data (SIMD) execution across vertically stacked tiles without reliance on dynamic scheduling, branch prediction, or speculative execution. Instruction streams can flow in a predetermined direction to intersect with horizontally flowing operand streams, enabling precise temporal and spatial coordination of instruction execution.

Tiles in a slice may execute instructions in a “staggered” fashion where instructions may be issued tile-by-tile within a slice over a period of N cycles. Functional slices may be arranged physically on-chip to allow efficient data-flow for pipelined execution across hundreds of cycles for common patterns. Data flows can perform a single “u-turn” (change in direction) corresponding to a single matrix operation before being written back to memory, in some embodiments, a particular data flow may change direction multiple times (due to multiple matrix and vector operations) before resulting data is written back into memory.

When using processor 1700 (e.g., TSP) having a functional slice architecture, TSP compiler (not shown) generates an explicit plan for how processor 1700 can execute a program (e.g., a microprogram). Compiler can specify when each operation will be executed, which functional slices will perform work, and which STREAM registers hold operands. Compiler can maintain a high-fidelity (cycle accurate) model of processor 1700 (e.g., TSP) hardware state so a microprogram can orchestrate data flow.

Processor 1700 (e.g., TSP) can use a Web-hosted compiler that takes as its input a model (e.g., a ML model such as, but not limited to, a TensorFlow model) and emits a proprietary instruction stream targeting processor 1700 (e.g., TSP). Compiler, in at least one embodiment, is responsible for coordinating control and data flow of a program, and specifies any instruction-level parallelism by explicitly bundling instructions that can and should execute concurrently so that they may be dispatched together. Primary hardware structure includes an architecturally-visible streaming register file (STREAMs), described in greater detail below, which serves as a conduit through which operands flow from MEM slices (e.g., SRAM) to functional slices and vice versa.

MEM 1720C or MEM 1730C of processor 1700 can serve as: (1) storage for model parameters, microprograms and data on which they operate, and (2) network-on-chip (NoC) for communicating data operands from MEM to functional slices and computed results back to MEM. In some embodiments, on-chip memory can consumes ≈75% of chip area of processor 1700. In some embodiments, due to bandwidth requirements of processor 1700, on-chip memory of MEM tiles may include SRAM, and not DRAM. On-chip memory capacity of processor 1700 can determine (i) number of ML models that can simultaneously reside on-chip, (ii) size of any given model, and (iii) partitioning of large models to fit into multi-chip systems. In some embodiments, MEM system of processor 1700 can provide a plurality of memory slices organized into two different hemispheres (referred to as “MEM WEST” and “MEM EAST”, respectively).

Memory slices of each hemisphere may be mirrored, such that slices may be physically numbered {0, . . . . L} in an East hemisphere, and {L, . . . 0} in a West hemisphere, such that memory slice 0 for each hemisphere corresponds to a slice closest to VXM slices between hemispheres, where each hemisphere comprises L slices. Direction of data transfer towards the center of a chip may be referred to as inwards, while data transfer toward the outer (Eastern or Western most) edge of a chip may be referred to as outwards. Although hemispheres of memory of processor 1700 may be referred to as east and west, it is understood that in other embodiments, other names may be used to refer to different hemispheres of memory.

In various embodiments, the processor 1700 may implement a flat memory hierarchy using on-chip global SRAM (comprised of the memory slices 1730C). To facilitate the continuous flow of data required for model (e.g., large language model (LLM), vision-language-action (VLA) model, multi-modal model, other types of model) inference, the processor 1700 may further comprise a plurality of streaming register files. These registers are configured to buffer and track the state of active tensors as they traverse the data transport lanes. The compiler allocates these registers in both space (specific physical locations) and time (specific clock cycles), allowing for the concurrent execution of memory operations and arithmetic computations without resource contention. Because the latency of the transport lanes and the execution units can be fixed and known at compile time, the processor ensures a predetermined temporal relationship between the arrival of an instruction at a functional unit and the arrival of the corresponding operand data. This configuration eliminates the need for runtime hardware arbitration, flow control signals, or data metadata (headers), thereby maximizing the silicon area and power budget available for arithmetic operations.

The intersection of an instruction stream and a data stream at a specific tile triggers an operation. Because the latency of the transport lanes can be fixed, the compiler can predict exactly where a piece of data will be at any given clock cycle (t). This eliminates the need for hardware “handshaking” or “ready” signals, as the data is guaranteed to be present when the instruction issues.

To accommodate workloads exceeding the capacity of a single processor 1700, such as trillion-parameter language models, the system employs a multi-processor system having a plesiochronous timing architecture where independent clocks are nominally the same frequency but may have slight phase drifts. In this configuration, a plurality of processors 1700 are interconnected via a direct-attached network (e.g., a Dragonfly topology) that does not require external switching hardware.

The system can be configured to synchronize the clock phases of the interconnected processors, establishing a global time base. This global synchronization permits the compiler to schedule data transfers across the inter-chip links with the same deterministic precision as intra-chip transfers. Consequently, a cluster of such processors 1700 can function as a single, logical synchronous compute fabric, where the latency of communication between any two nodes can be fixed and deterministic. This architecture significantly reduces tail latency and enables linear performance scaling for distributed tensor computations.

With respect to any processors in FIG. 17 and any components described above or elsewhere herein, one or more of APIs or equivalents described herein can, for example, get compiled into instructions or equivalents, which may be fetched by instruction fetch logic or equivalents, decoded by a processor decoder or equivalents, scheduled (e.g., in order or out of order) for execution by a scheduler or equivalents, executed by execution logic or equivalents, reordered, and then retired by retirement logic or equivalents. API(s) (and/or compiled instructions including API(s)) can be stored in any storage outside or inside of processor 1700 (e.g., in cache and/or memory). A result of API(s) can then be stored in storage within or outside of processor 1700, including registers, DRAM, flash, SRAM, cache, or other memory equivalents.

In some embodiments, the processor employs a software-defined deterministic execution model. The processor architecture may not contain any reactive hardware control structures—such as dynamic branch predictors, speculative execution logic, reorder buffers, and hardware-managed cache controllers—that introduce non-deterministic latency in conventional processors. Instead, the execution of the processor can be controlled by a compiler-generated schedule that explicitly defines the state of the processor at every clock cycle.

In at least one embodiment, processor 1700 can include circuitry (e.g., one or more circuits described above and elsewhere herein) to perform distributed computations for training and inference of a structure prediction model across multiple processors or otherwise perform any of the operations described above or elsewhere herein. One or more circuits can be configured by software to perform distributed computations for training and inference of a structure prediction model across multiple processors or otherwise perform any of the operations described above or elsewhere herein.

### Software Constructions

The following figures set forth, without limitation, examples of software constructs for implementing at least one embodiment.

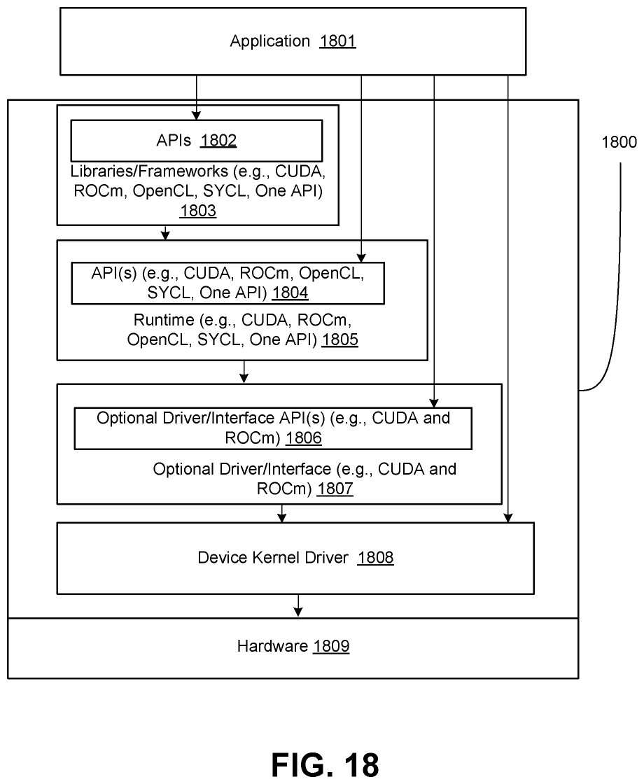

FIG. 18 illustrates a software stack of a programming platform, in accordance with at least one embodiment. A programming platform can include a platform for leveraging hardware on a computing system to accelerate computational tasks. A programming platform may be accessible to software developers through libraries, compiler directives, and/or extensions to programming languages, in at least one embodiment. A programming platform may be CUDA, Radeon Open Compute Platform (“ROCm”), OpenCL (OpenCL™ is developed by Khronos group), SYCL, Intel oneAPI, or another platform.

A software stack 1800 of a programming platform can provide an execution environment for an application 1801. Application 1801 may include any computer software capable of being launched on software stack 1800. Application 1801 may include an artificial intelligence (“AI”)/machine learning (“ML”) application, a high performance computing (“HPC”) application, a virtual desktop infrastructure (“VDI”), or a data center workload.

Application 1801 and software stack 1800 run on hardware 1808. Hardware 1808 may include one or more GPUs, CPUs, LPUs, FPGAs, AI engines, and/or other types of compute devices that support a programming platform. Software stack 1800 may be vendor specific and compatible with only devices from particular vendor(s), such as CUDA, ROCm, OneAPI, OpenCL, or other implementations. Hardware 1808 can include a host connected to one more devices that can be accessed to perform computational tasks via application programming interface (“API”) calls. A device within hardware 1808 may include hardware described in FIGS. 14-17B. API(s) (and/or compiled instructions including API(s)) can be stored in any storage outside or inside of hardware 1808 (e.g., in cache and/or memory). A result of API(s) can then be stored in storage within or outside of hardware 1808, including registers, DRAM, flash, SRAM, cache, or other memory. One or more of APIs described herein can receive a call. One or more of APIs described herein can communicate with a library or a portion of a library to perform a function described by the call. One or more of APIs described herein can receive a call and communicate with a library or portion of a library to perform a function described by the call.

Software stack 1800 of a programming platform can include a number of libraries 1803, a runtime 1805, an optional driver/interface 1807, and a device kernel driver 1808. Each of libraries 1803 may include data and programming code that can be used by computer programs and leveraged during software development. Libraries 1803 may include pre-written code and subroutines, classes, values, type specifications, configuration data, documentation, help data, and/or message templates. Libraries 1803 can include functions that may be optimized for execution on one or more types of devices. Libraries 1803 may include functions for performing mathematical, deep learning, and/or other types of operations on devices. Libraries 1803 can be associated with corresponding APIs 1802, which may include one or more APIs, that expose functions implemented in libraries 1803. A processor (e.g. CPU, GPU) may perform, call, or otherwise use one or more APIs to prioritize kernels. For example, a first kernel (e.g., parent) can launch a second kernel (e.g., child kernel), and said second kernel can be used by a processor to launch additional kernels (e.g., grandchildren kernels) independent of said first kernel. A processor may perform an API or calls an API from memory to be performed to support dynamic stream priority (e.g., updating priority while a stream is being used to perform operations). For example, when a processor performs said API, it allows a programmer to copy stream priority from one stream to one or more other streams.

Software stack 1800 may include one or more APIs to associate one or more instructions with one or more memory ordering operations, such as, but not limited to, a fence or membar operation. Instructions can be associated with one or more domains such that a memory ordering operation is executed in association to one or more particular domains without interfering with instructions of other domains. An API can indicate a thread has arrived (e.g., at a thread synchronization barrier), or finished a stage of work in relation to asynchronous data movement operations on a GPU. Software stack 1800 may include one or more to allow programmers to manually indicate an expected transaction count when a thread has finished a stage of work, which can be used to update an object that tracks whether all data movement operations for a set of threads may be complete.

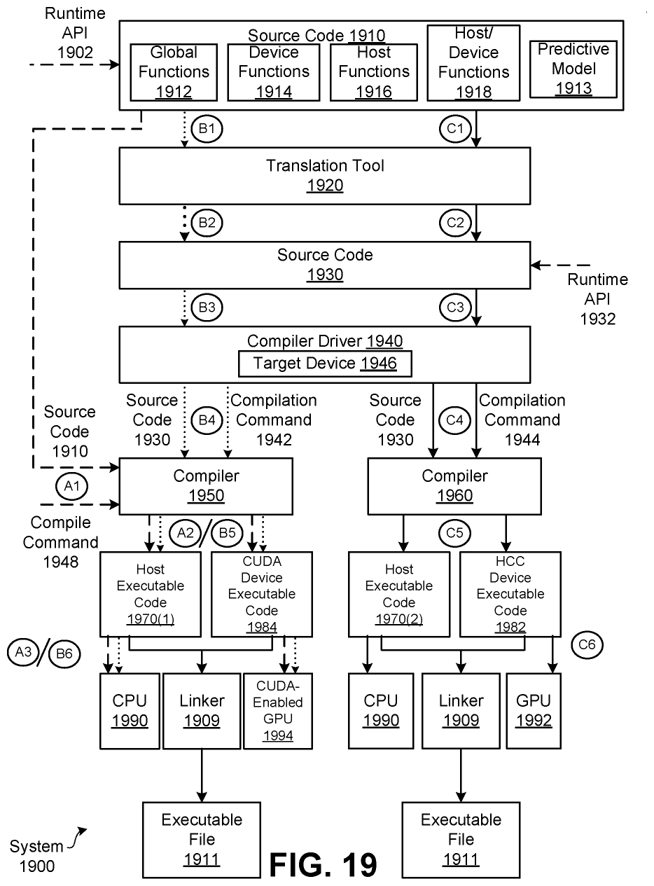

Application 1801 can be written as source code that is compiled into executable code, as discussed in greater detail below in conjunction with FIG. 19. Executable code of application 1801 may run, at least in part, on an execution environment provided by software stack 1800. During execution of application 1801, code may be reached that needs to run on a device, as opposed to a host. In such a case, runtime 1805 may be called to load and launch requisite code on a device. Runtime 1805 may include any technically feasible runtime system that is able to support execution of application 1801.

Runtime 1805 can be implemented as one or more runtime libraries associated with corresponding APIs, which are shown as API(s) 1804. One or more of such runtime libraries may include functions for memory management, execution control, device management, error handling, and/or synchronization, among other things. Memory management functions may include functions to allocate, deallocate, and copy device memory, as well as transfer data between host memory and device memory. Execution control functions may include functions to launch a function (sometimes referred to as a “kernel” when a function can be a global function callable from a host) on a device and set attribute values in a buffer maintained by a runtime library for a given function to be executed on a device.

Runtime libraries and corresponding API(s) 1804 may be implemented in any technically feasible manner. One (or any number of) API may expose a low-level set of functions for fine-grained control of a device, while another (or any number of) API may expose a higher-level set of such functions. A high-level runtime API may be built on top of a low-level API. One or more of runtime APIs may be language-specific APIs that may be layered on top of a language-independent runtime API.

An optional driver or interface 1807 may be implemented, e.g., for CUDA and ROCm implementations, that are described further below. Optional driver/interface 1807 may be associated with optional driver or interface API(s), such as, but not limited to, CUDA and/or ROCm API(s).

One or more processors disclosed in “processing systems” can perform, access, or otherwise use software stack 1800. For example, supercomputer 1300, system-on-a-chip 1400, parallel processor 1500, graphics multiprocessor 1534, processor 1600, processor 1700, accelerator 1500, neuromorphic processor 1401, accelerated processing unit 1424, tensor processing unit 1500, and language processing unit 1700 can perform, use, call, or otherwise implement (e.g., through accessing a memory) one or more APIs included in software stack 1800.

Device kernel driver 1808 can be configured to facilitate communication with an underlying device. Device kernel driver 1808 may provide low-level functionalities upon which APIs, such as, but not limited to, API(s) 1804, and/or other software relies. Device kernel driver 1808 may be configured to compile intermediate representation (“IR”) code into binary code at runtime. For CUDA or other implementations such as, but not limited to, ROCm, OneAPI, or OpenCL, device kernel driver 1808 may compile Parallel Thread Execution (“PTX”) IR code that is not hardware specific into binary code for a specific target device at runtime (with caching of compiled binary code), which is also sometimes referred to as “finalizing” code. Doing so may permit finalized code to run on a target device, which may not have existed when source code was originally compiled into PTX code. Alternatively, device source code may be compiled into binary code offline, without requiring device kernel driver 1808 to compile IR code at runtime.

Processors described elsewhere herein, such as, but not limited to, processors in FIGS. 14-17B can include circuitry (e.g., one or more circuits described above and elsewhere herein) to perform distributed computations for training and inference of a structure prediction model across multiple processors or otherwise perform any of the operations described above or elsewhere herein. One or more circuits can be configured by software, e.g., software stack 1800 to perform distributed computations for training and inference of a structure prediction model across multiple processors or otherwise perform any of the operations described above or elsewhere herein.

In accordance with at least one embodiment, software stack 1800 of FIG. 18 can be performed in a CUDA implementation. A CUDA software stack 1800, on which an application 1801 may be launched, may include CUDA libraries 1803, a CUDA runtime 1805, a CUDA driver 1807, and a device kernel driver 1808. CUDA software stack 1800 can execute on hardware (e.g., graphics multiprocessor 1534) that may include a GPU that supports CUDA and is developed by NVIDIA Corporation of Santa Clara, CA.

In accordance with at least one embodiment, software stack 1800 of FIG. 18 can be performed in a ROCm implementation. A ROCm software stack 1800, on which an application 1801 may be launched, includes a language runtime 1803, a system runtime 1805, a thunk 1807, and a ROCm kernel driver 1808. ROCm software stack 1800 executes on hardware 1809, which may include a GPU that supports ROCm and is developed by AMD Corporation of Santa Clara, CA.

Application 1801 may perform similar functionalities as discussed above in conjunction with FIG. 18. In addition, language runtime 1803 and system runtime 1805 may perform similar functionalities as runtime 1805 discussed above in conjunction with FIG. 18. Language runtime 1803 and system runtime 1805 may differ in that system runtime 1805 is a language-independent runtime that implements a ROCr system runtime API 1804 and makes use of a Heterogeneous System Architecture (“HSA”) Runtime API. HSA runtime API can include a thin, user-mode API that exposes interfaces to access and interact with an AMD GPU, including functions for memory management, execution control via architected dispatch of kernels, error handling, system and agent information, and runtime initialization and shutdown, among other things. In contrast to system runtime 1805, language runtime 1803 can be an implementation of a language-specific runtime API 1802 layered on top of ROCr system runtime API 1804. Language runtime API may include a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and a HIP language runtime API may include functions that may be similar to those of CUDA runtime API discussed above in conjunction with FIG. 18, such as, but not limited to, functions for memory management, execution control, device management, error handling, and synchronization, among other things.

Thunk (ROCt) 1807 can be an interface 1806 that can be used to interact with underlying ROCm driver 1808. ROCm driver 1808 can be a ROCK driver, which is a combination of an AMDGPU driver and a HSA kernel driver (amdkfd). AMDGPU driver can be a device kernel driver for GPUs developed by AMD that performs similar functionalities as device kernel driver 1808 discussed above in conjunction with FIG. 18. HSA kernel driver can be a driver permitting different types of processors to share system resources more effectively via hardware features.

Various libraries (not shown) may be included in ROCm software stack 1800 above language runtime 1803 and provide functionality similar to CUDA libraries 1803, discussed above in conjunction with FIG. 18. Various libraries may include mathematical, deep learning, and/or other libraries such as, but not limited to, a hipBLAS library that implements functions similar to those of CUDA cuBLAS, a rocFFT library for computing FFTs that is similar to CUDA cuFFT, among others.

Processors described elsewhere herein, such as, but not limited to, processors in FIGS. 14-17B can include circuitry (e.g., one or more circuits described above and elsewhere herein) to perform distributed computations for training and inference of a structure prediction model across multiple processors or otherwise perform any of the operations described above or elsewhere herein. One or more circuits can be configured by software, e.g., software stack 1800 to perform distributed computations for training and inference of a structure prediction model across multiple processors or otherwise perform any of the operations described above or elsewhere herein.

In accordance with at least one embodiment, software stack 1800 of FIG. 18 can be performed in an OpenCL implementation. An OpenCL software stack 1800, on which an application 1801 may be launched, can include an OpenCL framework 1803, an OpenCL runtime 1805, and a driver 1808. OpenCL software stack 1800 may execute on hardware 1809 that is not vendor-specific. As OpenCL is supported by devices developed by different vendors, specific OpenCL drivers may be required to interoperate with hardware from such vendors.

Application 1801, OpenCL runtime 1805, device kernel driver 1808, and hardware 1809 may perform similar functionalities as other implementations of application 1801, runtime 1805, device kernel driver 1808, and hardware 1809, respectively, that are discussed above in conjunction with FIG. 18. Application 1801 can further include an OpenCL kernel (not shown) with code that is to be executed on a device.

OpenCL may define a “platform” that allows a host to control devices connected to a host. An OpenCL framework can provide a platform layer API and a runtime API, shown as platform API 1802 and runtime API 1804. Runtime API 1804 can use contexts to manage execution of kernels on devices. Each identified device may be associated with a respective context, which runtime API 1804 may use to manage command queues, program objects, and kernel objects, share memory objects, among other things, for that device. Platform API 1802 can expose functions that permit device contexts to be used to select and initialize devices, submit work to devices via command queues, and enable data transfer to and from devices, among other things. In addition, OpenCL framework can provide various built-in functions (not shown), including math functions, relational functions, and image processing functions, among others.

In accordance with at least one embodiment, software can be supported by a programming platform that is configured to support various programming models, middlewares and/or libraries, and frameworks that an application may rely upon. Application may be an AI/ML application implemented using, for example, a deep learning framework such as, but not limited to, MXNet, PyTorch, or TensorFlow, which may rely on libraries such as, but not limited to, cuDNN, NVIDIA Collective Communications Library (“NCCL”), and/or NVIDA Developer Data Loading Library (“DALI”) CUDA libraries to provide accelerated computing on underlying hardware.

Programming platform may be one of a CUDA, ROCm, or OpenCL platform described above in conjunction with FIG. 18. Programming platform can support multiple programming models, which may be abstractions of an underlying computing system permitting expressions of algorithms and data structures. Programming models may expose features of underlying hardware in order to improve performance. Programming models may include CUDA, HIP, OpenCL, C++ Accelerated Massive Parallelism (“C++ AMP”), Open Multi-Processing (“OpenMP”), Open Accelerators (“OpenACC”), and/or Vulkan Compute.

Libraries and/or middlewares may provide implementations of abstractions of programming models. Such libraries can include data and programming code that may be used by computer programs and leveraged during software development. Such middlewares can include software that provides services to applications beyond those available from programming platform. Libraries and/or middlewares may include cuBLAS, cuFFT, cuRAND, and other CUDA libraries, or rocBLAS, rocFFT, rocRAND, and other ROCm libraries. In addition, libraries and/or middlewares may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

Application frameworks may depend on libraries and/or middlewares. Each of application frameworks can be a software framework used to implement a standard structure of application software. Returning to the AI/ML example discussed above, an AI/ML application may be implemented using a framework such as, but not limited to, Caffe, Caffe2, TensorFlow, Keras, PyTorch, or MxNet deep learning frameworks, for example.

In at least one embodiment, processors described elsewhere herein, such as, but not limited to, processors in FIGS. 14-17B can include circuitry (e.g., one or more circuits described above and elsewhere herein) to perform distributed computations for training and inference of a structure prediction model across multiple processors or otherwise perform any of the operations described above or elsewhere herein. One or more circuits can be configured by software, e.g., programming platforms described herein, to perform distributed computations for training and inference of a structure prediction model across multiple processors or otherwise perform any of the operations described above or elsewhere herein.

FIG. 19 illustrates a system 1900 configured to compile and execute source code 1910 using different types of processing units, in accordance with at least one embodiment. System 1900 includes first source code 1910 (e.g., CUDA source code), a first compiler 1950 (e.g., a CUDA compiler), first host executable code 1970(1), first device executable code 1984 (e.g., CUDA device executable code), a CPU 1990, a CUDA-enabled GPU 1994, a GPU 1992, a translation tool 1920 (e.g., a CUDA to HIP translation tool), second source code 1930 (e.g., HIP source code), a compiler driver 1940 (e.g., a HIP compiler driver), a second compiler 1960 (e.g., an HCC), second host executable code 1970(2), and second device executable code 1982 (e.g., HCC device executable code).

First source code 1910 may be a collection of human-readable code in a CUDA programming language. A CUDA programming language can be an extension of the C++ programming language that includes mechanisms to define device code and distinguish between device code and host code. Device code can include source code that, after compilation, is executable in parallel on a device. A device may be a processor that is optimized for parallel instruction processing, such as, but not limited to, CUDA-enabled GPU 1994, GPU 1992, or another GPGPU, etc. Host code can be source code that, after compilation, is executable on a host. A host can be a processor that is optimized for sequential instruction processing, such as, but not limited to, CPU 1990.

First source code 1910 can include any number (including zero) of global functions 1912, any number (including zero) of device functions 1914, any number (including zero) of host functions 1916, and any number (including zero) of host/device functions 1918. Global functions 1912, device functions 1914, host functions 1916, and host/device functions 1918 may be mixed in first source code 1910. Each of global functions 1912 may be executable on a device and callable from a host. One or more of global functions 1912 may therefore act as entry points to a device. Each of global functions 1912 can be a kernel. In a technique known as dynamic parallelism, one or more of global functions 1912 can define a kernel that is executable on a device and callable from such a device. A kernel can be executed N (where N is any positive integer) times in parallel by N different threads on a device during execution. First source code 1910 can include instructions for a predictive model, such as a predictive model described elsewhere herein.

Each of device functions 1914 can be executed on a device and callable from such a device only. Each of host functions 1916 can be executed on a host and callable from such a host only. Each of host/device functions 1918 may define both a host version of a function that is executable on a host and callable from such a host only and a device version of the function that is executable on a device and callable from such a device only.

First source code 1910 may also include any number of calls to any number of functions that may be defined via a first runtime API 1902 (e.g., a CUDA runtime API). First runtime API 1902 may include any number of functions that execute on a host to allocate and deallocate device memory, transfer data between host memory and device memory, manage systems with multiple devices, etc. First source code 1910 may also include any number of calls to any number of functions that may be specified in any number of CUDA APIs. A CUDA API may be any API that is designed for use by CUDA code. CUDA APIs can include first runtime API 1902, a CUDA driver API, APIs for any number of CUDA libraries, etc., including any API(s) described elsewhere herein. Relative to first runtime API 1902, a CUDA driver API can be a lower-level API but can provide finer-grained control of a device. Examples of CUDA libraries include cuBLAS, cuFFT, cuRAND, cuDNN, etc.

First compiler 1950 may compile input CUDA code (e.g., first source code 1910) to generate first host executable code 1970(1) and first device executable code 1984. First compiler 1950 may be, but is not limited to, NVCC. First host executable code 1970(1) can be a compiled version of host code included in input source code that is executable on CPU 1990. CPU 1990 may be any processor that is optimized for sequential instruction processing.

First device executable code 1984 may be a compiled version of device code included in input source code that is executable on CUDA-enabled GPU 1994. First device executable code 1984 may include binary code. First device executable code 1984 can include IR code, such as, but not limited to, PTX code, that is further compiled at runtime into binary code for a specific target device (e.g., CUDA-enabled GPU 1994) by a device driver. CUDA-enabled GPU 1994 may include any processor that is optimized for parallel instruction processing and that supports CUDA. CUDA-enabled GPU 1994 may be developed by NVIDIA Corporation of Santa Clara, CA.

Translation tool 1920 can be configured to translate First source code 1910 to functionally similar second source code 1930. Second source code 1930 may include a collection of human-readable code in a HIP programming language. A HIP programming language can include an extension of the C++ programming language that includes functionally similar versions of CUDA mechanisms to define device code and distinguish between device code and host code. A HIP programming language may include a subset of functionality of a CUDA programming language. For example, a HIP programming language includes mechanism(s) to define global functions 1912, but such a HIP programming language may lack support for dynamic parallelism and therefore global functions 1912 defined in HIP code may be callable from a host only.

Second source code 1930 may include any number (including zero) of global functions 1912, any number (including zero) of device functions 1914, any number (including zero) of host functions 1916, and any number (including zero) of host/device functions 1918. Second source code 1930 may include at least a portion of predictive model 1913. Second source code 1930 may also include any number of calls to any number of functions that may be specified in a second runtime API 1932 (e.g., a HIP runtime API). Second runtime API 1932 may include functionally similar versions of a subset of functions included in first runtime API 1902. Second source code 1930 may also include any number of calls to any number of functions that may be specified in any number of HIP APIs. A HIP API may be any API that is designed for use by HIP code and/or ROCm. HIP APIs may include second runtime API 1932, a HIP driver API, APIs for any number of HIP libraries, APIs for any number of ROCm libraries, etc.

A translation tool 1920 can convert each kernel call in CUDA code from a CUDA syntax to a HIP syntax and can convert any number of other CUDA calls in CUDA code to any number of other functionally similar HIP calls. A CUDA call can include a call to a function specified in a CUDA API, and a HIP call can include a call to a function specified in a HIP API. Translation tool 1920 may convert any number of calls to functions specified in runtime API 1902 to any number of calls to functions specified in second runtime API 1932.

Translation tool 1920 can include a tool known as hipify-perl that executes a text-based translation process. Translation tool 1920 can include a tool known as hipify-clang that, relative to hipify-perl, executes a more complex and more robust translation process that involves parsing CUDA code using clang (a compiler front-end) and then translating resulting symbols. Converting CUDA code to HIP code may include modifications (e.g., manual edits) in addition to those performed by translation tool 1920.

Compiler driver 1940 can include a front end that determines a target device 1946 and then configures a compiler that is compatible with target device 1946 to compile second source code 1930 (e.g., generated via translation of first source code 1910 by translation tool 1920). Target device 1946 can include a processor that is optimized for parallel instruction processing. Compiler driver 1940 may determine target device 1946 in any technically feasible fashion.

If target device 1946 is compatible with CUDA (e.g., CUDA-enabled GPU 1994), then compiler driver 1940 can generate a first compilation command 1942 (e.g., a HIP/NVCC compilation command). First compilation command 1942 can configure first compiler 1950 to compile second source code 1930 using a HIP to CUDA translation header and a CUDA runtime library. In response to first compilation command 1942, first compiler 1950 may generate first host executable code 1970(1) and first device executable code 1984.

If target device 1946 is not compatible with CUDA, then compiler driver 1940 may generate a second compilation command 1944 (e.g., a HIP/HCC compilation command). Second compilation command 1944 can configure second compiler 1960 to compile second source code 1930 using an HCC header and a HIP/HCC runtime library. In response to second compilation command 1944, second compiler 1960 may generate second host executable code 1970(2) and second device executable code 1982. Second device executable code 1982 may be a compiled version of device code included in second source code 1930 that is executable on GPU 1992. GPU 1992 may be any processor that is optimized for parallel instruction processing, is not compatible with CUDA, and is compatible with HCC. GPU 1992 can be developed by AMD Corporation of Santa Clara, CA. GPU 1992 can include a non-CUDA-enabled GPU 1992.

For explanatory purposes only, three different flows that may be implemented in at least one embodiment to compile first source code 1910 for execution on CPU 1990 and different devices are depicted in FIG. 19. A direct CUDA flow can compile first source code 1910 for execution on CPU 1990 and CUDA-enabled GPU 1994 without translating first source code 1910 to second source code 1930. An indirect CUDA flow can translate first source code 1910 to second source code 1930 and then compiles second source code 1930 for execution on CPU 1990 and CUDA-enabled GPU 1994. A CUDA/HCC flow can translate first source code 1910 to second source code 1930 and then can compile second source code 1930 for execution on CPU 1990 and GPU 1992.

A direct CUDA flow that may be implemented is depicted via dashed lines and a series of bubbles annotated A1-A3. As depicted with bubble annotated A1, first compiler 1950 can receive first source code 1910 and a compile command 1948 that can configure first compiler 1950 to compile first source code 1910. First source code 1910 that can be used in a direct CUDA flow can be written in a CUDA programming language that is based on a programming language other than C++ (e.g., C, Fortran, Python, Java, etc.). In response to compile command 1948, first compiler 1950 can generate first host executable code 1970(1) and first device executable code 1984 (depicted with bubble annotated A2). As depicted with bubble annotated A3, first host executable code 1970(1) and first device executable code 1984 may be executed on, respectively, CPU 1990 and CUDA-enabled GPU 1994. First device executable code 1984 can include binary code. First device executable code 1984 can include PTX code and can be further compiled into binary code for a specific target device at runtime.

An indirect CUDA flow that may be implemented is depicted via dotted lines and a series of bubbles annotated B1-B6. As depicted with bubble annotated B1, translation tool 1920 can receive first source code 1910. As depicted with bubble annotated B2, translation tool 1920 can translate first source code 1910 to second source code 1930. As depicted with bubble annotated B3, compiler driver 1940 can receive second source code 1930 and can determine that target device 1946 is CUDA-enabled.

As depicted with bubble annotated B4, compiler driver 1940 can generate first compilation command 1942 and can transmit both first compilation command 1942 and second source code 1930 to first compiler 1950. First compilation command 1942 can configure first compiler 1950 to compile second source code 1930 using a HIP to CUDA translation header and a CUDA runtime library. The HIP to CUDA translation header can translate any number of mechanisms (e.g., functions) specified in any number of HIP APIs to any number of mechanisms specified in any number of CUDA APIs. First compiler 1950 may use HIP to CUDA translation header in conjunction with a CUDA runtime library corresponding to first runtime API 1902 to generate first host executable code 1970(1) and first device executable code 1984. In response to first compilation command 1942, first compiler 1950 can generate first host executable code 1970(1) and first device executable code 1984 (depicted with bubble annotated B5). As depicted with bubble annotated B6, first host executable code 1970(1) and first device executable code 1984 may be executed on, respectively, CPU 1990 and CUDA-enabled GPU 1994. First device executable code 1984 can include binary code. First device executable code 1984 can include PTX code and can be further compiled into binary code for a specific target device at runtime.

A CUDA/HCC flow that may be implemented is depicted via solid lines and a series of bubbles annotated C1-C6. As depicted with bubble annotated C1, translation tool 1920 can receive first source code 1910. As depicted with bubble annotated C2, translation tool 1920 can translate first source code 1910 to second source code 1930. As depicted with bubble annotated C3, compiler driver 1940 can receive second source code 1930 and can determine that target device 1946 is not CUDA-enabled.

Compiler driver 1940 may generate second compilation command 1944 and may transmit both second compilation command 1944 and second source code 1930 to second compiler 1960 (depicted with bubble annotated C4). Second compilation command 1944 can configure second compiler 1960 to compile second source code 1930 using an HCC header and a HIP/HCC runtime library. HIP/HCC runtime library can correspond to second runtime API 1932. HCC header may include any number and type of interoperability mechanisms for HIP and HCC. In response to second compilation command 1944, second compiler 1960 can generate second host executable code 1970(2) and second device executable code 1982 (depicted with bubble annotated C5). As depicted with bubble annotated C6, second host executable code 1970(2) and second device executable code 1982 may be executed on, respectively, CPU 1990 and GPU 1992.

After first source code 1910 is translated to second source code 1930, compiler driver 1940 may subsequently be used to generate executable code for either CUDA-enabled GPU 1994 or GPU 1992 without re-executing translation tool 1920. Translation tool 1920 can translate first source code 1910 to second source code 1930 that is then stored in memory. Compiler driver 1940 can then configure second compiler 1960 to generate second host executable code 1970(2) and second device executable code 1982 based on second source code 1930. In at least one embodiment, compiler driver 1940 subsequently configures first compiler 1950 to generate first host executable code 1970(1) and first device executable code 1984 based on stored second source code 1930.

An example kernel may be translated by translation tool 1920 of FIG. 19, in accordance with at least one embodiment. First source code 1910 can partition an overall problem that a given kernel is designed to solve into relatively coarse sub-problems that can independently be solved using thread blocks. Each thread block includes any number of threads. Each sub-problem can be partitioned into relatively fine pieces that can be solved cooperatively in parallel by threads within a thread block. Threads within a thread block can cooperate by sharing data through shared memory and by synchronizing execution to coordinate memory accesses.

First source code 1910 can organize thread blocks associated with a given kernel into a one-dimensional, a two-dimensional, or a three-dimensional grid of thread blocks. Each thread block includes any number of threads, and a grid includes any number of thread blocks.

A kernel can be a function in device code that is defined using a “_global_” declaration specifier. The dimension of a grid that executes a kernel for a given kernel call and associated streams may be specified using a CUDA kernel launch syntax. CUDA kernel launch syntax can be specified as “KernelName<<<GridSize, BlockSize, SharedMemorySize, Stream>>>(KernelArguments);”. An execution configuration syntax can include a “<<< . . . >>>” construct that is inserted between a kernel name (“KernelName”) and a parenthesized list of kernel arguments (“KernelArguments”). CUDA kernel launch syntax can include a CUDA launch function syntax instead of an execution configuration syntax.

“GridSize” can be of a type dim3 and specify the dimension and size of a grid. Type dim3 may be a CUDA-defined structure that includes unsigned integers x, y, and z. If z is not specified, then z may default to one. If y is not specified, then y may default to one. The number of thread blocks in a grid can be equal to the product of GridSize.x, GridSize.y, and GridSize.z. “BlockSize” can be of type dim3 and specify the dimension and size of each thread block. The number of threads per thread block may be equal to the product of BlockSize.x, BlockSize.y, and BlockSize.z. Each thread that executes a kernel may be given a unique thread ID that is accessible within the kernel through a built-in variable (e.g., “threadIdx”).

With respect to CUDA kernel launch syntax, “SharedMemorySize” may be an optional argument that may specify a number of bytes in a shared memory that is dynamically allocated per thread block for a given kernel call in addition to statically allocated memory. With respect to CUDA kernel launch syntax, SharedMemorySize may default to zero. With respect to CUDA kernel launch syntax, “Stream” may be an optional argument that specifies an associated stream and defaults to zero to specify a default stream. A stream may be a sequence of commands (possibly issued by different host threads) that execute in order. Different streams may execute commands out of order with respect to one another or concurrently.

First source code 1910 may include a kernel definition for an example kernel “MatAdd” and a main function. Main function may be host code that executes on a host and includes a kernel call that causes kernel MatAdd to execute on a device. Kernel MatAdd can add two matrices A and B of size N×N, where N is a positive integer, and store the result in a matrix C. Main function can define a threadsPerBlock variable as 16 by 16 and a numBlocks variable as N/16 by N/16. Main function can then specify kernel call “MatAdd<<<numBlocks, threadsPerBlock>>>(A, B, C);”. As per CUDA kernel launch syntax, kernel MatAdd can be executed using a grid of thread blocks having a dimension N/16 by N/16, where each thread block has a dimension of 16 by 16. Each thread block can include 256 threads, a grid can be created with enough blocks to have one thread per matrix element, and each thread in such a grid may execute kernel MatAdd to perform one pair-wise addition.

While translating first source code 1910 to second source code 1930, translation tool 1920 may translate each kernel call in first source code 1910 from CUDA kernel launch syntax to a HIP kernel launch syntax and may convert any number of other CUDA calls in first source code 1910 to any number of other functionally similar HIP calls. HIP kernel launch syntax can be specified as “hipLaunchKernelGGL(KernelName, GridSize, BlockSize, SharedMemorySize, Stream, KernelArguments);”. Each of KernelName, GridSize, BlockSize, ShareMemorySize, Stream, and KernelArguments can have the same meaning in HIP kernel launch syntax as in CUDA kernel launch syntax (described previously herein). Arguments SharedMemorySize and Stream can be required in HIP kernel launch syntax and can be optional in CUDA kernel launch syntax.

A portion of second source code 1930 can be identical to a portion of first source code 1910 depicted except for a kernel call that causes kernel MatAdd to execute on a device. Kernel MatAdd may be defined in second source code 1930 with the same “_global_” declaration specifier with which kernel MatAdd is defined in first source code 1910. A kernel call in second source code 1930 may be “hipLaunchKernelGGL(MatAdd, numBlocks, threadsPerBlock, 0, 0, A, B, C);”, while a corresponding kernel call in first source code 1910 is “MatAdd<<<numBlocks, threadsPerBlock>>>(A, B, C);”.

Code may be compiled to execute on one of programming platforms of FIG. 19 described above, in accordance with at least one embodiment. The compiler for the processor can have access to information that indicates the hardware configuration of the processor, and configures the timing of data and instruction flows such that corresponding data and instructions are received at each tile with a predetermined temporal relationship. The compiler may work with any processors disclosed within FIG. 14-17B. As such, operand data can be transmitted between the slices of the processor without any accompanying metadata. Instead, each slice can be able to determine what operations to perform on received data based upon the timing at which the data is received.

In some embodiments, a compiler for the processor has information indicating the hardware configuration of the processor, and synchronizes the timing of data and instruction flows such that corresponding data and instructions are received at each tile with a predetermined temporal relationship (e.g., during the same cycle, separated by a predetermined delay, etc.). In some embodiments, the predetermined temporal relationship may be based upon the hardware of the processor, a type of instruction, and/or the like. Because the temporal relationship between when data and instructions are received is known, the operand data received by a tile may not need to include any metadata indicating what the data is to be used for. Instead, each tile may receive instructions, and based upon the predetermined timing, perform the instruction on the corresponding data. This may allow for the data and instructions to flow through the processor more efficiently.

A compiler (e.g., first compiler 1950 or second compiler 1960) can be configured to receive source code (e.g., first source code 1910 or second source code 1930), compile the source code, and output an executable file 1911. The compiler can be configured to convert the source code into host executable code (e.g., first host executable code 1970(1) or second host executable code 1970(2)) for execution on a host and device executable code (e.g., first device executable code 1984 or second device executable code 1982) for execution on a device (e.g., CUDA-enabled GPU 1994 or GPU 1992). The source code may either be compiled offline prior to execution of an application, or online during execution of an application. The source code may include code in any programming language supported by the compiler, such as, but not limited to, C++, C, Fortran, etc. The source code may be included in a single-source file having a mixture of host code and device code, with locations of device code being indicated therein. A single-source file may be a .cu file that includes CUDA code or a .hip.cpp file that includes HIP code or a file in another format that includes both host code and device code. Alternatively, the source code may include multiple source code files, rather than a single-source file, into which host code and device code may be separated. The compiler includes or has access to one or more libraries to recognize a sequence of API calls to perform a single fused API, where a single fused API is a combined API for two or more APIs. In at least one embodiment, the compiler may be an NVIDIA CUDA compiler (“NVCC”) for compiling CUDA code in .cu files, or a HCC compiler for compiling HIP code in .hip.cpp files, or other compilers.

The compiler can include a compiler front end, a host compiler, and a device compiler. The compiler front end can be configured to separate device code from host code in the source code. The device code may be compiled by the device compiler into the device executable code, which as described may include binary code or IR code, in at least one embodiment. Separately, the host code may be compiled by the host compiler into the host executable code. For NVCC other compilers, such as, but not limited to, those for oneAPI, ROCm, and OpenCL, the host compiler may be a general purpose C/C++ compiler that outputs native object code, while the device compiler may be a Low Level Virtual Machine (“LLVM”)-based compiler that forks a LLVM compiler infrastructure and outputs PTX code or binary code. For HCC, both the host compiler and the device compiler may be LLVM-based compilers that output target binary code.

Subsequent to compiling the source code into the host executable code and the device executable code, a linker 1909 (e.g., included in the compiler or receiving an output from the compiler) can link the host executable code and the device executable code together in executable file 1911. Native object code for a host and PTX or binary code for a device may be linked together in an Executable and Linkable Format (“ELF”) file, which is a container format used to store object code. The host executable code and the device executable code may be in any suitable format, such as, but not limited to, binary code and/or IR code. In the case of CUDA, the host executable code may include native object code and the device executable code may include code in PTX intermediate representation, in at least one embodiment. In the case of ROCm, both the host executable code and the device executable code may include target binary code, in at least one embodiment. Other implementations, such as, but not limited to, oneAPI and OpenCL are contemplated and can be performed similarly to the CUDA and ROCm implementations above.

The source code may be translated prior to compiling source code. Source code can be passed through a translation tool (e.g., translation tool 1920), which translates the source code into translated source code. The compiler can be used to compile translated source code into the host executable code and the device executable code in a process that is similar to compilation of the source code by the compiler into the host executable code and the device executable code, as discussed above in conjunction with FIG. 19.

One or more techniques described herein can utilize a oneAPI programming model. A oneAPI programming model can refer to a programming model for interacting with various compute accelerator architectures. OneAPI may refer to an application programming interface (API) designed to interact with various compute accelerator architectures. A oneAPI programming model may utilize a DPC++ programming language. A DPC++ programming language may refer to a high-level language for data parallel programming productivity. A DPC++ programming language can be based at least in part on C and/or C++ programming languages. A oneAPI programming model can be a programming model such as, but not limited to, those developed by Intel Corporation of Santa Clara, CA.

OneAPI and/or oneAPI programming model can be utilized to interact with various accelerator, GPU, processor, and/or variations thereof, architectures. OneAPI may include a set of libraries that implement various functionalities. OneAPI may include at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

A oneAPI DPC++ library, also referred to as oneDPL, can be a library that implements algorithms and functions to accelerate DPC++ kernel programming. OneDPL may implement one or more standard template library (STL) functions. OneDPL can implement one or more parallel STL functions. OneDPL can provide a set of library classes and functions such as, but not limited to, parallel algorithms, iterators, function object classes, range-based API, and/or variations thereof. OneDPL can implement one or more classes and/or functions of a C++ standard library. OneDPL can implement one or more random number generator functions.

A oneAPI math kernel library, also referred to as oneMKL, can be a library that implements various optimized and parallelized routines for various mathematical functions and/or operations. OneMKL can implement one or more basic linear algebra subprograms (BLAS) and/or linear algebra package (LAPACK) dense linear algebra routines. OneMKL may implement one or more sparse BLAS linear algebra routines. OneMKL can implement one or more random number generators (RNGs). OneMKL may implement one or more vector mathematics (VM) routines for mathematical operations on vectors. OneMKL may implement one or more Fast Fourier Transform (FFT) functions.

A oneAPI data analytics library, also referred to as oneDAL, can include a library that implements various data analysis applications and distributed computations. OneDAL can implement various algorithms for preprocessing, transformation, analysis, modeling, validation, and decision making for data analytics, in batch, online, and distributed processing modes of computation. OneDAL can implement various C++ and/or Java APIs and various connectors to one or more data sources. OneDAL may implement DPC++ API extensions to a traditional C++ interface and enables GPU usage for various algorithms.

A oneAPI deep neural network library, also referred to as oneDNN, can include a library that implements various deep learning functions. OneDNN may implement various neural network, machine learning, and deep learning functions, algorithms, and/or variations thereof.

A oneAPI collective communications library, also referred to as oneCCL, can include a library that implements various applications for deep learning and machine learning workloads. OneCCL can be built upon lower-level communication middleware, such as, but not limited to, message passing interface (MPI) and libfabrics. OneCCL can enable a set of deep learning specific optimizations, such as, but not limited to, prioritization, persistent operations, out of order executions, and/or variations thereof. OneCCL can implement various CPU and GPU functions.

A oneAPI threading building blocks library, also referred to as oneTBB, can include a library that implements various parallelized processes for various applications. OneTBB can be utilized for task-based, shared parallel programming on a host. OneTBB may implement generic parallel algorithms. OneTBB may implement concurrent containers. OneTBB may implement a scalable memory allocator. OneTBB may implement a work-stealing task scheduler. OneTBB may implement low-level synchronization primitives. OneTBB may be compiler-independent and usable on various processors, such as, but not limited to, GPUs, PPUs, CPUs, and/or variations thereof.

A oneAPI video processing library, also referred to as oneVPL, can include a library that is utilized for accelerating video processing in one or more applications. OneVPL can implement various video decoding, encoding, and processing functions. OneVPL can implement various functions for media pipelines on CPUs, GPUs, and other accelerators. OneVPL can implement device discovery and selection in media centric and video analytics workloads. OneVPL can implement API primitives for zero-copy buffer sharing.

A oneAPI programming model may utilize a DPC++ programming language. A DPC++ programming language can include a programming language that can include functionally similar versions of CUDA mechanisms to define device code and distinguish between device code and host code. A DPC++ programming language may include a subset of functionality of a CUDA programming language. One or more CUDA programming model operations may be performed using a oneAPI programming model using a DPC++ programming language.

Any application programming interface (API) described herein can be compiled into one or more instructions, operations, or any other signal by a compiler, interpreter, or other software tool. Compilation can include generating one or more machine-executable instructions, operations, or other signals from source code. An API compiled into one or more instructions, operations, or other signals, when performed, can cause one or more processors such as, but not limited to, processors described, e.g., in FIGS. 14-17B, or any other logic circuit further described herein to perform one or more computing operations.

In at least one embodiment, translation tools described elsewhere herein, such as, but not limited to, can include circuitry (e.g., one or more circuits described above and elsewhere herein) to translate CUDA code to perform distributed computations for training and inference of a structure prediction model across multiple processors to HIP, oneAPI, OpenCL, or any other language used to perform any of the operations described above or elsewhere herein. One or more circuits can be configured by software to translate CUDA code to perform distributed computations for training and inference of a structure prediction model across multiple processors to HIP, oneAPI, OpenCL, or any other language used to perform any of the operations described above or elsewhere herein.

### Logic and Neural Network Training and Deployment

The following figures set forth, without limitation, examples of logic and artificial intelligence-based systems that can be used to implement functionality and/or operations described herein.

FIGS. 20A and 20B illustrate logic 2015 which, as described elsewhere herein, can be used in one or more devices or systems (e.g., such as any of the processors in FIGS. 14-17B), data centers, cloud or web-based services described herein) to perform operations such as, but not limited to, those discussed herein, in accordance with at least one embodiment. Logic can refer to any combination of software logic, hardware logic, and/or firmware logic to provide functionality and/or operations described herein, wherein logic may be, collectively or individually, embodied as circuitry that forms part of a larger system, for example, an integrated circuit (IC), an application-specific integrated circuit (ASIC), a field programmable array (FPGA), system-on-chip (SoC), or one or processors (e.g., CPU, GPU). Logic 2015 illustrated in FIGS. 20A and 20B may be used in conjunction with an application-specific integrated circuit (“ASIC”), such as, but not limited to, those in FIGS. 14-17B.

Logic 2015 can be used to perform inferencing and/or training operations associated with one or more embodiments. Logic 2015 may be inference and/or training logic. In at least one embodiment, FIG. 20A illustrates inference and/or training logic 2015 used to perform inferencing and/or training operations associated with one or more embodiments. Inference and/or training logic 2015 may include code and/or data storage 2001 to store forward and/or output weight and/or input/output data, and/or other parameters to configure neurons or layers of a neural network trained and/or used for inferencing in aspects of one or more embodiments. Training logic 2015 may include, or be coupled to code and/or data storage 2001 to store graph code or other software to control timing and/or order, in which weight and/or other parameter information is to be loaded to configure, logic, including integer and/or floating point units (collectively, arithmetic logic units (ALUs). Code, such as, but not limited to, graph code, can load weight or other parameter information into processor ALUs based on an architecture of a neural network to which such code corresponds. Code and/or data storage 2001 can store weight parameters and/or input/output data of each layer of a neural network trained or used in conjunction with one or more embodiments during forward propagation of input/output data and/or weight parameters during training and/or inferencing using aspects of one or more embodiments. Any portion of code and/or data storage 2001 may be included with other on-chip or off-chip data storage, including a processor's L1, L2, or L3 cache or system memory.

Any portion of code and/or data storage 2001 may be internal or external to one or more processors or other hardware logic devices or circuits. Code and/or code and/or data storage 2001 may be cache memory, dynamic randomly addressable memory (“DRAM”), static randomly addressable memory (“SRAM”), non-volatile memory (e.g., flash memory), or other storage. A choice of whether code and/or code and/or data storage 2001 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

Inference and/or training logic 2015 may include a code and/or data storage 2005 to store backward and/or output weight and/or input/output data corresponding to neurons or layers of a neural network trained and/or used for inferencing in aspects of one or more embodiments. Code and/or data storage 2005 can store weight parameters and/or input/output data of each layer of a neural network trained or used in conjunction with one or more embodiments during backward propagation of input/output data and/or weight parameters during training and/or inferencing using aspects of one or more embodiments. Training logic 2015 may include, or be coupled to code and/or data storage 2005 to store graph code or other software to control timing and/or order, in which weight and/or other parameter information is to be loaded to configure, logic, including integer and/or floating point units (collectively, arithmetic logic units (ALUs).

Code, such as, but not limited to, graph code, may cause loading of weight or other parameter information into processor ALUs based on an architecture of a neural network to which such code corresponds. Any portion of code and/or data storage 2005 may be included with other on-chip or off-chip data storage, including a processor's L1, L2, or L3 cache or system memory. Any portion of code and/or data storage 2005 may be internal or external to one or more processors or other hardware logic devices or circuits. Code and/or data storage 2005 may be cache memory, DRAM, SRAM, non-volatile memory (e.g., flash memory), or other storage. A choice of whether code and/or data storage 2005 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

Code and/or data storage 2001 and code and/or data storage 2005 may be separate storage structures. Code and/or data storage 2001 and code and/or data storage 2005 may be a combined storage structure. Code and/or data storage 2001 and code and/or data storage 2005 may be partially combined and partially separate. Any portion of code and/or data storage 2001 and code and/or data storage 2005 may be included with other on-chip or off-chip data storage, including a processor's L1, L2, or L3 cache or system memory.

Inference and/or training logic 2015 may include one or more arithmetic logic unit(s) (“ALU(s)”) 2010, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 2020 that may be functions of input/output and/or weight parameter data stored in code and/or data storage 2001 and/or code and/or data storage 2005. Activations stored in activation storage 2020 may be generated according to linear algebraic and or matrix-based mathematics performed by ALU(s) 2010 in response to performing instructions or other code, wherein weight values stored in code and/or data storage 2005 and/or data storage 2001 may be used as operands along with other values, such as, but not limited to, bias values, gradient information, momentum values, or other parameters or hyperparameters, any or all of which may be stored in code and/or data storage 2005 or code and/or data storage 2001 or another storage on or off-chip.

ALU(s) 2010 can be included within one or more processors or other hardware logic devices or circuits, whereas in another embodiment, ALU(s) 2010 may be external to a processor or other hardware logic device or circuit that uses them (e.g., a co-processor). ALUs 2010 may be included within a processor's execution units or otherwise within a bank of ALUs accessible by a processor's execution units either within same processor or distributed between different processors of different types (e.g., central processing units, graphics processing units, fixed function units, etc.). Code and/or data storage 2001, code and/or data storage 2005, and activation storage 2020 may share a processor or other hardware logic device or circuit, whereas in another embodiment, they may be in different processors or other hardware logic devices or circuits, or some combination of same and different processors or other hardware logic devices or circuits. Any portion of activation storage 2020 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

Activation storage 2020 may be cache memory, DRAM, SRAM, non-volatile memory (e.g., flash memory), or other storage. Activation storage 2020 may be completely or partially within or external to one or more processors or other logical circuits. A choice of whether activation storage 2020 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 2015 illustrated in FIG. 20A may be used in conjunction with an application-specific integrated circuit (“ASIC”), such as, but not limited to, a TensorFlow® Processing Unit from Google, an inference processing unit (IPU) from Graphcore™, or a Nervana® (e.g., “Lake Crest”) processor from Intel Corp. In at least one embodiment, inference and/or training logic 2015 illustrated in FIG. 20A may be used in conjunction with hardware similar to FIGS. 14-17B.

In FIG. 20B, for example, each of code and/or data storage 2001 and code and/or data storage 2005 is associated with a dedicated computational resource, such as, but not limited to, computational hardware 2002 and computational hardware 2006, respectively. Each of computational hardware 2002 and computational hardware 2006 can include one or more ALUs that perform mathematical functions, such as, but not limited to, linear algebraic functions, only on information stored in code and/or data storage 2001 and code and/or data storage 2005, respectively, result of which is stored in activation storage 2020.

Each of code and/or data storage 2001 and 2005 and corresponding computational hardware 2002 and 2006, respectively, correspond to different layers of a neural network, such that resulting activation from one storage/computational pair 2001/2002 of code and/or data storage 2001 and computational hardware 2002 is provided as an input to a next storage/computational pair 2005/2006 of code and/or data storage 2005 and computational hardware 2006, in order to mirror a conceptual organization of a neural network. Each of storage/computational pairs 2001/2002 and 2005/2006 may correspond to more than one neural network layer. Additional storage/computation pairs (not shown) subsequent to or in parallel with storage/computation pairs 2001/2002 and 2005/2006 may be included in inference and/or training logic 2015.

In at least one embodiment, logic 2015 described elsewhere herein, can include circuitry (e.g., one or more circuits described above and elsewhere herein) to perform distributed computations for training and inference of a structure prediction model across multiple processors or otherwise perform any of the operations described above or elsewhere herein. One or more circuits in logic 2015 can be configured by software described herein, to perform distributed computations for training and inference of a structure prediction model across multiple processors or otherwise perform any of the operations described above or elsewhere herein.

FIG. 20C illustrates training and deployment of a deep neural network, in accordance with at least one embodiment. An untrained neural network 2026 can be trained using a training dataset 2022. A training framework 2024 can be a PyTorch framework, and/or training framework 2024 can include a TensorFlow, Boost, Caffe, Microsoft Cognitive Toolkit/CNTK, MXNet, Chainer, Keras, Deeplearning4j, or other training framework. Training framework 2024 can train an untrained neural network 2026 and enables it to be trained using processing resources described herein to generate a trained neural network 2028. Weights may be chosen randomly or by pre-training using a deep belief network. Training may be performed in either a supervised, partially supervised, or unsupervised manner.

Untrained neural network 2026 can be trained using supervised learning, wherein training dataset 2022 includes an input paired with a desired output for an input, or where training dataset 2022 includes input having a known output and an output of neural network 2026 is manually graded. Untrained neural network 2026 can be trained in a supervised manner and processes inputs from training dataset 2022 and compares resulting outputs against a set of expected or desired outputs. Errors can then be propagated back through untrained neural network 2026. Training framework 2024 can adjust weights that control untrained neural network 2026. Training framework 2024 can include tools to monitor how well untrained neural network 2026 is converging towards a model, such as, but not limited to, trained neural network 2028, suitable to generating correct answers, such as, but not limited to, in result 2032, based on input data such as, but not limited to, a new dataset 2030. Training framework 2024 can train untrained neural network 2026 repeatedly while adjust weights to refine an output of untrained neural network 2026 using a loss function and adjustment algorithm, such as, but not limited to, stochastic gradient descent. Training framework 2024 can train untrained neural network 2026 until untrained neural network 2026 achieves a desired accuracy. Trained neural network 2028 can then be deployed to implement any number of machine learning operations.

Untrained neural network 2026 can be trained using unsupervised learning, wherein untrained neural network 2026 attempts to train itself using unlabeled data. Unsupervised learning training dataset 2022 can include input data without any associated output data or “ground truth” data. Untrained neural network 2026 can learn groupings within training dataset 2022 and can determine how individual inputs may be related to untrained dataset 2022. Unsupervised training can be used to generate a self-organizing map in trained neural network 2028 capable of performing operations useful in reducing dimensionality of new dataset 2030. Unsupervised training can also be used to perform anomaly detection, which allows identification of data points in new dataset 2030 that deviate from normal patterns of new dataset 2030.

Semi-supervised learning may be used, which is a technique in which in training dataset 2022 includes a mix of labeled and unlabeled data. Training framework 2024 may be used to perform incremental learning, such as, but not limited to, through transferred learning techniques. Incremental learning can enable trained neural network 2028 to adapt to new dataset 2030 without forgetting knowledge instilled within trained neural network 2028 during initial training.

Training framework 2024 can include a framework processed in connection with a software development toolkit such as, but not limited to, an OpenVINO (Open Visual Inference and Neural network Optimization) toolkit. An OpenVINO toolkit can include a toolkit such as, but not limited to, those developed by Intel Corporation of Santa Clara, CA.

OpenVINO can include a toolkit for facilitating development of applications, specifically neural network applications, for various tasks and operations, such as, but not limited to, human vision emulation, speech recognition, natural language processing, recommendation systems, and/or variations thereof. OpenVINO can support neural networks such as, but not limited to, convolutional neural networks (CNNs), recurrent and/or attention-based neural networks, and/or various other neural network models. OpenVINO can support various software libraries such as, but not limited to, OpenCV, OpenCL, and/or variations thereof.

OpenVINO can support neural network models for various tasks and operations, such as, but not limited to, classification, segmentation, object detection, face recognition, speech recognition, pose estimation (e.g., humans and/or objects), monocular depth estimation, image inpainting, style transfer, action recognition, colorization, and/or variations thereof.

OpenVINO can include one or more software tools and/or modules for model optimization, also referred to as a model optimizer. A model optimizer can include a command line tool that facilitates transitions between training and deployment of neural network models. A model optimizer may optimize neural network models for execution on various devices and/or processing units, such as, but not limited to, a GPU, CPU, PPU, GPGPU, and/or variations thereof. A model optimizer can generate an internal representation of a model, and can optimize said model to generate an intermediate representation. A model optimizer may reduce a number of layers of a model. A model optimizer can remove layers of a model that may be utilized for training. A model optimizer may perform various neural network operations, such as, but not limited to, modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as, but not limited to, floating point, to a second representation, such as, but not limited to, integer), and/or variations thereof.

OpenVINO can include one or more software libraries for inferencing, also referred to as an inference engine. An inference engine can include a C++ library, or any suitable programming language library. An inference engine can be utilized to infer input data. An inference engine may implement various classes to infer input data and generate one or more results. An inference engine can implement one or more API functions to process an intermediate representation, set input and/or output formats, and/or execute a model on one or more devices.

OpenVINO may provide various abilities for heterogeneous execution of one or more neural network models. Heterogeneous execution, or heterogeneous computing, can refer to one or more computing processes and/or systems that utilize one or more types of processors and/or cores. OpenVINO can provide various software functions to execute a program on one or more devices. OpenVINO may provide various software functions to execute a program and/or portions of a program on different devices. OpenVINO may provide various software functions to, for example, run a first portion of code on a CPU and a second portion of code on a GPU and/or FPGA. OpenVINO may provide various software functions to execute one or more layers of a neural network on one or more devices (e.g., a first set of layers on a first device, such as, but not limited to, a GPU, and a second set of layers on a second device, such as, but not limited to, a CPU).

OpenVINO can include various functionality similar to functionalities associated with a CUDA programming model, such as, but not limited to, various neural network model operations associated with frameworks such as, but not limited to, TensorFlow, PyTorch, and/or variations thereof. One or more CUDA programming model operations may be performed using OpenVINO. Various systems, methods, and/or techniques described herein may be implemented using Open VINO.

In at least one embodiment, circuitry (e.g., one or more circuits described above and elsewhere herein) can be used to cause one or more neural networks and training frameworks described elsewhere herein to perform distributed computations for training and inference of a structure prediction model across multiple processors or otherwise perform any of the operations described above or elsewhere herein. One or more neural networks and training frameworks can be configured by software to perform distributed computations for training and inference of a structure prediction model across multiple processors or otherwise perform any of the operations described above or elsewhere herein.

In at least one embodiment, computing system 1300, processors described in FIGS. 2-5B, software stack 1800, and logic 2015 may be deployed in a variety of operational environments including cloud computing platforms, autonomous vehicles, robotic systems, edge computing systems, and combinations thereof. These deployment environments may leverage the same or similar computing architectures, processors, interconnects, and software constructs described above to perform distributed computation, machine learning training, machine learning inference, sensor processing, or control operations.

In at least one embodiment, computing system 1300 may be implemented as part of a cloud computing infrastructure that provides scalable compute resources to remote clients over one or more networks. For example, computing system 1300 may correspond to a node or group of nodes within a cloud service provider infrastructure including, but not limited to, public clouds, private clouds, hybrid clouds, or distributed edge clouds.

In such embodiments, CPUs, GPUs, DPUs, LPUs, and other processors described herein may execute software workloads associated with artificial intelligence services, data analytics services, distributed databases, web services, media processing services, or high-performance computing tasks. Resource orchestrator 1335, job scheduler 1323, configuration manager 1325, and resource manager 1327 may allocate processing resources across nodes in response to service requests received from clients (e.g., processing devices 1302, 1304) over network 1330. For example, application(s) 1343 may include cloud-based machine learning inference services, speech recognition services, image analysis services, recommendation engines, or generative artificial intelligence services that operate on data submitted by remote clients.

In at least one embodiment, trained neural network models produced using training framework 2024 and deployed as trained neural network 2028 may be executed within such cloud infrastructures using processors described in FIGS. 2-5B. GPUs, LPUs, tensor processors, or other accelerators may perform parallel inference operations on batches of incoming requests, while DPUs or NICs may offload networking, storage virtualization, and security functions to improve overall data center efficiency.

In at least one embodiment, processors described herein may be incorporated into autonomous or semi-autonomous vehicle platforms. For example, system-on-chip 1400, parallel processor 1500, or processor 1700 may be integrated into an onboard compute module of a vehicle, such as an automobile, a truck, a drone, an aircraft, a marine vessel, or other autonomous or semi-autonomous platforms.

Such systems may receive input from one or more sensors including cameras, LiDAR sensors, radar sensors, ultrasonic sensors, inertial measurement units (IMUs), global navigation satellite systems (GNSS), or other environmental sensing devices. Sensor data may be processed using machine learning models executed by GPUs, LPUs, NPUs, tensor processors, or other accelerators described herein to perform perception, localization, mapping, object detection, semantic segmentation, trajectory prediction, or path planning operations.

In at least one embodiment, inference and/or training logic 2015 may execute neural network models that interpret sensor data to identify objects, determine drivable space, or estimate motion of surrounding entities. Outputs of these models may be provided to vehicle control logic that determines steering, braking, acceleration, or navigation actions. In some implementations, high-bandwidth memory architectures, high-speed interconnects, or specialized matrix processing units described herein may accelerate inference workloads associated with real-time perception systems.

In at least one embodiment, vehicle systems may communicate with remote computing systems, such as cloud-based implementations of computing system 1300, to upload training data, receive updated models, or participate in distributed training processes. For example, vehicle-collected sensor datasets may be transmitted to a data center where training framework 2024 may retrain or otherwise update neural networks using aggregated fleet data, and updated model parameters may subsequently be deployed back to vehicles for improved performance.

In at least one embodiment, processors and computing architectures described herein may be implemented in robotic systems including industrial robots, service robots, collaborative robots (cobots), warehouse robots, medical robots, agricultural robots, or mobile robots.

Robotic platforms may utilize processors such as SOC 1400, parallel processor 300, or processor 1700 to perform perception, control, and decision-making tasks. For example, robotic systems may execute machine learning models that perform object detection, grasp planning, scene understanding, human interaction recognition, or navigation in dynamic environments. In at least one embodiment, machine learning models executed by the robotic system for inference may be trained using GPU-accelerated software (e.g., CUDA-based or other training platforms) executed on processors described herein.

In at least one embodiment, sensor data from cameras, depth sensors, force sensors, or tactile sensors may be processed using inference logic implemented on GPUs, LPUs, NPUs, or other accelerators described herein. Neural network inference may generate control signals for robotic actuators including motors, grippers, articulated arms, or locomotion systems.

In some implementations, robotic systems may operate within distributed computing environments in which some computation occurs locally on embedded processors while other computation occurs remotely (e.g., in computing system 1300). For example, latency-sensitive inference tasks may execute locally on an onboard GPU, LPU, or NPU, while large-scale model training or global environment mapping may be performed in a remote data center.

In at least one embodiment, computing architectures described herein may be deployed in edge computing systems positioned between cloud data centers and end devices. Edge nodes may include processors such as SOC 1400 or GPU- or LPU-based systems (e.g., incorporating parallel processor 1500 or processor 1700) that provide localized computation for applications requiring reduced latency, reduced bandwidth usage, or improved reliability.

Examples of such edge deployments include intelligent transportation infrastructure, smart city monitoring systems, automated warehouses, retail analytics platforms, healthcare monitoring systems, and telecommunications edge infrastructure. Edge systems may process sensor data locally using machine learning models and communicate summarized or processed data to centralized cloud systems.

In these deployments, the combination of CPUs, GPUs, LPUs, NPUs, DPUs, and other accelerators described herein may enable efficient execution of distributed machine learning workloads, real-time analytics, and inference services across heterogeneous computing environments.

Accordingly, processors, computing systems, and software stacks described herein may be implemented in cloud computing platforms, autonomous vehicle systems, robotic systems, and edge computing environments, among other applications. These environments may leverage the parallel processing capabilities, high-bandwidth interconnects, and machine learning acceleration features described herein to perform complex computational tasks including training and deployment of neural networks, real-time sensor processing, and distributed data analysis. In at least one embodiment, cloud-based and/or web-based services and/or systems that can be used to perform distributed computations for training and inference of a structure prediction model across multiple processors or otherwise perform some or all of processes, operations and/or and techniques described above or elsewhere herein. Additionally, cloud-based and/or web-based services and/or systems can be configured by software to perform distributed computations for training and inference of a structure prediction model across multiple processors or otherwise perform any of the operations described above or elsewhere herein. In at least one embodiment, autonomous vehicle systems and/or robotic systems can include circuitry (e.g., one or more circuits described above and elsewhere herein) to perform distributed computations for training and inference of a structure prediction model across multiple processors or otherwise perform any of the operations described above or elsewhere herein. Additionally, one or more circuits in autonomous vehicle systems and/or robotic systems can be configured by software, e.g., programming platforms described herein, to perform distributed computations for training and inference of a structure prediction model across multiple processors or otherwise perform any of the operations described above or elsewhere herein.

At least one embodiment of the disclosure can be described in view of the following clauses:
1. One or more processors comprising circuitry to: generate, for a triangle attention computation, a local query block from a local block of a pair-representation tensor, the pair-representation tensor being partitioned into local blocks across a two-dimensional GPU mesh along a first pair axis and a second pair axis; and retain the local query block during a sequence of communication steps of the triangle attention computation; prior to a first communication step in the sequence of communication steps of the triangle attention computation, perform a first redistribution step that shifts triangle-bias data along a first mesh axis of the two-dimensional GPU mesh by an offset based on the GPU's coordinate on a second mesh axis of the two-dimensional GPU mesh, and perform a second redistribution step that shifts resulting triangle-bias data along the second mesh axis of the two-dimensional GPU mesh by an offset based on the GPU's coordinate on a first mesh axis of the two-dimensional GPU mesh, to store a triangle-bias block for use at the first communication step in the sequence of communication steps; during the sequence of communication steps, receive key blocks and value blocks along the first mesh axis and receive triangle-bias blocks along the second mesh axis such that, at each communication step in the sequence of communication steps, a received key block and a received triangle-bias block correspond to the same query-key comparisons as the local query block; compute, based on the local query block and the received key blocks, value blocks, and triangle-bias blocks, local triangle attention contributions for a local output block corresponding to the local query block; and generate the local output block corresponding to the local query block, wherein the local output block is generated based on the local triangle attention contributions by accumulating the local triangle attention contributions.
2. The one or more processors of clause 1, wherein subsequent shifts of the key blocks and the value blocks along the first mesh axis and of the triangle-bias blocks along the second mesh axis preserve per-step alignment across later communication steps such that, at each later communication step, a received key block and a received triangle-bias block correspond to the same query-key comparisons as the local query block.
3. The one or more processors of any of clauses 1-2, wherein computing and accumulating the local triangle attention contributions for the local output block comprises, for a communication step, computing attention scores based on the local query block and a received key block, adding a received triangle-bias block to the attention scores prior to softmax normalization, applying softmax normalization to the attention scores to generate attention weights, and generating a local triangle attention contribution based on the attention weights and a received value block.
4. The one or more processors of any of clauses 1-3, wherein the circuitry is further to receive communicated mask blocks aligned with the same query-key comparisons as the local query block, receive the communicated mask blocks along the first mesh axis with the key blocks and value blocks, compute attention scores based on the local query block and a received key block, and add the communicated mask blocks to the attention scores prior to softmax normalization.
5. The one or more processors of any of clauses 1-4, wherein the circuitry is further to compute, for a communication step, local normalization information for softmax normalization, the local normalization information comprising a local maximum-score value and a local logarithm of a sum of exponentials of values obtained by subtracting the local maximum-score value from respective attention scores after addition of a received triangle-bias block and, where used, a received mask block.
6. The one or more processors of any of clauses 1-5, wherein the circuitry is further to maintain, across the sequence of communication steps, a local normalization state for softmax normalization, the local normalization state comprising a maximum-score value maintained across the sequence of communication steps and a logarithm of a sum of exponentials of attention-score differences maintained across the sequence of communication steps.
7. The one or more processors of any of clauses 1-6, wherein the circuitry is further to update the local normalization state for a communication step by combining local normalization information for the communication step with a previously maintained local normalization state.
8. The one or more processors of any of clauses 1-7, wherein the circuitry is further to update the local output block by rescaling a previously generated local output block and a current local triangle attention contribution using the local normalization state, and combining the rescaled previously generated local output block and the rescaled current local triangle attention contribution.
9. A method, comprising: generating, for a triangle attention computation on a GPU of a two-dimensional GPU mesh, a local query block from a local shard of a pair-representation tensor, and retaining the local query block during successive communication steps of the triangle attention computation; prior to a first communication step, shifting triangle-bias data along a first mesh axis by an offset based on an index of the GPU along a second mesh axis, and shifting resulting triangle-bias data along the second mesh axis by an offset based on an index of the GPU along the first mesh axis to store a triangle-bias block aligned with query-key comparisons for the local query block; during the successive communication steps, receiving key blocks and value blocks along the first mesh axis and receiving triangle-bias blocks along the second mesh axis such that, at each of the successive communication steps, a received key block and a received triangle-bias block correspond to the same query-key comparisons as the local query block; and computing and accumulating local triangle attention contributions for a local output block based on the local query block, the received key blocks, the received value blocks, and the received triangle-bias blocks.
10. The method of clause 9, further comprising performing the triangle attention computation without transmitting the local query block from the GPU to another GPU of the two-dimensional GPU mesh.
11. The method of any of clauses 9-10, further comprising enqueueing communication for a subsequent communication step concurrently with computing a local triangle attention contribution for a current communication step using double-buffered receive buffers for at least the key blocks, the value blocks, and the triangle-bias blocks.
12. The method of any of clauses 9-11, further comprising deriving the triangle-bias block from the pair-representation tensor by a linear projection that converts feature-channel information of the pair-representation tensor into additive bias values for respective attention heads and respective query-key pairs of the triangle attention computation.
13. The method of any of clauses 9-12, wherein the triangle attention computation is a starting-node triangle attention computation in which the local query block is indexed along a first pair axis and the key blocks and the value blocks are indexed along a second pair axis.
14. The method of any of clauses 9-13, wherein the triangle attention computation is an ending-node triangle attention computation, the method further comprising transposing the local shard of the pair-representation tensor across a first pair axis and a second pair axis prior to the successive communication steps and transposing the local output block back after the successive communication steps.
15. A system, comprising: one or more processors to: generate, for a triangle attention computation on a GPU of a two-dimensional GPU mesh, a local query block from a local shard of a pair-representation tensor, and retain the local query block during successive communication steps of the triangle attention computation; prior to a first communication step, shift triangle-bias data along a first mesh axis by an offset based on an index of the GPU along a second mesh axis, and shift resulting triangle-bias data along the second mesh axis by an offset based on an index of the GPU along the first mesh axis to store a triangle-bias block aligned with query-key comparisons for the local query block; during the successive communication steps, receive key blocks and value blocks along the first mesh axis and receive triangle-bias blocks along the second mesh axis such that, at each of the successive communication steps, a received key block and a received triangle-bias block correspond to the same query-key comparisons as the local query block; and compute and accumulate local triangle attention contributions for a local output block based on the local query block, the received key blocks, the received value blocks, and the received triangle-bias blocks.
16. The system of clause 15, wherein the one or more processors are further to, during a backward pass for the triangle attention computation, receive stored key blocks, value blocks, and triangle-bias blocks through successive communication steps corresponding to the communication schedule of the forward pass, accumulate a local query-gradient corresponding to the local query block, and receive and transmit key-gradient blocks, value-gradient blocks, and triangle-bias-gradient blocks during the successive communication steps.
17. The system of any of clauses 15-16, wherein the one or more processors are further to, during a backward pass for the triangle attention computation, compute a local query-gradient, key-gradient blocks, value-gradient blocks, and triangle-bias-gradient blocks using saved forward-pass normalization information corresponding to a distributed softmax merge.
18. The system of any of clauses 15-17, wherein the one or more processors are further to, after successive communication steps of a backward pass for the triangle attention computation, perform a first bias-gradient restoration step that reverses shifting of triangle-bias data along the second mesh axis and perform a second bias-gradient restoration step that reverses shifting of triangle-bias data along the first mesh axis.
19. The system of any of clauses 15-18, wherein computing and accumulating the local triangle attention contributions for the local output block comprises, for a communication step, computing attention scores based on the local query block and a received key block, adding a received triangle-bias block to the attention scores prior to softmax normalization, applying softmax normalization to the attention scores to generate attention weights, and generating a local triangle attention contribution based on the attention weights and a received value block.
20. The system of any of clauses 15-19, wherein the one or more processors are further to, after successive communication steps of a backward pass for the triangle attention computation, perform a key-gradient and value-gradient restoration operation that returns key-gradient data and value-gradient data to devices corresponding to forward-pass ownership of key data and value data.
21. One or more processors comprising circuitry to: generate, for a triangle multiplication computation, a local first tensor block from a local block of a first input tensor and a local second tensor block from a local block of a second input tensor, wherein the one or more processors are of a GPU in a two-dimensional GPU mesh, and wherein the first input tensor and the second input tensor are pair-derived tensors derived from a pair-representation tensor; receive a redistributed tensor block, the redistributed tensor block being aligned on a shared sequence-position dimension with a local tensor block corresponding to the other input tensor for contraction over the shared sequence-position dimension, wherein the redistributed tensor block corresponds to the first input tensor or the second input tensor according to whether the triangle multiplication computation is an outgoing variant or an incoming variant; compute, based on the redistributed tensor block and the local tensor block, a local multiply-and-accumulate contribution; and generate an updated local output block by accumulating the local multiply-and-accumulate contribution with a previously generated local output block.
22. The one or more processors of clause 21, wherein the redistributed tensor block is generated by transposing ownership of blocks of the corresponding input tensor across the two-dimensional GPU mesh.
23. The one or more processors of any of clauses 21-22, wherein the redistributed tensor block is received subsequent to a row-wise initial shift of left-hand-side operand blocks and a column-wise initial shift of right-hand-side operand blocks that align the operand blocks on the shared sequence-position dimension before a first communication step.
24. The one or more processors of any of clauses 21-23, wherein the triangle multiplication computation is an outgoing variant, the redistributed tensor block corresponds to the second input tensor, and the shared sequence-position dimension is a second sequence-position dimension of each of the first input tensor and the second input tensor.
25. The one or more processors of any of clauses 21-24, wherein the triangle multiplication computation is an incoming variant, the redistributed tensor block corresponds to the first input tensor, and the shared sequence-position dimension is a first sequence-position dimension of each of the first input tensor and the second input tensor.
26. The one or more processors of any of clauses 21-25, wherein the first input tensor and the second input tensor are pair-derived tensors obtained from a pair-representation tensor having a batch dimension, a first sequence-position dimension, a second sequence-position dimension, and a feature dimension, each of the first input tensor and the second input tensor having the batch dimension, the first sequence-position dimension, the second sequence-position dimension, and the feature dimension.
27. The one or more processors of any of clauses 21-26, wherein the local first tensor block and the local second tensor block comprise local slices of the pair-derived tensors sharded across two orthogonal mesh axes, each local slice spanning a subset of the first sequence-position dimension and a subset of the second sequence-position dimension.
28. The one or more processors of any of clauses 21-27, wherein the updated local output block is generated without performing a collective all-gather of either input tensor and without performing a collective all-reduce of an output of the triangle multiplication computation.
29. A method comprising: generating, for a triangle multiplication computation, a local first tensor block from a local block of a first input tensor and a local second tensor block from a local block of a second input tensor, wherein the method is performed by one or more processors of a GPU in a two-dimensional GPU mesh, and wherein the first input tensor and the second input tensor are pair-derived tensors derived from a pair-representation tensor; receiving a redistributed tensor block, the redistributed tensor block being aligned on a shared sequence-position dimension with a local tensor block corresponding to the other input tensor for contraction over the shared sequence-position dimension, wherein the redistributed tensor block corresponds to the first input tensor or the second input tensor according to whether the triangle multiplication computation is an outgoing variant or an incoming variant; computing, based on the redistributed tensor block and the local tensor block, a local multiply-and-accumulate contribution; and generating an updated local output block by accumulating the local multiply-and-accumulate contribution into a previously generated local output block.
30. The method of clause 29, further comprising, before a first communication step of the triangle multiplication computation, shifting left-hand-side operand blocks along GPU rows by row-coordinate-based offsets and shifting right-hand-side operand blocks along GPU columns by column-coordinate-based offsets to align the operand blocks on the shared sequence-position dimension.
31. The method of any of clauses 29-30, further comprising initiating communication for a subsequent communication step while computing the local multiply-and-accumulate contribution for a current communication step using double-buffered receive buffers.
32. The method of any of clauses 29-31, wherein generating the local first tensor block and the local second tensor block comprises applying an input normalization operation, one or more linear projections, a sigmoid-activated gate, and a pair mask to a local block of a pair-representation tensor.
33. The method of any of clauses 29-32, wherein the triangle multiplication computation is an outgoing variant, and computing the local multiply-and-accumulate contribution comprises combining a first input tensor value indexed by a first output sequence position and a second sequence-position dimension with a second input tensor value indexed by a second output sequence position and the second sequence-position dimension.
34. The method of any of clauses 29-33, wherein the triangle multiplication computation is an incoming variant, and computing the local multiply-and-accumulate contribution comprises combining a first input tensor value indexed by a first sequence-position dimension and a first output sequence position with a second input tensor value indexed by the first sequence-position dimension and a second output sequence position.
35. A system comprising: one or more processors configured to: generate, for a triangle multiplication computation, a local first tensor block from a local block of a first input tensor and a local second tensor block from a local block of a second input tensor, wherein the one or more processors are of a GPU in a two-dimensional GPU mesh, and wherein the first input tensor and the second input tensor are pair-derived tensors derived from a pair-representation tensor; receive a redistributed tensor block, the redistributed tensor block being aligned on a shared sequence-position dimension with a local tensor block corresponding to the other input tensor for contraction over the shared sequence-position dimension, wherein the redistributed tensor block corresponds to the first input tensor or the second input tensor according to whether the triangle multiplication computation is an outgoing variant or an incoming variant; compute, based on the redistributed tensor block and the local tensor block, a local multiply-and-accumulate contribution; and generate an updated local output block by accumulating the local multiply-and-accumulate contribution with a previously generated local output block.
36. The system of clause 35, wherein, during a backward pass, the one or more processors are further configured to cast an upstream output gradient to a data type matching saved forward-pass operand data, perform first and second distributed batched matrix multiplications to generate first and second operand-gradient blocks, concatenate the first and second operand-gradient blocks along a feature dimension, and generate an input gradient and a gate gradient from the concatenated operand-gradient blocks.
37. The system of any of clauses 35-36, wherein the one or more processors are further configured to use a same row-wise and column-wise ring-communication primitive for the triangle multiplication computation, for a first backward distributed batched matrix multiplication, and for a second backward distributed batched matrix multiplication.
38. The system of any of clauses 35-37, wherein, during a backward pass for an outgoing variant, the one or more processors are further configured to redistribute an arrangement of the upstream output gradient when generating a gradient corresponding to the second input tensor.
39. The system of any of clauses 35-38, wherein, during a backward pass for an incoming variant, the one or more processors are further configured to redistribute an arrangement of the upstream output gradient when generating a gradient corresponding to the first input tensor.
40. The system of any of clauses 35-39, wherein each backward distributed batched matrix multiplication includes, prior to repeated communication steps, an optional transpose communication, a row-wise initial shift, and a column-wise initial shift that align currently resident blocks on a same partition of a contraction dimension used in the backward pass.
41. One or more processors, comprising: circuitry to: receive, during successive communication steps on a GPU of a two-dimensional GPU mesh, aligned distributed value blocks derived from a sequence-alignment representation and aligned distributed weight blocks derived from a pair-representation tensor, the aligned distributed value blocks and the aligned distributed weight blocks being for the same weighted-averaging computation over a shared sequence-position axis and being distributed according to different sharding arrangements on the two-dimensional GPU mesh; compute, from currently aligned ones of the aligned distributed value blocks and the aligned distributed weight blocks, a local weighted-averaging contribution and local normalization information; update a local normalization state across the successive communication steps based on the local normalization information; and generate a local output block for the weighted-averaging computation based on the local weighted-averaging contribution and the local normalization state.
42. The one or more processors of clause 41, wherein computing the local weighted-averaging contribution comprises applying a softmax normalization to the weight blocks along the shared sequence-position axis to generate local weights and applying the local weights to the value blocks, and wherein the local normalization information comprises a local maximum-score value and a local logarithm of a sum of exponentials of values obtained by subtracting the local maximum-score value from respective weighting values.
43. The one or more processors of any of clauses 41-42, wherein the circuitry is further to redistribute the weight blocks prior to the weighted-averaging computation by transferring a weight block owned by a GPU having a first coordinate on a first mesh axis and a second coordinate on a second mesh axis to a GPU having a second coordinate on the first mesh axis and the first coordinate on the second mesh axis.
44. The one or more processors of any of clauses 41-43, wherein the circuitry is further to, after redistributing the weight blocks and prior to a first communication step, circularly shift value blocks along a row axis by an offset based on a column-axis coordinate and circularly shift redistributed weight blocks along a column axis by an offset based on a row-axis coordinate.
45. The one or more processors of any of clauses 41-44, wherein the value blocks are derived from a sequence-alignment representation having a batch dimension, an aligned-sequence dimension, a sequence-position dimension, and a channel dimension, and wherein the weight blocks are derived from a pair-representation tensor having a batch dimension, a first sequence-position dimension, a second sequence-position dimension, and a head dimension.
46. The one or more processors of any of clauses 41-45, wherein the value blocks are sharded on the two-dimensional GPU mesh over the aligned-sequence dimension and the sequence-position dimension, and wherein the weight blocks are sharded on the two-dimensional GPU mesh over the first sequence-position dimension and the second sequence-position dimension.
47. The one or more processors of any of clauses 41-46, wherein the circuitry is further to, during a backward pass, shift post-softmax weight blocks along a second mesh axis, shift output-gradient blocks and softmax-correction data along a first mesh axis, accumulate a local value gradient, accumulate weight-gradient contributions via a virtual all-reduce across successive communication steps, and, after the successive communication steps, restore weight-gradient ownership to devices corresponding to original ownership of pair-representation blocks from which the weight blocks were derived.
48. A method, comprising: receiving, during successive communication steps on a GPU of a two-dimensional GPU mesh, aligned distributed value blocks derived from a sequence-alignment representation and aligned distributed weight blocks derived from a pair-representation tensor, the aligned distributed value blocks and the aligned distributed weight blocks being for the same weighted-averaging computation over a shared sequence-position axis and being distributed according to different sharding arrangements on the two-dimensional GPU mesh; computing, from currently aligned ones of the aligned distributed value blocks and the aligned distributed weight blocks, a local weighted-averaging contribution and local normalization information; updating a local normalization state across the successive communication steps based on the local normalization information; and generating a local output block for the weighted-averaging computation based on the local weighted-averaging contribution and the local normalization state.
49. The method of clause 48, wherein computing the local weighted-averaging contribution comprises applying a softmax normalization to the weight blocks along the shared sequence-position axis to generate local weights and applying the local weights to the value blocks, and wherein the local normalization information comprises a local maximum-score value and a local logarithm of a sum of exponentials of values obtained by subtracting the local maximum-score value from respective weighting values.
50. The method of any of clauses 48-49, further comprising, prior to a first communication step, redistributing the weight blocks by transferring a weight block owned by a GPU having a first coordinate on a first mesh axis and a second coordinate on a second mesh axis to a GPU having a second coordinate on the first mesh axis and the first coordinate on the second mesh axis, circularly shifting value blocks along a row axis by an offset based on a column-axis coordinate, and circularly shifting redistributed weight blocks along a column axis by an offset based on a row-axis coordinate.
51. The method of any of clauses 48-50, further comprising, during a backward pass, shifting post-softmax weight blocks along a second mesh axis, shifting output-gradient blocks and softmax-correction data along a first mesh axis, accumulating a local value gradient, accumulating weight-gradient contributions via a virtual all-reduce across successive communication steps, and, after the successive communication steps, restoring weight-gradient ownership to devices corresponding to original ownership of pair-representation blocks from which the weight blocks were derived.
52. The method of any of clauses 48-51, wherein the value blocks are derived from a sequence-alignment representation having a batch dimension, an aligned-sequence dimension, a sequence-position dimension, and a channel dimension, and wherein the weight blocks are derived from a pair-representation tensor having a batch dimension, a first sequence-position dimension, a second sequence-position dimension, and a head dimension.
53. The method of any of clauses 48-52, wherein the value blocks are sharded on the two-dimensional GPU mesh over the aligned-sequence dimension and the sequence-position dimension, and wherein the weight blocks are sharded on the two-dimensional GPU mesh over the first sequence-position dimension and the second sequence-position dimension.
54. A system, comprising: one or more processors to: receive, during successive communication steps on a GPU of a two-dimensional GPU mesh, aligned distributed value blocks derived from a sequence-alignment representation and aligned distributed weight blocks derived from a pair-representation tensor, the aligned distributed value blocks and the aligned distributed weight blocks being for the same weighted-averaging computation over a shared sequence-position axis and being distributed according to different sharding arrangements on the two-dimensional GPU mesh; compute, from currently aligned ones of the aligned distributed value blocks and the aligned distributed weight blocks, a local weighted-averaging contribution and local normalization information; update a local normalization state across the successive communication steps based on the local normalization information; and generate a local output block for the weighted-averaging computation based on the local weighted-averaging contribution and the local normalization state.
55. The system of clause 54, wherein computing the local weighted-averaging contribution comprises applying a softmax normalization to the weight blocks along the shared sequence-position axis to generate local weights and applying the local weights to the value blocks, and wherein the local normalization information comprises a local maximum-score value and a local logarithm of a sum of exponentials of values obtained by subtracting the local maximum-score value from respective weighting values.
56. The system of any of clauses 54-55, wherein the one or more processors are further to redistribute the weight blocks prior to the weighted-averaging computation by transferring a weight block owned by a GPU having a first coordinate on a first mesh axis and a second coordinate on a second mesh axis to a GPU having a second coordinate on the first mesh axis and the first coordinate on the second mesh axis.
57. The system of any of clauses 54-56, wherein the one or more processors are further to, after redistributing the weight blocks and prior to a first communication step, circularly shift value blocks along a row axis by an offset based on a column-axis coordinate and circularly shift redistributed weight blocks along a column axis by an offset based on a row-axis coordinate.
58. The system of any of clauses 54-57, wherein the one or more processors are further to, during a backward pass, shift post-softmax weight blocks along a second mesh axis, shift output-gradient blocks and softmax-correction data along a first mesh axis, accumulate a local value gradient, accumulate weight-gradient contributions via a virtual all-reduce across successive communication steps, and, after the successive communication steps, restore weight-gradient ownership to devices corresponding to original ownership of pair-representation blocks from which the weight blocks were derived.
59. The system of any of clauses 54-58, wherein the value blocks are derived from a sequence-alignment representation having a batch dimension, an aligned-sequence dimension, a sequence-position dimension, and a channel dimension, and wherein the weight blocks are derived from a pair-representation tensor having a batch dimension, a first sequence-position dimension, a second sequence-position dimension, and a head dimension.
60. The system of any of clauses 54-59, wherein the value blocks are sharded on the two-dimensional GPU mesh over the aligned-sequence dimension and the sequence-position dimension, and wherein the weight blocks are sharded on the two-dimensional GPU mesh over the first sequence-position dimension and the second sequence-position dimension.
61. One or more processors, comprising: circuitry to: generate local projected blocks of a first projected tensor and a second projected tensor for an outer-product-mean computation from a local block of a sequence-alignment representation; receive communicated projected blocks of one of the first projected tensor and the second projected tensor aligned with local projected blocks of the other of the first projected tensor and the second projected tensor for the outer-product-mean computation; compute, based on the local projected blocks and the communicated projected blocks, a local outer-product contribution for ordered pairs of aligned positions of a local pair block; and generate an updated local pair block for the outer-product-mean computation by combining the local outer-product contribution with an accumulated local pair block and normalization information associated with aligned sequences of an aligned-sequence axis of the sequence-alignment representation, the normalization information comprising count information associated with the aligned sequences contributing to the local pair block.
62. The one or more processors of clause 61, wherein the local outer-product contribution comprises, for each ordered pair of aligned positions of the local pair block, an outer product over a hidden-feature axis of the first projected tensor and a hidden-feature axis of the second projected tensor.
63. The one or more processors of any of clauses 61-62, wherein the circuitry is further to transmit blocks of the first projected tensor to peer GPU devices along GPU rows and to transmit blocks of the second projected tensor to peer GPU devices along GPU columns.
64. The one or more processors of any of clauses 61-63, wherein the count information comprises updated local contribution-count information, and the circuitry is further to reduce the updated local contribution-count information across processors holding different shards of the aligned-sequence axis to generate a divisor for normalizing the updated local pair block.
65. The one or more processors of any of clauses 61-64, wherein, during a backward pass for the outer-product-mean computation, the circuitry is further to perform separate distributed ring passes to generate respective gradients for the first projected tensor and the second projected tensor based on gradient data associated with the local pair block and communicated blocks of the other projected tensor.
66. The one or more processors of any of clauses 61-65, wherein the sequence-alignment representation is sharded across the aligned-sequence axis and an aligned-position axis of a two-dimensional GPU mesh, and the local pair block is sharded across first and second aligned-position axes of the two-dimensional GPU mesh.
67. A method, comprising: generating local projected blocks of a first projected tensor and a second projected tensor for an outer-product-mean computation from a local block of a sequence-alignment representation; receiving communicated projected blocks of one of the first projected tensor and the second projected tensor aligned with local projected blocks of the other of the first projected tensor and the second projected tensor for the outer-product-mean computation; computing, based on the local projected blocks and the communicated projected blocks, a local outer-product contribution for ordered pairs of aligned positions of a local pair block; and generating an updated local pair block for the outer-product-mean computation by combining the local outer-product contribution with an accumulated local pair block and normalization information associated with aligned sequences of an aligned-sequence axis of the sequence-alignment representation, the normalization information comprising count information associated with the aligned sequences contributing to the local pair block.
68. The method of clause 67, wherein the sequence-alignment representation is sharded across the aligned-sequence axis and an aligned-position axis of a two-dimensional GPU mesh, and the local pair block is sharded across first and second aligned-position axes of the two-dimensional GPU mesh.
69. The method of any of clauses 67-68, wherein the method further comprises, prior to a first communication step, transposing ownership of blocks of one of the first projected tensor and the second projected tensor across a two-dimensional GPU mesh.
70. The method of any of clauses 67-69, wherein the method further comprises, prior to the first communication step, circularly shifting blocks of the first projected tensor along GPU rows by row-index-based offsets and blocks of the second projected tensor along GPU columns by column-index-based offsets.
71. The method of any of clauses 67-70, wherein the method further comprises aligning the circularly shifted blocks so that, for the first communication step, a currently resident block of the first projected tensor and a currently resident block of the second projected tensor share a same shard index of the aligned-sequence axis.
72. The method of any of clauses 67-71, wherein the local outer-product contribution comprises, for each ordered pair of aligned positions of the local pair block, an outer product over a hidden-feature axis of the first projected tensor and a hidden-feature axis of the second projected tensor.
73. The method of any of clauses 67-72, wherein, during a backward pass for the outer-product-mean computation, the method further comprises performing separate distributed ring passes to generate respective gradients for the first projected tensor and the second projected tensor based on gradient data associated with the local pair block and communicated blocks of the other projected tensor.
74. A system, comprising: one or more processors to: generate local projected blocks of a first projected tensor and a second projected tensor for an outer-product-mean computation from a local block of a sequence-alignment representation; receive communicated projected blocks of one of the first projected tensor and the second projected tensor aligned with local projected blocks of the other of the first projected tensor and the second projected tensor for the outer-product-mean computation; compute, based on the local projected blocks and the communicated projected blocks, a local outer-product contribution for ordered pairs of aligned positions of a local pair block; and generate an updated local pair block for the outer-product-mean computation by combining the local outer-product contribution with an accumulated local pair block and normalization information associated with aligned sequences of an aligned-sequence axis of the sequence-alignment representation, the normalization information comprising count information associated with the aligned sequences contributing to the local pair block.
75. The system of clause 74, wherein the one or more processors are further to transmit blocks of the first projected tensor to peer GPU devices along GPU rows and to transmit blocks of the second projected tensor to peer GPU devices along GPU columns.
76. The system of any of clauses 74-75, wherein the count information comprises updated local contribution-count information, and the one or more processors are further to reduce the updated local contribution-count information across processors holding different shards of the aligned-sequence axis to generate a divisor for normalizing the updated local pair block.
77. The system of any of clauses 74-76, wherein the sequence-alignment representation is sharded across the aligned-sequence axis and an aligned-position axis of a two-dimensional GPU mesh, and the local pair block is sharded across first and second aligned-position axes of the two-dimensional GPU mesh.
78. The system of any of clauses 74-77, wherein the one or more processors are further to, prior to a first communication step, transpose ownership of blocks of one of the first projected tensor and the second projected tensor across a two-dimensional GPU mesh.
79. The system of any of clauses 74-78, wherein the one or more processors are further to, prior to the first communication step, circularly shift blocks of the first projected tensor along GPU rows by row-index-based offsets and blocks of the second projected tensor along GPU columns by column-index-based offsets to align the first projected tensor and the second projected tensor to share a same shard index of the aligned-sequence axis for the first communication step.
80. The system of any of clauses 74-79, wherein, during a backward pass for the outer-product-mean computation, the one or more processors are further to perform separate distributed ring passes to generate respective gradients for the first projected tensor and the second projected tensor based on gradient data associated with the local pair block and communicated blocks of the other projected tensor.
81. One or more processors, comprising: circuitry to: generate, for an attention computation, a local query block; prior to repeated ring-communication steps along a first mesh axis of a two-dimensional GPU mesh, redistribute key blocks, value blocks, and, where used, mask blocks across a second mesh axis of the two-dimensional GPU mesh; during the repeated ring-communication steps along the first mesh axis, receive communicated attention data including key blocks, value blocks, and pair-bias blocks derived from a pair-representation tensor, wherein the pair-bias blocks are passed in coordination with corresponding key blocks and value blocks such that, at each repeated ring-communication step, a received key block, a received value block, and a received pair-bias block correspond to the same query-key comparisons as the local query block; and generate a local output block for the local query block based on local attention contributions computed using the local query block and the communicated attention data.
82. The one or more processors of clause 81, wherein redistributing the key blocks, the value blocks, and, where used, the mask blocks across the second mesh axis comprises transposing ownership of the key blocks, the value blocks, and, where used, the mask blocks across the second mesh axis.
83. The one or more processors of any of clauses 81-82, wherein the circuitry is further to perform the repeated ring-communication steps without transmitting the local query block to another GPU of the two-dimensional GPU mesh.
84. The one or more processors of any of clauses 81-83, wherein the pair-bias blocks are generated, prior to the repeated ring-communication steps, by applying a learned pair-bias projection to local blocks of the pair-representation tensor.
85. The one or more processors of any of clauses 81-84, wherein the single-representation tensor includes a batch dimension, a sequence-position dimension, and a single-representation feature dimension, and the pair-representation tensor includes a batch dimension, a first sequence-position dimension, a second sequence-position dimension, and a pair-representation feature dimension, the pair-representation tensor storing, for each ordered pair of sequence positions, a feature vector corresponding to a query-key comparison between the ordered pair of sequence positions.
86. The one or more processors of any of clauses 81-85, wherein generating the local output block comprises rescaling a previously generated local output block and a current local attention contribution using a running maximum-score value and a running normalization value representing a logarithm of a sum of exponentials.
87. The one or more processors of any of clauses 81-86, wherein the circuitry is further to enqueue communication for a subsequent ring-communication step concurrently with computing a current local attention contribution using double-buffered receive buffers.
88. The one or more processors of any of clauses 81-87, wherein, during a backward pass, the circuitry is further to compute local query-gradient, key-gradient, value-gradient, and pair-bias-gradient contributions from saved forward-pass tensors, transpose key-gradient and value-gradient contributions to a forward-pass ownership layout, and all-reduce query-gradient, key-gradient, and value-gradient contributions across a context-parallel mesh axis.
89. A method, comprising: generating, by a GPU of a two-dimensional GPU mesh and for an attention computation, a local query block; prior to repeated ring-communication steps along a first mesh axis of the two-dimensional GPU mesh, redistributing key blocks, value blocks, and, where used, mask blocks across a second mesh axis of the two-dimensional GPU mesh; during the repeated ring-communication steps along the first mesh axis, receiving communicated attention data including key blocks, value blocks, and pair-bias blocks derived from a pair-representation tensor, wherein the pair-bias blocks are passed in coordination with corresponding key blocks and value blocks such that, at each repeated ring-communication step, a received key block, a received value block, and a received pair-bias block correspond to the same query-key comparisons as the local query block; and generating a local output block for the local query block based on local attention contributions computed using the local query block and the communicated attention data.
90. The method of clause 89, wherein redistributing the key blocks, the value blocks, and, where used, the mask blocks across the second mesh axis comprises transposing ownership of the key blocks, the value blocks, and, where used, the mask blocks across the second mesh axis so that different sequence-position shards of the key blocks and the value blocks reside on different GPUs of the second mesh axis.
91. The method of any of clauses 89-90, further comprising generating a local key block and a local value block by applying respective learned projections to a local block of a single-representation tensor, and generating the pair-bias blocks, prior to the repeated ring-communication steps, by applying a learned pair-bias projection to local blocks of the pair-representation tensor, wherein the single-representation tensor includes a batch dimension, a sequence-position dimension, and a single-representation feature dimension, and the pair-representation tensor includes a batch dimension, a first sequence-position dimension, a second sequence-position dimension, and a pair-representation feature dimension.
92. The method of any of clauses 89-91, wherein generating the local output block comprises combining a current local attention contribution with a previously generated local output block using a running maximum-score value and a running normalization value representing a logarithm of a sum of exponentials.
93. The method of any of clauses 89-92, wherein, during the repeated ring-communication steps, the GPU transmits key blocks, value blocks, pair-bias blocks, and, where used, mask blocks to a neighboring GPU device along the first mesh axis, and no non-query attention block is shifted along the second mesh axis during the repeated ring-communication steps.
94. The method of any of clauses 89-93, wherein, during a backward pass, the method further comprises computing local query-gradient, key-gradient, value-gradient, and pair-bias-gradient contributions from saved forward-pass tensors, transposing ownership of key-gradient and value-gradient contributions to a forward-pass ownership layout, and all-reducing query-gradient, key-gradient, and value-gradient contributions across a context-parallel mesh axis.
95. A system, comprising: a GPU device of a two-dimensional GPU mesh, the GPU device including one or more processors configured to: generate, for an attention computation, a local query block, a local key block, and a local value block by applying respective learned projections to a local block of a single-representation tensor; prior to repeated ring-communication steps along a first mesh axis of the two-dimensional GPU mesh, redistribute the local key block, the local value block, and, where used, a local mask block across a second mesh axis of the two-dimensional GPU mesh by transposing ownership; generate, prior to the repeated ring-communication steps, a pair-bias block by applying a learned pair-bias projection to a local block of a pair-representation tensor; during the repeated ring-communication steps along the first mesh axis, receive communicated attention data including key blocks, value blocks, and pair-bias blocks, wherein, at each repeated ring-communication step, a received key block, a received value block, and a received pair-bias block correspond to the same query-key comparisons as the local query block; and generate a local output block for the local query block based on local attention contributions computed using the local query block and the communicated attention data.
96. The system of clause 95, wherein the one or more processors are further configured to: (a) redistribute the local key block, the local value block, and, where used, the local mask block across the second mesh axis by transposing ownership; (b) generate the pair-bias block by applying the learned pair-bias projection to the local block of the pair-representation tensor; and (c) perform the repeated ring-communication steps along the first mesh axis, each repeated ring-communication step transmitting a currently resident key block, a currently resident value block, a currently resident pair-bias block, and, where used, a currently resident mask block to a neighboring GPU device along the first mesh axis.
97. The system of any of clauses 95-96, wherein, during the repeated ring-communication steps, the one or more processors are further configured to transmit key blocks, value blocks, pair-bias blocks, and, where used, mask blocks only along the first mesh axis and not shift non-query attention blocks along the second mesh axis during the repeated ring-communication steps.
98. The system of any of clauses 95-97, wherein the single-representation tensor includes a batch dimension, a sequence-position dimension, and a single-representation feature dimension, the pair-representation tensor includes a batch dimension, a first sequence-position dimension, a second sequence-position dimension, and a pair-representation feature dimension, and ownership of the local block of the pair-representation tensor used to generate the pair-bias block is unchanged by the transposing ownership of the local key block, the local value block, and, where used, the local mask block.
99. The system of any of clauses 95-98, wherein generating the local output block comprises combining a current local attention contribution with a previously generated local output block using a running maximum-score value and a running normalization value representing a logarithm of a sum of exponentials.
100. The system of any of clauses 95-99, wherein, during a backward pass, the one or more processors are further configured to compute local query-gradient, key-gradient, value-gradient, and pair-bias-gradient contributions from saved forward-pass tensors, transpose ownership of key-gradient and value-gradient contributions to a forward-pass ownership layout, and all-reduce query-gradient, key-gradient, and value-gradient contributions across a context-parallel mesh axis.

As will be apparent to one of ordinary skill in the art, other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

As described further herein, processors, such as those disclosed in FIGS. 14-17B can use instructions to perform any of the operations described herein. Instructions, for example, can be performed using one or more threads. A thread block can include any number of threads of execution. A workgroup can be a thread block. A processor can execute a group of threads (e.g., 16 threads). A group of threads can also be referred to as a warp, or subgroup, or wavefront (e.g., as used by AMD and Intel). Each thread in a warp, wave, subgroup, or wavefront can belong to a single thread block and can be configured to process a different set of data based on a single set of instructions. A lane can be a thread. A work item can be a thread, such as, but not limited to, e.g., with OpenCL.

A processor, such as, processors described further herein (e.g., FIGS. 14-17B) can include one or more threads that can perform instructions synchronously. A thread can perform instructions synchronously. For example, a thread can perform a sequence of two instructions. An output of the first instruction can be input to the second instruction.

In at least one embodiment, a thread performs an instruction asynchronously if the thread performs one or more subsequent instructions before a processor's completion of all operations corresponding to the instruction have been completely been performed. For example, the thread can perform the instruction to cause a processor to queue or otherwise begin performing an operation and the thread can perform subsequent instructions before the processor has completed performing the operation. A processor, such as, processors described further herein (e.g., FIGS. 14-17B) can perform instructions asynchronously. For example, a thread may submit or issue an instruction to be performed by processor, and processor can perform the instruction independently of a thread that can be performing other instruction(s). A thread may submit or issue an instruction that can be performed by processor, and, for example, can inform one or more threads (the same thread or other threads) when the processor has performed a previously submitted or issued instruction. A thread may perform a first instruction to wait to be informed that processor has performed previously submitted or issued instructions, and, for example, output from the processor can be available to the thread. Output from processor can be input to a thread performing a second instruction. Instructions can be performed asynchronously in a variety of sequences. For example, one or more threads may submit one or more instructions to a processor, and processor may perform instructions in a sequence that is the same or different than an order submitted by the threads. Processor may specify a sequencing for the instructions that the processor performs.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Use of “may” and/or “can” is intended to indicate by way of example without limiting any particular embodiment or component or other function described above, below, or elsewhere herein. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as, but not limited to, phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). Number of items in a plurality can be at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. A process such as, but not limited to, those processes described herein (or variations and/or combinations thereof) can be performed under control of one or more computer systems configured with executable instructions and is implemented as code (e.g., executable instructions, one or more computer programs or one or more applications) executing collectively on one or more processors, by hardware or combinations thereof. Code can be stored on a computer-readable storage medium, for example, in form of a computer program comprising a plurality of instructions executable by one or more processors. A computer-readable storage medium can be a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. Code (e.g., executable code or source code) can be stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media can include multiple non-transitory computer-readable storage media and one or more of individual non-transitory storage media of multiple non-transitory computer-readable storage media lack all of code while multiple non-transitory computer-readable storage media collectively store all of code. Executable instructions can be executed such that different instructions are executed by different processors—for example, a non-transitory computer-readable storage medium store instructions and a main central processing unit (“CPU”) executes some of instructions while a graphics processing unit (“GPU”) executes other instructions. Different components of a computer system can have separate processors and different processors execute different subsets of instructions.

An arithmetic logic unit can include a set of combinational logic circuitry that takes one or more inputs to produce a result. An arithmetic logic unit can be used by a processor to implement mathematical operation such as, but not limited to, addition, subtraction, or multiplication. An arithmetic logic unit is used to implement logical operations such as, but not limited to, logical AND/OR or XOR. An arithmetic logic unit can be stateless, and made from physical switching components such as, but not limited to, semiconductor transistors arranged to form logical gates. An arithmetic logic unit may operate internally as a stateful logic circuit with an associated clock. An arithmetic logic unit may be constructed as an asynchronous logic circuit with an internal state not maintained in an associated register set. An arithmetic logic unit can be used by a processor to combine operands stored in one or more registers of the processor and produce an output that can be stored by the processor in another register or a memory location.

As a result of processing an instruction retrieved by the processor, the processor may present one or more inputs or operands to an arithmetic logic unit, causing the arithmetic logic unit to produce a result based at least in part on an instruction code provided to inputs of the arithmetic logic unit. The instruction codes provided by the processor to the ALU may be based at least in part on the instruction executed by the processor. Combinational logic in the ALU may process the inputs and produces an output which is placed on a bus within the processor. A processor can select a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

One or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Computer systems can be configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as, but not limited to,”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as, but not limited to, “processing,” “computing,” “calculating,” “determining,” or like, refer to action and/or processes of a computer or computing system, or similar electronic computing device, that manipulate and/or transform data represented as physical, such as, but not limited to, electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU or other accelerator. A “computing platform” may comprise one or more processors. As used herein, “software” processes may include, for example, software and/or hardware entities that perform work over time, such as, but not limited to, tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

References may be made to obtaining, acquiring, receiving, or inputting analog or digital data into a subsystem, computer system, or computer-implemented machine. Processes of obtaining, acquiring, receiving, or inputting analog and digital data can be accomplished in a variety of ways such as, but not limited to, by receiving data as a parameter of a function call or a call to an application programming interface. Processes of obtaining, acquiring, receiving, or inputting analog or digital data can be accomplished by transferring data via a serial or parallel interface. Processes of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. One or more processors, comprising: circuitry to:
receive, during successive communication steps on a GPU of a two-dimensional GPU mesh, aligned distributed value blocks derived from a sequence-alignment representation and aligned distributed weight blocks derived from a pair-representation tensor, the aligned distributed value blocks and the aligned distributed weight blocks being for the same weighted-averaging computation over a shared sequence-position axis and being distributed according to different sharding arrangements on the two-dimensional GPU mesh;
compute, from currently aligned ones of the aligned distributed value blocks and the aligned distributed weight blocks, a local weighted-averaging contribution and local normalization information;
update a local normalization state across the successive communication steps based on the local normalization information; and
generate a local output block for the weighted-averaging computation based on the local weighted-averaging contribution and the local normalization state.

2. The one or more processors of claim 1, wherein computing the local weighted-averaging contribution comprises applying a softmax normalization to the weight blocks along the shared sequence-position axis to generate local weights and applying the local weights to the value blocks, and wherein the local normalization information comprises a local maximum-score value and a local logarithm of a sum of exponentials of values obtained by subtracting the local maximum-score value from respective weighting values.

3. The one or more processors of claim 1, wherein the circuitry is further to redistribute the weight blocks prior to the weighted-averaging computation by transferring a weight block owned by a GPU having a first coordinate on a first mesh axis and a second coordinate on a second mesh axis to a GPU having a second coordinate on the first mesh axis and the first coordinate on the second mesh axis.

4. The one or more processors of claim 1, wherein the circuitry is further to, after redistributing the weight blocks and prior to a first communication step, circularly shift value blocks along a row axis by an offset based on a column-axis coordinate and circularly shift redistributed weight blocks along a column axis by an offset based on a row-axis coordinate.

5. The one or more processors of claim 1, wherein the circuitry is further to, for each step in a fixed number of communication steps, circularly shift value blocks along a row axis by at least one block, and to circularly shift weight blocks along the column axis by at least one block.

6. The one or more processors of claim 1, wherein the value blocks are derived from a sequence-alignment representation having a batch dimension, an aligned-sequence dimension, a sequence-position dimension, and a channel dimension, and wherein the weight blocks are derived from a pair-representation tensor having a batch dimension, a first sequence-position dimension, a second sequence-position dimension, and a head dimension.

7. The one or more processors of claim 1, wherein the value blocks are sharded on the two-dimensional GPU mesh over the aligned-sequence dimension and the sequence-position dimension, and wherein the weight blocks are sharded on the two-dimensional GPU mesh over the first sequence-position dimension and the second sequence-position dimension.

8. The one or more processors of claim 1, wherein the circuitry is further to, during a backward pass, shift post-softmax weight blocks along a second mesh axis, shift output-gradient blocks and softmax-correction data along a first mesh axis, accumulate a local value gradient, accumulate weight-gradient contributions via a virtual all-reduce across successive communication steps, and, after the successive communication steps, restore weight-gradient ownership to devices corresponding to original ownership of pair-representation blocks from which the weight blocks were derived.

9. A method, comprising:
receiving, during successive communication steps on a GPU of a two-dimensional GPU mesh, aligned distributed value blocks derived from a sequence-alignment representation and aligned distributed weight blocks derived from a pair-representation tensor, the aligned distributed value blocks and the aligned distributed weight blocks being for the same weighted-averaging computation over a shared sequence-position axis and being distributed according to different sharding arrangements on the two-dimensional GPU mesh;
computing, from currently aligned ones of the aligned distributed value blocks and the aligned distributed weight blocks, a local weighted-averaging contribution and local normalization information;
updating a local normalization state across the successive communication steps based on the local normalization information; and
generating a local output block for the weighted-averaging computation based on the local weighted-averaging contribution and the local normalization state.

10. The method of claim 9, wherein computing the local weighted-averaging contribution comprises applying a softmax normalization to the weight blocks along the shared sequence-position axis to generate local weights and applying the local weights to the value blocks, and wherein the local normalization information comprises a local maximum-score value and a local logarithm of a sum of exponentials of values obtained by subtracting the local maximum-score value from respective weighting values.

11. The method of claim 9, further comprising, prior to a first communication step, redistributing the weight blocks by transferring a weight block owned by a GPU having a first coordinate on a first mesh axis and a second coordinate on a second mesh axis to a GPU having a second coordinate on the first mesh axis and the first coordinate on the second mesh axis, circularly shifting value blocks along a row axis by an offset based on a column-axis coordinate, and circularly shifting redistributed weight blocks along a column axis by an offset based on a row-axis coordinate.

12. The method of claim 9, further comprising, for each step in a fixed number of communication steps:
circularly shifting one or more value blocks along a row axis by at least one block; and
circularly shifting one or more weight blocks along the column axis by at least one block.

13. A system, comprising: one or more processors to:
receive, during successive communication steps on a GPU of a two-dimensional GPU mesh, aligned distributed value blocks derived from a sequence-alignment representation and aligned distributed weight blocks derived from a pair-representation tensor, the aligned distributed value blocks and the aligned distributed weight blocks being for the same weighted-averaging computation over a shared sequence-position axis and being distributed according to different sharding arrangements on the two-dimensional GPU mesh;
compute, from currently aligned ones of the aligned distributed value blocks and the aligned distributed weight blocks, a local weighted-averaging contribution and local normalization information;
update a local normalization state across the successive communication steps based on the local normalization information; and
generate a local output block for the weighted-averaging computation based on the local weighted-averaging contribution and the local normalization state.

14. The system of claim 13, wherein computing the local weighted-averaging contribution comprises applying a softmax normalization to the weight blocks along the shared sequence-position axis to generate local weights and applying the local weights to the value blocks, and wherein the local normalization information comprises a local maximum-score value and a local logarithm of a sum of exponentials of values obtained by subtracting the local maximum-score value from respective weighting values.

15. The system of claim 13, wherein the one or more processors are further to redistribute the weight blocks prior to the weighted-averaging computation by transferring a weight block owned by a GPU having a first coordinate on a first mesh axis and a second coordinate on a second mesh axis to a GPU having a second coordinate on the first mesh axis and the first coordinate on the second mesh axis.

16. The system of claim 13, wherein the one or more processors are further to, for each step in a fixed number of communication steps, circularly shift one or more value blocks along a row axis by one block, and circularly shift one or more weight blocks along the column axis by one block.

17. The system of claim 13, wherein the one or more processors are further to, after redistributing the weight blocks and prior to a first communication step, circularly shift value blocks along a row axis by an offset based on a column-axis coordinate and circularly shift redistributed weight blocks along a column axis by an offset based on a row-axis coordinate.

18. The system of claim 13, wherein the one or more processors are further to, during a backward pass, shift post-softmax weight blocks along a second mesh axis, shift output-gradient blocks and softmax-correction data along a first mesh axis, accumulate a local value gradient, accumulate weight-gradient contributions via a virtual all-reduce across successive communication steps, and, after the successive communication steps, restore weight-gradient ownership to devices corresponding to original ownership of pair-representation blocks from which the weight blocks were derived.

19. The system of claim 13, wherein the value blocks are derived from a sequence-alignment representation having a batch dimension, an aligned-sequence dimension, a sequence-position dimension, and a channel dimension, and wherein the weight blocks are derived from a pair-representation tensor having a batch dimension, a first sequence-position dimension, a second sequence-position dimension, and a head dimension.

20. The system of claim 13, wherein the value blocks are sharded on the two-dimensional GPU mesh over the aligned-sequence dimension and the sequence-position dimension, and wherein the weight blocks are sharded on the two-dimensional GPU mesh over the first sequence-position dimension and the second sequence-position dimension.
